(19) United States
(12) Patent Application Publication
(10) Pub. No.: US 2026/0125493 A1
(43) Pub. Date: May 7, 2026

(54) SYSTEMS AND METHODS FOR MANUFACTURING HYDROXYPROPYL-BETA-CYCLODEXTRIN

(71) Applicant: Beren Therapeutics P.B.C., West Hollywood, CA (US)

(72) Inventors: Steven Pfeiffer, West Hollywood, CA (US); Benjamin Rizkin, West Hollywood, CA (US)

(21) Appl. No.: 18/874,525

(22) PCT Filed: Jun. 13, 2023
(86) PCT No.: PCT/IB2023/056096

§ 371 Date: Dec. 12, 2024

Related U.S. Application Data
(60) Provisional application No. 63/351,719, filed on Jun. 13, 2022.

(51) Int. Cl. C08B 37/16; B01D 61/02; B01D 69/06; B01J 19/00; B01J 19/24

(52) U.S. Cl. CPC C08B 37/0012; B01D 61/027; B01D 69/06; B01J 19/0013; B01J 19/0053; B01J 19/24; B01D 2311/08; B01D 2315/16; B01J 2219/00054; B01J 2219/00164; B01J 2219/1944

(57) ABSTRACT

Provided herein are systems and methods for manufacturing hydroxypropyl-β-cyclodextrin.

### CROSS-REFERENCE TO RELATED APPLICATIONS

This application is a 371 application claiming priority to PCT/IB2023/056096 titled “SYSTEMS AND METHODS FOR MANUFACTURING HYDROXYPROPYL-BETA-CYCLODEXTRIN,” filed Jun. 13, 2023, which claims priority to U.S. Provisional Application No. 63/351,719 entitled “SYSTEMS AND METHODS FOR MANUFACTURING HYDROXYPROPYL-BETA-CYCLODEXTRIN” filed Jun. 13, 2022, the entire contents of which are incorporated by reference herein.

### SEQUENCE LISTING

The present application contains a Sequence Listing which has been submitted electronically in .XML format and is hereby incorporated by reference in its entirety. Said computer readable file was created on Nov. 3, 2025, is named “P085960WO-Sequence-Listing.xml” and is 77,607 bytes in size.

### FIELD

The present disclosure relates to systems and methods for manufacturing hydroxypropyl-β-cyclodextrin. Therefore, the disclosure generally relates to the fields of chemistry, pharmacy, and chemical engineering.

### BACKGROUND

Hydroxypropyl-β-cyclodextrin (HPBCD) is of growing interest in the pharmaceutical field for its potential to treat multiple disease types. New systems and methods for producing HPBCD are therefore needed to meet growing demand.

### SUMMARY OF THE DISCLOSURE

Provided herein is a reactor system for producing hydroxypropyl-β-cyclodextrin (HPBCD). The system comprises a propylene oxide feed, a β-cyclodextrin (BCD) feed, a mass flow meter or mass flow controller, and a static mixer. In some embodiments, the system further comprises a back pressure regulator. In some additional embodiments, the system comprises a mass flow controller. In still further embodiments, the system comprises a temperature controller. In some aspects, the static mixer is a helical static mixer.

In some embodiments, the propylene oxide feed is pressurized. In other embodiments, the BCD feed is pressurized.

In some embodiments, the system comprises at least two propylene oxide feeds. In some aspects, the at least two propylene oxide feeds are operably connected to a separate mass flow meter or controller. In some embodiments, a first propylene oxide feed provides a concentration from about 7 to about 15 equivalents of BCD and a second propylene oxide feed provides a concentration from about 3.5 to about 15 equivalents of BCD.

In some embodiments, the BCD feed comprises sodium hydroxide (NaOH). In some aspects, the β-cyclodextrin feed comprises a concentration from about 5 to about 10 equivalents of NaOH.

In some embodiments, the system further comprises a pump. In some aspects, the pump may be a syringe pump operably connected to one or more of the feeds.

In some embodiments, the system further comprises a coil of tubing. In some embodiments, the system comprises a plug flow reactor. In some aspects, the plug flow reactor comprises at least two coils of tubing and a temperature control unit. In some embodiments, a back pressure regulator is operably connected to a plug flow reactor or a coil of tubing. In some aspects, the temperature control unit maintains a temperature from about 30° C. to about 60° C.

In some embodiments, the propylene oxide is dosed in two places. In some aspects, the propylene oxide is dosed before a plug flow reactor. In some additional aspects, at least one dose of propylene oxide is dosed before a first coil of tubing, and at least another dose of propylene oxide is dosed before the second coil of tubing.

In some embodiments, the system further comprises a collection tank. In some aspects, the collection tank is operably connected to an acid feed. In some further aspects, the acid feed comprises hydrochloric acid, sulfuric acid, lactic acid, acetic acid, formic acid, citric acid, oxalic acid, uric acid, malic acid, fumaric acid, tartaric acid, or a combination thereof. In some additional aspects, the system provides a total residence time from about 30 minutes to about 70 minutes.

Further provided herein is a method of manufacturing a hydroxypropyl-β-cyclodextrin (HPBCD) mixture comprising: (a) contacting a hydroxypropyl-β-cyclodextrin (HPBCD) mixture with at least two solvents, the HPBCD mixture comprising high degree substitution HPBCD and low degree substitution HPBCD; (b) dissolving the high degree substitution HPBCD in one of the solvents; and, (c) removing the low degree substitution HPBCD by precipitation. In some embodiments, the at least two solvents comprise ethanol and acetone.

Further provided herein is a method of manufacturing a hydroxypropyl-β-cyclodextrin (HPBCD) mixture comprising: (a) contacting a hydroxypropyl-β-cyclodextrin (HPBCD) mixture with at least two solvents, the HPBCD mixture comprising high degree substitution HPBCD; (b) dissolving the high degree substitution HPBCD in one of the solvents to form a mother liquor; and (c) filtering off the mother liquor. In some embodiments, the method comprises lyophilizing the mother liquor to yield a solid. In some aspects, the method further comprises analyzing the solid by MALDI-TOF to determine the degree of substitution. In some embodiments, the at least two solvents comprise ethanol and acetone.

Further provided herein is a composition comprising a methylated 2-hydroxypropyl-β-cyclodextrin (HPBCD) mixture having a degree of substitution from about 6.5 to about 9.5 and methylated glucose bearing from 0 to 5 2-hydroxypropyl groups. In some examples, the composition may have a mass spectrum as depicted in FIG. 25.

Further provided herein is method of oligomeric substitution through methanolysis of a hydroxypropyl-β-cyclodextrin (HPBCD) mixture, the method comprising: (a) mixing HPBCD and methanol; (b) stirring until the HPBCD is dissolved; (c) adding an acid to the mixture; (d) heating the mixture to at least 50 to about 90° C.; (e) stirring the mixture and maintaining the heat for at least about 24 hours; (f) neutralizing the mixture with a base; and, (g) filtering the mixture.

Further provided herein is a method of purifying a hydroxypropyl-β-cyclodextrin (HPBCD) mixture comprising: (a) purifying a HPBCD mixture by nanofiltration; (b) collecting a nanofiltration permeate for a total of at least 5 diafiltration volumes; and, (c) lyophilizing a resulting retentate to yield a solid hydroxypropyl-β-cyclodextrin.

In some embodiments, the purifying occurs at a feed pressure from about 200 to about 400 psi (e.g., about 300 psi). In some embodiments, the purifying by nanofiltration comprises a flat sheet membrane. In some aspects, the flat sheet membrane comprises an area from 0.010 to 0.050 m².

In some embodiments, the method comprises collecting a nanofiltration permeate for a total of at least 7 diafiltration volumes, or more preferably a total of at least 10 diafiltration volumes.

Further provided herein is a method of purifying a hydroxypropyl-β-cyclodextrin (HPBCD) mixture comprising: (a) purifying a HPBCD mixture by nanofiltration; (b) collecting a nanofiltration permeate for a total of at least 5 diafiltration volumes; and, (c) analyzing a resulting retentate for propylene glycol content. In some embodiments, the method further comprises lyophilizing the resulting retentate to yield a solid hydroxypropyl-β-cyclodextrin.

In some embodiments, the claimed invention also encompasses compositions, including compositions produced according to any of the methods or systems described herein. For example, the composition may comprise a mixture of beta-cyclodextrin molecules substituted at one or more hydroxyl positions by hydroxypropyl groups, wherein: the mixture comprises less than 0.3% unsubstituted beta-cyclodextrin (“DS-0”) or less than 1% beta-cyclodextrin substituted with one hydroxypropyl group (“DS-1”), wherein the composition is suitable for intrathecal, intravenous, or intracerebroventricular administration to a patient in need thereof. The invention may alco include a composition produced by the method of any one of embodiments 26-30 or 33-42 or any one of claims 28-32 or 35-45, the composition comprising a mixture of beta-cyclodextrin molecules substituted at one or more hydroxyl positions by hydroxypropyl groups, wherein: the mixture comprises less than 1% unsubstituted beta-cyclodextrin (“DS-0”) and beta-cyclodextrin substituted with one hydroxypropyl group (“DS-1”); and, at least 70% of the beta-cyclodextrins have a DS within DSₐ±1σ, wherein σ is the standard deviation. In addition, the invention may comprise a composition produced by the method of any one of embodiments 26-30 or 33-42, or any one of claims 28-32 or 35-45, the composition comprising a mixture of beta-cyclodextrin molecules substituted at one or more hydroxyl positions by hydroxypropyl groups, wherein: the mixture comprises less than 1% unsubstituted beta-cyclodextrin (“DS-0”) and beta-cyclodextrin substituted with one hydroxypropyl group (“DS-1”); and, the mixture comprises from 1% to 10% beta-cyclodextrin substituted with seven hydroxypropyl groups (“DS-7”).

Alternatively, the composition may be produced by any of the methods described herein (such as the method of any one of embodiments 28-32 or 35-45), the composition comprising a mixture of beta-cyclodextrin molecules substituted at one or more hydroxyl positions by hydroxypropyl groups, wherein: the mixture comprises less than 1% unsubstituted beta-cyclodextrin (“DS-0”) and beta-cyclodextrin substituted with one hydroxypropyl group (“DS-1”); and, the mixture comprises no more than 25% beta-cyclodextrin substituted with four hydroxypropyl groups (“DS-4”). Similarly, the invention may include a composition produced by the method of any one of embodiments 26-30 or 33-42 or any one of claims 28-32 or 35-45, the composition comprising a mixture of beta-cyclodextrin molecules substituted at one or more hydroxyl positions by hydroxypropyl groups, wherein: the mixture comprises less than 1% unsubstituted beta-cyclodextrin (“DS-0”) and beta-cyclodextrin substituted with one hydroxypropyl group (“DS-1”); and, the mixture comprises no more than 20% beta-cyclodextrin substituted with five hydroxypropyl groups (“DS-5”). In another aspect, the composition may be produced by the method of any one of embodiments 26-30 or 33-42 or any one of claims 28-32 or 35-45, the composition comprising mixture of beta-cyclodextrin molecules substituted at one or more hydroxyl positions by hydroxypropyl groups, wherein: the mixture comprises less than 2.5% beta-cyclodextrin substituted with one hydroxypropyl group (“DS-1”), wherein the composition is suitable for intrathecal, intravenous, or intracerebroventricular administration to a patient in need thereof. The composition may be produced by the method of any one of embodiments 26-30 or 33-42 or any one of claims 28-32 or 35-45, the composition comprising a mixture of beta-cyclodextrin molecules substituted at one or more hydroxyl positions by hydroxypropyl groups, wherein: the mixture comprises less than 1% unsubstituted beta-cyclodextrin (“DS-0”) and beta-cyclodextrin substituted with one hydroxypropyl group (“DS-1”); and, the mixture comprises from 5% to 25% beta-cyclodextrin substituted with six hydroxypropyl groups (“DS-6”). Finally, the invention may also include a composition produced by the method of any of embodiments 26-30 or 33-42 or any one of claims 28-32 or 35-45, the composition comprising a mixture of beta-cyclodextrin molecules substituted at one or more hydroxyl positions by hydroxypropyl groups, wherein: the mixture comprises less than 1% unsubstituted beta-cyclodextrin (“DS-0”) and beta-cyclodextrin substituted with one hydroxypropyl group (“DS-1”); and beta-cyclodextrins having glucose units of the structure:

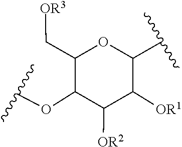

wherein R1, R2, and R3, independently for each occurrence, are —H or —HP, wherein HP comprises one or more hydroxypropyl groups, and the percentage of total occurrences of R1 and R2 combined that are HP ranges from 85% to 95% in the beta-cyclodextrin.
   In some embodiments, the current invention produces at least two different, at least three different, and least four different, at least five different compositions simultaneously, wherein each composition comprises a different mixture of beta-cyclodextrin molecules. As such, in some embodiments, the current invention produces at least a plurality of different compositions simultaneously, wherein each composition comprises a different mixture of beta-cyclodextrin molecules.

### BRIEF DESCRIPTION OF THE FIGURES

FIG. 1 shows an exemplary diagram of a system of the present disclosure.

FIG. 2 shows exemplary ¹H-NMR spectra. The top spectrum is a ¹H-NMR spectrum of β-cyclodextrin. The middle spectrum is a ¹H-NMR spectrum of HPBCD with a molecular weight of 1380 Da. The bottom spectrum is a ¹H-NMR spectrum of HPBCD with a molecular weight of 1540 Da.

FIG. 3 shows an HPLC-ELSD chromatogram (orange line) and approximate population generated by Monte Carlo rejection sampling represented as a histogram (blue bars).

FIG. 4 shows a plot of predicted vs. actual D.S. values using a fitted parametric equation described in Example 2. Orange dots are validation samples that were not used in the fit of the equation.

FIG. 5 shows a plot of predicted vs. actual D.S. values using the fitted parametric equation described in Example 2 showing negative estimated D.S. for low D.S. HPBCD species.

FIG. 6 shows a plot of predicted vs. actual D.S. values using a revised parametric equation (Equation 3) for estimation of D.S. from HPLC-ELSD data.

FIG. 7 shows a plot of predicted vs. actual D.S. values using a revised parametric equation (Equation 4) for estimation of D.S. from HPLC-ELSD data.

FIG. 8 shows a plot of D.S. values of HPBCD produced using a system described herein.

FIG. 9 shows a plot of the actual D.S. versus the calculated D.S for HPBCD produced using a system of the present disclosure.

FIG. 10 shows a plot of the actual HPLC-ELSD peak variance versus the calculated HPLC-ELSD peak variance for HPBCD produced using a system of the present disclosure.

FIG. 11 shows a ¹H-NMR spectrum of HPBCD prepared by isolation from ethanol/acetone.

FIG. 12 shows a ¹H-NMR spectrum of HPBCD material remaining in mother liquor after isolation from ethanol/acetone.

FIG. 13 shows overlaid HPLC-ELSD spectra of isolated solid HPBCD, the ingoing material, and the mother liquor after isolation from ethanol/acetone.

FIG. 14 shows the powder x-ray diffraction pattern of isolated solid HPBCD overlaid with the pattern of the starting material.

FIG. 15 shows the mother liquor concentration and D.S. for increasing volume % ethanol.

FIG. 16 shows the mother liquor concentration and D.S. for HPBCD in the mother liquor and solids with increasing acetone volume %.

FIG. 17 shows the ELSD data from discarded material from fractionated HPBCD.

FIG. 18 shows the ELSD data of the starting material overlaid with the product of fractionated HPBCD.

FIG. 19 shows a MALDI-TOF spectrum for purified HPBCD with D.S. 6.9 as determined by ¹H-NMR.

FIG. 20 shows a MALDI-TOF spectrum for purified HPBCD with D.S. 9.3 as determined by ¹H-NMR.

FIG. 21 shows MALDI-TOF data of crude quenched reactor effluent from with a D.S. of 7.7 as determined by HPLC-ELSD analysis.

FIG. 22 shows the product distribution of Cavitron HP7 HPBCD using MALDI-TOF.

FIG. 23 shows the product distribution for HPBCD made using a system of the present disclosure.

FIG. 24 shows the D.S. versus variance for the DoE MALDI-TOF data.

FIG. 25 shows a mass spectrum of methanolyzed HPBCD.

FIGS. 26A-26B show an exemplary flow diagram of a system of the present disclosure.

FIG. 27A depicts a non-limiting example of a one enzyme reaction to convert sucrose to amylose, in accordance with embodiments of the disclosure.

FIG. 27B depicts a non-limiting example of a two enzyme reaction to convert sucrose to amylose, in accordance with embodiments of the disclosure.

FIG. 28 depicts a non-limiting example of an enzymatic reaction to convert amylose to alpha-cyclodextrin, in accordance with embodiments of the disclosure.

### DETAILED DESCRIPTION

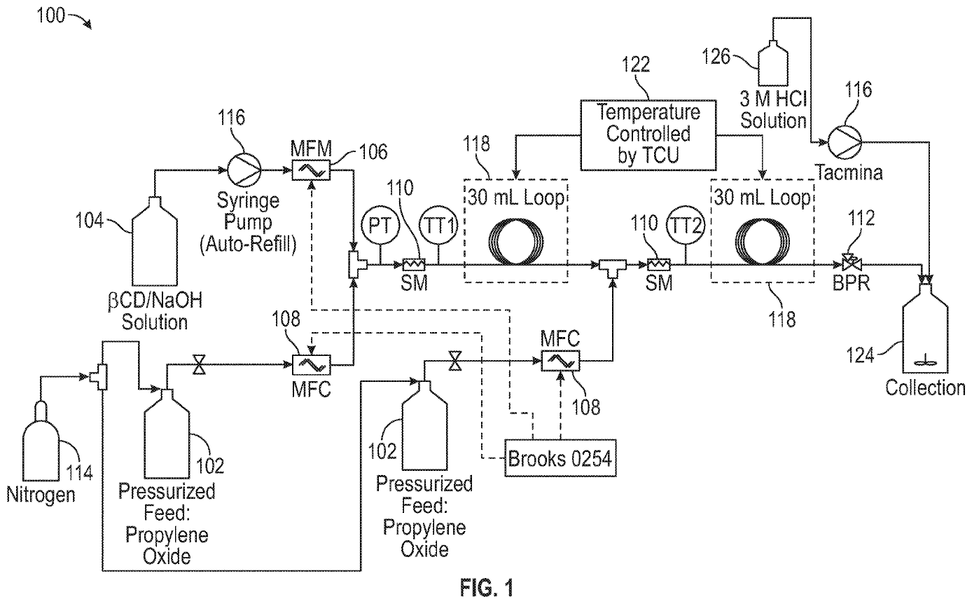

Provided herein are reactor systems for producing hydroxypropyl-β-cyclodextrin (HPBCD). Referring to FIG. 1, a reactor system 100 of the present disclosure generally includes a propylene oxide feed 102, a β-cyclodextrin (BCD) feed 104, a mass flow meter 106 or mass flow controller 108, and a static mixer 110. The propylene oxide from the propylene oxide feed 102 and the BCD from the BCD feed 104 are combined and mixed in a static mixer 110. The reactants then pass through a reactor 118 forming a first reactor effluent, after which, optionally, more propylene oxide from a second propylene oxide feed 102 is added. This mixture passes through a second static mixer 110 before entering a second reactor 118, forming a second reactor effluent. The second reactor effluent 118 is collected in a collection tank 124 where they are quenched with acid provided by an acid feed 126. The reactor systems described herein are operable to produce HPBCD efficiently and with a targeted degree of substitution.

The reactor systems of the present disclosure are operable to produce HPBCD according to the reaction scheme set out below. BCD is reacted with propylene oxide and base (e.g., sodium hydroxide), followed by quenching with an acid (e.g., hydrochloric acid).

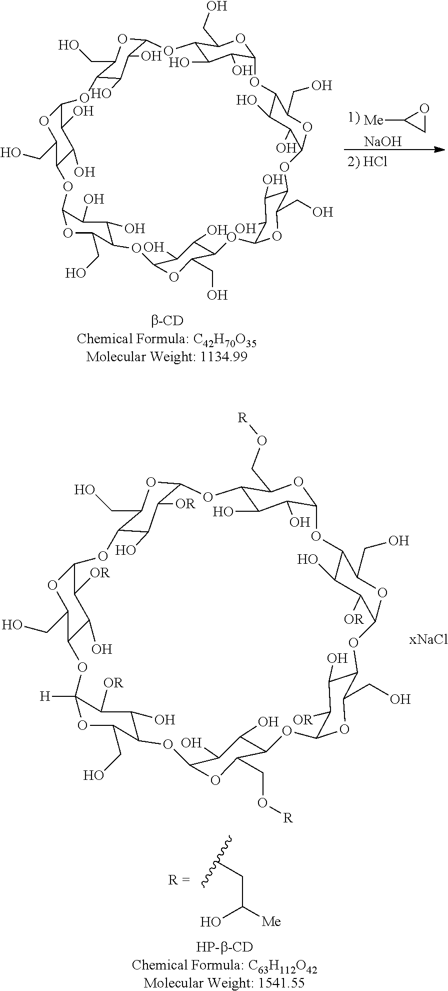

The system 100 includes at least one propylene oxide feed 102; however, it is noted the reactor system may include at least two propylene oxide feeds (i.e., at least a plurality of propylene oxide feeds), at least three propylene oxide feeds, and so on. The propylene oxide feed 102 may comprise a tank having piping and instrumentation operable to deliver the propylene oxide to the system 100. The propylene oxide may be introduced into the system at one or more locations. The propylene oxide may be introduced at a flow rate from about 0.1 g/min to about 10 g/min; for example, about 0.1 g/min, 0.2 g/min, 0.3 g/min, 0.4 g/min, 0.5 g/min, 0.6 g/min, 0.7 g/min, 0.8 g/min, 0.9 g/min, 1.0 g/min, 2.0 g/min, 3.0 g/min, 4.0 g/min, 5.0 g/min, 6.0 g/min, 7.0 g/min, 8.0 g/min, 9.0 g/min, or about 10.0 g/min. The propylene oxide may be dosed in one or more places in the system 100. In systems 100 having more than one reactor 118, the propylene oxide may be dosed before each reactor. For example, as in the system 100 of FIG. 1, the propylene oxide may be dosed in two places. In general, however, at least one dose of propylene oxide is dosed before a reactor 118. In some embodiments, the propylene oxide feed may comprise a racemic mixture of propylene oxide; in other embodiments, the propylene oxide feed may comprise an enantiopure propylene oxide. The propylene oxide may comprise deuterated propylene oxide.

The propylene oxide may be dosed at a concentration from about 1 to about 20, from about 3.5 to about 20, from about 5 to about 20, from about 7 to about 20, from about 1 to about 15, from about 3.5 to about 15, from about 5 to about 15, or from about 7 to about 15 molar equivalents of BCD. For example, the propylene oxide may be dosed at a concentration of about 1, about 2, about 3, about 4, about 5, about 6, about 7, about 8, about 9, about 10, about 11, about 12, about 13, about 14, about 15, about 16, about 17, about 18, about 19, or about 20 molar equivalents of BCD. In embodiments where the propylene oxide is dosed in two places, the first propylene oxide feed may provide propylene oxide at a concentration from about 7 to about 15 molar equivalents of BCD, and the second propylene oxide feed may provide propylene oxide at a concentration from about 3.5 to about 15 molar equivalents of BCD.

The system 100 includes at least one BCD feed 104. The BCD feed 104 may comprise a tank having piping and instrumentation operable to deliver the BCD to the system 100. The BCD may be introduced at a flow rate from about 0.0 g/min to about 20 g/min, from about 0.1 g/min to about 10 g/min, from about 0.5 g/min to about 7 g/min, or from about 1.0 g/min to about 5 g/min; for example, about 0.1 g/min, about 0.2 g/min, about 0.3 g/min, about 0.4 g/min, about 0.5 g/min, about 0.6 g/min, about 0.7 g/min, about 0.8 g/min, about 0.9 g/min, about 1.0 g/min, about 2.0 g/min, about 3.0 g/min, about 4.0 g/min, about 5.0 g/min, about 6.0 g/min, about 7.0 g/min, about 8.0 g/min, about 9.0 g/min, or about 10.0 g/min. The BCD feed may comprise deuterated BCD.

The system may further comprise a base or sodium hydroxide (NaOH) feed. The base or sodium hydroxide may be provided at a concentration from about 1 to about 10, from about 3 to about 10, from about 5 to about 10, or from about 7 to about 10 molar equivalents of BCD, or more preferably about 5 to about 10 molar equivalents of BCD. In some embodiments, the BCD feed may comprise the base or sodium hydroxide.

The propylene oxide feed(s) 102 and/or the BCD feed(s) 104 may be pressurized. Pressurizing the feeds may be beneficial when low flow rates (e.g., about 1.5 g/min) of the reactants are required. The feeds may be pressurized with an inert gas, such as a noble gas (e.g., helium, neon, argon, krypton, or xenon), or another non-reactive gas, such as nitrogen or carbon dioxide. The inert gas may be provided in a pressurization tank 114 operably connected to the feed.

The propylene oxide feed(s) 102 and/or the BCD feed(s) 104 may be operably connected to a mass flow meter 106. The mass flow meter 106 is operable to determine the mass flow rate of the propylene oxide or BCD. Mass flow meters and methods of measuring mass flow rates are generally known in the art. Additional mass flow meters may be included at other locations in the system to monitor the mass flow rate of the reactants and/or products.

The propylene oxide feed(s) 102 and/or the BCD feed(s) 104 may be operably connected to a mass flow controller 108. The mass flow controller is operable to control the mass flow rate of the propylene oxide or BCD; for example, the mass flow controller may increase, decrease, or hold constant the mass flow rate of the feed. Mass flow controllers and methods of measuring mass flow rates are generally known in the art.

The mass flow meter(s) 106 and/or the mass flow controller(s) 108 may be operably connected to a controller. The controller may be operable to communicate electronically or wirelessly to any of the system components. In general, the controller may include one or more processors and a non-transitory computer-readable storage medium having stored thereon instructions for causing the one or more processors to control one or more of startup, operation, or shutdown of any one or more of the various aspects of the system to facilitate safe and efficient operation. For example, the controller may interrupt power to any of the system components in the event an anomalous condition is detected. The controller may also be operable to open or close valves or adjust other system parameters (e.g., temperature and pressure) to ensure safe and efficient operation of the system.

The system 100 may further comprise at least one static mixer 110. The static mixer is operable to continuously mix the fluids flowing through the static mixer without the use of moving parts by directing flow to increase turbulence. Static mixers are generally well-known in the art and may comprise plates, baffles, helical elements, or geometric grids. In an exemplary embodiment, the static mixer is a helical static mixer. The system 100 may include one or more static mixers 110 at various points in the system 100.

One or more of the feeds may be operably connected to a pump 116. The pump may be any pump known in the art, including centrifugal pumps, positive displacement pumps, syringe pumps, etc. The pump 116 may be operably connected to one or more of the feeds. In an exemplary embodiment, the system includes a syringe pump operably connected to the BCD feed.

The system 100 may further comprise a reactor 118. The reactor comprises a plug flow reactor, which may comprise at least one coil of tubing. In some embodiments, the system may comprise two or more reactors. In additional embodiments, the plug flow reactor may comprise at least two coils of tubing. The reactor may have a volume of about 1 to about 1000 mL, about 1 to about 500 mL, about 1 to about 250 mL, or about 1 to about 100 mL; for example, about 1 mL, about 2 mL, about 3 mL, about 4 mL, about 5 mL, about 6 mL, about 7 mL, about 8 mL, about 9 mL, about 10 mL, about 20 mL, about 30 mL, about 40 mL, about 50 mL, about 60 mL, about 70 mL, about 80 mL, about 90 mL, about 100 mL, about 250 mL, about 500 mL, or about 1000 mL. The reactor may also have a volume of greater than 100 mL, greater than 250 mL, greater than 500 mL, or greater than 1000 mL.

The volume of the reactor and the flow rate of the reactants may be used to determine a residence time of the reactants in the reactor. The reactants may have a residence time in the reactor of about 1 minute to about 360 minutes, of about 3 minutes to about 180 minutes, about 5 minutes to about 90 minutes, or about 10 minutes to about 60 minutes; for example, about 10 minutes, about 15 minutes, about 20 minutes, about 25 minutes, about 30 minutes, about 35 minutes, about 40 minutes, about 45 minutes, about 50 minutes, about 55 minutes, or about 60 minutes. The reactants may have a residence time in the reactor greater than about 60 minutes, greater than about 90 minutes, greater than about 180 minutes, or greater than about 360 minutes.

The system 100 may further comprise a temperature control unit 122. The temperature control unit may be operably connected to one or more reactors 118. The temperature control unit 122 may maintain a temperature from about 40° C. to about 50° C., from about 35° C. to about 55° C., from about 30° C. to about 60° C., from about 25° C. to about 65° C., from about 20° C. to about 70° C., from about 15° C. to about 90° C., or from about 10° C. to about 95° C. in the reactor(s) 118.

The system 100 may further comprise a back pressure regulator 112. The back pressure regulator is operable to maintain a predetermined set pressure upstream from the back pressure regulator. Generally, the back pressure regulator 112 is placed near the end of the system 100; for example, directly before the collection tank 124. Thus, the back pressure regulator may be operably connected to the collection tank 124. The back pressure regulator may also be operably connected to a reactor. The back pressure regulator may be operable to maintain a back pressure from about 0 psi to about 500 psi, from about 1 psi to about 400 psi, from about 1 psi to about 300 psi, from about 3 psi to about 200 psi, from about 5 psi to about 100 psi, from about 10 psi to about 50 psi; for example, about 10 psi, about 15 psi, about 20 psi, about 25 psi, about 30 psi, about 35 psi, about 40 psi, about 45 psi, or about 50 psi. The back pressure regulator may be operable to maintain a back pressure greater than 5 psi, greater than 10 psi, greater than 25 psi, greater than 50 psi, greater than 100 psi, greater than 200 psi, greater than 300 psi, greater than 400 psi, or greater than 500 psi.

The system 100 may further comprise a collection tank 124. The collection tank may be operable to hold the products and/or any leftover reactants from the reaction. Additionally, the collection tank may be operable to quench the mixture from reactor 118 with an acid, such as hydrochloric acid. The acid may be fed stoichiometrically with relation to the HPBCD produced or in an amount sufficient to reach a predetermined pH. The contents of the collection tank generally include a crude HPBCD mixture. Collection tanks are generally known in the art. The collection tank may additionally include a stirring mechanism to continuously stir the contents and maintain a homogeneous mixture.

The system 100 may further comprise an acid feed 126. The acid feed 126 may be operably connected to the collection tank 124. The acid feed may comprise hydrochloric acid, sulfuric acid, lactic acid, acetic acid, formic acid, citric acid, oxalic acid, uric acid, malic acid, fumaric acid, tartaric acid, or a combination thereof. Alternatively, the reactor effluent may be quenched by contacting the reactor effluent with an acidic ion exchange resin, such as Amberlyst™ 35 Dry.

The system 100 may provide a total residence time of the components from about 5 minutes to about 360 minutes, 5 minutes to about 180 minutes, 10 minutes to about 100 minutes, or more preferably about 30 minutes to about 70 minutes. For example, the system may provide a total residence time of about 5 minutes, about 10 minutes, about 20 minutes, about 30 minutes, about 40 minutes, about 50 minutes, about 60 minutes, about 70 minutes, about 80 minutes, about 90 minutes, about 100 minutes, about 180 minutes, or about 360 minutes. The system may provide a total residence time greater than about 90 minutes, greater than about 100 minutes, greater than about 180 minutes, or greater than about 360 minutes.

In some embodiments, one or more of the feeds may comprise a deuterated material (e.g., deuterated BCD or deuterated propylene oxide). Use of the deuterated material in one or more feeds may produce a deuterated HPBCD mixture.

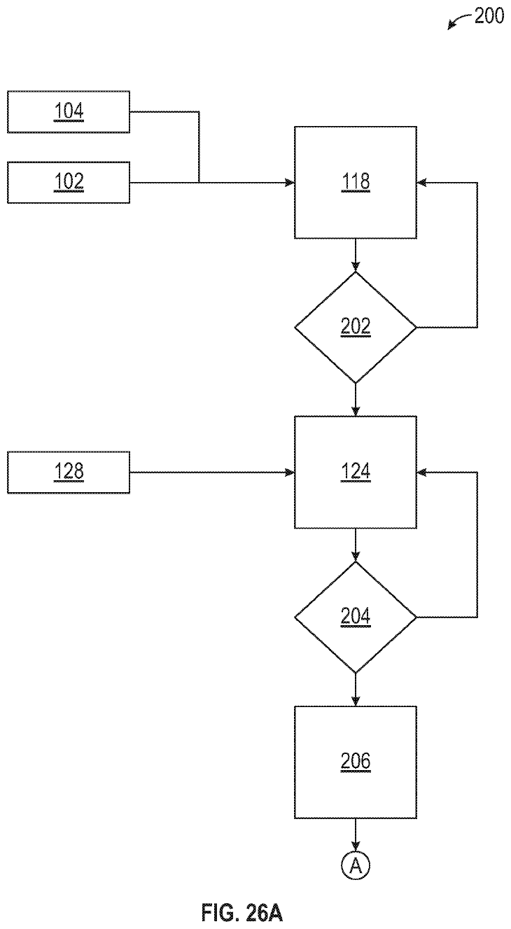

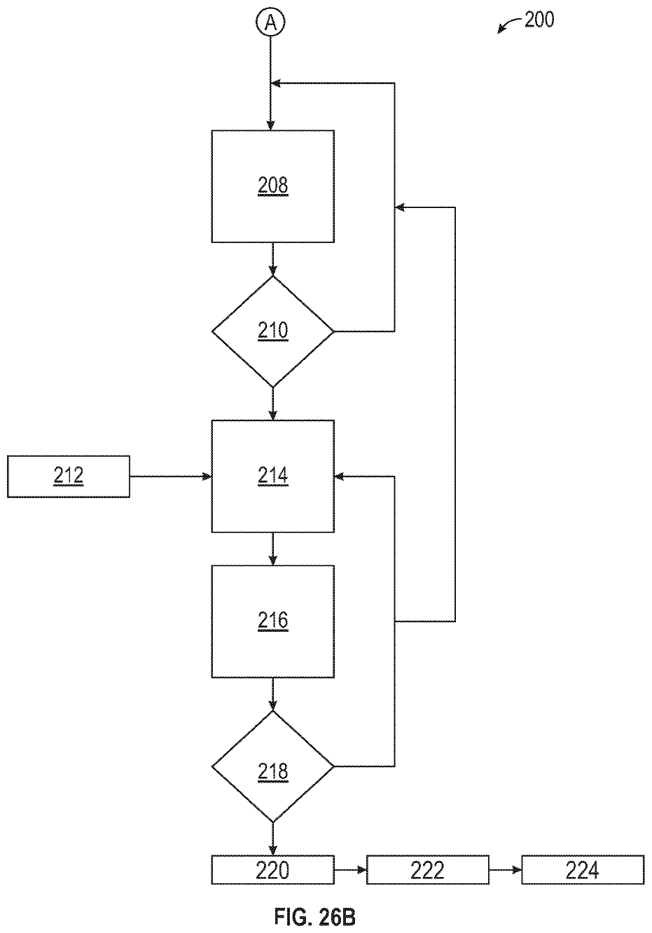

In some embodiments, the crude HPBCD mixture collected in the collection tank 124 may be further purified through a purification process 200 such as that shown in FIGS. 26A-26B. This purification process may be performed as a batch process or as a continuous process.

Prior to the commencement of the purification process 200, the HPBCD produced in reactor 118 may be monitored at junction 202 to determine the pH, concentration, and/or conductivity of the produced HPBCD and/or other parameters of the HPBCD. The HPBCD may be recycled back through the reactor 118 before quenching in the collection tank 124 if any parameter is determined to fall outside of a predetermined range.

Also prior to the commencement of the purification process 200, the crude HPBCD mixture collected in collection tank 124 may be monitored at junction 204 to determine the pH, concentration, and/or conductivity, of the crude HPBCD mixture, or other parameters of the mixture. The HPBCD mixture may be recycled back to the collection tank 124 before purification if any parameter is determined to fall outside of a predetermined range.

The purification process 200 of FIGS. 26A-26B commences by first liquid filtering the crude HPBCD mixture collected in collection tank 124 using filter 206. Filter 206 may be a liquid material filter that is capable of removing any bulk solids and/or biological contaminants from the crude HPBCD mixture.

Next, the HPBCD mixture may be nanofiltered using a membrane filter 208. The membrane may have a pore size from about 10 nm to about 1 nm, such as from about 10 nm to about 5 nm, or from about 5 nm to about 1 nm. In some aspects, the membrane may have a pore size of about 10 nm, about 9 nm, about 8 nm, about 7 nm, about 6 nm, about 5 nm, about 4 nm, about 3 nm, about 2 nm, or about 1 nm. The membrane filter 208 may comprise regenerated cellulose, polyethersulfone, polyvinylidene fluoride, polypropylene, polyamide, polyethylenimine, polyacrylonitrile, polyethylene, polytetrafluoroethylene, metal-organic frameworks, graphene, ceramic, composites, or other membrane materials known in the art and combinations thereof. Preferably, the membrane filter 208 comprises regenerated cellulose or polyethersulfone.

In some embodiments, filter 208 may comprise a flat sheet membrane to accomplish the nanofiltration. Flat sheet membranes and methods of making and procuring flat sheet membranes for nanofiltration are generally known in the art. The flat sheet membrane may have an area from about 0.010 m² to about 0.500 m², about 0.050 m² to about 0.100 m², or about 0.010 m² to about 0.050 m². For example, the flat sheet membrane may have an area of about 0.010 m², about 0.015 m², about 0.020 m², about 0.025 m², about 0.030 m², about 0.035 m², about 0.040 m², about 0.045 m², or about 0.050 m². The flat sheet membrane may have an area greater than 0.010 m², greater than about 0.025 m², greater than about 0.050 m², greater than about 0.100 m², or greater than about 0.500 m².

The nanofiltration may be accomplished at a temperature from about 40° C. to about 50° C., such as from about 40° C. to about 45° C., or from about 45° C. to about 50° C. In some aspects, the nanofiltration may be accomplished at a temperature of about 40° C., about 41° C., about 42° C., about 43° C., about 44° C., about 45° C., about 46° C., about 47° C., about 48° C., about 49° C., or about 50° C.

The nanofiltration may be accomplished at a pressure from about 1.5 to about 2.0 MPa, such as from about 1.5 MPa to about 1.75 MPa, or from about 1.75 MPa to about 2.0 MPa. In some aspects, the nanofiltration may be accomplished at a pressure of about 1.5 MPa, about 1.55 MPa, about 1.6 MPa, about 1.65 MPa, about 1.7 MPa, about 1.75 MPa, about 1.8 MPa, about 1.85 MPa, about 1.9 MPa, about 1.95 MPa, or about 2.0 MPa.

Alternatively, the nanofiltration may be accomplished at a pressure from about 0 psi to about 600 psi, about 50 psi to about 600 psi, about 100 psi to about 500 psi, about 200 psi to about 400 psi, or about 250 psi to about 350 psi. For example, the purifying may occur at a feed pressure of about 25 psi, about 50 psi, about 75 psi, about 100 psi, about 125 psi, about 150 psi, about 175 psi, about 200 psi, about 225 psi, about 250 psi, about 275 psi, about 300 psi, about 325 psi, about 350 psi, about 375 psi, about 400 psi, about 425 psi, about 450 psi, about 475 psi, or about 500 psi.

The nanofiltered HPBCD mixture may have a conductivity of about 50 μS/cm or less, such as about 45 μS/cm or less, about 40 μS/cm or less, about 35 μS/cm or less, about 30 μS/cm or less, about 25 μS/cm or less, about 20 μS/cm or less, about 15 μS/cm or less, about 10 μS/cm or less, or about 5 μS/cm or less. Alternatively, the nanofiltered HPBCD mixture may have a conductivity from about 0 μS/cm to about 50 μS/cm. For example, the nanofiltered HPBCD mixture may have a conductivity from about 0 μS/cm to about 10 μS/cm, about 0 μS/cm to about 20 μS/cm, about 0 μS/cm to about 30 μS/cm, about 0 μS/cm to about 40 μS/cm, about 0 μS/cm to about 50 μS/cm, about 10 μS/cm to about 50 μS/cm, about 20 μS/cm to about 50 μS/cm, about 30 μS/cm to about 50 μS/cm, or about 40 μS/cm. In some aspects, the nanofiltered HPBCD mixture may have a conductivity of about 5 μS/cm, about 10 μS/cm, about 15 μS/cm, about 20 μS/cm, about 25 μS/cm, about 30 μS/cm, about 35 μS/cm, about 40 μS/cm, about 45 μS/cm, or about 50 μS/cm.

The nanofiltered HPBCD mixture may have an impurity concentration of about 0.10 wt % or less. The impurities may include propylene glycol, propylene oxide, endotoxins, etc. For example, the nanofiltered HPBCD mixture may have an impurity concentration of about 0.10 wt % or less, about 0.09 wt % or less, about 0.08 wt % or less, about 0.07 wt % or less, about 0.06 wt % or less, about 0.05 wt % or less, about 0.04 wt % or less, about 0.03 wt % or less, about 0.02 wt % or less, or about 0.01 wt % or less.

Before proceeding, the nanofiltered HPBCD mixture may be monitored to determine the purity and conductivity of the nanofiltered HPBCD mixture at junction 210. If the purity and/or the conductivity of the nanofiltered HPBCD mixture falls outside a predetermined range, the HPBCD mixture may be recycled at junction 210 to filter 208 to undergo further nanofiltration. Purified water may be added to the HPBCD mixture when recycled to aid in the subsequent nanofiltration.

After the HPBCD mixture is nanofiltered, the HPBCD mixture may be contacted with activated carbon in vessel 214. The activated carbon may be useful to remove additional impurities, such as propylene oxide. The activated carbon may be prepared by first washing the activated carbon in vessel 212 with purified water to remove any salts. The activated carbon may be washed with purified water until the wash water has a conductivity of less than 10 μS/cm. The activated carbon may then be placed in vessel 214 with the nanofiltered HPBCD mixture and agitated to ensure adequate contact with the HPBCD mixture.

The contacting may occur for a period of 1 hour or more, 2 hours or more, 3 hours or more, 4 hours or more, 5 hours or more, 6 hours or more, 7 hours or more, 8 hours or more, 9 hours or more, or 10 hours or more.

The contacting may occur at a temperature from about 15° C. to about 30° C. For example, the contacting may occur at a temperature from about 15° C. to about 20° C., about 15° C. to about 25° C., about 15° C. to about 30° C., about 20° C. to about 30° C., or about 25° C. to about 30° C. In some examples, the contacting may occur at a temperature of about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C.

After the contacting, the HPBCD mixture may then be filtered in filter 216 to remove the activated carbon from the mixture. Any filter capable of removing the solid activated carbon from the liquid mixture may be used. Preferably, filter 216 comprises a Nutsche filter.

Once the activated carbon has been filtered from the HPBCD mixture, the HPBCD mixture may have a propylene oxide concentration of less than 0.3 ppm. For example, the HPBCD mixture may have a propylene oxide concentration of about 0.2 ppm or less, about 0.1 ppm or less, about 0.09 ppm or less, about 0.08 ppm or less, about 0.07 ppm or less, about 0.06 ppm or less, about 0.05 ppm or less, about 0.04 ppm or less, about 0.03 ppm or less, about 0.02 ppm or less, or about 0.01 ppm or less. If the HPBCD mixture has a propylene oxide concentration of 0.3 ppm or greater, the step of contacting the HPBCD mixture with the activated carbon may be repeated until the propylene oxide concentration is less than 0.3 ppm.

Once filtering the activated carbon mixture is complete, the HPBCD mixture may have a conductivity of less than 90 μS/cm. For example, the HPBCD mixture may have a conductivity of about 80 μS/cm or less, about 70 μS/cm or less, about 60 μS/cm or less, about 50 μS/cm or less, about 40 μS/cm or less, about 30 μS/cm or less, about 20 μS/cm or less, or about 10 μS/cm or less. If the HPBCD mixture has a conductivity of 90 μS/cm or greater, the step of nanofiltering the HPBCD mixture may be repeated until the conductivity of the HPBCD mixture is less than 90 μS/cm.

Before proceeding, the HPBCD mixture may be monitored at junction 218 to determine the propylene oxide concentration and/or the conductivity of the HPBCD mixture. If the purity of the HPBCD mixture falls outside of a predetermined range, the HPBCD mixture may be recycled at junction 218 to filter vessel 214 to undergo further purification. If the conductivity of the HPBCD mixture falls outside of a predetermined range, the HPBCD mixture may be recycled at junction 218 to filter 208 to undergo further nanofiltration.

Once the activated carbon has been filtered and the HPBCD mixture has the desired purity and conductivity, the HPBCD mixture may be sterile-filtered in filter 220. The sterile filtering reduces the presence of bacteria and other microorganisms in the HPBCD mixture. Sterile filtration systems and methods are generally known to those having ordinary skill in the art. The sterile filter preferably has a pore size of 0.22 μm or less. In some embodiments, sterile filter may be a capsule filter. The sterile filter membrane may comprise polytetrafluoroethylene, polyethersulfone, polyvinylidene fluoride, nylon, polycarbonate, cellulose acetate, or other materials known in the art for sterile filtration and combinations thereof. The sterile filter preferably comprises a polytetrafluoroethylene membrane.

The HPBCD mixture may then be filtered in a tangential flow filtration system 222. Tangential flow filtration systems and methods are generally known to those having ordinary skill in the art. In some embodiments, the tangential flow filtration system 222 may include a membrane comprising polyethersulfone, polypropylene, polyurethane, regenerated cellulose, polyvinylidene fluoride, or other materials known in the art for tangential filtration membranes and combinations thereof. Preferably, the membrane comprises polyethersulfone.

After the HPBCD mixture is filtered in the tangential flow filtration system 222, the HPBCD mixture may be dried in dryer 224. Preferably, the HPBCD mixture is spray-dried.

In embodiments where the HPBCD mixture is spray-dried, the input temperature of the spray dryer may be from about 180° C. to about 220° C.; for example, the input temperature of the spray dryer may be from about 180° C. to about 190° C., about 180° C. to about 200° C., about 180° C. to about 210° C., about 180° C. to about 220° C., about 190° C. to about 200° C., about 190° C. to about 210° C., about 190° C. to about 220° C., about 200° C. to about 210° C., about 200° C. to about 220° C., or about 210° C. to about 220° C. The output temperature of the spray dryer may be from about 100° C. to about 120° C.; for example, the output temperature of the spray dryer may be from about 100° C. to about 105° C., about 100° C. to about 110° C., about 100° C. to about 115° C., about 100° C. to about 120° C., about 105° C. to about 110° C., about 105° C. to about 115° C., about 105° C. to about 120° C., about 110° C. to about 115° C., about 110° C. to about 120° C., or about 115° C. to about 120° C.

Further provided herein are methods of manufacturing a HPBCD mixture. The method may be accomplished by using any of the systems described above. The method comprises: (a) contacting a HPBCD mixture with at least two solvents, the HPBCD mixture comprising high degree substitution HPBCD and low degree substitution HPBCD; (b) dissolving the high degree substitution HPBCD in one of the solvents; and (c) removing the low degree substitution HPBCD by precipitation. The at least two solvents may comprise ethanol and acetone. The high degree substitution HPBCD may have an average degree of substitution of about 6.0 or greater, of about 6.5 or greater, of about 7.0 or greater, of about 7.5 or greater, of about 8.0 or greater, of about 8.5 or greater, of about 9.0 or greater, of about 9.5 or greater. The low degree substitution may have an average degree of substitution of less than about 7.5, less than about 7.0, less than about 6.5, less than about 6.0, less than about 5.5, or less than about 5.0.

Alternatively, the method may comprise: (a) contacting a HPBCD mixture with at least two solvents, the HPBCD mixture comprising high degree substitution HPBCD; (b) dissolving the high degree substitution HPBCD in one of the solvents to form a mother liquor; and (c) filtering off the mother liquor. The method may further comprise crystallizing or lyophilizing the mother liquor to yield a solid. The solid may be analyzed by MALDI-TOF to determine the degree of substitution.

In some embodiments, deuterated reactants (e.g., deuterated BCD or deuterated propylene oxide) may be used to provide a deuterated product such as deuterated HPBCD.

The system 100 may further comprise a purification system to purify the HPBCD. The purification system may include absorption chromatography alumina, solvent precipitation, or combinations thereof.

Further provided herein is a method of oligomeric substitution through methanolysis of a HPBCD mixture. The method generally comprises mixing HPBCD and methanol, stirring until the HPBCD is dissolved, adding an acid to the mixture, heating the mixture to at least about 50 to about 90° C., stirring the mixture and maintaining the heat for at least about 24 hours, neutralizing the mixture with a base, and filtering the mixture. In some embodiments, the HPBCD may be a racemic mixture of HPBCD; in other embodiments, the HPBCD may be an enantiopure HPBCD.

The methanol may be added in an amount of about 100 to about 300 molar equivalents of HPBCD; for example, the methanol may be added in an amount of about 50, about 75, about 100, about 125, about 150, about 175, about 200, about 225, about 250, about 275, about 300, about 350, or about 400 molar equivalents of HPBCD. In some embodiments, the methanol may comprise deuterated methanol.

The acid added to the mixture may comprise hydrochloric acid, sulfuric acid, lactic acid, acetic acid, formic acid, citric acid, oxalic acid, uric acid, malic acid, fumaric acid, tartaric acid, or a combination thereof. In an exemplary embodiment, the acid comprises sulfuric acid.

The heat of the mixture may be maintained for at least 24 hours; for example, the heat may be maintained for 24 hours, 30 hours, 36 hours, 42 hours, 48 hours, or greater than 48 hours.

The base used to neutralize the mixture may comprise sodium hydroxide, potassium hydroxide, lithium hydroxide, magnesium hydroxide, calcium hydroxide, or a combination thereof. In an exemplary embodiment, the base is sodium hydroxide.

The mixture may be filtered by filtration methods generally known in the art. In preferred embodiments, the mixture is filtered by the nanofiltration method described below.

Further provided herein is a method of purifying a HPBCD mixture comprising purifying a HPBCD mixture by nanofiltration, collecting a nanofiltration permeate for a total of at least 5 diafiltration volumes, and lyophilizing a resulting retentate to yield a solid hydroxypropyl-β-cyclodextrin. In some aspects, a different number of diafiltration volumes may produce a different HPBCD mixture.

The HPBCD mixture is purified by nanofiltration. The purifying by nanofiltration may comprise a flat sheet membrane to accomplish the nanofiltration. Flat sheet membranes and methods of making and procuring flat sheet membranes for nanofiltration are generally known in the art. The flat sheet membrane may have an area from about 0.010 m² to about 0.500 m², about 0.050 m² to about 0.100 m², or about 0.010 m² to about 0.050 m². For example, the flat sheet membrane may have an area of about 0.010 m², about 0.015 m², about 0.020 m², about 0.025 m², about 0.030 m², about 0.035 m² about 0.040 m², about 0.045 m², or about 0.050 m². The flat sheet membrane may have an area greater than 0.010 m², greater than about 0.025 m², greater than about 0.050 m² greater than about 0.100 m², or greater than about 0.500 m².

The purifying and/or feed may occur at a feed pressure from about 0 psi to about 600 psi, about 50 psi to about 600 psi, about 100 psi to about 500 psi, about 200 psi to about 400 psi, about 250 psi to about 350 psi. For example, the purifying may occur at a feed pressure of about 25 psi, about 50 psi, about 75 psi, about 100 psi, about 125 psi, about 150 psi, about 175 psi, about 200 psi, about 225 psi, about 250 psi, about 275 psi, about 300 psi, about 325 psi, about 350 psi, about 375 psi, about 400 psi, about 425 psi, about 450 psi, about 475 psi, or about 500 psi.

The collecting a nanofiltration permeate may be accomplished for a total of at least 1 diafiltration volumes, at least 2 diafiltration volumes, at least 3 diafiltration volumes, at least 4 diafiltration volumes, or at least 5 diafiltration volumes. For example, the nanofiltration permeate may be collected for a total of at least 5 diafiltration volumes, at least 6 diafiltration volumes, at least 7 diafiltration volumes, at least 8 diafiltration volumes, at least 9 diafiltration volumes, or at least 10 diafiltration volumes. In some embodiments, the nanofiltration permeate may be collected for greater than 10 diafiltration volumes.

The method may further comprise analyzing a resulting retentate for propylene glycol content. Methods of analyzing a composition for propylene glycol content are generally known in the art, and may include mass spectrometry, high pressure liquid chromatography, gas chromatography, etc.

Further provided herein is a method of purifying a HPBCD mixture comprising purifying a HPBCD mixture by nanofiltration, collecting a nanofiltration permeate for a total of at least 5 diafiltration volumes, and analyzing a resulting retentate for propylene glycol content.

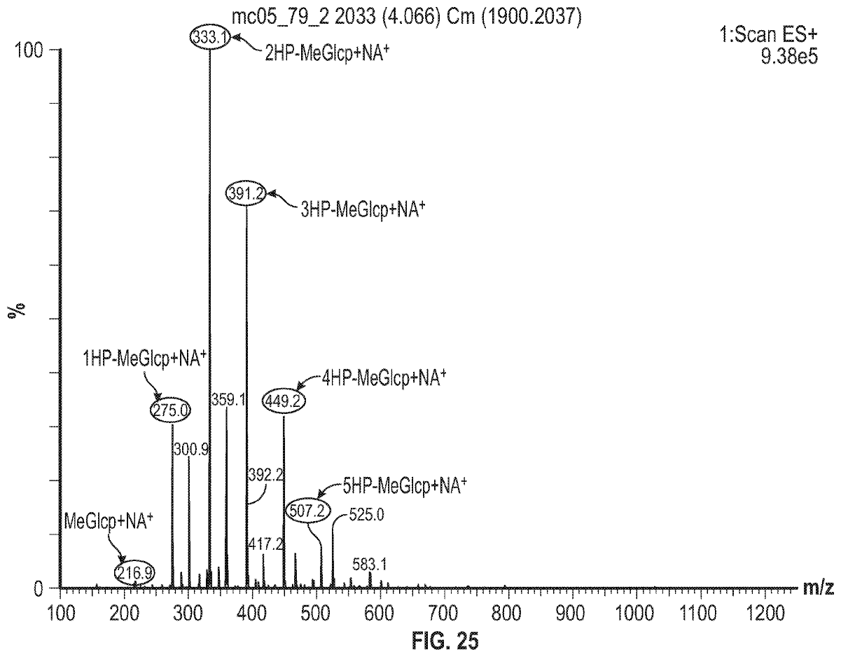

Further provided herein is a composition comprising a methylated 2-hydroxypropyl-β-cyclodextrin mixture having an average degree of substitution from about 6.5 to about 9.5 and methylated glucose bearing from 0 to about 5 2-hydroxypropyl groups; for example, the methylated 2-hydroxypropyl-β-cyclodextrin mixture may have an average degree of substitution of about 6.5, about 7.0, about 7.5, about 8.0, about 8.5, about 9.0, or about 9.5. The methylated 2-hydroxypropyl-β-cyclodextrin mixture may have an average degree of substitution from about 6.5 to about 9.5, from about 6.5 to about 9.0, from about 6.8 to about 9.5, from about 6.8 to about 9.0, from about 7.0 to about 9.5, from about 7.0 to about 9.0, from about 7.2 to about 9.5, from about 7.2 to about 9.0, from about 7.5 to about 9.5, from about 7.5 to about 9.0, from about 7.8 to about 9.5, from about 7.8 to about 9.0, from about 8.0 to about 9.5, from about 8.0 to about 9.0, from about 8.2 to about 9.5, from about 8.2 to about 9.0, from about 8.5 to about 9.5, from about 8.5 to about 9.0, from about 8.8 to about 9.5, or from about 8.8 to about 9.0. In an exemplary embodiment, the composition has a mass spectrum as depicted in FIG. 25.

Further provided herein are compositions produced using one or more of the systems and/or methods provided herein, the compositions comprising a mixture of beta-cyclodextrin molecules substituted at one or more hydroxyl positions by hydroxypropyl groups, wherein: the mixture comprises less than 0.3% unsubstituted beta-cyclodextrin (“DS-0”) or less than 1% beta-cyclodextrin substituted with one hydroxypropyl group (“DS-1”), wherein the composition is suitable for intrathecal, intravenous, or intracerebroventricular administration to a patient in need thereof. The mixture may comprise less than 0.1% DS-0 and less than 0.1% DS-1, collectively. For example, the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-0; and/or the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-1. The amount of DS-0 or DS-1 may be determined by peak height of an electrospray MS spectrum.

The mixture may have an average molar substitution in the range from about 0.40 to about 0.80; for example, the mixture may have an average molar substitution of about 0.40, 0.45, 0.50, 0.55, 0.60, 0.65, 0.70, 0.75, or about 0.80. The mixture may have an average degree of substitution (“DSₐ”) of about 3 to about 7, from about 4 to about 7, from about 5 to about 7, or from about 6 to about 7. For example, the mixture may have an average degree of substitution of about 3, 3.5, 4, 4.5, 5, 5.5, 6, 6.5, or about 7.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC, gas chromatography or the PG/EG ratio of propylene glycol to ethylene glycol.

The composition may comprise no more than 1 ppm propylene oxide, no more than 0.9 ppm propylene oxide, no more than 0.8 ppm propylene oxide, no more than 0.7 ppm propylene oxide, no more than 0.6 ppm propylene oxide, no more than 0.5 ppm propylene oxide, no more than 0.4 ppm propylene oxide, no more than 0.3 ppm propylene oxide, no more than 0.2 ppm propylene oxide, or no more than 0.1 ppm propylene oxide. The amount of propylene oxide may be measured by HPLC or gas chromatography.

The total amount of other unspecified impurities in the composition may be less than or equal to 0.05%; for example, the total amount of unspecified impurities in the composition may be 0.05%, less than 0.05%, less than or equal to 0.04%, less than or equal to 0.03%, less than or equal to 0.02%, or less than or equal to 0.01%. The amount of unspecified impurities may be measured by HPLC or gas chromatography.

The composition may be suitable for administration intrathecal, intravenous, or intracerebroventricular administration to a patient in need thereof. The patient may be an adult patient or a pediatric patient. The composition may further comprise a pharmaceutically acceptable diluent.

The composition may solubilize lipids in an aqueous medium. The lipids may comprise unesterified or esterified cholesterol. The composition may be provided as a solution, wherein the mixture of beta-cyclodextrin molecules substituted at one or more hydroxyl positions by hydroxypropyl groups has a concentration of 20% w/v in the solution. The composition may have an affinity for unesterified cholesterol. The solubilization may be determined by UV spectrometry or by HPLC.

In some embodiments, about 200 mg of the composition solubilizes at least about 2 mg, 3 mg, 4 mg, 5 mg, 6 mg, 7 mg, 8 mg, 9 mg, or at least about 10 mg of unesterified cholesterol in distilled water at room temperature. In one example, 1 mL of the solution is able to solubilize about 2 mg of unesterified cholesterol at room temperature when measured by UV spectrometry after about 24 hours.

The composition may have a concentration in a solution from about 10 mg/mL to about 200 mg/mL. For example, the composition may have a concentration in a solution from about 10 mg/mL to about 20 mg/mL, about 10 mg/mL to about 30 mg/mL, about 10 mg/mL to about 40 mg/mL, about 10 mg/mL to about 50 mg/mL, about 10 mg/mL to about 60 mg/mL, about 10 mg/mL to about 70 mg/mL, about 10 mg/mL to about 80 mg/mL, about 10 mg/mL to about 90 mg/mL, about 10 mg/mL to about 100 mg/mL, about 10 mg/mL to about 110 mg/mL, about 10 mg/mL to about 120 mg/mL, about 10 mg/mL to about 130 mg/mL, about 10 mg/mL to about 140 mg/mL, about 10 mg/mL to about 150 mg/mL, about 10 mg/mL to about 160 mg/mL, about 10 mg/mL to about 170 mg/mL, about 10 mg/mL to about 180 mg/mL, about 10 mg/mL to about 190 mg/mL, about 20 mg/mL to about 200 mg/mL, about 30 mg/mL to about 200 mg/mL, about 40 mg/mL to about 200 mg/mL, about 50 mg/mL to about 200 mg/mL, about 60 mg/mL to about 200 mg/mL, about 70 mg/mL to about 200 mg/mL, about 80 mg/mL to about 200 mg/mL, about 90 mg/mL to about 200 mg/mL, about 100 mg/mL to about 200 mg/mL, about 110 mg/mL to about 200 mg/mL, about 120 mg/mL to about 200 mg/mL, about 130 mg/mL to about 200 mg/mL, about 140 mg/mL to about 200 mg/mL, about 150 mg/mL to about 200 mg/mL, about 160 mg/mL to about 200 mg/mL, about 170 mg/mL to about 200 mg/mL, about 180 mg/mL to about 200 mg/mL, or about 190 mg/mL to about 200 mg/mL.

Further provided herein are compositions produced using one or more of the systems and/or methods provided herein, the compositions comprising a mixture of beta-cyclodextrin molecules substituted at one or more hydroxyl positions by hydroxypropyl groups, wherein: the mixture comprises less than 2.5% beta-cyclodextrin substituted with one hydroxypropyl group (“DS-1”), wherein the composition is suitable for intrathecal, intravenous, or intracerebroventricular administration to a patient in need thereof. The mixture may comprise less than 2.5%, less than 2.4%, less than 2.3%, less than 2.2%, less than 2.1%, 2.0%, less than 1.9%, less than 1.8%, less than 1.7%, less than 1.6%, less than 1.5%, less than 1.4%, less than 1.3%, less than 1.2%, less than 1.1%, less than 1.0%, less than 0.9%, less than 0.8%, less than 0.7%, less than 0.6%, less than 0.5%, less than 0.4%, less than 0.3%, less than 0.2%, less than 0.1%, less than 0.09%, less than 0.08%, less than 0.07%, less than 0.06%, less than 0.05%, less than 0.04%, less than 0.03%, less than 0.02%, or less than 0.01% DS-1. The amount of DS-1 may be determined by peak height of an electrospray MS spectrum.

The composition may comprise no more than 1% of unsubstituted beta-cyclodextrin (“DS-0”). For example, the composition may comprise no more than 0.9%, no more than 0.8%, no more than 0.7%, no more than 0.6%, no more than 0.5%, no more than 0.4%, no more than 0.3%, no more than 0.2%, no more than 0.1%, no more than 0.09%, no more than 0.08%, no more than 0.07%, no more than 0.06%, no more than 0.05%, no more than 0.04%, no more than 0.03%, no more than 0.02%, or no more than 0.01% DS-0. The amount of DS-0 may be determined by peak height of an electrospray MS spectrum.

The mixture may have an average molar substitution in the range from about 0.40 to about 0.80; for example, the mixture may have an average molar substitution of about 0.40, 0.45, 0.50, 0.55, 0.60, 0.65, 0.70, 0.75, or about 0.80. The mixture may have an average degree of substitution (“DSₐ”) of about 3 to about 7, from about 4 to about 7, from about 5 to about 7, or from about 6 to about 7. For example, the mixture may have an average degree of substitution of about 3, 3.5, 4, 4.5, 5, 5.5, 6, 6.5, or about 7.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC, gas chromatography or the PG/EG ratio of propylene glycol to ethylene glycol.

The composition may comprise no more than 1 ppm propylene oxide, no more than 0.9 ppm propylene oxide, no more than 0.8 ppm propylene oxide, no more than 0.7 ppm propylene oxide, no more than 0.6 ppm propylene oxide, no more than 0.5 ppm propylene oxide, no more than 0.4 ppm propylene oxide, no more than 0.3 ppm propylene oxide, no more than 0.2 ppm propylene oxide, or no more than 0.1 ppm propylene oxide. The amount of propylene oxide may be measured by HPLC or gas chromatography.

The total amount of other unspecified impurities in the composition may be less than or equal to 0.05%; for example, the total amount of unspecified impurities in the composition may be 0.05%, less than 0.05%, less than or equal to 0.04%, less than or equal to 0.03%, less than or equal to 0.02%, or less than or equal to 0.01%. The amount of unspecified impurities may be measured by HPLC or gas chromatography.

The composition may be suitable for administration intrathecal, intravenous, or intracerebroventricular administration to a patient in need thereof. The patient may be an adult patient or a pediatric patient. The composition may further comprise a pharmaceutically acceptable diluent.

The composition may solubilize lipids in an aqueous medium. The lipids may comprise unesterified or esterified cholesterol. The composition may be provided as a solution, wherein the composition has a concentration of 20% w/v in the solution. The composition may have an affinity for unesterified cholesterol. The solubilization may be determined by UV spectrometry or by HPLC.

In some embodiments, about 200 mg of the composition solubilizes at least about 2 mg, 3 mg, 4 mg, 5 mg, 6 mg, 7 mg, 8 mg, 9 mg, or at least about 10 mg of unesterified cholesterol in distilled water at room temperature. In one example, 1 mL of the solution is able to solubilize about 2 mg of unesterified cholesterol at room temperature when measured by UV spectrometry after about 24 hours.

The composition may have a concentration in a solution from about 10 mg/mL to about 200 mg/mL. For example, the composition may have a concentration in a solution from about 10 mg/mL to about 20 mg/mL, about 10 mg/mL to about 30 mg/mL, about 10 mg/m L to about 40 mg/mL, about 10 mg/mL to about 50 mg/m L, about 10 mg/mL to about 60 mg/mL, about 10 mg/mL to about 70 mg/mL, about 10 mg/mL to about 80 mg/mL, about 10 mg/mL to about 90 mg/mL, about 10 mg/mL to about 100 mg/mL, about 10 mg/mL to about 110 mg/mL, about 10 mg/mL to about 120 mg/mL, about 10 mg/mL to about 130 mg/mL, about 10 mg/mL to about 140 mg/mL, about 10 mg/mL to about 150 mg/mL, about 10 mg/mL to about 160 mg/mL, about 10 mg/mL to about 170 mg/mL, about 10 mg/mL to about 180 mg/mL, about 10 mg/mL to about 190 mg/mL, about 20 mg/mL to about 200 mg/mL, about 30 mg/mL to about 200 mg/mL, about 40 mg/mL to about 200 mg/mL, about 50 mg/mL to about 200 mg/mL, about 60 mg/mL to about 200 mg/mL, about 70 mg/mL to about 200 mg/mL, about 80 mg/mL to about 200 mg/mL, about 90 mg/mL to about 200 mg/mL, about 100 mg/mL to about 200 mg/mL, about 110 mg/mL to about 200 mg/mL, about 120 mg/mL to about 200 mg/mL, about 130 mg/mL to about 200 mg/mL, about 140 mg/mL to about 200 mg/mL, about 150 mg/mL to about 200 mg/mL, about 160 mg/mL to about 200 mg/mL, about 170 mg/mL to about 200 mg/mL, about 180 mg/mL to about 200 mg/mL, or about 190 mg/mL to about 200 mg/mL.

Further provided herein are compositions produced using one or more of the systems and/or methods provided herein, the compositions comprising a mixture of beta-cyclodextrin molecules substituted at one or more hydroxyl positions by hydroxypropyl groups, wherein: the mixture comprises less than 1% unsubstituted beta-cyclodextrin (“DS-0”) and beta-cyclodextrin substituted with one hydroxypropyl group (“DS-1”); and, the mixture comprises from 5% to 25% beta-cyclodextrin substituted with six hydroxypropyl groups (“DS-6”).

The mixture may comprise less than 0.1% DS-0 and less than 0.1% DS-1, collectively. For example, the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-0; and/or the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-1.

The mixture may comprise at least 8% beta-cyclodextrin substituted with six hydroxypropyl groups (“DS-6”). The mixture may comprise at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, or at least 25% DS-6. Alternatively, the mixture may comprise from about 8% to about 9%, from about 8% to about 10%, from about 8% to about 11%, from about 8% to about 12%, from about 8% to about 13%, from about 8% to about 14%, from about 8% to about 15%, from about 8% to about 16%, from about 8% to about 17%, from about 8% to about 18%, from about 8% to about 19%, from about 8% to about 20%, from about 8% to about 21%, from about 8% to about 22%, from about 8% to about 23%, from about 8% to about 24%, or from about 8% to about 25%. Alternatively, the mixture may comprise no more than 15%, no more than 14%, no more than 13%, no more than 12%, no more than 11%, no more than 10%, no more than 9%, or no more than 8% DS-6.

The amount of DS-0, DS-1, or DS-6 may be determined by peak height of an electrospray MS spectrum.

The mixture may have an average molar substitution in the range from about 0.40 to about 0.80; for example, the mixture may have an average molar substitution of about 0.40, 0.45, 0.50, 0.55, 0.60, 0.65, 0.70, 0.75, or about 0.80. The mixture may have an average degree of substitution (“DSₐ”) of about 3 to about 7, from about 4 to about 7, from about 5 to about 7, or from about 6 to about 7. For example, the mixture may have an average degree of substitution of about 3, 3.5, 4, 4.5, 5, 5.5, 6, 6.5, or about 7.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC or gas chromatography.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC, gas chromatography or the PG/EG ratio of propylene glycol to ethylene glycol.

The composition may comprise no more than 1 ppm propylene oxide, no more than 0.9 ppm propylene oxide, no more than 0.8 ppm propylene oxide, no more than 0.7 ppm propylene oxide, no more than 0.6 ppm propylene oxide, no more than 0.5 ppm propylene oxide, no more than 0.4 ppm propylene oxide, no more than 0.3 ppm propylene oxide, no more than 0.2 ppm propylene oxide, or no more than 0.1 ppm propylene oxide. The amount of propylene oxide may be measured by HPLC or gas chromatography.

The total amount of other unspecified impurities in the composition may be less than or equal to 0.05%; for example, the total amount of unspecified impurities in the composition may be 0.05%, less than 0.05%, less than or equal to 0.04%, less than or equal to 0.03%, less than or equal to 0.02%, or less than or equal to 0.01%. The amount of unspecified impurities may be measured by HPLC or gas chromatography.

The composition may be suitable for administration intrathecal, intravenous, or intracerebroventricular administration to a patient in need thereof. The patient may be an adult patient or a pediatric patient. The composition may further comprise a pharmaceutically acceptable diluent.

The composition may solubilize lipids in an aqueous medium. The lipids may comprise unesterified or esterified cholesterol. The composition may be provided as a solution, wherein the composition has a concentration of 20% w/v in the solution. The composition may have an affinity for unesterified cholesterol. The solubilization may be determined by UV spectrometry or by HPLC.

In some embodiments, about 200 mg of the composition solubilizes at least about 2 mg, 3 mg, 4 mg, 5 mg, 6 mg, 7 mg, 8 mg, 9 mg, or at least about 10 mg of unesterified cholesterol in distilled water at room temperature. In one example, 1 mL of the solution is able to solubilize about 2 mg of unesterified cholesterol at room temperature when measured by UV spectrometry after about 24 hours.

The composition may have a concentration in a solution from about 10 mg/mL to about 200 mg/mL. For example, the composition may have a concentration in a solution from about 10 mg/mL to about 20 mg/mL, about 10 mg/mL to about 30 mg/mL, about 10 mg/m L to about 40 mg/mL, about 10 mg/mL to about 50 mg/m L, about 10 mg/mL to about 60 mg/mL, about 10 mg/mL to about 70 mg/mL, about 10 mg/mL to about 80 mg/mL, about 10 mg/mL to about 90 mg/mL, about 10 mg/mL to about 100 mg/mL, about 10 mg/mL to about 110 mg/mL, about 10 mg/mL to about 120 mg/mL, about 10 mg/mL to about 130 mg/mL, about 10 mg/mL to about 140 mg/mL, about 10 mg/mL to about 150 mg/mL, about 10 mg/mL to about 160 mg/mL, about 10 mg/mL to about 170 mg/mL, about 10 mg/mL to about 180 mg/mL, about 10 mg/mL to about 190 mg/mL, about 20 mg/mL to about 200 mg/mL, about 30 mg/mL to about 200 mg/mL, about 40 mg/mL to about 200 mg/mL, about 50 mg/mL to about 200 mg/mL, about 60 mg/mL to about 200 mg/mL, about 70 mg/mL to about 200 mg/mL, about 80 mg/mL to about 200 mg/mL, about 90 mg/mL to about 200 mg/mL, about 100 mg/mL to about 200 mg/mL, about 110 mg/mL to about 200 mg/mL, about 120 mg/mL to about 200 mg/mL, about 130 mg/mL to about 200 mg/mL, about 140 mg/mL to about 200 mg/mL, about 150 mg/mL to about 200 mg/mL, about 160 mg/mL to about 200 mg/mL, about 170 mg/mL to about 200 mg/mL, about 180 mg/mL to about 200 mg/mL, or about 190 mg/mL to about 200 mg/mL.

Further provided herein are compositions produced using one or more of the systems and/or methods provided herein, the compositions comprising a mixture of beta-cyclodextrin molecules substituted at one or more hydroxyl positions by hydroxypropyl groups, wherein: the mixture comprises less than 1% unsubstituted beta-cyclodextrin (“DS-0”) and beta-cyclodextrin substituted with one hydroxypropyl group (“DS-1”); and, the mixture comprises from 1% to 10% beta-cyclodextrin substituted with seven hydroxypropyl groups (“DS-7”).

The mixture may comprise less than 0.1% DS-0 and less than 0.1% DS-1, collectively. For example, the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-0; and/or the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-1.

The mixture may comprise from about 1% to about 10% DS-7; for example, the mixture may comprise from about 1% to about 2%, from about 1% to about 3%, from about 1% to about 4%, from about 1% to about 5%, from about 1% to about 6%, from about 1% to about 7%, from about 1% to about 8%, from about 1% to about 9%, from about 2% to about 10%, from about 3% to about 10%, from about 4% to about 10%, from about 5% to about 10%, from about 6% to about 10%, from about 7% to about 10%, from about 8% to about 10%, from about 9% to about 10%, from about 2% to about 9%, from about 3% to about 8%, from about 4% to about 7%, or from about 5% to about 6% DS-7. The mixture may comprise about 1%, 1.5%, 2% 2.5%, 3%, 3.5%, 4%, 4.5%, 5%, 5.5%, 6%, 6.5%, 7%, 7.5%, 8%, 8.5%, 9%, 9.5%, or about 10% DS-7. Alternatively, the composition may have less than about 10%, less than about 9%, less than about 8%, less than about 7%, less than about 6%, less than about 5%, less than about 4%, less than about 3%, less than about 2%, or less than about 1% DS-7.

The amount of DS-0, DS-1, or DS-7 may be determined by peak height of an electrospray MS spectrum.

The mixture may have an average molar substitution in the range from about 0.40 to about 0.80; for example, the mixture may have an average molar substitution of about 0.40, 0.45, 0.50, 0.55, 0.60, 0.65, 0.70, 0.75, or about 0.80. The mixture may have an average degree of substitution (“DSₐ”) of about 3 to about 7, from about 4 to about 7, from about 5 to about 7, or from about 6 to about 7. For example, the mixture may have an average degree of substitution of about 3, 3.5, 4, 4.5, 5, 5.5, 6, 6.5, or about 7.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC or gas chromatography.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC, gas chromatography, or the PG/EG ratio of propylene glycol to ethylene glycol.

The composition may comprise no more than 1 ppm propylene oxide, no more than 0.9 ppm propylene oxide, no more than 0.8 ppm propylene oxide, no more than 0.7 ppm propylene oxide, no more than 0.6 ppm propylene oxide, no more than 0.5 ppm propylene oxide, no more than 0.4 ppm propylene oxide, no more than 0.3 ppm propylene oxide, no more than 0.2 ppm propylene oxide, or no more than 0.1 ppm propylene oxide. The amount of propylene oxide may be measured by HPLC or gas chromatography.

The total amount of other unspecified impurities in the composition may be less than or equal to 0.05%; for example, the total amount of unspecified impurities in the composition may be 0.05%, less than 0.05%, less than or equal to 0.04%, less than or equal to 0.03%, less than or equal to 0.02%, or less than or equal to 0.01%. The amount of unspecified impurities may be measured by HPLC or gas chromatography.

The composition may be suitable for administration intrathecal, intravenous, or intracerebroventricular administration to a patient in need thereof. The patient may be an adult patient or a pediatric patient. The composition may further comprise a pharmaceutically acceptable diluent.

The composition may solubilize lipids in an aqueous medium. The lipids may comprise unesterified or esterified cholesterol. The composition may be provided as a solution, wherein the composition has a concentration of 20% w/v in the solution. The composition may have an affinity for unesterified cholesterol. The solubilization may be determined by UV spectrometry or by HPLC.

In some embodiments, about 200 mg of the composition solubilizes at least about 2 mg, 3 mg, 4 mg, 5 mg, 6 mg, 7 mg, 8 mg, 9 mg, or at least about 10 mg of unesterified cholesterol in distilled water at room temperature. In one example, 1 mL of the solution is able to solubilize about 2 mg of unesterified cholesterol at room temperature when measured by UV spectrometry after about 24 hours.

The composition may have a concentration in a solution from about 10 mg/mL to about 200 mg/mL. For example, the composition may have a concentration in a solution from about 10 mg/mL to about 20 mg/mL, about 10 mg/mL to about 30 mg/mL, about 10 mg/mL to about 40 mg/mL, about 10 mg/mL to about 50 mg/mL, about 10 mg/mL to about 60 mg/mL, about 10 mg/mL to about 70 mg/mL, about 10 mg/mL to about 80 mg/mL, about 10 mg/mL to about 90 mg/mL, about 10 mg/mL to about 100 mg/mL, about 10 mg/mL to about 110 mg/mL, about 10 mg/mL to about 120 mg/mL, about 10 mg/mL to about 130 mg/mL, about 10 mg/mL to about 140 mg/mL, about 10 mg/mL to about 150 mg/mL, about 10 mg/mL to about 160 mg/mL, about 10 mg/mL to about 170 mg/mL, about 10 mg/mL to about 180 mg/mL, about 10 mg/mL to about 190 mg/mL, about 20 mg/mL to about 200 mg/mL, about 30 mg/mL to about 200 mg/mL, about 40 mg/mL to about 200 mg/mL, about 50 mg/mL to about 200 mg/mL, about 60 mg/mL to about 200 mg/mL, about 70 mg/mL to about 200 mg/mL, about 80 mg/mL to about 200 mg/mL, about 90 mg/mL to about 200 mg/mL, about 100 mg/mL to about 200 mg/mL, about 110 mg/mL to about 200 mg/mL, about 120 mg/mL to about 200 mg/mL, about 130 mg/mL to about 200 mg/mL, about 140 mg/mL to about 200 mg/mL, about 150 mg/mL to about 200 mg/mL, about 160 mg/mL to about 200 mg/mL, about 170 mg/mL to about 200 mg/mL, about 180 mg/mL to about 200 mg/mL, or about 190 mg/mL to about 200 mg/mL.

Further provided herein are compositions produced using one or more of the systems and/or methods provided herein, the compositions comprising a mixture of beta-cyclodextrin molecules substituted at one or more hydroxyl positions by hydroxypropyl groups, wherein: the mixture comprises less than 1% unsubstituted beta-cyclodextrin (“DS-0”) and beta-cyclodextrin substituted with one hydroxypropyl group (“DS-1”); and, the mixture comprises no more than 50% beta-cyclodextrin substituted with four hydroxypropyl groups (“DS-4”).

The mixture may comprise less than 0.1% DS-0 and less than 0.1% DS-1, collectively. For example, the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-0; and/or the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-1.

The mixture may comprise no more than 25% beta-cyclodextrin substituted with four hydroxypropyl groups (“DS-4”). The mixture may comprise at least 1%, at least 2%, at least 3%, at least 4%, at least 5%, at least 6%, at least 7%, at least at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, or at least 25% DS-4. Alternatively, the mixture may comprise no more than 25%, no more than 30%, no more than 35%, no more than 40%, no more than 45%, or no more than 50% DS-4. The mixture may comprise from about 5% to about 50%, about 5% to about 10%, about 5% to about 20%, about 5% to about 30%, about 5% to about 40%, about 10% to about 50%, about 20% to about 50%, about 30% to about 50%, about 40% to about 50% about 10% to about 40%, or about 20% to about 30% DS-4.

The amount of DS-0, DS-1, or DS-4 may be determined by peak height of an electrospray MS spectrum.

The mixture may have an average molar substitution in the range from about 0.40 to about 0.80; for example, the mixture may have an average molar substitution of about 0.40, 0.45, 0.50, 0.55, 0.60, 0.65, 0.70, 0.75, or about 0.80. The mixture may have an average degree of substitution (“DSₐ”) of about 3 to about 7, from about 4 to about 7, from about 5 to about 7, or from about 6 to about 7. For example, the mixture may have an average degree of substitution of about 3, 3.5, 4, 4.5, 5, 5.5, 6, 6.5, or about 7.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC or gas chromatography.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC, gas chromatography, or the PG/EG ratio of propylene glycol to ethylene glycol.

The composition may comprise no more than 1 ppm propylene oxide, no more than 0.9 ppm propylene oxide, no more than 0.8 ppm propylene oxide, no more than 0.7 ppm propylene oxide, no more than 0.6 ppm propylene oxide, no more than 0.5 ppm propylene oxide, no more than 0.4 ppm propylene oxide, no more than 0.3 ppm propylene oxide, no more than 0.2 ppm propylene oxide, or no more than 0.1 ppm propylene oxide. The amount of propylene oxide may be measured by HPLC or gas chromatography.

The total amount of other unspecified impurities in the composition may be less than or equal to 0.05%; for example, the total amount of unspecified impurities in the composition may be 0.05%, less than 0.05%, less than or equal to 0.04%, less than or equal to 0.03%, less than or equal to 0.02%, or less than or equal to 0.01%. The amount of unspecified impurities may be measured by HPLC or gas chromatography.

The composition may be suitable for administration intrathecal, intravenous, or intracerebroventricular administration to a patient in need thereof. The patient may be an adult patient or a pediatric patient. The composition may further comprise a pharmaceutically acceptable diluent.

The composition may solubilize lipids in an aqueous medium. The lipids may comprise unesterified or esterified cholesterol. The composition may be provided as a solution, wherein the composition has a concentration of 20% w/v in the solution. The composition may have an affinity for unesterified cholesterol. The solubilization may be determined by UV spectrometry or by HPLC.

In some embodiments, about 200 mg of the composition solubilizes at least about 2 mg, 3 mg, 4 mg, 5 mg, 6 mg, 7 mg, 8 mg, 9 mg, or at least about 10 mg of unesterified cholesterol in distilled water at room temperature. In one example, 1 mL of the solution is able to solubilize about 2 mg of unesterified cholesterol at room temperature when measured by UV spectrometry after about 24 hours.

The composition may have a concentration in a solution from about 10 mg/mL to about 200 mg/mL. For example, the composition may have a concentration in a solution from about 10 mg/mL to about 20 mg/mL, about 10 mg/mL to about 30 mg/mL, about 10 mg/m L to about 40 mg/mL, about 10 mg/mL to about 50 mg/m L, about 10 mg/mL to about 60 mg/mL, about 10 mg/mL to about 70 mg/mL, about 10 mg/mL to about 80 mg/mL, about 10 mg/mL to about 90 mg/mL, about 10 mg/mL to about 100 mg/mL, about 10 mg/mL to about 110 mg/mL, about 10 mg/mL to about 120 mg/mL, about 10 mg/mL to about 130 mg/mL, about 10 mg/mL to about 140 mg/mL, about 10 mg/mL to about 150 mg/mL, about 10 mg/mL to about 160 mg/mL, about 10 mg/mL to about 170 mg/mL, about 10 mg/mL to about 180 mg/mL, about 10 mg/mL to about 190 mg/mL, about 20 mg/mL to about 200 mg/mL, about 30 mg/mL to about 200 mg/mL, about 40 mg/mL to about 200 mg/mL, about 50 mg/mL to about 200 mg/mL, about 60 mg/mL to about 200 mg/mL, about 70 mg/mL to about 200 mg/mL, about 80 mg/mL to about 200 mg/mL, about 90 mg/mL to about 200 mg/mL, about 100 mg/mL to about 200 mg/mL, about 110 mg/mL to about 200 mg/mL, about 120 mg/mL to about 200 mg/mL, about 130 mg/mL to about 200 mg/mL, about 140 mg/mL to about 200 mg/mL, about 150 mg/mL to about 200 mg/mL, about 160 mg/mL to about 200 mg/mL, about 170 mg/mL to about 200 mg/mL, about 180 mg/mL to about 200 mg/mL, or about 190 mg/mL to about 200 mg/mL.

Further provided herein are compositions produced using one or more of the systems and/or methods provided herein, the compositions comprising a mixture of beta-cyclodextrin molecules substituted at one or more hydroxyl positions by hydroxypropyl groups, wherein: the mixture comprises less than 1% unsubstituted beta-cyclodextrin (“DS-0”) and beta-cyclodextrin substituted with one hydroxypropyl group (“DS-1”); and, the mixture comprises no more than 50% beta-cyclodextrin substituted with five hydroxypropyl groups (“DS-5”).

The mixture may comprise less than 0.1% DS-0 and less than 0.1% DS-1, collectively. For example, the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-0; and/or the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-1.

The mixture may comprise no more than 25% beta-cyclodextrin substituted with five hydroxypropyl groups (“DS-5”). The mixture may comprise at least 1%, at least 2%, at least 3%, at least 4%, at least 5%, at least 6%, at least 7%, at least at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, or at least 25% DS-5. Alternatively, the mixture may comprise no more than 25%, no more than 30%, no more than 35%, no more than 40%, no more than 45%, or no more than 50% DS-5. The mixture may comprise from about 5% to about 50%, about 5% to about 10%, about 5% to about 20%, about 5% to about 30%, about 5% to about 40%, about 10% to about 50%, about 20% to about 50%, about 30% to about 50%, about 40% to about 50% about 10% to about 40%, or about 20% to about 30% DS-5.

The amount of DS-0, DS-1, or DS-5 may be determined by peak height of an electrospray MS spectrum.

The mixture may have an average molar substitution in the range from about 0.40 to about 0.80; for example, the mixture may have an average molar substitution of about 0.40, 0.45, 0.50, 0.55, 0.60, 0.65, 0.70, 0.75, or about 0.80. The mixture may have an average degree of substitution (“DSₐ”) of about 3 to about 7, from about 4 to about 7, from about 5 to about 7, or from about 6 to about 7. For example, the mixture may have an average degree of substitution of about 3, 3.5, 4, 4.5, 5, 5.5, 6, 6.5, or about 7.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC or gas chromatography.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC, gas chromatography, or the PG/EG ratio of propylene glycol to ethylene glycol.

The composition may comprise no more than 1 ppm propylene oxide, no more than 0.9 ppm propylene oxide, no more than 0.8 ppm propylene oxide, no more than 0.7 ppm propylene oxide, no more than 0.6 ppm propylene oxide, no more than 0.5 ppm propylene oxide, no more than 0.4 ppm propylene oxide, no more than 0.3 ppm propylene oxide, no more than 0.2 ppm propylene oxide, or no more than 0.1 ppm propylene oxide. The amount of propylene oxide may be measured by HPLC or gas chromatography.

The total amount of other unspecified impurities in the composition may be less than or equal to 0.05%; for example, the total amount of unspecified impurities in the composition may be 0.05%, less than 0.05%, less than or equal to 0.04%, less than or equal to 0.03%, less than or equal to 0.02%, or less than or equal to 0.01%. The amount of unspecified impurities may be measured by HPLC or gas chromatography.

The composition may be suitable for administration intrathecal, intravenous, or intracerebroventricular administration to a patient in need thereof. The patient may be an adult patient or a pediatric patient. The composition may further comprise a pharmaceutically acceptable diluent.

The composition may solubilize lipids in an aqueous medium. The lipids may comprise unesterified or esterified cholesterol. The composition may be provided as a solution, wherein the composition has a concentration of 20% w/v in the solution. The composition may have an affinity for unesterified cholesterol. The solubilization may be determined by UV spectrometry or by HPLC.

In some embodiments, about 200 mg of the composition solubilizes at least about 2 mg, 3 mg, 4 mg, 5 mg, 6 mg, 7 mg, 8 mg, 9 mg, or at least about 10 mg of unesterified cholesterol in distilled water at room temperature. In one example, 1 mL of the solution is able to solubilize about 2 mg of unesterified cholesterol at room temperature when measured by UV spectrometry after about 24 hours.

The composition may have a concentration in a solution from about 10 mg/mL to about 200 mg/mL. For example, the composition may have a concentration in a solution from about 10 mg/mL to about 20 mg/mL, about 10 mg/mL to about 30 mg/mL, about 10 mg/m L to about 40 mg/mL, about 10 mg/mL to about 50 mg/m L, about 10 mg/mL to about 60 mg/mL, about 10 mg/mL to about 70 mg/mL, about 10 mg/mL to about 80 mg/mL, about 10 mg/mL to about 90 mg/mL, about 10 mg/mL to about 100 mg/mL, about 10 mg/mL to about 110 mg/mL, about 10 mg/mL to about 120 mg/mL, about 10 mg/mL to about 130 mg/mL, about 10 mg/mL to about 140 mg/mL, about 10 mg/mL to about 150 mg/mL, about 10 mg/mL to about 160 mg/mL, about 10 mg/mL to about 170 mg/mL, about 10 mg/mL to about 180 mg/mL, about 10 mg/mL to about 190 mg/mL, about 20 mg/mL to about 200 mg/mL, about 30 mg/mL to about 200 mg/mL, about 40 mg/mL to about 200 mg/mL, about 50 mg/mL to about 200 mg/mL, about 60 mg/mL to about 200 mg/mL, about 70 mg/mL to about 200 mg/mL, about 80 mg/mL to about 200 mg/mL, about 90 mg/mL to about 200 mg/mL, about 100 mg/mL to about 200 mg/mL, about 110 mg/mL to about 200 mg/mL, about 120 mg/mL to about 200 mg/mL, about 130 mg/mL to about 200 mg/mL, about 140 mg/mL to about 200 mg/mL, about 150 mg/mL to about 200 mg/mL, about 160 mg/mL to about 200 mg/mL, about 170 mg/mL to about 200 mg/mL, about 180 mg/mL to about 200 mg/mL, or about 190 mg/mL to about 200 mg/mL.

Further provided herein are compositions produced using one or more of the systems and/or methods provided herein, the compositions comprising a mixture of beta-cyclodextrin molecules substituted at one or more hydroxyl positions by hydroxypropyl groups, wherein: the mixture comprises less than 1% unsubstituted beta-cyclodextrin (“DS-0”) and beta-cyclodextrin substituted with one hydroxypropyl group (“DS-1”); and, at least 70% of the beta-cyclodextrins have a DS within DSₐ±1σ, wherein σ is the standard deviation.

At least 70% of the beta-cyclodextrins have a DS within DSₐ±1σ, wherein σ is the standard deviation. In some embodiments, at least 75%, at least 80%, at least 85%, at least 90%, at least 95%, at least 96%, at least 97%, at least 98%, or at least 99% of the beta-cyclodextrins have a DS within DSₐ±1σ.

The mixture may comprise less than 0.1% DS-0 and less than 0.1% DS-1, collectively. For example, the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-0; and/or the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-1.

The amount of DS-0 or DS-1 may be determined by peak height of an electrospray MS spectrum.

The mixture may have an average molar substitution in the range from about 0.40 to about 0.80; for example, the mixture may have an average molar substitution of about 0.40, 0.45, 0.50, 0.55, 0.60, 0.65, 0.70, 0.75, or about 0.80. The mixture may have an average degree of substitution (“DSₐ”) of about 3 to about 7, from about 4 to about 7, from about 5 to about 7, or from about 6 to about 7. For example, the mixture may have an average degree of substitution of about 3, 3.5, 4, 4.5, 5, 5.5, 6, 6.5, or about 7.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC or gas chromatography.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC, gas chromatography, or the PG/EG ratio of propylene glycol to ethylene glycol.

The composition may comprise no more than 1 ppm propylene oxide, no more than 0.9 ppm propylene oxide, no more than 0.8 ppm propylene oxide, no more than 0.7 ppm propylene oxide, no more than 0.6 ppm propylene oxide, no more than 0.5 ppm propylene oxide, no more than 0.4 ppm propylene oxide, no more than 0.3 ppm propylene oxide, no more than 0.2 ppm propylene oxide, or no more than 0.1 ppm propylene oxide. The amount of propylene oxide may be measured by HPLC or gas chromatography.

The total amount of other unspecified impurities in the composition may be less than or equal to 0.05%; for example, the total amount of unspecified impurities in the composition may be 0.05%, less than 0.05%, less than or equal to 0.04%, less than or equal to 0.03%, less than or equal to 0.02%, or less than or equal to 0.01%. The amount of unspecified impurities may be measured by HPLC or gas chromatography.

The composition may be suitable for administration intrathecal, intravenous, or intracerebroventricular administration to a patient in need thereof. The patient may be an adult patient or a pediatric patient. The composition may further comprise a pharmaceutically acceptable diluent.

The composition may solubilize lipids in an aqueous medium. The lipids may comprise unesterified or esterified cholesterol. The composition may be provided as a solution, wherein the composition has a concentration of 20% w/v in the solution. The composition may have an affinity for unesterified cholesterol. The solubilization may be determined by UV spectrometry or by HPLC.

In some embodiments, about 200 mg of the composition solubilizes at least about 2 mg, 3 mg, 4 mg, 5 mg, 6 mg, 7 mg, 8 mg, 9 mg, or at least about 10 mg of unesterified cholesterol in distilled water at room temperature. In one example, 1 mL of the solution is able to solubilize about 2 mg of unesterified cholesterol at room temperature when measured by UV spectrometry after about 24 hours.

The composition may have a concentration in a solution from about 10 mg/mL to about 200 mg/mL. For example, the composition may have a concentration in a solution from about 10 mg/mL to about 20 mg/mL, about 10 mg/mL to about 30 mg/mL, about 10 mg/mL to about 40 mg/mL, about 10 mg/mL to about 50 mg/mL, about 10 mg/mL to about 60 mg/mL, about 10 mg/mL to about 70 mg/mL, about 10 mg/mL to about 80 mg/mL, about 10 mg/mL to about 90 mg/mL, about 10 mg/mL to about 100 mg/mL, about 10 mg/mL to about 110 mg/mL, about 10 mg/mL to about 120 mg/mL, about 10 mg/mL to about 130 mg/mL, about 10 mg/mL to about 140 mg/mL, about 10 mg/mL to about 150 mg/mL, about 10 mg/mL to about 160 mg/mL, about 10 mg/mL to about 170 mg/mL, about 10 mg/mL to about 180 mg/mL, about 10 mg/mL to about 190 mg/mL, about 20 mg/mL to about 200 mg/mL, about 30 mg/mL to about 200 mg/mL, about 40 mg/mL to about 200 mg/mL, about 50 mg/mL to about 200 mg/mL, about 60 mg/mL to about 200 mg/mL, about 70 mg/mL to about 200 mg/mL, about 80 mg/mL to about 200 mg/mL, about 90 mg/mL to about 200 mg/mL, about 100 mg/mL to about 200 mg/mL, about 110 mg/mL to about 200 mg/mL, about 120 mg/mL to about 200 mg/mL, about 130 mg/mL to about 200 mg/mL, about 140 mg/mL to about 200 mg/mL, about 150 mg/mL to about 200 mg/mL, about 160 mg/mL to about 200 mg/mL, about 170 mg/mL to about 200 mg/mL, about 180 mg/mL to about 200 mg/mL, or about 190 mg/mL to about 200 mg/mL.

Further provided herein are compositions produced using one or more of the systems and/or methods provided herein, the compositions comprising a mixture of β-cyclodextrin molecules wherein the mixture of β-cyclodextrin molecules may include β-cyclodextrin substituted with zero hydroxypropyl groups (“DS-0”, also referred to as “unsubstituted”), β-cyclodextrin substituted with one hydroxypropyl group (“DS-1”), β-cyclodextrin substituted with two hydroxypropyl groups (“DS-2”), β-cyclodextrin substituted with three hydroxypropyl groups (“DS-3”), β-cyclodextrin substituted with four hydroxypropyl groups (“DS-4”), β-cyclodextrin substituted with five hydroxypropyl groups (“DS-5”), β-cyclodextrin substituted with six hydroxypropyl groups (“DS-6”), β-cyclodextrin substituted with seven hydroxypropyl groups (“DS-7”), β-cyclodextrin substituted with eight hydroxypropyl groups (“DS-8”), β-cyclodextrin substituted with nine hydroxypropyl groups (“DS-9”), β-cyclodextrin substituted with ten hydroxypropyl groups (“DS-10”), β-cyclodextrin substituted with eleven hydroxypropyl groups (“DS-11”), β-cyclodextrin substituted with twelve hydroxypropyl groups (“DS-12”), β-cyclodextrin substituted with thirteen hydroxypropyl groups (“DS-13”), and β-cyclodextrin substituted with fourteen hydroxypropyl groups (“DS-14”). The degree of substitution of the mixture of β-cyclodextrin molecules may be determined MALDI-TOF-MS. As relevant here, the number of hydroxypropyl groups per anhydroglucose unit in the mixture of beta-cyclodextrins is the “molar substitution”, or “MS”, and is determined according to the procedures set forth in the USP monograph on Hydroxypropyl Betadex (USP NF 2015) (“USP Hydroxypropyl Betadex monograph”), incorporated herein by reference in its entirety. In this disclosure, the term “average molar substitution”, or “MSₐ”, is used synonymously with “MS” as that term is used in the USP Hydroxypropyl Betadex monograph, and the term “glucose unit” is used as a synonym for “anhydroglucose unit” as that term is used in the USP Hydroxypropyl Betadex monograph. As further relevant here, the “average number of hydroxypropyl groups per beta-cyclodextrin,” also known as an “average degree of substitution,” “average DS,” or “DSₐ,” refers to the total number of hydroxypropyl groups in a population of beta-cyclodextrins divided by the number of beta-cyclodextrin molecules. In an illustrative example, an equal parts mixture of beta-cyclodextrins containing glucose units that are each substituted with one hydroxypropyl group and beta-cyclodextrins containing glucose units that are each substituted with two hydroxypropyl groups has a DSₐ=10.5 (average of equal parts beta-cyclodextrins with DS=7 and DS=14). In another illustrative example, a mixture of 33.3% beta-cyclodextrins in which only one of the seven glucose units is substituted with a hydroxypropyl group (i.e., DS=1) and 66.7% beta-cyclodextrins containing glucose units that are each substituted with one hydroxypropyl group (i.e., DS=7) has a DSₐ=5.0. The DSₐ is determined by multiplying the MS by 7. As further relevant here, the “degree of substitution” or “DS” refers to the total number of hydroxypropyl groups substituted directly or indirectly on a beta-cyclodextrin molecule. For example, a beta-cyclodextrin molecule containing glucose units, each of which is substituted with one hydroxypropyl group, has a DS=7. In another example, a beta-cyclodextrin molecule in which only one of the seven glucose units is substituted with a hydroxypropyl group, and that hydroxypropyl group is itself substituted with another hydroxypropyl group (e.g., a beta-cyclodextrin with a single occurrence of HP that comprises two hydroxypropyl groups), has a DS=2. As used herein, DSₐ is used synonymously with “degree of substitution” as that term is defined in the USP Hydroxypropyl Betadex monograph.

In certain embodiments, the pharmaceutical compositions of the disclosure comprise, as a pharmaceutically active ingredient, a mixture of unsubstituted beta-cyclodextrin molecules and beta-cyclodextrin molecules substituted at one or more hydroxyl positions by hydroxypropyl groups, wherein the mixture has an average number of hydroxypropyl groups per beta-cyclodextrin molecule (DSₐ) of about 3 to about 7.

In some embodiments, the DSₐ is about 3 to about 5, such as about 3 to about 4. In some embodiments, the DSₐ is 3.3±0.3, 3.5±0.3, or 3.7±0.3. In other embodiments, the DSₐ is 3.2±0.2, 3.3±0.2, 3.4±0.2, 3.5±0.2, 3.6±0.2, 3.7±0.2, or 3.8±0.2. In other embodiments, the DSₐ is 3.1±0.1, 3.2±0.1, 3.3±0.1, 3.4±0.1, 0.1, 3.6±0.1, 3.7±0.1, 3.8±0.1, or 3.9±0.1.

In some embodiments, the DSₐ is about 3.5 to about 5.5, such as about 3.5 to about 4.5. In some embodiments, the DSₐ is 3.8±0.3, 4.0 0.3, or 4.2±0.3. In other embodiments, the DSₐ is 3.7±0.2, 3.8±0.2, 3.9±0.2, 4.0 0.2, 4.1±0.2, 4.2±0.2, or 4.3±0.2. In other embodiments, the DSₐ is 3.6±0.1, 3.7±0.1, 3.8±0.1, 3.9±0.1, 4.0 0.1, 4.1 0.1, 4.2±0.1, 4.3±0.1, or 4.4±0.1.

In some embodiments, the DSₐ is about 4 to about 6, such as about 4 to about 5. In some embodiments, the DSₐ is 4.3±0.3, 4.5±0.3, or 4.7±0.3. In other embodiments, the DSₐ is 4.2±0.2, 4.3±0.2, 4.4±0.2, 4.5±0.2, 4.6±0.2, 4.7±0.2, or 4.8±0.2. In other embodiments, the DSₐ is 4.1±0.1, 4.2±0.1, 4.3±0.1, 4.4±0.1, 4.5±0.1, 4.6±0.1, 4.7±0.1, 4.8±0.1, or 4.9±0.1.

In some embodiments, the DSₐ is about 4.5 to about 6.5, such as about 4.5 to about 5.5. In some embodiments, the DSₐ is 4.8±0.3, 5.0 0.3, or 5.2±0.3. In other embodiments, the DSₐ is 4.7±0.2, 4.8±0.2, 4.9±0.2, 5.0 0.2, 5.1±0.2, 5.2±0.2, or 5.3±0.2. In other embodiments, the DSₐ is 4.6±0.1, 4.7±0.1, 4.8±0.1, 4.9±0.1, 5.0±0.1, 5.1±0.1, 5.2±0.1, 5.3±0.1, or 5.4±0.1.

In some embodiments, the DSₐ is about 5 to about 7, such as about 5 to about 6. In some embodiments, the DSₐ is 5.3±0.3, 5.5±0.3, or 5.7±0.3. In other embodiments, the DSₐ is 5.2±0.2, 5.3±0.2, 5.4±0.2, 5.5±0.2, 5.6±0.2, 5.7±0.2, or 5.8±0.2. In other embodiments, the DSₐ is 5.1±0.1, 5.2±0.1, 5.3±0.1, 5.4±0.1, 5.5±0.1, 5.6±0.1, 5.7±0.1, 5.8±0.1, or 5.9±0.1.

In some embodiments, the DSₐ is about 5.5 to about 6.5. In some embodiments, the DSₐ is 5.8±0.3, 6.0±0.3, or 6.2±0.3. In other embodiments, the DSₐ is 5.7±0.2, 5.8±0.2, 5.9±0.2, 6.0±0.2, 6.1±0.2, 6.2±0.2, or 6.3±0.2. In other embodiments, the DSₐ is 5.6±0.1, 5.7±0.1, 5.8±0.1, 5.9±0.1, 6.0±0.1, 6.1±0.1, 6.2±0.1, 6.3±0.1, or 6.4±0.1.

In some embodiments, the DSₐ is about 6 to about 7. In some embodiments, the DSₐ is 6.3±0.3, 6.5±0.3, or 6.7±0.3. In other embodiments, the DSₐ is 6.2±0.2, 6.3±0.2, 6.4±0.2, 6.5±0.2, 6.6±0.2, 6.7±0.2, or 6.8±0.2. In other embodiments, the DSₐ is 6.1±0.1, 6.2±0.1, 6.3±0.1, 6.4±0.1, 6.5±0.1, 6.6±0.1, 6.7±0.1, 6.8±0.1, or 6.9±0.1.

In some embodiments, the DSₐ is about 4.1±15%, about 4.2±15%, about 4.3±15%, about 4.4±15%, or about 4.5±15%, such as about 4.1±10%, about 4.2±10%, about 4.3±10%, about 4.4±10%, or about 4.5±10%, such as about 4.1±5%, about 4.2±5%, about 4.3±5%, about 4.4±5%, or about 4.5±5%. For example, in certain embodiments, the DSₐ is about 4.31±10%, about 4.32±10%, about 4.33±10%, about 4.34±10%, about 4.35±10%, about 4.36±10%, or about 4.37±10%, such as about 4.31±5%, about 4.32±5%, about 4.33±5%, about 4.34±5%, about 4.35±5%, about 4.36±5%, or about 4.37±5%. In particular embodiments, the DSₐ is about 4.34±10%, such as about 4.34±5%.

In some embodiments, the DSₐ is about 4.3±15%, about 4.4±15%, about 4.5±15%, about 4.6±15%, or about 4.7±15%, such as about 4.3±10%, about 4.4±10%, about 4.5±10%, about 4.6±10%, or about 4.7±10%, such as about 4.3±5%, about 4.4±5%, about 4.5±5%, about 4.6±5%, or about 4.7±5%. For example, in certain embodiments, the DSₐ is about 4.47±10%, about 4.48±10%, about 4.49±10%, about 4.50±10%, about 4.51±10%, about 4.52±10%, or about 4.53±10%, such as about 4.47±5%, about 4.48±5%, about 4.49±5%, about 4.50±5%, about 4.51±5%, about 4.52±5%, or about 4.53±5%. In particular embodiments, the DSₐ is about 4.50±10%, such as about 4.50±5%.

In some embodiments, the DSₐ is about 6.1±15%, about 6.2±15%, about 6.3±15%, about 6.4±15%, or about 6.5±15%, such as about 6.1±10%, about 6.2±10%, about 6.3±10%, about 6.4±10%, or about 6.5±10%, such as about 6.1±5%, about 6.2±5%, about 6.3±5%, about 6.4±5%, or about 6.5±5%. For example, in certain embodiments, the DSₐ is about 6.34±10%, about 6.35±10%, about 6.36±10%, about 6.37±10%, about 6.38±10%, about 6.39±10%, or about 6.40±10%, such as about 6.34±5%, about 6.35±5%, about 6.36±5%, about 6.37±5%, about 6.38±5%, about 6.39±5%, or about 6.40±5%. In particular embodiments, the DSₐ is about 6.37±10%, such as about 6.37±5%.

In some embodiments, the DSₐ is about 6.3±15%, about 6.4±15%, about 6.5±15%, about 6.6±15%, or about 6.7±15%, such as about 6.3±10%, about 6.4±10%, about 6.5±10%, about 6.6±10%, or about 6.7±10%, such as about 6.3±5%, about 6.4±5%, about 6.5±5%, about 6.6±5%, or about 6.7±5%. For example, in certain embodiments, the DSₐ is about 6.50±10%, about 6.51±10%, about 6.52±10%, about 6.53±10%, about 6.54±10%, about 6.55±10%, or about 6.56±10%, such as about 6.50±5%, about 6.51±5%, about 6.52±5%, about 6.53±5%, about 6.54±5%, about 6.55±5%, or about 6.56±5%. In particular embodiments, the DSₐ is about 6.53±10%, such as about 6.53±5%.

The distribution of the degree of substitution within a mixture of unsubstituted beta-cyclodextrin molecules and beta-cyclodextrin molecules substituted at one or more hydroxyl positions by hydroxypropyl groups can vary. For example, an equal parts mixture of beta-cyclodextrins containing glucose units each of which is substituted with one hydroxypropyl group and beta-cyclodextrins containing glucose units each of which is substituted with two hydroxypropyl groups has a DSₐ=10.5 (average of equal parts beta-cyclodextrins with DS=7 and DS=14). Although DSₐ=10.5, in this example there are no beta-cyclodextrins having DS=10 or DS=11 within the mixture. In other cases, the majority of beta-cyclodextrins within the mixture of beta-cyclodextrins have DS that are close to the DSₐ.

In some embodiments of the disclosure, at least about 50%, e.g., at least about 55%, about 60%, about 65%, about 70%, about 75%, about 80%, about 85%, about 90%, about 95%, or about 97%, of the beta-cyclodextrins within the mixture have a DS within DSₐ±Xσ, wherein σ is the standard deviation, and X is 1, 2, or 3. For example, in some embodiments, at least about 50%, e.g., at least about 55%, about 60%, about 65%, about 70%, about 75%, about 80%, about 85%, about 90%, about 95%, or about 97%, of the beta-cyclodextrins within the mixture have a DS within DSₐ±1σ. In some embodiments, at least about 70% of the beta-cyclodextrins have a DS within DSₐ±1σ. In some embodiments, at least about 90% of the beta-cyclodextrins have a DS within DSₐ±1σ. In some embodiments, at least about 95% of the beta-cyclodextrins have a DS within DSₐ±1σ.

In some embodiments, at least about 50%, e.g., at least about 55%, about 60%, about 65%, about 70%, about 75%, about 80%, about 85%, about 90%, about 95%, or about 97%, of the beta-cyclodextrins within the mixture have a DS within DSₐ±2σ. In some embodiments, at least about 70% of the beta-cyclodextrins have a DS within DSₐ±2σ. In some embodiments, at least about 90% of the beta-cyclodextrins have a DS within DSₐ±2σ. In some embodiments, at least about 95% of the beta-cyclodextrins have a DS within DSₐ±2σ.

In some embodiments, at least about 50%, e.g., at least about 55%, about 60%, about 65%, about 70%, about 75%, about 80%, about 85%, about 90%, about 95%, or about 97%, of the beta-cyclodextrins within the mixture have a DS within DSₐ±3σ. In some embodiments, at least about 70% of the beta-cyclodextrins have a DS within DSₐ±3σ. In some embodiments, at least about 90% of the beta-cyclodextrins have a DS within DSₐ±3σ. In some embodiments, at least about 95% of the beta-cyclodextrins have a DS within DSₐ±3σ.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±1. In some embodiments, at least about 70% of the beta-cyclodextrins have a DS within DSₐ±1. In some embodiments, at least about 90% of the beta-cyclodextrins have a DS within DSₐ±1. In some embodiments, at least about 95% of the beta-cyclodextrins have a DS within DSₐ±1.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.8. In some embodiments, at least about 70% of the beta-cyclodextrins have a DS within DSₐ±0.8. In some embodiments, at least about 90% of the beta-cyclodextrins have a DS within DSₐ±0.8. In some embodiments, at least about 95% of the beta-cyclodextrins have a DS within DSₐ±0.8.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.6. In some embodiments, at least about 70% of the beta-cyclodextrins have a DS within DSₐ±0.6. In some embodiments, at least about 90% of the beta-cyclodextrins have a DS within DSₐ±0.6. In some embodiments, at least about 95% of the beta-cyclodextrins have a DS within DSₐ±0.6.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.5. In some embodiments, at least about 70% of the beta-cyclodextrins have a DS within DSₐ±0.5. In some embodiments, at least about 90% of the beta-cyclodextrins have a DS within DSₐ±0.5. In some embodiments, at least about 95% of the beta-cyclodextrins have a DS within DSₐ±0.5.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.4. In some embodiments, at least about 70% of the beta-cyclodextrins have a DS within DSₐ±0.4. In some embodiments, at least about 90% of the beta-cyclodextrins have a DS within DSₐ±0.4. In some embodiments, at least about 95% of the beta-cyclodextrins have a DS within DSₐ±0.4.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.3. In some embodiments, at least about 70% of the beta-cyclodextrins have a DS within DSₐ±0.3. In some embodiments, at least about 90% of the beta-cyclodextrins have a DS within DSₐ±0.3. In some embodiments, at least about 95% of the beta-cyclodextrins have a DS within DSₐ±0.3.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.2. In some embodiments, at least about 70% of the beta-cyclodextrins have a DS within DSₐ±0.2. In some embodiments, at least about 90% of the beta-cyclodextrins have a DS within DSₐ±0.2. In some embodiments, at least about 95% of the beta-cyclodextrins have a DS within DSₐ±0.2.

In some embodiments, at least about 50%, e.g., at least about 55%, about 60%, about 65%, about 70%, about 75%, about 80%, about 85%, about 90%, about 95%, or about 97%, of the beta-cyclodextrins have a DS within DSₐ±0.1. In some embodiments, at least about 70% of the beta-cyclodextrins have a DS within DSₐ±0.1. In some embodiments, at least about 90% of the beta-cyclodextrins have a DS within DSₐ±0.1. In some embodiments, at least about 95% of the beta-cyclodextrins have a DS within DSₐ±0.1.

In some embodiments, the MS ranges from 0.40 to 0.80, such as 0.41 to 0.79, 0.42 to 0.78, 0.43 to 0.77, 0.44 to 0.76, 0.45 to 0.75, 0.46 to 0.74, 0.47 to 0.73, 0.48 to 0.72, 0.49 to 0.71, 0.50 to 0.70, 0.51 to 0.69, 0.52 to 0.68, 0.53 to 0.67, 0.54 to 0.66, 0.55 to 0.65, 0.56 to 0.64, 0.57 to 0.63, 0.58 to 0.62, or 0.59 to 0.61.

In certain embodiments, the MS is about 0.40, about 0.41, about 0.42, about 0.43, about 0.44, about 0.45, about 0.46, about 0.47, about 0.48, about 0.49, about 0.50, about 0.51, about 0.52, about 0.53, about 0.54, about 0.55, about 0.56, about 0.57, about 0.58, about 0.59, about 0.60, about 0.61, about 0.62, about 0.63, about 0.64, about 0.65, about 0.66, about 0.67, about 0.68, about 0.69, about 0.70, about 0.71, about 0.72, about 0.73, about 0.74, about 0.75, about 0.76, about 0.77, about 0.78, about 0.79, or about 0.80.

In certain embodiments, the MS is about 0.571-0.686 (DSₐ about 4.0 to about 4.8). In some of these embodiments, the MS is in the range of about 0.58 to about 0.68. In currently preferred embodiments, the MS is in the range of 0.58-0.68.

In various embodiments, the MS is at least about 0.55. In certain embodiments, the MS is at least about 0.56, about 0.57, about 0.58, about 0.59, or about 0.60. In certain embodiments, the MS is no more than about 0.70. In specific embodiments, the MS is no more than about 0.69, about 0.68, about 0.67, about 0.66, or about 0.65.

Further provided herein are compositions produced using one or more of the systems and/or methods provided herein, the compositions comprising a mixture of β-cyclodextrin molecules, wherein the mixture of β-cyclodextrin molecules may include β-cyclodextrin substituted with four hydroxypropyl groups (“DS-4”), β-cyclodextrin substituted with five hydroxypropyl groups (“DS-5”), β-cyclodextrin substituted with six hydroxypropyl groups (“DS-6”), β-cyclodextrin substituted with seven hydroxypropyl groups (“DS-7”), β-cyclodextrin substituted with eight hydroxypropyl groups (“DS-8”), β-cyclodextrin substituted with nine hydroxypropyl groups (“DS-9”), β-cyclodextrin substituted with ten hydroxypropyl groups (“DS-10”), β-cyclodextrin substituted with eleven hydroxypropyl groups (“DS-11”), β-cyclodextrin substituted with twelve hydroxypropyl groups (“DS-12”), β-cyclodextrin substituted with thirteen hydroxypropyl groups (“DS-13”), and β-cyclodextrin substituted with fourteen hydroxypropyl groups (“DS-14”). The degree of substitution of the mixture of β-cyclodextrin molecules may be determined MALDI-TOF-MS.

In some embodiments, the composition may have an average degree of substitution of between about 7 to about 9; for example, the average degree of substitution may be about 7.0, about 7.1, about 7.2, about 7.3, about 7.4, about 7.5, about 7.6, about 7.7, about 7.8, about 7.9, about 8.0, about 8.1, about 8.2, about 8.3, about 8.4, about 8.5, about 8.6, about 8.7, about 8.8, about 8.9, or about 9.0. In an exemplary embodiment, the average degree of substitution of the mixture of β-cyclodextrin molecules is about 7.7.

In some embodiments, the mixture of β-cyclodextrin molecules may include less than 1% of DS-4; for example, the mixture of β-cyclodextrin molecules may include about 0.9% of DS-4, about 0.8% of DS-4, about 0.7% of DS-4, about 0.6% of DS-4, about 0.5% of DS-4, about 0.4% of DS-4, about 0.3% of DS-4, about 0.2% of DS-4, or about 0.1% of DS-4. In some aspects, the mixture of β-cyclodextrin molecules may include less than 1% to about 0.9% of DS-4, about 0.9% to about 0.8% of DS-4, about 0.8% to about 0.7% of DS-4, about 0.7% to about 0.6% of DS-4, about 0.7% to about 0.6% of DS-4, about 0.6% to about 0.5% of DS-4, about 0.5% to about 0.4% of DS-4, about 0.4% to about 0.3% of DS-4, about 0.3% to about 0.2% of DS-4, about 0.2% to about 0.1% of DS-4, or less than 0.1% of DS-4. In some additional aspects, the mixture of β-cyclodextrin molecules may include less than 1% to about 0.8% of DS-4, less than 1% to about 0.7% of DS-4, less than 1% to about 0.6% of DS-4, less than 1% to about 0.5% of DS-4, less than 1% to about 0.4% of DS-4, less than 1% to about 0.3% of DS-4, less than 1% to about 0.2% of DS-4, less than 1% to about 0.1% of DS-4, about 0.9% to about 0.1% of DS-4, about 0.8% to about 0.1% of DS-4, about 0.7% to about 0.1% of DS-4, about 0.6% to about 0.1% of DS-4, about 0.5% to about 0.1% of DS-4, about 0.4% to about 0.1% of DS-4, or about 0.3% to about 0.1% of DS-4. In still further aspects, the mixture of β-cyclodextrin may include less than 1% of DS-4, less than 0.9% of DS-4, less than 0.8% of DS-4, less than 0.7% of DS-4, less than 0.6% of DS-4, less than 0.5% of DS-4, less than 0.4% of DS-4, less than 0.3% of DS-4, less than 0.2% of DS-4, or less than 0.1% of DS-4. In still further aspects, the mixture of β-cyclodextrin molecules may include about 0.001%, 0.01%, 0.05%, 0.1%, 0.2%, 0.3%, 0.4%, 0.5%, 0.6%, 0.7%, 0.8%, 0.9%, or about 1% of DS-4. In some embodiments, the amount of DS-4 in the mixture of β-cyclodextrin molecules may be determined by MALDI-TOF-MS. In an exemplary embodiment, the area of DS-4 in the MALDI-TOF-MS spectrum is 0.73%.

In some embodiments, the mixture of β-cyclodextrin molecules may include about 2% to about 5% of DS-5. In some aspects, the mixture of β-cyclodextrin molecules may include about 2% to about 2.5% of DS-5, about 2.5% to about 3% of DS-5, about 3% to about 3.5% of DS-5, about 3.5% to about 4% of DS-5, about 4% to about 4.5% of DS-5, or about 4.5% to about 5% of DS-5. In some additional aspects, the mixture of β-cyclodextrin molecules may include about 2% to about 3% of DS-5, about 2% to about 3.5% of DS-5, about 2% to about 4% of DS-5, about 2% to about 4.5% of DS-5, about 2.5% to about 5% of DS-5, about 3% to about 5% of DS-5, about 3.5% to about 5% of DS-5, about 4% of DS-5 to about 5% of DS-5, or about 3% to about 4% of DS-5. In still further aspects, the mixture of β-cyclodextrin molecules may include about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, or about 5.0% of DS-5. In some embodiments, the amount of DS-5 in the mixture of β-cyclodextrin molecules may be determined by MALDI-TOF-MS. In an exemplary embodiment, the area of DS-5 in the MALDI-TOF-MS spectrum is 3.49%.

In some embodiments, the mixture of β-cyclodextrin molecules may include about 7% to about 13% of DS-6. In some aspects, the mixture of β-cyclodextrin molecules may include about 7% to about 7.5% of DS-6, about 7.5% to about 8% of DS-6, about 8% to about 8.5% of DS-6, about 8.5% to about 9% of DS-6, about 9% to about 9.5% of DS-6, about 9.5% to about 10% of DS-6, about 10% to about 10.5% of DS-6, about 10.5% to about 11% of DS-6, about 11% to about 11.5% of DS-6, about 11.5% to about 12% of DS-6, about 12% to about 12.5% of DS-6, or about 12.5% to about 13% of DS-6. In some additional aspects, the mixture of β-cyclodextrin molecules may include about 7% to about 8% of DS-6, about 7% to about 8.5% of DS-6, about 7% to about 9% of DS-6, about 7% to about 9.5% of DS-6, about 7% to about 10% of DS-6, about 7% to about 10.5% of DS-6, about 7% to about 11% of DS-6, about 7% to about 11.5% of DS-6, about 7% to about 12% of DS-6, about 7% to about 12.5% of DS-6, about 7.5% to about 13% of DS-6, about 8% to about 13% of DS-6, about 8.5% to about 13% of DS-6, about 9% to about 13% of DS-6, about 9.5% to about 13% of DS-6, about 10% to about 13% of DS-6, about 10.5% to about 13% of DS-6, about 11% to about 13% of DS-6, about 11.5% to about 13% of DS-6, about 12% to about 13% of DS-6, about 8% to about 12% of DS-6, or about 9% to about 11% of DS-6. In still further aspects, the mixture of β-cyclodextrin molecules may include about 7.0%, about 7.1%, about 7.2%, about 7.3%, about 7.4%, about 7.5%, about 7.6%, about 7.7%, about 7.8%, about 7.9%, about 8.0%, about 8.1%, about 8.2%, about 8.3%, about 8.4%, about 8.5%, about 8.6%, about 8.7%, about 8.8%, about 8.9%, about 9.0%, about 9.1%, about 9.2%, about 9.3%, about 9.4%, about 9.5%, about 9.6%, about 9.7%, about 9.8%, about 9.9%, about 10.0%, about 10.1%, about 10.2%, about 10.3%, about 10.4%, about 10.5%, about 10.6%, about 10.7%, about 10.8%, about 10.9%, about 11.0%, about 11.1%, about 11.2%, about 11.3%, about 11.4%, about 11.5%, about 11.6%, about 11.7%, about 11.8%, about 11.9%, about 12.0%, about 12.1%, about 12.2%, about 12.3%, about 12.4%, about 12.5%, about 12.6%, about 12.7%, about 12.8%, about 12.9%, or about 13.0% of DS-6. In some embodiments, the amount of DS-6 in the mixture of β-cyclodextrin molecules may be determined by MALDI-TOF-MS. In an exemplary embodiment, the area of DS-6 in the MALDI-TOF-MS spectrum is 10.66%.

In some embodiments, the mixture of β-cyclodextrin molecules may include about 21% to about 27% of DS-7. In some aspects, the mixture of β-cyclodextrin molecules may include about 21% to about 21.5% of DS-7, about 21.5% to about 22% of DS-7, about 22% to about 22.5% of DS-7, about 22.5% to about 23% of DS-7, about 23% to about 23.5% of DS-7, about 23.5% to about 24% of DS-7, about 24% to about 24.5% of DS-7, about 24.5% to about 25% of DS-7, about 25% to about 25.5% of DS-7, about 25.5% to about 26% of DS-7, about 26% to about 26.5% of DS-7, or about 26.5% to about 27% of DS-7. In some additional aspects, the mixture of β-cyclodextrin molecules may include about 21% to about 22% of DS-7, about 21% to about 22.5% of DS-7, about 21% to about 23% of DS-7, about 21% to about 23.5% of DS-7, about 21% to about 24% of DS-7, about 21% to about 24.5% of DS-7, about 21% to about 25% of DS-7, about 21% to about 25.5% of DS-7, about 21% to about 26% of DS-7, about 21% to about 26.5% of DS-7, about 21.5% to about 27% of DS-7, about 22% to about 27% of DS-7, 22.5% to about 27% of DS-7, about 23% to about 27% of DS-7, about 23.5% to about 27% of DS-7, about 24% to about 27% of DS-7, about 24.5% to about 27% of DS-7, about 25% to about 27% of DS-7, about 25.5% to about 27% of DS-7, about 26% to about 27% of DS-7, about 22% to about 26% of DS-7, or about 23% to about 25% of DS-7. In still further aspects, the mixture of β-cyclodextrin molecules may include about 21.0%, about 21.1%, about 21.2%, about 21.3%, about 21.4%, about 21.5%, about 21.6%, about 21.7%, about 21.8%, about 21.9%, about 22.0%, about 22.1%, about 22.2%, about 22.3%, about 22.4%, about 22.5%, about 22.6%, about 22.7%, about 22.8%, about 22.9%, about 23.0%, about 23.1%, about 23.2%, about 23.3%, about 23.4%, about 23.5%, about 23.6%, about 23.7%, about 23.8%, about 23.9%, about 24.0%, about 24.1%, about 24.2%, about 24.3%, about 24.4%, about 24.5%, about 24.6%, about 24.7%, about 24.8%, about 24.9%, about 25.0%, about 25.1%, about 25.2%, about 25.3%, about 25.4%, about 25.5%, about 25.6%, about 25.7%, about 25.8%, about 25.9%, about 26.0%, about 26.1%, about 26.2%, about 26.3%, about 26.4%, about 26.5%, about 26.6%, about 26.7%, about 26.8%, about 26.9%, or about 27.0% of DS-7. In some embodiments, the amount of DS-7 may be determined by MALDI-TOF-MS. In an exemplary embodiment, the area of DS-7 in the MALDI-TOF-MS spectrum is 24.10%.

In some embodiments, the mixture of β-cyclodextrin molecules may include about 23% to about 29% of DS-8. In some aspects, the mixture of β-cyclodextrin molecules may include about 23% to about 23.5% of DS-8, about 23.5% to about 24% of DS-8, about 24% to about 24.5% of DS-8, about 24.5% to about 25% of DS-8, about 25% to about 25.5% of DS-8, about 25.5% to about 26% of DS-8, about 26% to about 26.5% of DS-8, about 26.5% to about 27% of DS-8, about 27% to about 27.5% of DS-8, about 27.5% to about 28% of DS-8, about 28% to about 28.5% of DS-8, or about 28.5% to about 29% of DS-8. In some additional aspects, the mixture of β-cyclodextrin molecules may include about 23% to about 24% of DS-8, about 23% to about 24.5% of DS-8, about 23% to about 25% of DS-8, about 23% to about 25.5% of DS-8, about 23% to about 26% of DS-8, about 23% to about 26.5% of DS-8, about 23% to about 27% of DS-8, about 23% to about 27.5% of DS-8, about 23% to about 28% of DS-8, about 23% to about 28.5% of DS-8, about 23.5% to about 29% of DS-8, about 24% to about 29% of DS-8, about 24.5% to about 29% of DS-8, about 25% to about 29% of DS-8, about 25.5% to about 29% of DS-8, about 26% to about 29% of DS-8, about 26.5% to about 29% of DS-8, about 27% to about 29% of DS-8, about 27.5% to about 29% of DS-8, about 28% to about 29% of DS-8, about 24% to about 28% of DS-8, or about 25% to about 27% of DS-8. In still further aspects, the mixture of β-cyclodextrin molecules may include about 23.0%, about 23.1%, about 23.2%, about 23.3%, about 23.4%, about 23.5%, about 23.6%, about 23.7%, about 23.8%, about 23.9%, about 24.0%, about 24.1%, about 24.2%, about 24.3%, about 24.4%, about 24.5%, about 24.6%, about 24.7%, about 24.8%, about 24.9%, about 25.0%, about 25.1%, about 25.2%, about 25.3%, about 25.4%, about 25.5%, about 25.6%, about 25.7%, about 25.8%, about 25.9%, about 26.0%, about 26.1%, about 26.2%, about 26.3%, about 26.4%, about 26.5%, about 26.6%, about 26.7%, about 26.8%, about 26.9%, about 27.0%, about 27.1%, about 27.2%, about 27.3%, about 27.4%, about 27.5%, about 27.6%, about 27.7%, about 27.8%, about 27.9%, about 28.0%, about 28.1%, about 28.2%, about 28.3%, about 28.4%, about 28.5%, about 28.6%, about 28.7%, about 28.8%, about 28.9%, or about 29.0%. In some embodiments, the amount of DS-8 in the composition may be determined by MALDI-TOF-MS. In an exemplary embodiment, the area of DS-8 in the MALDI-TOF-MS spectrum is 26.43%.

In some embodiments, the mixture of β-cyclodextrin molecules may include about 15% to about 21% of DS-9. In some aspects, the mixture of β-cyclodextrin molecules may include about 15% to about 15.5% of DS-9, about 15.5% to about 16% of DS-9, about 16% to about 16.5% of DS-9, about 16.5% to about 17% of DS-9, about 17% to about 17.5% of DS-9, about 17.5% to about 18% of DS-9, about 18% to about 18.5% of DS-9, about 18.5% to about 19% of DS-9, about 19% to about 19.5% of DS-9, about 19.5% to about 20% of DS-9, about 20% to about 20.5% of DS-9, or about 20.5% to about 21% of DS-9. In some additional aspects, the mixture of β-cyclodextrin molecules may include about 15% to about 16% of DS-9, about 15% to about 16.5% of DS-9, about 15% to about 17% of DS-9, about 15% to about 17.5% of DS-9, about 15% to about 18% of DS-9, about 15% to about 18.5% of DS-9, about 15% to about 19% of DS-9, about 15% to about 19.5% of DS-9, about 15% to about 20% of DS-9, about 15% to about 20.5% of DS-9, about 15.5% to about 21% of DS-9, about 16% to about 21% of DS-9, about 16.5% to about 21% of DS-9, about 17% to about 21% of DS-9, about 17.5% to about 21% of DS-9, about 18% to about 21% of DS-9, about 18.5% to about 21% of DS-9, about 19% to about 21% of DS-9, about 19.5% to about 21% of DS-9, about 20% to about 21% of DS-9, about 16% to about 20% of DS-9, or about 17% to about 19% of DS-9. In still further aspects, the mixture of β-cyclodextrin molecules may include about 15.0%, about 15.1%, about 15.2%, about 15.3%, about 15.4%, about 15.5%, about 15.6%, about 15.7%, about 15.8%, about 15.9%, about 16.0%, about 16.1%, about 16.2%, about 16.3%, about 16.4%, about 16.5%, about 16.6%, about 16.7%, about 16.8%, about 16.9%, about 17.0%, about 17.1%, about 17.2%, about 17.3%, about 17.4%, about 17.5%, about 17.6%, about 17.7%, about 17.8%, about 17.9%, about 18.0%, about 18.1%, about 18.2%, about 18.3%, about 18.4%, about 18.5%, about 18.6%, about 18.7%, about 18.8%, about 18.9%, about 19.0%, about 19.1%, about 19.2%, about 19.3%, about 19.4%, about 19.5%, about 19.6%, about 19.7%, about 19.8%, about 19.9%, about 20.0%, about 20.1%, about 20.2%, about 20.3%, about 20.4%, about 20.5%, about 20.6%, about 20.7%, about 20.8%, about 20.9%, or about 21.0% of DS-9. In some embodiments, the amount of DS-9 in the composition may be determined by MALDI-TOF-MS. In an exemplary embodiment, the area of DS-9 in the MALDI-TOF-MS spectrum is 18.09%.

In some embodiments, the mixture of β-cyclodextrin molecules may include about 6% to about 12% of DS-10. In some aspects, the mixture of β-cyclodextrin molecules may include about 6% to about 6.5% of DS-10, about 6.5% to about 7% of DS-10, about 7% to about 7.5% of DS-10, about 7.5% to about 8% of DS-10, about 8% to about 8.5% of DS-10, about 8.5% to about 9% of DS-10, about 9% to about 9.5% of DS-10, about 9.5% to about 10% of DS-10, about 10% to about 10.5% of DS-10, about 10.5% to about 11% of DS-10, about 11% to about 11.5% of DS-10, or about 11.5% to about 12% of DS-10. In some additional aspects, the mixture of β-cyclodextrin molecules may include about 6% to about 7% of DS-10, about 6% to about 7.5% of DS-10, about 6% to about 8% of DS-10, about 6% to about 8.5% of DS-10, about 6% to about 9% of DS-10, about 6% to about 9.5% of DS-10, about 6% to about 10% of DS-10, about 6% to about 10.5% of DS-10, about 6% to about 11% of DS-10, about 6% to about 11.5% of DS-10, about 6.5% to about 12% of DS-10, about 7% to about 12% of DS-10, about 7.5% to about 12% of DS-10, about 8% to about 12% of DS-10, about 8.5% to about 12% of DS-10, about 9% to about 12% of DS-10, about 9.5% to about 12% of DS-10, about 10% to about 12% of DS-10, about 10.5% to about 12% of DS-10, about 11% to about 12% of DS-10, about 7% to about 11% of DS-10, or about 8% to about 10% of DS-10. In still further aspects, the mixture of β-cyclodextrin molecules may include about 6.0%, about 6.1%, about 6.2%, about 6.3%, about 6.4%, about 6.5%, about 6.6%, about 6.7%, about 6.8%, about 6.9%, about 7.0%, about 7.1%, about 7.2%, about 7.3%, about 7.4%, about 7.5%, about 7.6%, about 7.7%, about 7.8%, about 7.9%, about 8.0%, about 8.1%, about 8.2%, about 8.3%, about 8.4%, about 8.5%, about 8.6%, about 8.7%, about 8.8%, about 8.9%, about 9.0%, about 9.1%, about 9.2%, about 9.3%, about 9.4%, about 9.5%, about 9.6%, about 9.7%, about 9.8%, about 9.9%, about 10.0%, about 10.1%, about 10.2%, about 10.3%, about 10.4%, about 10.5%, about 10.6%, about 10.7%, about 10.8%, about 10.9%, about 11.0%, about 11.1%, about 11.2%, about 11.3%, about 11.4%, about 11.5%, about 11.6%, about 11.7%, about 11.8%, about 11.9%, or about 12.0% of DS-10. In some embodiments, the amount of DS-10 in the mixture of β-cyclodextrin molecules may be determined by MALDI-TOF-MS. In an exemplary embodiment, the area of DS-10 in the MALDI-TOF-MS spectrum is 9.39%.

In some embodiments, the mixture of β-cyclodextrin molecules may include about 2% to about 6% of DS-11. In some aspects, the mixture of β-cyclodextrin molecules may include about 2% to about 2.5% of DS-11, about 2.5% to about 3% of DS-11, about 3% to about 3.5% of DS-11, about 3.5% to about 4% of DS-11, about 4% to about 4.5% of DS-11, about 4.5% to about 5% of DS-11, about 5% to about 5.5% of DS-11, or about 5.5% to about 6% of DS-11. In some additional aspects, the mixture of β-cyclodextrin molecules may include about 2% to about 3% of DS-11, about 2% to about 3.5% of DS-11, about 2% to about 4% of DS-11, about 2% to about 4.5% of DS-11, about 2% to about 5% of DS-11, about 2% to about 5.5% of DS-11, about 2.5% to about 6% of DS-11, about 3% to about 6% of DS-11, about 3.5% to about 6% of DS-11, about 4% to about 6% of DS-11, about 4.5% to about 6% of DS-11, about 5% to about 6% of DS-11, or about 3% to about 5% of DS-11. In still additional aspects, the mixture of β-cyclodextrin molecules may include about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, about 5.0%, about 5.1%, about 5.2%, about 5.3%, about 5.4%, about 5.5%, about 5.6%, about 5.7%, about 5.8%, about 5.9%, or about 6.0% of DS-11. In some embodiments, the amount of DS-11 in the mixture of β-cyclodextrin molecules may be determined by MALDI-TOF-MS. In an exemplary embodiment, the area of DS-11 in the MALDI-TOF-MS spectrum is 4.58%.

In some embodiments, the mixture of β-cyclodextrin molecules may include about 0.5% to about 4% of DS-12. In some aspects, the mixture of β-cyclodextrin molecules may include about 0.5% to about 1% of DS-12, about 1% to about 1.5% of DS-12, about 1.5% to about 2% of DS-12, about 2% to about 2.5% of DS-12, about 2.5% to about 3% of DS-12, about 3% to about 3.5% of DS-12, or about 3.5% to about 4% of DS-12. In some additional aspects, the mixture of β-cyclodextrin molecules may include about 0.5% to about 1.5% of DS-12, about 0.5% to about 2% of DS-12, about 0.5% to about 2.5% of DS-12, about 0.5% to about 3% of DS-12, about 0.5% to about 3.5% of DS-12, about 1% to about 4% of DS-12, about 1.5% to about 4% of DS-12, about 2% to about 4% of DS-12, about 2.5% to about 4% of DS-12, about 3% to about 4% of DS-12, or about 1% to about 3% of DS-12. In still further aspects, the mixture of β-cyclodextrin molecules may include about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, or about 4.0%. In some embodiments, the amount of DS-12 in the mixture of β-cyclodextrin molecules may be determined by MALDI-TOF-MS. In an exemplary embodiment, the area of DS-12 in the MALDI-TOF-MS spectrum is 1.84%.

In some embodiments, the mixture of β-cyclodextrin molecules may include less than 1% of DS-13; for example, the mixture of β-cyclodextrin molecules may include about 0.9% of DS-13, about 0.8% of DS-13, about 0.7% of DS-13, about 0.6% of DS-13, about 0.5% of DS-13, about 0.4% of DS-13, about 0.3% of DS-13, about 0.2% of DS-13, or about 0.1% of DS-13. In some aspects, the mixture of β-cyclodextrin molecules may include less than 1% to about 0.9% of DS-13, about 0.9% to about 0.8% of DS-13, about 0.8% to about 0.7% of DS-13, about 0.7% to about 0.6% of DS-13, about 0.7% to about 0.6% of DS-13, about 0.6% to about 0.5% of DS-13, about 0.5% to about 0.4% of DS-13, about 0.4% to about 0.3% of DS-13, about 0.3% to about 0.2% of DS-13, about 0.2% to about 0.1% of DS-13, or less than 0.1% of DS-13. In some additional aspects, the mixture of β-cyclodextrin molecules may include less than 1% to about 0.8% of DS-13, less than 1% to about 0.7% of DS-13, less than 1% to about 0.6% of DS-13, less than 1% to about 0.5% of DS-13, less than 1% to about 0.4% of DS-13, less than 1% to about 0.3% of DS-13, less than 1% to about 0.2% of DS-13, less than 1% to about 0.1% of DS-13, about 0.9% to about 0.1% of DS-13, about 0.8% to about 0.1% of DS-13, about 0.7% to about 0.1% of DS-13, about 0.6% to about 0.1% of DS-13, about 0.5% to about 0.1% of DS-13, about 0.4% to about 0.1% of DS-13, or about 0.3% to about 0.1% of DS-13. In still further aspects, the mixture of β-cyclodextrin may include less than 1% of DS-13, less than 0.9% of DS-13, less than 0.8% of DS-13, less than 0.7% of DS-13, less than 0.6% of DS-13, less than 0.5% of DS-13, less than 0.4% of DS-13, less than 0.3% of DS-13, less than 0.2% of DS-13, or less than 0.1% of DS-13. In some embodiments, the amount of DS-13 in the mixture of β-cyclodextrin molecules may be determined by MALDI-TOF-MS. In an exemplary embodiment, the area of DS-13 in the MALDI-TOF-MS spectrum is 0.70%.

In some embodiments, the composition may include less than 1% of DS-14; for example, the mixture of β-cyclodextrin molecules may include about 0.9% of DS-14, about 0.8% of DS-14, about 0.7% of DS-14, about 0.6% of DS-14, about 0.5% of DS-14, about 0.4% of DS-14, about 0.3% of DS-14, about 0.2% of DS-14, or about 0.1% of DS-14. In some aspects, the mixture of β-cyclodextrin molecules may include less than 1% to about 0.9% of DS-14, about 0.9% to about 0.8% of DS-14, about 0.8% to about 0.7% of DS-14, about 0.7% to about 0.6% of DS-14, about 0.7% to about 0.6% of DS-14, about 0.6% to about 0.5% of DS-14, about 0.5% to about 0.4% of DS-14, about 0.4% to about 0.3% of DS-14, about 0.3% to about 0.2% of DS-14, about 0.2% to about 0.1% of DS-14, or less than 0.1% of DS-14. In some additional aspects, the mixture of β-cyclodextrin molecules may include less than 1% to about 0.8% of DS-14, less than 1% to about 0.7% of DS-14, less than 1% to about 0.6% of DS-14, less than 1% to about 0.5% of DS-14, less than 1% to about 0.4% of DS-14, less than 1% to about 0.3% of DS-14, less than 1% to about 0.2% of DS-14, less than 1% to about 0.1% of DS-14, about 0.9% to about 0.1% of DS-14, about 0.8% to about 0.1% of DS-14, about 0.7% to about 0.1% of DS-14, about 0.6% to about 0.1% of DS-14, about 0.5% to about 0.1% of DS-14, about 0.4% to about 0.1% of DS-14, or about 0.3% to about 0.1% of DS-14. In still further aspects, the mixture of β-cyclodextrin may optionally include less than 1% of DS-14, less than 0.9% of DS-14, less than 0.8% of DS-14, less than 0.7% of DS-14, less than 0.6% of DS-14, less than 0.5% of DS-14, less than 0.4% of DS-14, less than 0.3% of DS-14, less than 0.2% of DS-14, or less than 0.1% of DS-4. In still further aspects, the mixture of β-cyclodextrin molecules may optionally include about 0.001%, about 0.01%, about 0.05%, about 0.1%, about 0.2%, about 0.3%, about 0.4%, about 0.5%, about 0.6%, about 0.7%, about 0.8%, about 0.9%, or about 1% of DS-14. In some embodiments, the amount of DS-14 in the mixture of β-cyclodextrin molecules may be determined by MALDI-TOF-MS. In some embodiments, DS-14 is absent from the composition.

In an exemplary embodiment, the composition includes a mixture of β-cyclodextrin molecules, wherein the mixture of β-cyclodextrin molecules includes DS-4, DS-5, DS-6, DS-7, DS-8, DS-9, DS-10, DS-11, DS-12, DS-13, and DS-14, wherein the mixture of β-cyclodextrin molecules includes less than 1% of DS-1, DS-2, DS-3, and DS-4.

Further provided herein are compositions produced using one or more of the systems and/or methods provided herein, the compositions comprising a mixture of beta-cyclodextrin molecules substituted at one or more hydroxyl positions by hydroxypropyl groups, wherein: the mixture comprises less than 1% unsubstituted beta-cyclodextrin (“DS-0”) and beta-cyclodextrin substituted with one hydroxypropyl group (“DS-1”); and beta-cyclodextrins having glucose units of the structure:

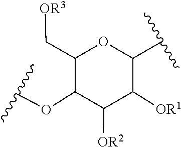

wherein R¹, R², and R³, independently for each occurrence, are —H or —HP, wherein HP comprises one or more hydroxypropyl groups, and the percentage of total occurrences of R¹ and R² combined that are HP ranges from 85% to 95%, or more preferably from 90% to 95%, in the beta-cyclodextrin.

In some embodiments, HP comprises one hydroxypropyl group. In some embodiments, HP consists essentially of one hydroxypropyl group. In some embodiments, HP consists of one hydroxypropyl group.

In some embodiments, not more than about 95%, e.g., not more than about 90%, not more than about 85%, not more than about 80%, not more than about 75%, not more than about 70%, not more than about 65%, not more than about 60%, not more than about 55%, or not more than about 50% of total occurrences of R¹ and R² combined are HP.

At least about 5% of the total occurrences of R³ may be HP; for example, at least about 5%, at least about 6%, at least about 7%, at least about 8%, at least about 9%, or at least about 10% of the total occurrences of R³ may be HP.

In some embodiments, the percentage of R¹ and R² combined that are HP ranges from about 5% to about 95%, such as about 10% to about 95%, about 15% to about 95%, about 20% to about 95%, about 25% to about 95%, about 30% to about 95%, about 35% to about 95%, about 40% to about 95%, about 45% to about 95%, about 50% to about 95%, about 55% to about 95%, about 60% to about 95%, about 65% to about 95%, about 70% to about 95%, about 75% to about 95%, about 80% to about 95%, about 85% to about 95%, about 90% to about 95%; such as from about 5% to about 90%, about 10% to about 90%, about 15% to about 90%, about 20% to about 90%, about 25% to about 90%, about 30% to about 90%, about 35% to about 90%, about 40% to about 90%, about 45% to about 90%, about 50% to about 90%, about 55% to about 90%, about 60% to about 90%, about 65% to about 90%, about 70% to about 90%, about 75% to about 90%, about 80% to about 90%, about 85% to about 90%; such as from about 5% to about 85%, about 10% to about 85%, about 15% to about 85%, about 20% to about 85%, about 25% to about 85%, about 30% to about 85%, about 35% to about 85%, about 40% to about 85%, about 45% to about 85%, about 50% to about 85%, about 55% to about 85%, about 60% to about 85%, about 65% to about 85%, about 70% to about 85%, about 75% to about 85%, about 80% to about 85%; such as from about 5% to about 80%, about 10% to about 80%, about 15% to about 80%, about 20% to about 80%, about 25% to about 80%, about 30% to about 80%, about 35% to about 80%, about 40% to about 80%, about 45% to about 80%, about 50% to about 80%, about 55% to about 80%, about 60% to about 80%, about 65% to about 80%, about 70% to about 80%, about 75% to about 80%; such as from about 5% to about 75%, about 10% to about 75%, about 15% to about 75%, about 20% to about 75%, about 25% to about 75%, about 30% to about 75%, about 35% to about 75%, about 40% to about 75%, about 45% to about 75%, about 50% to about 75%, about 55% to about 75%, about 60% to about 75%, about 65% to about 75%, about 70% to about 75%; such as from about 5% to about 70%, about 10% to about 70%, about 15% to about 70%, about 20% to about 70%, about 25% to about 70%, about 30% to about 70%, about 35% to about 70%, about 40% to about 70%, about 45% to about 70%, about 50% to about 70%, about 55% to about 70%, about 60% to about 70%, about 65% to about 70%; such as from about 5% to about 65%, about 10% to about 65%, about 15% to about 65%, about 20% to about 65%, about 25% to about 65%, about 30% to about 65%, about 35% to about 65%, about 40% to about 65%, about 45% to about 65%, about 50% to about 65%, about 55% to about 65%, about 60% to about 65%; such as from about 5% to about 60%, about 10% to about 60%, about 15% to about 60%, about 20% to about 60%, about 25% to about 60%, about 30% to about 60%, about 35% to about 60%, about 40% to about 60%, about 45% to about 60%, about 50% to about 60%, about 55% to about 60%; such as from about 5% to about 55%, about 10% to about 55%, about 15% to about 55%, about 20% to about 55%, about 25% to about 55%, about 30% to about 55%, about 35% to about 55%, about 40% to about 55%, about 45% to about 55%, about 50% to about 55%; such as from about 5% to about 50%, about 10% to about 50%, about 15% to about 50%, about 20% to about 50%, about 25% to about 50%, about 30% to about 50%, about 35% to about 50%, about 40% to about 50%, about 45% to about 50%; such as from about 5% to about 45%, about 10% to about 45%, about 15% to about 45%, about 20% to about 45%, about 25% to about 45%, about 30% to about 45%, about 35% to about 45%, about 40% to about 45%; such as from about 5% to about 40%, about 10% to about 40%, about 15% to about 40%, about 20% to about 40%, about 25% to about 40%, about 30% to about 40%, about 35% to about 40%; such as from about 5% to about 35%, about 10% to about 35%, about 15% to about 35%, about 20% to about 35%, about 25% to about 35%, about 30% to about 35%; such as from about 5% to about 30%, about 10% to about 30%, about 15% to about 30%, about 20% to about 30%, about 25% to about 30%; such as from about 5% to about 25%, about 10% to about 25%, about 15% to about 25%, about 20% to about 25%; such as from about 5% to about 20%, about 10% to about 20%, about 15% to about 20%; such as from about 5% to about 15%, about 10% to about 15%; or about 5% to about 10%.

The mixture may comprise less than 0.1% DS-0 and less than 0.1% DS-1, collectively. For example, the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-0; and/or the mixture may comprise less than 0.1%, less than 0.09%, less than 0.08%, less than 0.07%, less than 0.06%, less than 0.05%, less than 0.04%, less than 0.03%, less than 0.02%, or less than 0.01% DS-1.

The amount of DS-0 or DS-1 may be determined by peak height of an electrospray MS spectrum.

The mixture may have an average molar substitution in the range from about 0.40 to about 0.80; for example, the mixture may have an average molar substitution of about 0.40, 0.45, 0.50, 0.55, 0.60, 0.65, 0.70, 0.75, or about 0.80. The mixture may have an average degree of substitution (“DSₐ”) of about 3 to about 7, from about 4 to about 7, from about 5 to about 7, or from about 6 to about 7. For example, the mixture may have an average degree of substitution of about 3, 3.5, 4, 4.5, 5, 5.5, 6, 6.5, or about 7. Stated another way, the average number of occurrences of HP per beta-cyclodextrin may be from 3 to 4, 3 to 5, 3 to 6, 3 to 7, 4 to 5, 4 to 6, 4 to 7, 5 to 6, 5 to 7, or from 6 to 7.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC or gas chromatography.

The composition may comprise no more than 0.01% propylene glycol; for example, the composition may comprise no more than 0.01%, 0.009%, 0.008%, 0.007%, 0.006%, 0.005%, 0.004%, 0.003%, 0.002%, or about 0.001% propylene glycol. The amount of propylene glycol may be measured by HPLC, gas chromatography, or the PG/EG ratio of propylene glycol to ethylene glycol.

The composition may comprise no more than 1 ppm propylene oxide, no more than 0.9 ppm propylene oxide, no more than 0.8 ppm propylene oxide, no more than 0.7 ppm propylene oxide, no more than 0.6 ppm propylene oxide, no more than 0.5 ppm propylene oxide, no more than 0.4 ppm propylene oxide, no more than 0.3 ppm propylene oxide, no more than 0.2 ppm propylene oxide, or no more than 0.1 ppm propylene oxide. The amount of propylene oxide may be measured by HPLC or gas chromatography.

The total amount of other unspecified impurities in the composition may be less than or equal to 0.05%; for example, the total amount of unspecified impurities in the composition may be 0.05%, less than 0.05%, less than or equal to 0.04%, less than or equal to 0.03%, less than or equal to 0.02%, or less than or equal to 0.01%. The amount of unspecified impurities may be measured by HPLC or gas chromatography.

The composition may be suitable for administration intrathecal, intravenous, or intracerebroventricular administration to a patient in need thereof. The patient may be an adult patient or a pediatric patient. The composition may further comprise a pharmaceutically acceptable diluent.

The composition may solubilize lipids in an aqueous medium. The lipids may comprise unesterified or esterified cholesterol. The composition may be provided as a solution, wherein the mixture of beta-cyclodextrin molecules substituted at one or more hydroxyl positions by hydroxypropyl groups has a concentration of 20% w/v in the solution. The composition may have an affinity for unesterified cholesterol. The solubilization may be determined by UV spectrometry or by HPLC.

In some embodiments, about 200 mg of the composition solubilizes at least about 2 mg, 3 mg, 4 mg, 5 mg, 6 mg, 7 mg, 8 mg, 9 mg, or at least about 10 mg of unesterified cholesterol in distilled water at room temperature. In one example, 1 mL of the solution is able to solubilize about 2 mg of unesterified cholesterol at room temperature when measured by UV spectrometry after about 24 hours.

The composition may have a concentration in a solution from about 10 mg/mL to about 200 mg/mL. For example, the composition may have a concentration in a solution from about 10 mg/mL to about 20 mg/mL, about 10 mg/mL to about 30 mg/mL, about 10 mg/m L to about 40 mg/mL, about 10 mg/mL to about 50 mg/m L, about 10 mg/mL to about 60 mg/mL, about 10 mg/mL to about 70 mg/mL, about 10 mg/mL to about 80 mg/mL, about 10 mg/mL to about 90 mg/mL, about 10 mg/mL to about 100 mg/mL, about 10 mg/mL to about 110 mg/mL, about 10 mg/mL to about 120 mg/mL, about 10 mg/mL to about 130 mg/mL, about 10 mg/mL to about 140 mg/mL, about 10 mg/mL to about 150 mg/mL, about 10 mg/mL to about 160 mg/mL, about 10 mg/mL to about 170 mg/mL, about 10 mg/mL to about 180 mg/mL, about 10 mg/mL to about 190 mg/mL, about 20 mg/mL to about 200 mg/mL, about 30 mg/mL to about 200 mg/mL, about 40 mg/mL to about 200 mg/mL, about 50 mg/mL to about 200 mg/mL, about 60 mg/mL to about 200 mg/mL, about 70 mg/mL to about 200 mg/mL, about 80 mg/mL to about 200 mg/mL, about 90 mg/mL to about 200 mg/mL, about 100 mg/mL to about 200 mg/mL, about 110 mg/mL to about 200 mg/mL, about 120 mg/mL to about 200 mg/mL, about 130 mg/mL to about 200 mg/mL, about 140 mg/mL to about 200 mg/mL, about 150 mg/mL to about 200 mg/mL, about 160 mg/mL to about 200 mg/mL, about 170 mg/mL to about 200 mg/mL, about 180 mg/mL to about 200 mg/mL, or about 190 mg/mL to about 200 mg/mL.

Further provided herein is a composition produced by any of the systems and/or processes described provided herein, the composition comprising a mixture of beta-cyclodextrin molecules substituted at one or more hydroxyl positions by hydroxypropyl groups, wherein: the mixture comprises less than 0.05% unsubstituted beta-cyclodextrin (“DS-0”) and less than 0.05% beta-cyclodextrin substituted with one hydroxypropyl group (“DS-1”), the composition comprising an average degree of substitution of 6.02-7.98, wherein the composition is suitable for intrathecal, intravenous, oral, or intracerebroventricular administration to a patient in need thereof. In some embodiments, the composition has a pH of between 6.0 and 7.9. In some embodiments, the true density of the composition is about 1.096-1.098 g/cm³. In some embodiments, the osmolality of the composition is about 635-695 mOs/kg. In some embodiments, the composition further comprises a container and non-visible particulate matter, and the non-visible particulate matter with a size ≥25 microns is in an amount ≤600/container. In some embodiments, the composition comprises no more than 10 ppb of propylene glycol as measured by HPLC. In some embodiment, the composition comprises no more than 10 ppb propylene glycol as measured by gas chromatography. In some embodiments, the composition comprises no more than 10 ppb propylene glycol as measured by PG/EG-ratio of propylene glycol to ethylene glycol. In some embodiments, the composition comprises no more than 1 ppm propylene oxide. In some embodiments, the total amount of other unspecified impurities is less than or equal to 0.05% as measured by HPLC. In some embodiments, the composition has a concentration of about 10 mg/mL to about 200 mg/mL. In some embodiments, the composition exhibits a lower toxicity than Trappsol® Cyclo. In some embodiments, the composition has a conductivity of about ≤200 μS/cm. In some embodiments, the composition is stable for at least 6 months. In some embodiments, the composition further comprises at least one of a pharmaceutical excipient, a carrier, a pharmaceutically acceptable diluent, a pH adjusting agent, and a buffer. In some aspects, the pH adjusting agent is sodium hydroxide. In some aspects, the buffer comprises monobasic sodium phosphate and dibasic sodium phosphate.

Further provided herein is a composition produced by any of the systems and/or methods provided herein, the composition comprising a mixture of β-cyclodextrin molecules, wherein the mixture of β-cyclodextrin molecules comprises β-cyclodextrin substituted with four hydroxypropyl groups (“DS-4”); β-cyclodextrin substituted with five hydroxypropyl groups (“DS-5”); β-cyclodextrin substituted with six hydroxypropyl groups (“DS-6”); β-cyclodextrin substituted with seven hydroxypropyl groups (“DS-7”); β-cyclodextrin substituted with eight hydroxypropyl groups (“DS-8”); β-cyclodextrin substituted with nine hydroxypropyl groups (“DS-9”); β-cyclodextrin substituted with ten hydroxypropyl groups (“DS-10”); β-cyclodextrin substituted with eleven hydroxypropyl groups (“DS-11”); β-cyclodextrin substituted with twelve hydroxypropyl groups (“DS-12”); β-cyclodextrin substituted with thirteen hydroxypropyl groups (“DS-13”); and β-cyclodextrin substituted with fourteen hydroxypropyl groups (“DS-14”); and wherein the mixture of β-cyclodextrin molecules comprises less than 1% DS-4. In some embodiments, the mixture of β-cyclodextrin molecules comprises about 0.5% w/w to about 1% w/w DS-4. In some embodiments, the mixture of β-cyclodextrin molecules comprises about 2% w/w to about 5% w/w DS-5. In some embodiments, the mixture of β-cyclodextrin molecules comprises about 7% w/w to about 13% w/w DS-6. In some embodiments, the mixture of β-cyclodextrin molecules comprises about 21% w/w to about 27% w/w DS-7. In some embodiments, the mixture of β-cyclodextrin molecules comprises about 23% w/w to about 29% w/w DS-8. In some embodiments, the mixture of β-cyclodextrin molecules comprises about 15% w/w to about 21% w/w DS-9. In some embodiments, the mixture of β-cyclodextrin molecules comprises about 6% w/w to about 12% w/w DS-10. In some embodiments, the mixture of β-cyclodextrin molecules comprises about 2% w/w to about 6% w/w DS-11. In some embodiments, the mixture of β-cyclodextrin molecules comprises about 0.5% w/w to about 4% w/w DS-12. In some embodiments, the mixture of β-cyclodextrin molecules comprises less than about 1% w/w DS-13. In some embodiments, the mixture of β-cyclodextrin molecules is suitable for intravenous, intrathecal, or intracerebroventricular administration. In some embodiments, the amount of DS-1, DS-2, DS-3, DS-4, DS-5, DS-6, DS-7, DS-8, DS-9, DS-10, DS-11, DS-12, and DS-13 in the mixture of β-cyclodextrin molecules is determined by MALDI-TOF-MS. In some embodiments, DS-8 has the highest concentration in the mixture of β-cyclodextrin molecules as compared to the concentrations of DS-1, DS-2, DS-3, DS-4, DS-5, DS-6, DS-7, DS-9, DS-10, DS-11, DS-12, and DS-13. In some embodiments, the β-cyclodextrin molecules are substituted at the 2-O— position at a rate of 35-55%, the 3-O— position at a rate of 45-65%, and the 6-O— position at a rate of 0-20%. In some embodiments, the rate of substitution at the 2-O—, 3-O—, and 6-O positions is determined via DEPT-ed HSQC. In some embodiments, the composition has an average degree of substitution of between about 7 to about 9. In an exemplary embodiment, the composition has an average degree of substitution of about 7.7. In some embodiments, the composition has a true density of about 1.095 g/cm³ to about 1.100 g/cm³. In some embodiments, the composition has an osmolality of about 600 mOs/kg to about 750 mOs/kg. In some embodiments, the composition is a clear and colorless solution. In some embodiments, the composition has a pH of about 4.0 to about 6.0. In some embodiments, the composition has a viscosity of 1.5 cP to about 3.0 cP at 20° C. In some embodiments, the composition comprises less than or equal to about 0.05% impurities. In some embodiments, the composition comprises less than 600 particles per container having a diameter of greater than or equal to 25 microns. In some embodiments, the composition comprises less than 6000 particles per container having a diameter of greater than or equal to 10 microns.

Further provided herein is a composition produced by any of the systems and/or methods provided herein, the composition comprising a mixture of β-cyclodextrin molecules, the composition having a ¹H-NMR spectrum comprising at least one peak at about 5.0-5.4 ppm corresponding to anomeric protons of the β-cyclodextrin molecules; at least one peak at about 3.2-4.2 ppm corresponding to protons within a core region of the β-cyclodextrin molecules; and at least one peak at about 1.0-1.2 ppm corresponding to methyl protons of side chains of the β-cyclodextrin molecules.

Further provided herein is a composition produced by any one of the systems and/or methods provided herein, the composition comprising a mixture of isomerically-purified hydroxypropyl-β-cyclodextrin molecules comprising less than 1% β-cyclodextrin substituted with four hydroxypropyl groups (“DS-4”). In some embodiments, the hydroxypropyl β-cyclodextrin percentage is based upon area percentage from a MALDI-TOF-MS spectrum. In some embodiments, the hydroxypropyl β-cyclodextrin percentage is based upon weight percentage. In some embodiments, the composition comprises less than 1% β-cyclodextrin substituted with three hydroxypropyl groups (“DS-3”), β-cyclodextrin substituted with two hydroxypropyl groups (“DS-2”), and β-cyclodextrin substituted with one hydroxypropyl group (“DS-1”). In some embodiments, the mixture of isomerically-purified hydroxypropyl β-cyclodextrin molecules comprises about 1% to about 5% of β-cyclodextrin substituted with five hydroxypropyl groups (“DS-5”). In some embodiments, the mixture of isomerically-purified hydroxypropyl β-cyclodextrin comprises about 7% to about 13% of β-cyclodextrin substituted with six hydroxypropyl groups (“DS-6”). In some aspects, the mixture of isomerically-purified hydroxypropyl β-cyclodextrin comprises about 8% to about 12% of DS-6. In some embodiments, the mixture of isomerically-purified hydroxypropyl β-cyclodextrin comprises about 16% to about 22% of β-cyclodextrin substituted with seven hydroxypropyl groups (“DS-7”). In some aspects, the mixture of isomerically-purified hydroxypropyl β-cyclodextrin comprises about 17% to about 21% of DS-7. In some embodiments, the mixture of isomerically-purified hydroxypropyl β-cyclodextrin comprises about 26% to about 32% of β-cyclodextrin substituted with eight hydroxypropyl groups (“DS-8”). In some aspects, the mixture of isomerically-purified hydroxypropyl β-cyclodextrin comprises about 27% to about 31% of DS-8. In some embodiments, the mixture of isomerically-purified hydroxypropyl β-cyclodextrin comprises about 22% to about 28% of β-cyclodextrin substituted with nine hydroxypropyl groups (“DS-9”). In some aspects, the mixture of isomerically-purified hydroxypropyl β-cyclodextrin comprises about 23% to about 27% of DS-9. In some embodiments, the mixture of isomerically-purified hydroxypropyl β-cyclodextrin comprises about 11% to about 17% of β-cyclodextrin substituted with ten hydroxypropyl groups (“DS-10”). In some aspects, the mixture of isomerically-purified hydroxypropyl β-cyclodextrin comprises about 12% to about 16% of DS-10. In some embodiments, mixture of isomerically-purified hydroxypropyl β-cyclodextrin molecules comprising less than 1% β-cyclodextrin substituted with eleven hydroxypropyl groups (“DS-11”). In some embodiments, the mixture of isomerically-purified hydroxypropyl β-cyclodextrin molecules comprising less than 1% β-cyclodextrin substituted with twelve hydroxypropyl groups (“DS-12”), β-cyclodextrin substituted with thirteen hydroxypropyl groups (“DS-13”), and β-cyclodextrin substituted with fourteen hydroxypropyl groups (“DS-14”). In some embodiments, the average degree of substitution of the mixture of isomerically-purified hydroxypropyl β-cyclodextrin is about 6.4 to about 7.0. In an exemplary embodiment, the average degree of substitution is about 6.69. In some embodiments, about 52% to about 58% of the hydroxypropyl substitutions in the hydroxypropyl β-cyclodextrin molecules are located at the 3-O— position. In some aspects, about 55% to about 56% of the hydroxypropyl substitutions in the β-cyclodextrin molecules are located at the 3-O— position. In some embodiments, about 41% to about 47% of the hydroxypropyl substitutions in the hydroxypropyl β-cyclodextrin molecules are located at the 2-O— position. In some aspects, about 43% to about 45% of the hydroxypropyl substitutions in the hydroxypropyl β-cyclodextrin molecules are located at the 2-O— position. In some embodiments, the concentration of the composition does not substantially change the time required for nanofiltration. In some aspects, the length of time to nanofilter the composition ranges from 1.04 to 1.20 hours per diafiltration volume (kg soln/m²-hr/L soln). In some embodiments, the composition has a conductivity between 0 and 8.0 μS/cm, 0 and 4.5 μS/cm, 0 and 3 μS/cm, or between 0 and 1.5 μS/cm.

Further provided herein is a composition produced by any of the systems and/or methods provided herein, the composition comprising a mixture of isomerically-purified hydroxypropyl β-cyclodextrin molecules comprising: β-cyclodextrin substituted with five hydroxypropyl groups (“DS-5”); β-cyclodextrin substituted with six hydroxypropyl groups (“DS-6”); β-cyclodextrin substituted with seven hydroxypropyl groups (“DS-7”); β-cyclodextrin substituted with eight hydroxypropyl groups (“DS-8”); β-cyclodextrin substituted with nine hydroxypropyl groups (“DS-9”); and β-cyclodextrin substituted with ten hydroxypropyl groups (“DS-10”), wherein the composition comprises less than 1% β-cyclodextrin substituted with four hydroxypropyl groups (“DS-4”) and less than 1% β-cyclodextrin substituted with eleven hydroxypropyl groups (“DS-11”). In some embodiments, the composition comprises 0.0 to 1.0% β-cyclodextrin substituted with three hydroxypropyl groups (“DS-3”), 0.0 to 1.0% β-cyclodextrin substituted with two hydroxypropyl groups (“DS-2”), and 0.0 to 1.0% β-cyclodextrin substituted with one hydroxypropyl group (“DS-1”). In some embodiments, the composition comprises less than 1% β-cyclodextrin substituted with twelve hydroxypropyl groups (“DS-12”), β-cyclodextrin substituted with thirteen hydroxypropyl groups (“DS-13”), and β-cyclodextrin substituted with fourteen hydroxypropyl groups (“DS-14”). In some embodiments, the DS-8 has the highest concentration in the mixture of isomerically-purified hydroxypropyl β-cyclodextrin molecules as compared to DS-5, DS-6, DS-7, DS-9, and DS-10. In some embodiments, the mixture of isomerically-purified hydroxypropyl β-cyclodextrin molecules comprises about 1% to about 5% of DS-5. In some embodiments, the mixture of isomerically-purified hydroxypropyl β-cyclodextrin comprises about 7% to about 13% of DS-6. In some embodiments, the mixture of isomerically-purified hydroxypropyl β-cyclodextrin comprises about 16% to about 22% of DS-7. In some embodiments, the mixture of isomerically-purified hydroxypropyl β-cyclodextrin comprises about 26% to about 32% of DS-8. In some embodiments, the mixture of isomerically-purified hydroxypropyl β-cyclodextrin comprises about 22% to about 28% of DS-9. In some embodiments, the mixture of isomerically-purified hydroxypropyl β-cyclodextrin comprises about 11% to about 17% of DS-10. In some embodiments, the average degree of substitution of the mixture of isomerically-purified hydroxypropyl β-cyclodextrin is about 6.4 to about 7.0. In an exemplary embodiment, the average degree of substitution is about 6.69. In some embodiments, about 52% to about 58% of the hydroxypropyl substitutions in the hydroxypropyl β-cyclodextrin molecules are located at the 3-O— position. In some embodiments, about 41% to about 47% of the hydroxypropyl substitutions in the hydroxypropyl β-cyclodextrin molecules are located at the 2-O— position. In some embodiments, the composition has a −ESI-MS spectrum with peaks at about 653 m/z, about 682 m/z, about 711 m/z, about 741 m/z, about 769 m/z, about 799 m/z, about 828 m/z, and about 857 m/z, and a +ESI-MS spectrum with peaks at about 686 m/z, about 715 m/z, about 744 m/z, about 773 m/z, about 802 m/z, about 832 m/z, about 861 m/z, and about 890 m/z. In some embodiments, the composition has a MALDI-TOF spectrum with peaks at about 1436 m/z, about 1495 m/z, about 1555 m/z, about 1614 m/z, about 1674 m/z, and about 1733 m/z. In some embodiments, the osmolality of the composition is about 635-695 mOs/kg. In some embodiments, the true density of the composition is about 1.096-1.098 g/cm³. In some embodiments, the composition comprises no more than 10 ppb of propylene glycol as measured by HPLC. In some embodiments, the composition comprises no more than 1 ppm propylene oxide. In some embodiments, the total amount of other unspecified impurities is less than or equal to 0.05% as measured by HPLC. In some embodiments, the composition further comprises between 0 and 10 ppm chloride. In some embodiments, the composition is nanofiltered. In some embodiments, the nanofiltered composition has no substantial difference observed in HPLC-ELSD after nanofiltration as compared to before nanofiltration. In some embodiments, the nanofiltered composition has no substantial difference observed in NMR after nanofiltration as compared to before nanofiltration.

Further provided herein is a composition produced by any of the systems and/or methods provided herein, the composition comprising a mixture of isomerically-purified hydroxypropyl β-cyclodextrin molecules comprising less than 1% hydroxypropyl β-cyclodextrin with five hydroxypropyl groups (“DS-5”). In some embodiments, the hydroxypropyl β-cyclodextrin percentage is based upon area percentage from a MALDI-TOF-MS spectrum. In some embodiments, the hydroxypropyl β-cyclodextrin percentage is based upon weight percentage. In some embodiments, the composition comprises less than 1% β-cyclodextrin substituted with four hydroxypropyl groups (“DS-4”), β-cyclodextrin substituted with three hydroxypropyl groups (“DS-3”), β-cyclodextrin substituted with two hydroxypropyl groups (“DS-2”), and β-cyclodextrin substituted with one hydroxypropyl group (“DS-1”). In some embodiments, the mixture of isomerically-purified hydroxypropyl β-cyclodextrin comprises about 0% to about 6% of hydroxypropyl β-cyclodextrin substituted with six hydroxypropyl groups (“DS-6”). In some aspects, the mixture of isomerically-purified β-hydroxypropyl cyclodextrin molecules comprises about 1% to about 5% of DS-6. In some embodiments, the mixture of isomerically-purified hydroxypropyl β-cyclodextrin molecules comprises about 8% to about 14% of hydroxypropyl β-cyclodextrin substituted with seven hydroxypropyl groups (“DS-7”). In some aspects, wherein the mixture of isomerically-purified hydroxypropyl β-cyclodextrin molecules comprises about 9% to about 13% of DS-7. In some embodiments, the mixture of isomerically-purified β-hydroxypropyl cyclodextrin molecules comprises about 19% to about 25% of hydroxypropyl β-cyclodextrin substituted with eight hydroxypropyl groups (“DS-8”). In some aspects, the mixture of isomerically-purified hydroxypropyl β-cyclodextrin molecules comprises about 20% to about 24% of DS-8. In some embodiments, the mixture of isomerically-purified β-hydroxypropyl cyclodextrin molecules comprises about 23% to about 29% hydroxypropyl β-cyclodextrin substituted with nine hydroxypropyl groups (“DS-9”). In some aspects, the mixture of isomerically-purified hydroxypropyl β-cyclodextrin molecules comprises about 24% to about 28% of DS-9. In some embodiments, the mixture of isomerically-purified hydroxypropyl β-cyclodextrin molecules comprises about 17% to about 23% of hydroxypropyl β-cyclodextrin substituted with ten hydroxypropyl groups (“DS-10). In some aspects, the mixture of isomerically-purified β-hydroxypropyl cyclodextrin molecules comprises about 18% to about 22% of DS-10. In some embodiments, the mixture of isomerically-purified β-hydroxypropyl cyclodextrin molecules comprises about 9% to about 15% of hydroxypropyl β-cyclodextrin substituted with eleven hydroxypropyl groups (“DS-11”). In some aspects, the mixture of isomerically-purified β-cyclodextrin molecules comprises about 10% to about 14% of DS-11. In some embodiments, the mixture of isomerically-purified β-cyclodextrin molecules comprises about 2% to about 8% hydroxypropyl β-cyclodextrin substituted with twelve hydroxypropyl groups (“DS-12”). In some aspects, the mixture of isomerically-purified β-cyclodextrin molecules comprises about 3% to about 7% DS-12. In some embodiments, the mixture of isomerically-purified β-cyclodextrin molecules has an average degree of substitution of about 7 to about 8. In an exemplary embodiment, the average degree of substitution is about 7.42. In some embodiments, about 36% to about 42% of the hydroxypropyl substitutions in the hydroxypropyl β-cyclodextrin molecules are located at the 3-O— position. In some aspects, about 37% to about 41% of the hydroxypropyl substitutions in the hydroxypropyl β-cyclodextrin molecules are located at the 3-O— position. In some embodiments, about 58% to about 64% of the hydroxypropyl substitutions in the hydroxypropyl β-cyclodextrin molecules are located at the 2-O— position. In some aspects, about 59% to about 63% of the hydroxypropyl substitutions in the hydroxypropyl β-cyclodextrin molecules are located at the 2-O— position. In some embodiments, the concentration of the composition does not substantially change the time required for nanofiltration. In some aspects, the length of time to nanofilter the composition ranges from 1.04 to 1.20 hours per diafiltration volume (kg soln/m²-hr/L soln). In some embodiments, the composition has no substantial difference observed in HPLC-ELSD after nanofiltration as compared to before nanofiltration. In some embodiments, wherein the composition has no substantial difference observed in NMR after nanofiltration as compared to before nanofiltration. In some embodiments, the composition has a conductivity between 0 and 8.0 μS/cm, 0 and 4.5 μS/cm, 0 and 3 μS/cm, or between 0 and 1.5 μS/cm.

Further provided herein is a composition produced by any of the systems and/or methods provided herein, the composition comprising a mixture of isomerically-purified hydroxypropyl β-cyclodextrin molecules comprising: β-cyclodextrin substituted with six hydroxypropyl groups (“DS-6”); β-cyclodextrin substituted with seven hydroxypropyl groups (“DS-7”); β-cyclodextrin substituted with eight hydroxypropyl groups (“DS-8”); β-cyclodextrin substituted with nine hydroxypropyl groups (“DS-9”); β-cyclodextrin substituted with ten hydroxypropyl groups (“DS-10”); β-cyclodextrin substituted with eleven hydroxypropyl groups (“DS-11”); and β-cyclodextrin substituted with twelve hydroxypropyl groups (“DS-12”), wherein the composition comprises less than 1% β-cyclodextrin substituted with five hydroxypropyl groups (“DS-5”) and the composition comprises less than 1% I β-cyclodextrin substituted with thirteen hydroxypropyl groups (“DS-13”). In some embodiments, the composition comprises less than 1% β-cyclodextrin substituted with four hydroxypropyl groups (“DS-4”), β-cyclodextrin substituted with three hydroxypropyl groups (“DS-3”), β-cyclodextrin substituted with two hydroxypropyl groups (“DS-2”), and β-cyclodextrin substituted with one hydroxypropyl group (“DS-1”). In some embodiments, the composition comprises less than 1% β-cyclodextrin substituted with thirteen hydroxypropyl groups (“DS-13”) and hydroxypropyl β-cyclodextrin substituted with fourteen hydroxypropyl groups (“DS-14”). In some embodiments, the DS-9 has the highest concentration in the composition as compared to DS-6, DS-7, DS-8, DS-10, DS-11, and DS-12. In some embodiments, the mixture of isomerically-purified hydroxypropyl β-cyclodextrin molecules comprises about 0% to about 6% of DS-6. In some embodiments, the mixture of isomerically-purified hydroxypropyl β-cyclodextrin molecules comprises about 8% to about 14% of DS-7. In some embodiments, the mixture of isomerically-purified hydroxypropyl β-cyclodextrin molecules comprises about 19% to about 25% of DS-8. In some embodiments, the mixture of isomerically-purified hydroxypropyl β-cyclodextrin molecules comprises about 23% to about 29% of DS-9. In some embodiments, the mixture of isomerically-purified hydroxypropyl β-cyclodextrin molecules comprises about 17% to about 23% of DS-10. In some embodiments, the mixture of isomerically-purified hydroxypropyl β-cyclodextrin molecules comprises about 9% to about 15% of DS-11. In some embodiments, the mixture of isomerically-purified hydroxypropyl β-cyclodextrin molecules comprises about 2% to about 8% DS-12. In some embodiments, the mixture of isomerically-purified hydroxypropyl β-cyclodextrin molecules has an average degree of substitution of about 7 to about 8. In some embodiments, about 36% to about 42% of the hydroxypropyl substitutions in the hydroxypropyl β-cyclodextrin molecules are located at the 3-O— position. In some embodiments, about 58% to about 64% of the hydroxypropyl substitutions in the hydroxypropyl β-cyclodextrin molecules are located at the 2-O— position. In some embodiments, the composition has a −ESI-MS spectrum with peaks at about 682 m/z, about 712 m/z, about 740 m/z, about 770 m/z, about 798 m/z, about 828 m/z, about 856 m/z, and about 886 m/z, and a +ESI-MS spectrum with peaks at about 744 m/z, about 773 m/z, about 803 m/z, about 832 m/z, about 860 m/z, about 889 m/z, and about 919 m/z. In some embodiments, the composition has a MALDI-TOF-MS spectrum with peaks at about 1497 m/z, about 1557 m/z, about 1616 m/z, about 1675 m/z, about 1734 m/z, about 1794 m/z, and about 1914 m/z. In some embodiments, the osmolality of the composition is about 635-695 mOs/kg. In some embodiments, the true density of the composition is about 1.096-1.098 g/cm³. In some embodiments, the composition comprises no more than 10 ppb of propylene glycol as measured by HPLC. In some embodiments, the composition comprises no more than 1 ppm propylene oxide. In some embodiments, the total amount of other unspecified impurities is less than or equal to 0.05% as measured by HPLC. In some embodiments, the composition comprises between 0 and 10 ppm chloride. In some embodiments, the composition has a conductivity between 0 and 8 μS/cm. In some embodiments, the composition is nanofiltered. In some embodiments, the nanofiltered composition has no substantial difference observed in HPLC-ELSD after nanofiltration as compared to before nanofiltration. In some embodiments, the nanofiltered composition has no substantial difference observed in NMR after nanofiltration as compared to before nanofiltration.

Further provided herein is a composition produced by any of the methods and/or systems provided herein, the composition comprising a mixture of isomerically-purified hydroxypropyl β-cyclodextrin molecules comprising less than 1% hydroxypropyl β-cyclodextrin with six hydroxypropyl groups (“DS-6”) and less than 1% β-cyclodextrin substituted with fourteen hydroxypropyl groups (“DS-14”). In some embodiments, the hydroxypropyl β-cyclodextrin percentage is based upon area percentage from a MALDI-TOF-MS spectrum. In some embodiments, the hydroxypropyl β-cyclodextrin percentage is based upon weight percentage. In some embodiments, the composition comprises less than 1% β-cyclodextrin substituted with five hydroxypropyl groups (“DS-5”), β-cyclodextrin substituted with four hydroxypropyl groups (“DS-4”), β-cyclodextrin substituted with three hydroxypropyl groups (“DS-3”), β-cyclodextrin substituted with two hydroxypropyl groups (“DS-2”), and β-cyclodextrin substituted with one hydroxypropyl group (“DS-1”). In some embodiments, the mixture of isomerically-purified hydroxypropyl β-cyclodextrin molecules comprises about 1% to about 7% of β-cyclodextrin substituted with seven hydroxypropyl groups (“DS-7”). In some aspects, the mixture of isomerically-purified hydroxypropyl β-cyclodextrin molecules comprises about 2% to about 6% of DS-7. In some embodiments, the mixture of isomerically-purified hydroxypropyl β-cyclodextrin molecules comprises about 16% to about 22% of β-cyclodextrin substituted with eight hydroxypropyl groups (“DS-8”). In some aspects, the mixture of isomerically-purified hydroxypropyl β-cyclodextrin molecules comprises about 17% to about 21% of DS-8. In some embodiments, the mixture of isomerically-purified hydroxypropyl β-cyclodextrin molecules comprises about 22% to about 28% of β-cyclodextrin substituted with nine hydroxypropyl groups (“DS-9”). In some aspects, the mixture of isomerically-purified hydroxypropyl β-cyclodextrin molecules comprises about 23% to about 27% of DS-9. In some embodiments, the mixture of isomerically-purified hydroxypropyl β-cyclodextrin molecules comprises about 19% to about 25% of β-cyclodextrin substituted with ten hydroxypropyl groups (“DS-10). In some aspects, the mixture of isomerically-purified hydroxypropyl β-cyclodextrin molecules comprises about 20% to about 24% of DS-10. In some embodiments, the mixture of isomerically-purified hydroxypropyl β-cyclodextrin molecules comprises about 14% to about 20% of β-cyclodextrin substituted with eleven hydroxypropyl groups (“DS-11”). In some aspects, the mixture of isomerically-purified hydroxypropyl β-cyclodextrin molecules comprises about 15% to about 19% of DS-11. In some embodiments, the mixture of isomerically-purified hydroxypropyl β-cyclodextrin molecules comprises about 5% to about 11% of β-cyclodextrin substituted with twelve hydroxypropyl groups (“DS-12”). In some aspects, the mixture of isomerically-purified hydroxypropyl β-cyclodextrin molecules comprises about 6% to about 10% of DS-12. In some embodiments, the mixture of isomerically-purified hydroxypropyl β-cyclodextrin molecules comprises about 1% to about 7% of β-cyclodextrin substituted with thirteen hydroxypropyl groups (“DS-13”). In some aspects, the mixture of isomerically-purified hydroxypropyl β-cyclodextrin molecules comprises about 2% to about 6% of DS-13. In some embodiments, the average degree of substitution of the mixture of isomerically-purified hydroxypropyl β-cyclodextrin is about 8 to about 9. In an exemplary embodiment, the average degree of substitution of the mixture of isomerically-purified hydroxypropyl 3-cyclodextrin is about 8.53. In some embodiments, about 26% to about 32% of the hydroxypropyl substitutions in the hydroxypropyl β-cyclodextrin molecules are located at the 3-O— position. In some aspects, about 27% to about 31% of the hydroxypropyl substitutions in the hydroxypropyl β-cyclodextrin molecules are located at the 3-O— position. In some embodiments, about 68% to about 74% of the hydroxypropyl substitutions in the hydroxypropyl β-cyclodextrin molecules are located at the 2-O— position. In some aspects, about 69% to about 73% of the hydroxypropyl substitutions in the hydroxypropyl β-cyclodextrin molecules are located at the 2-O— position. In some embodiments, the concentration of the composition does not substantially change the time required for nanofiltration. In some aspects, the length of time to nanofilter the composition ranges from 1.04 to 1.20 hours per diafiltration volume (kg soln/m²-hr/L soln). In some embodiments, the composition has no substantial difference observed in HPLC-ELSD after nanofiltration as compared to before nanofiltration. In some embodiments, the composition has no substantial difference observed in NMR after nanofiltration as compared to before nanofiltration. In some embodiments, the composition has a conductivity between 0 and 8.0 μS/cm, 0 and 4.5 μS/cm, 0 and 3 μS/cm, or between 0 and 1.5 μS/cm.

Further provided herein is composition produced by any of the systems and/or methods provided herein, the composition comprising a mixture of isomerically-purified hydroxypropyl β-cyclodextrin molecules comprising: β-cyclodextrin substituted with seven hydroxypropyl groups (“DS-7”); β-cyclodextrin substituted with eight hydroxypropyl groups (“DS-8”); β-cyclodextrin substituted with nine hydroxypropyl groups (“DS-9”); β-cyclodextrin substituted with ten hydroxypropyl groups (“DS-10”); β-cyclodextrin substituted with eleven hydroxypropyl groups (“DS-11”); β-cyclodextrin substituted with twelve hydroxypropyl groups (“DS-12”); and β-cyclodextrin substituted with thirteen hydroxypropyl groups (“DS-13”), wherein the composition comprises less than 1% β-cyclodextrin substituted with six hydroxypropyl groups (“DS-6”) and less than 1% β-cyclodextrin substituted with fourteen hydroxypropyl groups (“DS-14”). In some embodiments, the composition comprises less than 1% β-cyclodextrin substituted with five hydroxypropyl groups (“DS-5”), β-cyclodextrin substituted with four hydroxypropyl groups (“DS-4”), β-cyclodextrin substituted with three hydroxypropyl groups (“DS-3”), β-cyclodextrin substituted with two hydroxypropyl groups (“DS-2”), and β-cyclodextrin substituted with one hydroxypropyl group (“DS-1”). In some embodiments, the DS-9 has the highest concentration in the mixture of isomerically-purified hydroxypropyl β-cyclodextrin molecules as compared to DS-6, DS-7, DS-8, DS-10, DS-11, DS-12, and DS-13. In some embodiments, the mixture of isomerically-purified hydroxypropyl β-cyclodextrin molecules comprises about 16% to about 22% of DS-8. In some embodiments, the mixture of isomerically-purified hydroxypropyl β-cyclodextrin molecules comprises about 22% to about 28% of DS-9. In some embodiments, the mixture of isomerically-purified hydroxypropyl β-cyclodextrin molecules comprises about 19% to about 25% of DS-10. In some embodiments, the mixture of isomerically-purified hydroxypropyl β-cyclodextrin molecules comprises about 14% to about 20% of DS-11. In some embodiments, the mixture of isomerically-purified hydroxypropyl β-cyclodextrin molecules comprises about 5% to about 11% of DS-12. In some embodiments, the mixture of isomerically-purified hydroxypropyl β-cyclodextrin molecules comprises about 1% to about 7% of DS-13. In some embodiments, the average degree of substitution of the mixture of isomerically-purified hydroxypropyl β-cyclodextrin is about 8 to about 9. In an exemplary embodiment, the average degree of substitution of the mixture of isomerically-purified hydroxypropyl β-cyclodextrin is about 8.53. In some embodiments, about 26% to about 32% of the hydroxypropyl substitutions in the β-cyclodextrin molecules are located at the 3-O— position. In some embodiments, about 68% to about 74% of the hydroxypropyl substitutions in the β-cyclodextrin molecules are located at the 2-O— position. In an exemplary embodiment, the HPLC-CAD mean retention time of the composition is about 13.5 minutes. In some embodiments, the composition has a −ESI-MS spectrum with peaks at about 741 m/z, about 769 m/z, about 799 m/z, about 828 m/z, about 856 m/z, about 886 m/z, and a +ESI-MS spectrum with peaks at about 773 m/z, about 803 m/z, about 833 m/z, about 860 m/z, about 889 m/z, and about 920 m/z. In some embodiments, the composition has a MALDI-TOF spectrum with peaks at about 1557 m/z, about 1617 m/z, about 1676 m/z, about 1736 m/z, about 1795 m/z, about 1855 m/z, and about 1915 m/z. In some embodiments, the osmolality of the composition is about 635-695 mOs/kg. In some embodiments, the true density of the composition is about 1.096-1.098 g/cm³. In some embodiments, the composition comprises no more than 10 ppb of propylene glycol as measured by HPLC. In some embodiments, the composition comprises no more than 1 ppm propylene oxide. In some embodiments, the total amount of other unspecified impurities is less than or equal to 0.05% as measured by HPLC. In some embodiments, the composition comprises between 0 and 10 ppm chloride. In some embodiments, the composition comprises between 0 and 1 ppm chloride. In some embodiments, the composition has a conductivity between 0 and 8 μS/cm. In some embodiments, the composition is nanofiltered. In some embodiments, the nanofiltered composition has no substantial difference observed in HPLC-ELSD after nanofiltration as compared to before nanofiltration. In some embodiments, wherein the nanofiltered composition has no substantial difference observed in NMR after nanofiltration as compared to before nanofiltration.

Further provided herein is a composition produced by any of the systems and/or methods provided herein, the composition comprising a mixture of isomerically-purified hydroxypropyl β-cyclodextrin molecules comprising less than 1% hydroxypropyl β-cyclodextrin with six hydroxypropyl groups (“DS-6”). In some embodiments, the hydroxypropyl β-cyclodextrin percentage is based upon area percentage from a MALDI-TOF-MS spectrum. In some embodiments, the hydroxypropyl β-cyclodextrin percentage is based upon weight percentage. In some embodiments, the composition comprises less than 1% β-cyclodextrin substituted with five hydroxypropyl groups (“DS-5”), β-cyclodextrin substituted with four hydroxypropyl groups (“DS-4”), β-cyclodextrin substituted with three hydroxypropyl groups (“DS-3”), β-cyclodextrin substituted with two hydroxypropyl groups (“DS-2”), and β-cyclodextrin substituted with one hydroxypropyl group (“DS-1”). In some embodiments, the mixture of isomerically-purified hydroxypropyl β-cyclodextrin molecules comprises about 0% to about 6% of β-cyclodextrin substituted with seven hydroxypropyl groups (“DS-7”). In some aspects, the mixture of isomerically-purified hydroxypropyl β-cyclodextrin molecules comprises about 1% to about 5% of DS-7. In some embodiments, the mixture of isomerically-purified hydroxypropyl β-cyclodextrin molecules comprises about 13% to about 19% of β-cyclodextrin substituted with eight hydroxypropyl groups (“DS-8”). In some embodiments, the mixture of isomerically-purified hydroxypropyl β-cyclodextrin molecules comprises about 14% to about 18% of DS-8. In some embodiments, the mixture of isomerically-purified hydroxypropyl β-cyclodextrin molecules comprises about 22% to about 28% of β-cyclodextrin substituted with nine hydroxypropyl groups (“DS-9”). In some aspects, wherein the mixture of isomerically-purified hydroxypropyl β-cyclodextrin molecules comprises about 23% to about 27% of DS-9. In some embodiments, the mixture of isomerically-purified hydroxypropyl β-cyclodextrin molecules comprises about 23% to about 29% of β-cyclodextrin substituted with ten hydroxypropyl groups (“DS-10). In some aspects, the mixture of isomerically-purified hydroxypropyl β-cyclodextrin molecules comprises about 24% to about 28% of DS-10. In some embodiments, the mixture of isomerically-purified hydroxypropyl β-cyclodextrin molecules comprises about 12% to about 18% of β-cyclodextrin substituted with eleven hydroxypropyl groups (“DS-11”). In some aspects, the mixture of isomerically-purified hydroxypropyl β-cyclodextrin molecules comprises about 13% to about 17% of DS-11. In some embodiments, the mixture of isomerically-purified hydroxypropyl β-cyclodextrin molecules comprises about 7% to about 13% of β-cyclodextrin substituted with twelve hydroxypropyl groups (“DS-12”). In some aspects, the mixture of isomerically-purified hydroxypropyl β-cyclodextrin molecules comprises about 8% to about 12% of DS-12. In some embodiments, the mixture of isomerically-purified hydroxypropyl β-cyclodextrin molecules comprises about 2% to about 8% of β-cyclodextrin substituted with thirteen hydroxypropyl groups (“DS-13”). In some aspects, the mixture of isomerically-purified hydroxypropyl β-cyclodextrin molecules comprises about 3% to about 7% of DS-13. In some embodiments, the average degree of substitution of the mixture of isomerically-purified hydroxypropyl β-cyclodextrin is about 7.5 to about 8.5. In an exemplary embodiment, the average degree of substitution of the mixture of isomerically-purified hydroxypropyl β-cyclodextrin is about 8.08. In some embodiments, about 22% to about 28% of the hydroxypropyl substitutions in the hydroxypropyl β-cyclodextrin molecules are located at the 3-O— position. In some aspects, about 23% to about 27% of the hydroxypropyl substitutions in the hydroxypropyl β-cyclodextrin molecules are located at the 3-O— position. In some embodiments, about 72% to about 78% of the hydroxypropyl substitutions in the hydroxypropyl β-cyclodextrin molecules are located at the 2-O— position. In some aspects, about 73% to about 77% of the hydroxypropyl substations in the hydroxypropyl β-cyclodextrin molecules are located at the 2-O— position. In some embodiments, the concentration of the composition does not substantially change the time required for nanofiltration. In some aspects, the length of time to nanofilter the composition ranges from 1.04 to 1.20 hours per diafiltration volume (kg soln/m²-hr/L soln). In some embodiments, the nanofiltrated composition has no substantial difference observed in HPLC-ELSD after nanofiltration as compared to before nanofiltration. In some embodiments, the nanofiltrated composition has no substantial difference observed in NMR after nanofiltration as compared to before nanofiltration. In some embodiments, the composition has a conductivity between 0 and 8.0 μS/cm, 0 and 4.5 μS/cm, 0 and 3 μS/cm, or between 0 and 1.5 μS/cm.

Further provided herein is a composition produced by any of the systems and/or methods provided herein, the composition comprising a mixture of isomerically-purified hydroxypropyl β-cyclodextrin molecules comprising: β-cyclodextrin substituted with seven hydroxypropyl groups (“DS-7”); β-cyclodextrin substituted with eight hydroxypropyl groups (“DS-8”); β-cyclodextrin substituted with nine hydroxypropyl groups (“DS-9”); β-cyclodextrin substituted with ten hydroxypropyl groups (“DS-10”); β-cyclodextrin substituted with eleven hydroxypropyl groups (“DS-11”); β-cyclodextrin substituted with twelve hydroxypropyl groups (“DS-12”); β-cyclodextrin substituted with thirteen hydroxypropyl groups (“DS-13”); and β-cyclodextrin substituted with fourteen hydroxypropyl groups (“DS-14”), wherein the composition comprises less than 1% β-cyclodextrin substituted with six hydroxypropyl groups (“DS-6”). In some embodiments, the composition comprises less than 1% β-cyclodextrin substituted with five hydroxypropyl groups (“DS-5”), β-cyclodextrin substituted with four hydroxypropyl groups (“DS-4”), β-cyclodextrin substituted with three hydroxypropyl groups (“DS-3”), β-cyclodextrin substituted with two hydroxypropyl groups (“DS-2”), and β-cyclodextrin substituted with one hydroxypropyl group (“DS-1”). In some embodiments, the DS-9 has the highest concentration in the mixture of isomerically-purified hydroxypropyl β-cyclodextrin molecules as compared to DS-7, DS-8, DS-10, DS-11, DS-12, DS-13, and DS-14. In some embodiments, the DS-10 has the highest concentration in the mixture of isomerically-purified hydroxypropyl β-cyclodextrin molecules as compared to DS-7, DS-8, DS-10, DS-11, DS-12, DS-13, and DS-14. In some embodiments, the mixture of isomerically-purified hydroxypropyl β-cyclodextrin molecules comprises about 0% to about 6% DS-7. In some embodiments, the mixture of isomerically-purified hydroxypropyl β-cyclodextrin molecules comprises about 13% to about 19% DS-8. In some embodiments, the mixture of isomerically-purified hydroxypropyl β-cyclodextrin molecules comprises about 22% to about 28% DS-9. In some embodiments, the mixture of isomerically-purified hydroxypropyl β-cyclodextrin molecules comprises about 23% to about 29% DS-10. In some embodiments, the mixture of isomerically-purified hydroxypropyl β-cyclodextrin molecules comprises about 12% to about 18% DS-11. In some embodiments, the mixture of isomerically-purified hydroxypropyl β-cyclodextrin molecules comprises about 7% to about 13% DS-12. In some embodiments, the mixture of isomerically-purified hydroxypropyl β-cyclodextrin molecules comprises about 2% to about 8% DS-13. In some embodiments, the mixture of isomerically-purified hydroxypropyl β-cyclodextrin molecules comprises about 0% to about 6% DS-14. In some embodiments, the average degree of substitution of the mixture of isomerically-purified hydroxypropyl β-cyclodextrin is about 7.5 to about 8.5. In some embodiments, about 22% to about 28% of the hydroxypropyl substitutions in the hydroxypropyl β-cyclodextrin molecules are located at the 3-O— position. In some embodiments, about 72% to about 78% of the hydroxypropyl substitutions in the β-cyclodextrin molecules are located at the 2-O— position. In some embodiments, the composition has a −ESI-MS spectrum with peaks at about 740 m/z, about 770 m/z, about 798 m/z, about 828 m/z, and about 857 m/z, and a +ESI-MS spectrum with peaks at about 803 m/z, about 831 m/z, about 861 m/z, about 889 m/z, and about 919 m/z. In some embodiments, the composition has a MALDI-TOF spectrum with peaks at about 1559 m/z, about 1618 m/z, about 1678 m/z, about 1737 m/z, about 1796 m/z, about 1857 m/z, and about 1916 m/z. In some embodiments, the osmolality of the composition is about 635-695 mOs/kg. In some embodiments, the true density of the composition is about 1.096-1.098 g/cm³. In some embodiments, the composition comprises no more than 10 ppb of propylene glycol as measured by HPLC. In some embodiments, the composition comprises no more than 1 ppm propylene oxide. In some embodiments, the total amount of other unspecified impurities is less than or equal to 0.05% as measured by HPLC. In some embodiments, the composition comprises between 0 and 10 ppm chloride. In some embodiments, the composition has a conductivity between 0 and 8 μS/cm. In some embodiments, the composition is nanofiltered. In some embodiments, the nanofiltrated composition has no substantial difference observed in HPLC-ELSD after nanofiltration as compared to before nanofiltration. In some embodiments, the nanofiltrated composition has no substantial difference observed in NMR after nanofiltration as compared to before nanofiltration.

Further provided herein is a composition produced by any of the systems and/or methods provided herein, the composition comprising a mixture of isomerically-purified hydroxypropyl β-cyclodextrin molecules comprising less than 1% hydroxypropyl β-cyclodextrin with seven hydroxypropyl groups (“DS-7”). In some embodiments, the hydroxypropyl β-cyclodextrin percentage is based upon area percentage from a MALDI-TOF-MS spectrum. In some embodiments, the hydroxypropyl β-cyclodextrin percentage is based upon weight percentage. In some embodiments, the composition comprises less than 1% β-cyclodextrin substituted with six hydroxypropyl groups (“DS-6”), β-cyclodextrin substituted with five hydroxypropyl groups (“DS-5”), β-cyclodextrin substituted with four hydroxypropyl groups (“DS-4”), β-cyclodextrin substituted with three hydroxypropyl groups (“DS-3”), β-cyclodextrin substituted with two hydroxypropyl groups (“DS-2”), and β-cyclodextrin substituted with one hydroxypropyl group (“DS-1”). In some embodiments, the mixture of isomerically-purified hydroxypropyl β-cyclodextrin molecules comprises about 6% to about 12% of β-cyclodextrin substituted with eight hydroxypropyl groups (“DS-8”). In some aspects, the mixture of isomerically-purified hydroxypropyl β-cyclodextrin molecules comprises about 7% to about 11% of DS-8. In some embodiments, the mixture of isomerically-purified hydroxypropyl β-cyclodextrin molecules comprises about 18% to about 24% of β-cyclodextrin substituted with nine hydroxypropyl groups (“DS-9”). In some aspects, the mixture of isomerically-purified hydroxypropyl β-cyclodextrin molecules comprises about 19% to about 23% of DS-9. In some embodiments, the mixture of isomerically-purified hydroxypropyl β-cyclodextrin molecules comprises about 24% to about 30% of β-cyclodextrin substituted with ten hydroxypropyl groups (“DS-10). In some aspects, the mixture of isomerically-purified hydroxypropyl β-cyclodextrin molecules comprises about 25% to about 29% of DS-10. In some embodiments, the mixture of isomerically-purified hydroxypropyl β-cyclodextrin molecules comprises about 18% to about 24% of β-cyclodextrin substituted with eleven hydroxypropyl groups (“DS-11”). In some aspects, the mixture of isomerically-purified hydroxypropyl β-cyclodextrin molecules comprises about 19% to about 23% of DS-11. In some embodiments, the mixture of isomerically-purified hydroxypropyl β-cyclodextrin molecules comprises about 10% to about 16% of β-cyclodextrin substituted with twelve hydroxypropyl groups (“DS-12”). In some aspects, the mixture of isomerically-purified hydroxypropyl β-cyclodextrin molecules comprises about 11% to about 15% of DS-12. In some embodiments, the mixture of isomerically-purified hydroxypropyl β-cyclodextrin molecules comprises about 4% to about 10% of β-cyclodextrin substituted with thirteen hydroxypropyl groups (“DS-13”). In some aspects, the mixture of isomerically-purified hydroxypropyl β-cyclodextrin molecules comprises about 5% to about 9% of DS-13. In some embodiments, the mixture of isomerically-purified hydroxypropyl β-cyclodextrin molecules comprises about 0% to about 6% of β-cyclodextrin substituted with fourteen hydroxypropyl groups (“DS-14”). In some aspects, the mixture of isomerically-purified hydroxypropyl β-cyclodextrin molecules comprises about 1% to about 5% of DS-14. In some embodiments, the average degree of substitution of the mixture of isomerically-purified hydroxypropyl β-cyclodextrin is about 9 to about 10. In an exemplary embodiment, the average degree of substitution of the mixture of isomerically-purified hydroxypropyl β-cyclodextrin is about 9.65. In some embodiments, about 15% to about 21% of the hydroxypropyl substitutions in the hydroxypropyl β-cyclodextrin molecules are located at the 3-O— position. In some aspects, about 16% to about 20% of the hydroxypropyl substitutions in the hydroxypropyl β-cyclodextrin molecules are located at the 3-O— position. In some embodiments, about 79% to about 85% of the hydroxypropyl substitutions in the hydroxypropyl β-cyclodextrin molecules are located at the 2-O— position. In some aspects, about 80% to about 84% of the hydroxypropyl substitutions in the hydroxypropyl β-cyclodextrin molecules are located at the 2-O— position. In some embodiments, the concentration of the composition does not substantially change the time required for nanofiltration. In some embodiments, the length of time to nanofilter the composition ranges from 1.04 to 1.20 hours per diafiltration volume (kg soln/m²-hr/L soln). In some embodiments, the composition has no substantial difference observed in HPLC-ELSD after nanofiltration as compared to before nanofiltration. In some embodiments, the composition has no substantial difference observed in NMR after nanofiltration as compared to before nanofiltration. In some embodiments, the composition has a conductivity between 0 and 8.0 μS/cm, 0 and 4.5 μS/cm, 0 and 3 μS/cm, or between 0 and 1.5 μS/cm.

Further provided herein is a composition produced by any of the systems and/or methods provided herein, the composition comprising a mixture of isomerically-purified hydroxypropyl β-cyclodextrin molecules comprising: β-cyclodextrin substituted with eight hydroxypropyl groups (“DS-8”); β-cyclodextrin substituted with nine hydroxypropyl groups (“DS-9”); β-cyclodextrin substituted with ten hydroxypropyl groups (“DS-10”); β-cyclodextrin substituted with eleven hydroxypropyl groups (“DS-11”); β-cyclodextrin substituted with twelve hydroxypropyl groups (“DS-12”); β-cyclodextrin substituted with thirteen hydroxypropyl groups (“DS-13”); and β-cyclodextrin substituted with fourteen hydroxypropyl groups (“DS-14”), wherein the composition comprises less than 1% β-cyclodextrin substituted with seven hydroxypropyl groups (“DS-7”). In some embodiments, the composition comprises less than 1% β-cyclodextrin substituted with six hydroxypropyl groups (“DS-6”), 1% β-cyclodextrin substituted with five hydroxypropyl groups (“DS-5”), β-cyclodextrin substituted with four hydroxypropyl groups (“DS-4”), β-cyclodextrin substituted with three hydroxypropyl groups (“DS-3”), β-cyclodextrin substituted with two hydroxypropyl groups (“DS-2”), and β-cyclodextrin substituted with one hydroxypropyl group (“DS-1”). In some embodiments, the DS-10 has the highest concentration in the mixture of isomerically-purified hydroxypropyl β-cyclodextrin molecules as compared to DS-8, DS-9, DS-11, DS-12, DS-13, and DS-14. In some embodiments, the mixture of isomerically-purified hydroxypropyl β-cyclodextrin molecules comprises about 6% to about 12% DS-8. In some embodiments, the mixture of isomerically-purified hydroxypropyl β-cyclodextrin molecules comprises about 18% to about 24% DS-9. In some embodiments, the mixture of isomerically-purified hydroxypropyl β-cyclodextrin molecules comprises about 24% to about 30% DS-10. In some embodiments, the mixture of isomerically-purified hydroxypropyl β-cyclodextrin molecules comprises about 18% to about 24% DS-11. In some embodiments, the mixture of isomerically-purified hydroxypropyl β-cyclodextrin molecules comprises about 10% to about 16% DS-12. In some embodiments, the mixture of isomerically-purified hydroxypropyl β-cyclodextrin molecules comprises about 4% to about 10% DS-13. In some embodiments, the mixture of isomerically-purified hydroxypropyl β-cyclodextrin molecules comprises about 0% to about 6% DS-14. In some embodiments, the average degree of substitution of the mixture of isomerically-purified hydroxypropyl β-cyclodextrin is about 9 to about 10. In some embodiments, about 15% to about 21% of the hydroxypropyl substitutions in the hydroxypropyl β-cyclodextrin molecules are located at the 3-O— position. In some embodiments, about 79% to about 85% of the hydroxypropyl substitutions in the hydroxypropyl β-cyclodextrin molecules are located at the 2-O— position. In some embodiments, the composition has a −ESI-MS spectrum with peaks at about 770 m/z, about 798 m/z, about 828 m/z, about 857 m/z, about 885 m/z, and a +ESI-MS spectrum with peaks at about 803 m/z, about 831 m/z, about 861 m/z, about 889 m/z, and about 919 m/z. In some embodiments, the composition has a MALDI-TOF spectrum with peaks at about 1614 m/z, about 1673 m/z, about 1733 m/z, about 1792 m/z, about 1852 m/z, about 1912 m/z, and about 1971 m/z. In some embodiments, the osmolality of the composition is about 635-695 mOs/kg. In some embodiments, the true density of the composition is about 1.096-1.098 g/cm³. In some embodiments, the composition comprises no more than 10 ppb of propylene glycol as measured by HPLC. In some embodiments, the composition comprises no more than 1 ppm propylene oxide. In some embodiments, the total amount of other unspecified impurities is less than or equal to 0.05% as measured by HPLC. In some embodiments, the composition comprises between 0 and 10 ppm chloride. In some embodiments, the composition has a conductivity between 0 and 8 μS/cm. In some embodiments, the composition is nanofiltered. In some embodiments, the nanofiltrated composition has no substantial difference observed in HPLC-ELSD after nanofiltration as compared to before nanofiltration. In some embodiments, the nanofiltrated composition has no substantial difference observed in NMR after nanofiltration as compared to before nanofiltration.

It is envisioned that the systems and methods provided herein may be used to produce the compositions describe in e.g., U.S. Pat. No. 10,933,083, filed Mar. 2, 2021, and its related applications (e.g., U.S. Pat. No. 9,675,634, filed Jun. 13, 2017, U.S. Pat. No. 10,258,641, filed Apr. 16, 2019, and U.S. Pat. No. 10,300,086, filed May 28, 2019), as well as those described in U.S. Provisional Application No. 63/311,661 entitled “COMPOSITIONS OF HYDROXYPROPYL-BETA-CYCLODEXTRIN AND METHODS OF PURIFYING THE SAME” filed Feb. 18, 2022. These patents, patent applications, and provisional applications are each hereby incorporated by reference herein in their entirety.

### Methods of Making Beta-Cyclodextrin

The beta cyclodextrin (BCD) used in the systems and methods described herein may be produced via an enzymatic synthesis process. Suitable enzymatic synthesis processes are disclosed in, for example, PCT/IB2023/055977, the disclosure of which is incorporated herein by reference.

In some cases, the method for producing the BCD, or for producing a composition comprising cyclodextrin, comprises (a) contacting sucrose with an enzyme, or an enzyme mixture, capable of converting sucrose to amylose under conditions that permit the conversion of the sucrose to amylose, thereby producing amylose. In some cases, the method further comprises (b) contacting the amylose with an enzyme capable of converting amylose to cyclodextrin under conditions that permit the conversion of the amylose to cyclodextrin, thereby producing the composition comprising cyclodextrin. In some cases, the enzyme capable of converting amylose to cyclodextrin is a variant enzyme capable of producing a greater amount and/or concentration (e.g., wt %, mol % or w/v) of beta-cyclodextrin than alpha-cyclodextrin, gamma-cyclodextrin, or both, relative to a wild-type enzyme capable of converting amylose to cyclodextrin. In some cases, the composition comprising cyclodextrin comprises beta-cyclodextrin, and may optionally further comprise alpha-cyclodextrin, gamma-cyclodextrin, or any combination thereof. In some cases, the composition comprising cyclodextrin comprises beta-cyclodextrin in an amount and/or concentration (e.g., wt %, mol % or w/v) greater than alpha-cyclodextrin, gamma-cyclodextrin, or both. In some cases, the amount and/or concentration of alpha-cyclodextrin, beta-cyclodextrin, and gamma-cyclodextrin is measured by high-performance liquid chromatography (HPLC).

### Method Step (a) for Enzymatic Conversion of Sucrose to Amylose

The methods provided herein may involve the enzymatic conversion of sucrose to amylose. In some cases, the amylose is alpha-amylose. In some embodiments, the methods involve contacting sucrose with an enzyme, or an enzyme mixture, capable of converting sucrose to amylose under conditions that permit the conversion of the sucrose to amylose, thereby producing amylose. In one aspect, the methods involve the use of a single enzyme to convert sucrose to amylose. In alternative aspects, the methods involve the use of an enzyme mixture (e.g., two enzymes), which collectively or in combination, convert sucrose to amylose. In some cases, the sucrose is deuterated sucrose (e.g., one or more hydrogens have been replaced with deuterium). In some cases, the sucrose, and/or any one or more reagents used in the synthesis reaction are deuterated.

One Enzyme Method for Producing Amylose from Sucrose

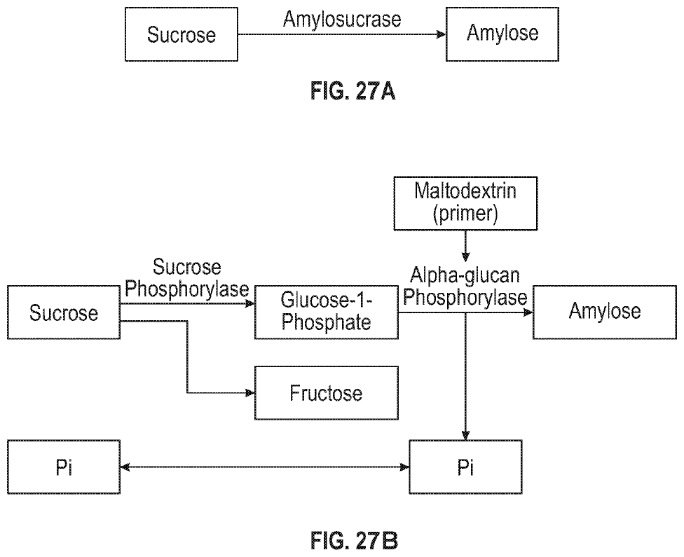

In some aspects, the enzyme is amylosucrase. FIG. 27A depicts a schematic of a single enzyme method of producing amylose from sucrose. In this example, sucrose is contacted with amylosucrase which converts the sucrose to amylose. In some cases, the amylosucrase is a wild-type amylosucrase. For example, the wild-type amylosucrase may be Cellulomonas carboniz T26 amylosucrase (NCBI Accession No. N868_11335). In some cases, the wild-type Cellulomonas carboniz T26 amylosucrase may have the amino acid sequence of SEQ ID NO: 1. In some cases, the wild-type amylosucrase may be Neisseria polysaccharea amylosucrase (NCBI Accession No. AJ011781). In some cases, the wild-type Neisseria polysaccharea amylosucrase may have the amino acid sequence of SEQ ID NO: 2. Table 1 below depicts non-limiting examples of wild-type amylosucrase enzymes (and their amino acid sequences) that can be used in accordance with the methods provided herein.

TABLE 1
Non-limiting examples of wild-type amylosucrase enzymes

| Enzyme | SEQ ID NO: | Sequence (5′ to 3′) |
|---|---|---|
| Cellulomonas | SEQ ID NO: | MRVSEPLHPSVTAAVAAARDPRTSAEHWAAIEARVAREWP |
| carboniz T26 | 1 | RLERLFLEVYGEGERTRSELAALAHQLVVSAQERPADLRAV |
| amylosucrase | | DVAREADPAWFTSHRMLGGVCYVDRYAGDLEGLRRHIPYL |
| | | RELGLTYLHLMPLFEAPAENSDGGYAVSSYRRVNPALGTM |
| | | EQLTALAAELRENGISLVLDFIFNHTSDEHEWARRALAGERE |
| | | YEDYYWVFPDREMPDAYERTVREIFPDDHPGSFVPMPDSP |
| | | DGSRTGRWIWATFHSFQWDLNYANPAVFRAMAGEMLFLA |
| | | NKGVDVLRMDAVAFIWKQLGTACESLPQAHLLIQAFNAALRI |
| | | AAPGVLFKSEAIVHPDEVVQYISPDECQISYNPLQMALIWSS |
| | | LATREANLLQQALERRHALPPGTAWVNYVRSHDDIGWTFA |
| | | DEDAAELGIDGFQHRRFLNAFYVDRFPGSFARGVPFQDNP |
| | | RTGDCRISGTTASLAGLEARDPGAVDRILLAHSIVLSTGGIPL |
| | | LYLGDEVGQLNDYSYRDQPGLAEDSRWVNRPWYPAQAYA |
| | | NRLVPSTAAGRVFRGLRHLLEVRRRTPELAGGTLVPFDAHN |
| | | RHVVGYQRPGELDGVPTTVLCLASFADEPQAVEPLTLSGM |
| | | PAEAEDLLTGATVDLRAGLVLRPHGFVWLRVRHAA |
| Neisseria | SEQ ID NO: 2 | MLTPTQQVGLILQYLKTRILDIYTPEQRAGIEKSEDWRQFSR |
| polysaccharea | | RMDTHFPKLMNELDSVYGNNEALLPMLEMLLAQAWQSYSQ |
| amylosucrase | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLREIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |

In some embodiments, the amylosucrase is a variant amylosucrase comprising at least one amino acid variant relative to a wild-type amylosucrase. The variant amylosucrase may comprise one or more amino acid substitutions, deletions, insertions, and/or modifications relative to a wild-type amylosucrase. In some cases, the variant amylosucrase is capable of producing a greater amount and/or concentration of amylose from sucrose relative to a wild-type amylosucrase.

In some cases, the variant amylosucrase comprises at least one amino acid variant relative to wild-type Cellulomonas carboniz T26 amylosucrase (SEQ ID NO: 1). In some cases, the variant amylosucrase comprises at least one amino acid variant relative to wild-type Neisseria polysaccharea amylosucrase (SEQ ID NO: 2). In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of wild-type Cellulomonas carboniz T26 amylosucrase. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 1. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of wild-type Neisseria polysaccharea amylosucrase. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2.

In some cases, the at least one amino acid variant comprises at least one amino acid substitution relative to a wild-type amylosucrase. In some cases, the at least one amino acid variant comprises at least one amino acid substitution relative to wild-type Cellulomonas carboniz T26 amylosucrase. In some cases, the at least one amino acid variant comprises at least one amino acid substitution relative to wild-type Neisseria polysaccharea amylosucrase. In some cases, the at least one amino acid substitution comprises or consists of an amino acid substitution at amino acid position 234 relative to the amino acid sequence of SEQ ID NO: 2. In some cases, the amino acid substitution at amino acid position 234 relative to the amino acid sequence of SEQ ID NO: 2 is selected from the group consisting of: R234Q, R234G, R234A, R234S, R234M, R234C, R234K, R2341, R234D, R234Y, R234W, R234E, R234L, and R234H. In a preferred embodiment, the amino acid substitution at amino acid position 234 relative to the amino acid sequence of SEQ ID NO: 2 is selected from the group consisting of: R234Q, R234G, R234A, R234S, R234M, R234C, and R234K. In this regard, it will be appreciated that R234Q denotes that the arginine (R) at amino acid position 234 relative to the amino acid sequence of SEQ ID NO: 2 is substituted with a glutamine (Q), etc. In some cases, the amino acid substitution at amino acid position 234 relative to the amino acid sequence of SEQ ID NO: 2 is R234Q (e.g., SEQ ID NO: 3 in Table 2). In some cases, the amino acid substitution at amino acid position 234 relative to the amino acid sequence of SEQ ID NO: 2 is R234G (e.g., SEQ ID NO: 4 in Table 2). In some cases, the amino acid substitution at amino acid position 234 relative to the amino acid sequence of SEQ ID NO: 2 is R234A (e.g., SEQ ID NO: 5 in Table 2). In some cases, the amino acid substitution at amino acid position 234 relative to the amino acid sequence of SEQ ID NO: 2 is R234S (e.g., SEQ ID NO: 6 in Table 2). In some cases, the amino acid substitution at amino acid position 234 relative to the amino acid sequence of SEQ ID NO: 2 is R234M (e.g., SEQ ID NO: 7 in Table 2). In some cases, the amino acid substitution at amino acid position 234 relative to the amino acid sequence of SEQ ID NO: 2 is R234C (e.g., SEQ ID NO: 8 in Table 2). In some cases, the amino acid substitution at amino acid position 234 relative to the amino acid sequence of SEQ ID NO: 2 is R234K (e.g., SEQ ID NO: 9 in Table 2). In some cases, the amino acid substitution at amino acid position 234 relative to the amino acid sequence of SEQ ID NO: 2 is R2341 (e.g., SEQ ID NO: 10 in Table 2). In some cases, the amino acid substitution at amino acid position 234 relative to the amino acid sequence of SEQ ID NO: 2 is R234D (e.g., SEQ ID NO: 11 in Table 2). In some cases, the amino acid substitution at amino acid position 234 relative to the amino acid sequence of SEQ ID NO: 2 is R234Y (e.g., SEQ ID NO: 12 in Table 2). In some cases, the amino acid substitution at amino acid position 234 relative to the amino acid sequence of SEQ ID NO: 2 is R234W (e.g., SEQ ID NO: 13 in Table 2). In some cases, the amino acid substitution at amino acid position 234 relative to the amino acid sequence of SEQ ID NO: 2 is R234E (e.g., SEQ ID NO: 14 in Table 2). In some cases, the amino acid substitution at amino acid position 234 relative to the amino acid sequence of SEQ ID NO: 2 is R234L (e.g., SEQ ID NO: 15 in Table 2). In some cases, the amino acid substitution at amino acid position 234 relative to the amino acid sequence of SEQ ID NO: 2 is R234H (e.g., SEQ ID NO: 16 in Table 2). In some aspects, the variant amylosucrase comprises or consists of an amino acid sequence according to any one of SEQ ID NOS: 3-16 or 48, depicted in Table 2, or an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) to an amino acid sequence according to any one of SEQ ID NOS: 3-16 or 48, depicted in Table 2. In a preferred embodiment, the variant amylosucrase comprises or consists of an amino acid sequence according to any one of SEQ ID NOS: 3-9 or 48, depicted in Table 2.

TABLE 2
Non-limiting examples of variant amylosucrase enzymes.

| Enzyme | SEQ ID NO: | Sequence (5′ to 3′) |
|---|---|---|
| Amylosucrase | SEQ ID NO: | MLTPTQQVGLILQYLKTRILDIYTPEQRAGIEKSEDWRQFSR |
| R234Q | 3 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLQEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: 4 | MLTPTQQVGLILQYLKTRILDIYTPEQRAGIEKSEDWRQFSR |
| R234G | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLGEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: 5 | MLTPTQQVGLILQYLKTRILDIYTPEQRAGIEKSEDWRQFSR |
| R234A | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLAEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: 6 | MLTPTQQVGLILQYLKTRILDIYTPEQRAGIEKSEDWRQFSR |
| R234S | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLSEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: 7 | MLTPTQQVGLILQYLKTRILDIYTPEQRAGIEKSEDWRQFSR |
| R234M | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLMEIFPDQHPGGFS |
| | | QLEDGRWVWTTFNSFQWDLNYSNPWVFRAMAGEMLFLAN |
| | | LGVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: 8 | MLTPTQQVGLILQYLKTRILDIYTPEQRAGIEKSEDWRQFSR |
| R234C | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLCEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: 9 | MLTPTQQVGLILQYLKTRILDIYTPEQRAGIEKSEDWRQFSR |
| R234K | | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLKEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R2341 | 10 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLIEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234D | 11 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLDEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234Y | 12 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLYEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234W | 13 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLWEIFPDQHPGGFS |
| | | QLEDGRWVWTTFNSFQWDLNYSNPWVFRAMAGEMLFLAN |
| | | LGVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234E | 14 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLEEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234L | 15 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLLEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MLTPTQQVGLILQYLKTRILDIYTPEQRAGIEKSEDWRQFSR |
| R234H | 16 | RMDTHFPKLMNELDSVYGNNEALLPMLEMLLAQAWQSYSQ |
| | | RNSSLKDIDIARENNPDWILSNKQVGGVCYVDLFAGDLKGL |
| | | KDKIPYFQELGLTYLHLMPLFKCPEGKSDGGYAVSSYRDVN |
| | | PALGTIGDLREVIAALHEAGISAVVDFIFNHTSNEHEWAQRC |
| | | AAGDPLFDNFYYIFPDRRMPDQYDRTLHEIFPDQHPGGFSQ |
| | | LEDGRWVWTTFNSFQWDLNYSNPWVFRAMAGEMLFLANL |
| | | GVDILRMDAVAFIWKQMGTSCENLPQAHALIRAFNAVMRIA |
| | | APAVFFKSEAIVHPDQVVQYIGQDECQIGYNPLQMALLWNT |
| | | LATREVNLLHQALTYRHNLPEHTAWVNYVRSHDDIGWTFA |
| | | DEDAAYLGISGYDHRQFLNRFFVNRFDGSFARGVPFQYNP |
| | | STGDCRVSGTAAALVGLAQDDPHAVDRIKLLYSIALSTGGLP |
| | | LIYLGDEVGTLNDDDWSQDSNKSDDSRWAHRPRYNEALYA |
| | | QRNDPSTAAGQIYQGLRHMIAVRQSNPRFDGGRLVTFNTN |
| | | NKHIIGYIRNNALLAFGNFSEYPQTVTAHTLQAMPFKAHDLIG |
| | | GKTVSLNQDLTLQPYQVMWLEIA |
| Amylosucrase | SEQ ID NO: | MGLILQYLKTRILDIYTPEQRAGIEKSEDWRQFSRRMDTHFP |
| R234Ndelta8 | 48 | KLMNELDSVYGNNEALLPMLEMLLAQAWQSYSQRNSSLKD |
| AA | | IDIARENNPDWILSNKQVGGVCYVDLFAGDLKGLKDKIPYFQ |
| | | ELGLTYLHLMPLFKCPEGKSDGGYAVSSYRDVNPALGTIGD |
| | | LREVIAALHEAGISAVVDFIFNHTSNEHEWAQRCAAGDPLFD |
| | | NFYYIFPDRRMPDQYDRTLNEIFPDQHPGGFSQLEDGRWV |
| | | WTTFNSFQWDLNYSNPWVFRAMAGEMLFLANLGVDILRMD |
| | | AVAFIWKQMGTSCENLPQAHALIRAFNAVMRIAAPAVFFKS |
| | | EAIVHPDQVVQYIGQDECQIGYNPLQMALLWNTLATREVNL |
| | | LHQALTYRHNLPEHTAWVNYVRSHDDIGWTFADEDAAYLGI |
| | | SGYDHRQFLNRFFVNRFDGSFARGVPFQYNPSTGDCRVS |
| | | GTAAALVGLAQDDPHAVDRIKLLYSIALSTGGLPLIYLGDEV |
| | | GTLNDDDWSQDSNKSDDSRWAHRPRYNEALYAQRNDPST |
| | | AAGQIYQGLRHMIAVRQSNPRFDGGRLVTFNTNNKHIIGYIR |
| | | NNALLAFGNFSEYPQTVTAHTLQAMPFKAHDLIGGKTVSLN |
| | | QDLTLQPYQVMWLEIA |

In some aspects, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and an amino acid substitution at amino acid position 234 relative to SEQ ID NO: 2. In this regard, and as used throughout the disclosure, the stated sequence identity includes the amino acid substitution (i.e., the sequence identity is calculated based on the entire amino acid sequence of the variant enzyme, including the amino acid substitution). In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and an amino acid substitution at amino acid position 234 relative to SEQ ID NO: 2 selected from the group consisting of: R234Q, R234G, R234A, R234S, R234M, R234C, R234K, R2341, R234D, R234Y, R234W, R234E, R234L, and R234H. In a preferred embodiment, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and an amino acid substitution at amino acid position 234 relative to SEQ ID NO: 2 selected from the group consisting of: R234Q, R234G, R234A, R234S, R234M, R234C, and R234K. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234Q relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234G relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234A relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234S relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234M relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234C relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234K relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R2341 relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234D relative to SEQ ID NO: 2. In some cases, the variant amylosucrase comprises or consists an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234Y relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234W relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234E relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234L relative to SEQ ID NO: 2. In some cases, the variant amylosucrase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 2, and the amino acid substitution R234H relative to SEQ ID NO: 2.

In some embodiments, the amylosucrase is derived from a microbial cell. In some cases, the amylosucrase is isolated and/or purified from a microbial cell. In some cases, the microbial cell is a bacterial cell. In some cases, the bacterial cell is Escherichia coli. In some embodiments, the amylosucrase is derived from Neisseria polysaccharea. In some embodiments, the amylosucrase is derived from Cellulomonas carboniz T26. In some embodiments, the amylosucrase may be produced within a microbial cell. In some embodiments, the amylosucrase is expressed in a recombinant host cell (e.g., from a recombinant polynucleotide). In some cases, the amylosucrase is recombinantly produced. In some cases, the amylosucrase is produced (e.g., recombinantly produced) in a yeast cell. In some cases, the yeast cell is a Pichia yeast cell, such as a Pichia pastoris cell.

Two Enzyme Method for Producing Amylose from Sucrose

In some aspects, the methods involve contacting sucrose with an enzyme mixture capable of converting sucrose to amylose under conditions that permit the conversion of the sucrose to amylose, thereby producing amylose. In some cases, the methods involve contacting sucrose with an enzyme mixture that contains at least two enzymes, which, collectively or in combination, are capable of converting the sucrose to amylose. For example, the enzyme mixture may contain at least sucrose phosphorylase and alpha-glucan phosphorylase. The methods may involve contacting sucrose with the at least two enzymes simultaneously or substantially simultaneously. Alternatively, the methods may involve contacting sucrose with the at least two enzymes sequentially. FIG. 27B depicts a schematic of a two enzyme method of producing amylose from sucrose. In this example, sucrose is contacted with sucrose phosphorylase to convert the sucrose to glucose-1-phosphate. The glucose-1-phosphate is then contacted with alpha-glucan phosphorylase to convert the glucose-1-phosphate to amylose. In some cases, the sucrose phosphorylase and the alpha-glucan phosphorylase are contacted with the sucrose simultaneously or substantially simultaneously. In other cases, the sucrose phosphorylase and the alpha-glucan phosphorylase are added sequentially (e.g., the sucrose phosphorylase is contacted with the sucrose first to generate glucose-1-phosphate, then the alpha-glucan phosphorylase is added to generate the amylose). In some cases, the glucose-1-phosphate generated from the reaction with sucrose phosphorylase is isolated and/or purified prior to contacting the glucose-1-phosphate with the alpha-glucan phosphorylase. In other cases, the glucose-1-phosphate generated from the reaction with sucrose phosphorylase is not isolated and/or purified prior to contacting the glucose-1-phosphate with the alpha-glucan phosphorylase. The term “substantially simultaneously” when used in context with the addition of two or more components to a reaction mixture as described herein means the two or more components are added to the reaction mixture within 10 seconds or less of one another.

In some cases, the sucrose phosphorylase is a wild-type sucrose phosphorylase. For example, the wild-type sucrose phosphorylase may be Bifidobacterium longum sucrose phosphorylase (e.g., NCBI Accession No. AA084039). In some cases, the wild-type Bifidobacterium longum sucrose phosphorylase may have the amino acid sequence according to SEQ ID NO: 17. In some cases, the wild-type sucrose phosphorylase may be Leuconostoc mesenteroide sucrose phosphorylase (e.g., NCBI Accession No. D90314.1). In some cases, the wild-type Leuconostoc mesenteroide sucrose phosphorylase may have the amino acid sequence according to SEQ ID NO: 18. In some cases, the wild-type sucrose phosphorylase may be Streptococcus mutans sucrose phosphorylase (e.g., NCBI Accession No. NZ_CP013237.1). In some cases, the wild-type Streptococcus mutans sucrose phosphorylase may have the amino acid sequence according to SEQ ID NO: 19 (e.g., NCBI Accession No. P10249). In some cases, the sucrose phosphorylase enzyme is a variant sucrose phosphorylase enzyme. In some cases, the variant sucrose phosphorylase has one or more amino acid substitutions relative to a wild-type sucrose phosphorylase. In some cases, the variant sucrose phosphorylase has an amino acid substitution at one or more of, or all of, amino acid residues T47, S62, Y77, V128, K140, Q144, N155, and D249, relative to SEQ ID NO: 19. In some cases, the amino acid substitution at amino acid position 47 relative to SEQ ID NO: 19 is T47S. In some cases, the amino acid substitution at amino acid position 62 relative to SEQ ID NO: 19 is S62P. In some cases, the amino acid substitution at amino acid position 77 relative to SEQ ID NO: 19 is Y77H. In some cases, the amino acid substitution at amino acid position 128 relative to SEQ ID NO: 19 is V128L. In some cases, the amino acid substitution at amino acid position 140 relative to SEQ ID NO: 19 is K140M. In some cases, the amino acid substitution at amino acid position 144 relative to SEQ ID NO: 19 is Q144R. In some cases, the amino acid substitution at amino acid position 155 relative to SEQ ID NO: 19 is N155S. In some cases, the amino acid substitution at amino acid position 249 relative to SEQ ID NO: 19 is D249G. In some cases, the variant sucrose phosphorylase has amino acid substitutions T47S, S62P, Y77H, V128L, K140M, Q144R, N155S, and D249G, relative to SEQ ID NO: 19. In some cases, the variant sucrose phosphorylase comprises or consists of an amino acid sequence according to SEQ ID NO: 20. Table 3 below depicts non-limiting examples of sucrose phosphorylase enzymes (and their amino acid sequences) that can be used in accordance with the methods provided herein.

TABLE 3
Non-limiting examples of sucrose phosphorylase enzymes

| Enzyme | SEQ ID NO: | Sequence (5′ to 3′) |
|---|---|---|
| Bifidobacterium | SEQ ID NO: | MKNKVQLITYADRLGDGTLSSMADILRTRFDGVYDGVHILPF |
| longum | 17 | FTPFDGADAGFDPIDHTKVDERLGSWDDVAELSKTHNIMVD |
| sucrose | | AIVNHMSWESKQFQDVLEKGEESEYYPMFLTMSSVFPNGA |
| phosphorylase | | TEEDLAGIYRPRPGLPFTHYKFAGKTRLVWVSFTPQQVDID |
| | | TDSDKGWEYLMSIFDQMAASHVSYIRLDAVGYGAKEAGTS |
| | | CFMTPKTFKLISRLREEGVKRGLEILIEVHSYYKKQVEIASKV |
| | | DRVYDFALPPLLLHSLFTGHVEPVAHWTEIRPNNAVTVLDT |
| | | HDGIGVIDIGSDQLDRSLKGLVPDEDVDNLVNTIHANTHGES |
| | | QAATGAAASNLDLYQVNSTYYSALGCNDQHYLAARAVQFF |
| | | LPGVPQVYYVGALAGRNDMELLRRTNNGRDINRHYYSTAEI |
| | | DENLERPVVKALNALAKFRNELPAFDGEFSYEVDGDTSITF |
| | | RWTAADGTSTAALTFEPGRGLGTDNATPVASLAWSDAAGD |
| | | HETRDLLANPPIADID |
| Leuconostoc | SEQ ID NO: | MEIQNKAMLITYADSLGKNLKDVHQVLKEDIGDAIGGVHLLP |
| mesenteroides | 18 | FFPSTGDRGFAPADYTRVDAAFGDWADVEALGEEYYLMFD |
| sucrose | | FMINHISRESVMYQDFKKNHDDSKYKDFFIRWEKFWAKAGE |
| phosphorylase | | NRPTQADVDLIYKRKDKAPTQEITFDDGTTENLWNTFGEEQI |
| | | DIDVNSAIAKEFIKTTLEDMVKHGANLIRLDAFAYAVKKVDTN |
| | | DFFVEPEIWDTLNEVREILTPLKAEILPEIHEHYSIPKKINDHG |
| | | YFTYDFALPMTTLYTLYSGKTNQLAKWLKMSPMKQFTTLDT |
| | | HDGIGVVDARDILTDDEIDYASEQLYKVGANVKKTYSSASYN |
| | | NLDIYQINSTYYSALGNDDAAYLLSRVFQVFAPGIPQIYYVGL |
| | | LAGENDIALLESTKEGRNINRHYYTREEVKSEVKRPVVANLL |
| | | KLLSWRNESPAFDLAGSITVDTPTDTTIVVTRQDENGQNKA |
| | | VLTADAANKTFEIVENGQTVMSSDNLTQN |
| Streptococcus | SEQ ID NO: | MPIINKTMLITYADSLGKNLKELNENIENYFGDAVGGVHLLPF |
| mutans | 19 | FPSTGDRGFAPIDYHEVDSAFGDWDDVKCLGEKYYLMFDF |
| sucrose | | MINHISRQSKYYKDYQEKHEASAYKDLFLNWDKFWPKNRP |
| phosphorylase | | TQEDVDLIYKRKDRAPKQEIQFADGSVEHLWNTFGEEQIDL |
| | | DVTKEVTMDFIRSTIENLAANGCDLIRLDAFAYAVKKLDTND |
| | | FFVEPEIWTLLDKVRDIAAVSGAEILPEIHEHYTIQFKIADHDY |
| | | YVYDFALPMVTLYSLYSSKVDRLAKWLKMSPMKQFTTLDTH |
| | | DGIGVVDVKDILTDEEITYTSNELYKVGANVNRKYSTAEYNN |
| | | LDIYQINSTYYSALGDDDQKYFLARLIQAFAPGIPQVYYVGFL |
| | | AGKNDLELLESTKEGRNINRHYYSSEEIAKEVKRPVVKALLN |
| | | LFTYRNQSAAFDLDGRIEVETPNEATIVIERQNKDGSHIAKA |
| | | EINLQDMTYRVTENDQTISFE |
| SP3-M8 | SEQ ID NO: | MPITNKTMLITYADSLGKNLKELNENIENYFGDAVGGVHLLP |
| (T47S, S62P, | 20 | FFPSSGDRGFAPIDYHEVDPAFGDWDDVKRLGEKHYLMFD |
| Y77H, V128L, | | FMINHISRQSKYYKDYQEKHEASAYKDLFLNWDKFWPKNR |
| K140M, | | PTQEDLDLIYKRKDRAPMQEIRFADGSVEHLWSTFGEEQID |
| Q144R, | | LDVTKEVTMDFIRSTIENLAANGCDLIRLDAFAYAVKKLDTND |
| N155S and | | FFVEPEIWTLLDKVRDIAAVSGAEILPEIHEHYTIQFKIADHGY |
| D249G) | | YVYDFALPMVTLYSLYSGKVDRLAKWLKMSPMKQFTTLDT |
| | | HDGIGVVDVKDILTDEEITYTSNELYKVGANVNRKYSTAEYN |
| | | NLDIYQINSTYYSALGDDDQKYFLARLIQAFAPGIPQVYYVG |
| | | FLAGKNDLELLESTKEGRNINRHYYSSEEIAKEVKRPVVKAL |
| | | LNLFTYRNQSAAFDLDGRIEVETPNEATIVIERQNKDGSHIAT |
| | | AEINLQDMTYRVTENDQTISFE |

In some cases, the sucrose phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to wild-type Bifidobacterium longum sucrose phosphorylase. In some cases, the sucrose phosphorylase comprises or consists of an amino acid sequence having at least about 70% sequence identity (e.g., 75%, at least about 80%, at least about at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 17. In some cases, the sucrose phosphorylase comprises or consists of an amino acid sequence having at least about 70% sequence identity (e.g., 75%, at least about 80%, at least about at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to wild-type Leuconostoc mesenteroides sucrose phosphorylase. In some cases, the sucrose phosphorylase comprises or consists of an amino acid sequence having at least about 70% sequence identity (e.g., 75%, at least about 80%, at least about at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 18. In some cases, the sucrose phosphorylase comprises or consists of an amino acid sequence having at least about 70% sequence identity (e.g., 75%, at least about 80%, at least about at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to wild-type Streptococcus mutans sucrose phosphorylase. In some cases, the sucrose phosphorylase comprises or consists of an amino acid sequence having at least about 70% sequence identity (e.g., 75%, at least about 80%, at least about at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 19. In some cases, the sucrose phosphorylase comprises or consists of an amino acid sequence having at least about 70% sequence identity (e.g., 75%, at least about 80%, at least about at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 20, and comprises the amino acid substitutions T47S, S62P, Y77H, V128L, K140M, Q144R, N155S, and D249G, relative to SEQ ID NO: 19.

In some embodiments, the sucrose phosphorylase is derived from a microbial cell. In some cases, the sucrose phosphorylase is isolated and/or purified from a microbial cell. In some cases, the microbial cell is a bacterial cell. In some cases, the bacterial cell is Escherichia coli. In some embodiments, the sucrose phosphorylase is derived from Bifidobacterium longum. In some embodiments, the sucrose phosphorylase is derived from Leuconostoc mesenteroides. In some embodiments, the sucrose phosphorylase is derived from Streptococcus mutans. In some embodiments, the sucrose phosphorylase may be produced within a microbial cell. In some embodiments, the sucrose phosphorylase is expressed in a recombinant host cell (e.g., from a recombinant polynucleotide). In some cases, the sucrose phosphorylase is recombinantly produced. In some cases, the sucrose phosphorylase is produced (e.g., recombinantly produced) in a yeast cell. In some cases, the yeast cell is a Pichia yeast cell, such as a Pichia pastoris cell.

In some aspects, the alpha-glucan phosphorylase is a wild-type alpha-glucan phosphorylase. In some cases, the wild-type alpha-glucan phosphorylase may be Solanum tuberosum alpha-glucan phosphorylase (e.g., NCBI Accession No. D00520.1). In some cases, the wild-type Solanum tuberosum alpha-glucan phosphorylase may have the amino acid sequence according to SEQ ID NO: 21. In some cases, the wild-type alpha-glucan phosphorylase may be S. tokodaii strain 7 alpha-glucan phosphorylase (e.g., NCBI Accession No. NC_003106.2). In some cases, the wild-type S. tokodaii strain 7 alpha-glucan phosphorylase may have the amino acid sequence according to SEQ ID NO: 22. In some cases, the wild-type alpha-glucan phosphorylase may be C. callunae DSM 20145 alpha-glucan phosphorylase (e.g., NCBI Accession No. AY102616.1). In some cases, the wild-type C. callunae DSM20145 alpha-glucan phosphorylase may have the amino acid sequence according to SEQ ID NO: 23. In some cases, the alpha-glucan phosphorylase enzyme is a variant alpha-glucan phosphorylase enzyme. In some cases, the variant alpha-glucan phosphorylase has one or more amino acid substitutions relative to a wild-type alpha-glucan phosphorylase. In some cases, the variant alpha-glucan phosphorylase has an amino acid substitution at one or more of, or all of, amino acid residues F39, N135, and T706, relative to SEQ ID NO: 21. In some cases, the amino acid substitution at amino acid position 39 relative to SEQ ID NO: 21 is F39L. In some cases, the amino acid substitution at amino acid position 135 relative to SEQ ID NO: 21 is N135S. In some cases, the amino acid substitution at amino acid position 706 relative to SEQ ID NO: 21 is T7061. In some cases, the variant alpha-glucan phosphorylase has amino acid substitutions F39L, N135S, and T7061, relative to SEQ ID NO: 21. In some cases, the variant alpha-glucan phosphorylase enzyme comprises or consists of the amino acid sequence according to SEQ ID NO: 24. Table 4 below depicts non-limiting examples of alpha-glucan phosphorylase enzymes (and their amino acid sequences) that can be used in accordance with the methods provided herein.

TABLE 4
Non-limiting examples of alpha-glucan phosphorylase enzymes

| | SEQ ID NO: | Sequence (5′ to 3′) |
|---|---|---|
| Solanum | SEQ ID NO: | TLSEKIHHPITEQGGESDLSSFAPDAASITSSIKYHAEFTPVF |
| tuberosum | 21 | SPERFELPKAFFATAQSVRDSLLINWNATYDIYEKLNMKQAY |
| alpha-glucan | | YLSMEFLQGRALLNAIGNLELTGAFAEALKNLGHNLENVAS |
| phosphorylase | | QEPDAALGNGGLGRLASCFLDSLATLNYPAWGYGLRYKYG |
| | | LFKQRITKDGQEEVAEDWLEIGSPWEVVRNDVSYPIKFYGK |
| | | VSTGSDGKRYWIGGEDIKAVAYDVPIPGYKTRTTISLRLWST |
| | | QVPSADFDLSAFNAGEHTKACEAQANAEKICYILYPGDESE |
| | | EGKILRLKQQYTLCSASLQDIISRFERRSGDRIKWEEFPEKV |
| | | AVQMNDTHPTLCIPELMRILIDLKGLNWNEAWNITQRTVAYT |
| | | NHTVLPEALEKWSYELMQKLLPRHVEIIEAIDEELVHEIVLKY |
| | | GSMDLNKLEEKLTTMRILENFDLPSSVAELFIKPEISVDDDTE |
| | | TVEVHDKVEASDKVVTNDEDDTGKKTSVKIEAAAEKDIDKKT |
| | | PVSPEPAVIPPKKVRMANLCVVGGHAVNGVAEIHSEIVKEEV |
| | | FNDFYELWPEKFQNKTNGVTPRRWIRFCNPPLSAIITKWTG |
| | | TEDWVLKTEKLAELQKFADNEDLQNEWREAKRSNKIKVVSF |
| | | LKEKTGYSVVPDAMFDIQVKRIHEYKRQLLNIFGIVYRYKKM |
| | | KEMTAAERKTNFVPRVCIFGGKAFATYVQAKRIVKFITDVGA |
| | | TINHDPEIGDLLKVVFVPDYNVSVAELLIPASDLSEHISTAGM |
| | | EASGTSNMKFAMNGCIQIGTLDGANVEIREEVGEENFFLFG |
| | | AQAHEIAGLRKERADGKFVPDERFEEVKEFVRSGAFGSYN |
| | | YDDLIGSLEGNEGFGRADYFLVGKDFPSYIECQEKVDEAYR |
| | | DQKRWTTMSILNTAGSYKFSSDRTIHEYAKDIWNIEAVEIA |
| S. tokodaii | SEQ ID NO: | MRKHLKGKAHKKLHMIISITAELGIDFGENFAGGLGVLEGDK |
| strain 7 alpha- | 22 | FYASARLGIDYTVFTLFYRKGYTGNEEKQKELLKNLVKEWE |
| glucan | | TEIELKKGKIKIEYLTYKLNTAKAIFINILSPDWAKRLNEKLYIE |
| phosphorylase | | NSEEDRFYKYLVLAKATEKYISEKIGWDKIKYVDLQEAYPSF |
| | | LPLLKYFPRYRIIIHTPAPWGHPTFPARYFKEEFGFEFPFDPV |
| | | VMTEIGLSSAVQGIVVSKKMLHHVSKTFPHHMHKIKAITNAV |
| | | EIPRWRHPLLNNVKDLDDFIKKKKEVKKESLKKLGKESDKPT |
| | | IGWVRRITQYKRPEFILRLIDELRDDVVFIIGGKAHPYEYYGV |
| | | ELEKKFKEYAQKRNNVIYVQGVDIQQMKLAIWSSDIWTFTPY |
| | | SGWEASGTSFMKAGVNGVPSVASRDGAVPEIIKDGYNGWL |
| | | YGEDRYELLPVDTYDREYEEFARKVKEALNKYYEVGYNAY |
| | | HTFSDFCSMDRLMKEYAL |
| C. callunae | SEQ ID NO: | MSPEKQPLPAALVGSHVRAAAGTPADLATDRKFWTGLSRA |
| DSM 20145 | 23 | VQERIADDWERTREAYGAARQQHYFSAEFLMGRALLNNLT |
| alpha-glucan | | NLGLVDEAAAATRELGHELTDILEIENDAALGNGGLGRLAAC |
| phosphorylase | | FLDSAVTQDYPVTGYGLLYRFGLFRQSFNEGFQVEKPDPW |
| | | REEEYPFTIRRASDQLVVCFDDMKTRAIPYDMPITGYGTHN |
| | | VGTLRLWKAEPWEEFDYDAFNSQRFTDAIIERERVSDICRV |
| | | LYPNDTTYEGKKLRVRQQYFFTSASLQAMIQDHLAHHKDLS |
| | | NFAEFHSVQLNDTHPVLAIPELMRLLMDEHDMGWEESWAI |
| | | VSKTFAYTNHTVLTEALEQWDEQIFQQLFWRVWEIIAEIDRR |
| | | FRLERAADGLDEETINRMAPIQHGTVHMAWIACYAAYSING |
| | | VAALHTEIIKAETLADWYALWPEKFNNKTNGVTPRRWLRMI |
| | | NPGLSDLLTRLSGSDDWVTDLDELKKLRSYADDKSVLEELR |
| | | AIKAANKQDFAEWILERQGIEIDPESIFDVQIKRLHEYKRQLM |
| | | NALYVLDLYFRIKEDGLTDIPARTVIFGAKAAPGYVRAKAIIKL |
| | | INSIADLVNNDPEVSPLLKVVFVENYNVSPAEHILPASDVSE |
| | | QISTAGKEASGTSNMKFMMNGALTLGTMDGANVEIVDSVG |
| | | EENAYIFGARVEELPALRESYKPYELYETVPGLKRALDALDN |
| | | GTLNDNNSGLFYDLKHSLIHGYGKDASDTYYVLGDFADYRE |
| | | TRDRMAADYASDPLGWARMAWINICESGRFSSDRTIRDYA |
| | | TEIWKLEPTPAVKK |
| GP-M3 (GP | SEQ ID NO: | TLSEKIHHPITEQGGESDLSSFAPDAASITSSIKYHAELTPVF |
| F39L N135S | 24 | SPERFELPKAFFATAQSVRDSLLINWNATYDIYEKLNMKQAY |
| T7061) | | YLSMEFLQGRALLNAIGNLELTGAFAEALKNLGHNLENVAS |
| | | QEPDAALGSGGLGRLASCFLDSLATLNYPAWGYGLRYKYG |
| | | LFKQRITKDGQEEVAEDWLEIGSPWEVVRNDVSYPIKFYGK |
| | | VSTGSDGKRYWIGGEDIKAVAYDVPIPGYKTRTTISLRLWST |
| | | QVPSADFDLSAFNAGEHTKACEAQANAEKICYILYPGDESE |
| | | EGKILRLKQQYTLCSASLQDIISRFERRSGDRIKWEEFPEKV |
| | | AVQMNDTHPTLCIPELMRILIDLKGLNWNEAWNITQRTVAYT |
| | | NHTVLPEALEKWSYELMQKLLPRHVEIIEAIDEELVHEIVLKY |
| | | GSMDLNKLEEKLTTMRILENFDLPSSVAELFIKPEISVDDDTE |
| | | TVEVHDKVEASDKVVTNDEDDTGKKTSVKIEAAAEKDIDKKT |
| | | PVSPEPAVIPPKKVRMANLCVVGGHAVNGVAEIHSEIVKEEV |
| | | FNDFYELWPEKFQNKTNGVTPRRWIRFCNPPLSAIITKWTG |
| | | TEDWVLKTEKLAELQKFADNEDLQNEWREAKRSNKIKVVSF |
| | | LKEKTGYSVVPDAMFDIQVKRIHEYKRQLLNIFGIVYRYKKM |
| | | KEMTAAERKTNFVPRVCIFGGKAFATYVQAKRIVKFIIDVGA |
| | | TINHDPEIGDLLKVVFVPDYNVSVAELLIPASDLSEHISTAGM |
| | | EASGTSNMKFAMNGCIQIGTLDGANVEIREEVGEENFFLFG |
| | | AQAHEIAGLRKERADGKFVPDERFEEVKEFVRSGAFGSYN |
| | | YDDLIGSLEGNEGFGRADYFLVGKDFPSYIECQEKVDEAYR |
| | | DQKRWTTMSILNTAGSYKFSSDRTIHEYAKDIWNIEAVEIA |

In some cases, the alpha-glucan phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to wild-type Solanum tuberosum alpha-glucan phosphorylase. In some cases, the alpha-glucan phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 21. In some cases, the alpha-glucan phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to wild-type S. tokodaii strain 7 alpha-glucan phosphorylase. In some cases, the alpha-glucan phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 22. In some cases, the alpha-glucan phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to wild-type C. callunae DSM 20145 alpha-glucan phosphorylase. In some cases, the alpha-glucan phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 23. In some cases, the sucrose phosphorylase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 24, and comprises the amino acid substitutions F39L, N135S, and T7061, relative to SEQ ID NO: 21.

In some embodiments, the alpha-glucan phosphorylase is derived from a microbial cell. In some cases, the alpha-glucan phosphorylase is isolated and/or purified from a microbial cell. In some cases, the microbial cell is a bacterial cell. In some cases, the bacterial cell is Escherichia coli. In some embodiments, the alpha-glucan phosphorylase is derived from Solanum tuberosum. In some embodiments, the alpha-glucan phosphorylase is derived from S. tokodaii strain 7. In some embodiments, the alpha-glucan phosphorylase is derived from C. callunae DSM 20145. In some embodiments, the alpha-glucan phosphorylase may be produced within a microbial cell. In some embodiments, the alpha-glucan phosphorylase is expressed in a recombinant host cell (e.g., from a recombinant polynucleotide). In some cases, the alpha-glucan phosphorylase is recombinantly produced. In some cases, the alpha-glucan phosphorylase is produced (e.g., recombinantly produced) in a yeast cell. In some cases, the yeast cell is a Pichia yeast cell, such as a Pichia pastoris cell.

### Method Step (b) for Enzymatic Conversion of Amylose to Beta-Cyclodextrin

In various aspects, the methods further comprise enzymatically converting the amylose (e.g., produced by the methods (e.g. method step (a)) provided herein) to cyclodextrin, preferably beta-cyclodextrin. In some cases, the methods comprise contacting the amylose with an enzyme or an enzyme mixture (e.g., such as two or more enzymes) capable of converting amylose to cyclodextrin under conditions that permit the conversion of the amylose to cyclodextrin. In some cases, the enzyme capable of converting amylose to cyclodextrin is a variant enzyme capable of producing a greater amount and/or concentration of beta-cyclodextrin than alpha-cyclodextrin, gamma-cyclodextrin, or both, relative to a wild-type enzyme capable of converting amylose to cyclodextrin.

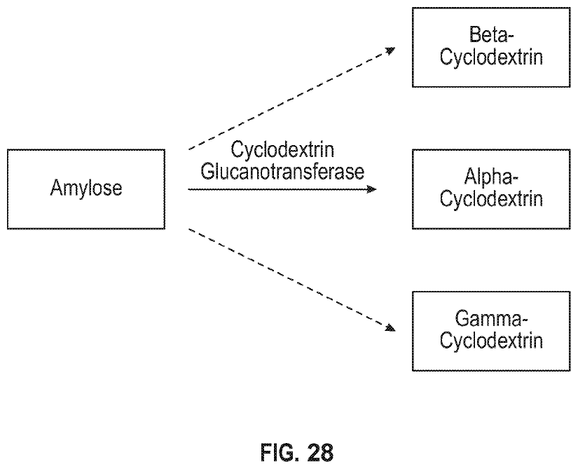

In some aspects, the enzyme capable of converting the amylose to cyclodextrin comprises a variant cyclodextrin glucanotransferase. In some cases, the variant cyclodextrin glucanotransferase comprises at least one amino acid variant relative to a wild-type cyclodextrin glucanotransferase. FIG. 28 depicts the enzymatic conversion of amylose to beta-cyclodextrin with cyclodextrin glucanotransferase. Preferably, the cyclodextrin glucanotransferase produces beta-cyclodextrin from amylose in an amount and/or concentration greater than an amount and/or concentration of alpha-cyclodextrin and/or gamma-cyclodextrin.

In some embodiments, the cyclodextrin glucanotransferase is a variant cyclodextrin glucanotransferase comprising at least one amino acid variant relative to a wild-type cyclodextrin glucanotransferase. The variant cyclodextrin glucanotransferase may comprise one or more amino acid substitutions, deletions, insertions, and/or modifications relative to a wild-type cyclodextrin glucanotransferase. In some cases, the variant cyclodextrin glucanotransferase is capable of producing a greater amount and/or concentration of beta-cyclodextrin relative to alpha-cyclodextrin and/or gamma-cyclodextrin from amylose relative to a wild-type cyclodextrin glucanotransferase.

In some cases, the variant cyclodextrin glucanotransferase comprises at least one amino acid variant relative to wild-type Bacillus sp. (strain no. 38-2) cyclodextrin glucanotransferase (e.g., NCBI Accession No. M19880.1; SEQ ID NO: 25). In some cases, the variant cyclodextrin glucanotransferase comprises at least one amino acid variant relative to wild-type B. circulans strain 251 cyclodextrin glucanotransferase (e.g., NCBI Accession No. X78145.1; SEQ ID NOs: 26 or 27). In some cases, the variant cyclodextrin glucanotransferase comprises at least one amino acid variant relative to wild-type B. circulans strain 251 cyclodextrin glucanotransferase of SEQ ID NO: 27. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 25. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOs: 26 or 27. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 27.

In some cases, the at least one amino acid variant comprises at least one amino acid substitution relative to a wild-type cyclodextrin glucanotransferase. In some cases, the at least one amino acid substitution comprises an amino acid substitution at amino acid position 31 relative to the amino acid sequence of SEQ ID NO: 27. In some cases, the amino acid substitution at amino acid position 31 relative to the amino acid sequence of SEQ ID NO: 27 is A31R (e.g., SEQ ID NO: 28 in Table 5). In some cases, the amino acid substitution at amino acid position 31 relative to the amino acid sequence of SEQ ID NO: 27 is A31P (e.g., SEQ ID NO: 29 in Table 5). In some cases, the amino acid substitution at amino acid position 31 relative to the amino acid sequence of SEQ ID NO: 27 is A31T (e.g., SEQ ID NO: 30 in Table 5). In some aspects, the cyclodextrin glucanotransferase comprises or consists of an amino acid sequence according to any one of SEQ ID NOS: 25-30, depicted in Table 5.

In some cases, the variant cyclodextrin glucanotransferase comprises at least one amino acid variant relative to wild-type Paenibacillus macerans cyclodextrin glucanotransferase (e.g., NCBI Accession No. AAA22298.1 or X59045.1; e.g., SEQ ID NOS: 31-34). In some cases, the variant cyclodextrin glucanotransferase comprises at least one amino acid variant relative to any one of SEQ ID NOS: 31-34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of wild-type Paenibacillus macerans cyclodextrin glucanotransferase. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of any one of SEQ ID NOS: 31-34.

In some cases, the at least one amino acid variant comprises at least one amino acid substitution relative to a wild-type cyclodextrin glucanotransferase. In some cases, the at least one amino acid substitution comprises an amino acid substitution at amino acid position 146 relative to the amino acid sequence of SEQ ID NO: 34. In some cases, the amino acid substitution at amino acid position 146 relative to the amino acid sequence of SEQ ID NO: 34 is R146A (e.g., SEQ ID NO: 35 in Table 5). In some cases, the amino acid substitution at amino acid position 146 relative to the amino acid sequence of SEQ ID NO: 34 is R146P (e.g., SEQ ID NO: 36 in Table 5). In some cases, the at least one amino acid substitution comprises an amino acid substitution at amino acid position 147 relative to the amino acid sequence of SEQ ID NO: 34. In some cases, the amino acid substitution at amino acid position 147 relative to the amino acid sequence of SEQ ID NO: 34 is D147A (e.g., SEQ ID NO: 37 in Table 5). In some cases, the amino acid substitution at amino acid position 147 relative to the amino acid sequence of SEQ ID NO: 34 is D147P (e.g., SEQ ID NO: 38 in Table 5). In some cases, the at least one amino acid substitution comprises an amino acid substitution at amino acid positions 146 and 147 relative to the amino acid sequence of SEQ ID NO: 34. In some cases, the amino acid substitution at amino acid position 146 relative to the amino acid sequence of SEQ ID NO: 34 is R146A, and the amino acid substitution at amino acid position 147 relative to the amino acid sequence of SEQ ID NO: 34 is D147P (e.g., SEQ ID NO: 39 in Table 5). In some cases, the amino acid substitution at amino acid position 146 relative to the amino acid sequence of SEQ ID NO: 34 is R146P, and the amino acid substitution at amino acid position 147 relative to the amino acid sequence of SEQ ID NO: 34 is D147A (e.g., SEQ ID NO: 40 in Table 5). In some cases, the amino acid substitution at amino acid position 146 relative to the amino acid sequence of SEQ ID NO: 34 is R146P, and the amino acid substitution at amino acid position 147 relative to the amino acid sequence of SEQ ID NO: 34 is D147P (e.g., SEQ ID NO: 41 in Table 5).

In some cases, the at least one amino acid substitution comprises an amino acid substitution at amino acid position 372 relative to the amino acid sequence of SEQ ID NO: 32 or SEQ ID NO: 34. In some cases, the amino acid substitution at amino acid position 372 relative to the amino acid sequence of SEQ ID NO: 32 or SEQ ID NO: 34 is D372K (e.g., SEQ ID NO: 42 (relative to SEQ ID NO: 32), and SEQ ID NO: 45 (relative to SEQ ID NO: 34), in Table 5). In some cases, the at least one amino acid substitution comprises an amino acid substitution at amino acid position 89 relative to the amino acid sequence of SEQ ID NO: 32 or SEQ ID NO: 34. In some cases, the amino acid substitution at amino acid position 89 relative to the amino acid sequence of SEQ ID NO: 32 or SEQ ID NO: 34 is Y89R (e.g., SEQ ID NO: 43 (relative to SEQ ID NO: 32), and SEQ ID NO: 47 (relative to SEQ ID NO: 34), in Table 5). In some cases, the at least one amino acid substitution comprises an amino acid substitution at amino acid position 372 relative to the amino acid sequence of SEQ ID NO: 32 or SEQ ID NO: 34, and an amino acid substitution at amino acid position 89 relative to the amino acid sequence of SEQ ID NO: 32 or SEQ ID NO: 34. In some cases, the amino acid substitution at amino acid position 372 relative to the amino acid sequence of SEQ ID NO: 32 or 34 is D372K, and the amino acid substitution at amino acid position 89 relative to the amino acid sequence of SEQ ID NO: 32 or 34 is Y89R (e.g., SEQ ID NO: 44 (relative to SEQ ID NO: 32), and SEQ ID NO: 47 (relative to SEQ ID NO: 34), in Table 5).

In some aspects, the cyclodextrin glucanotransferase comprises or consists of an amino acid sequence according to any one of SEQ ID NOS: 31-47, depicted in Table 5. In some aspects, the cyclodextrin glucanotransferase comprises or consists of an amino acid sequence having at least about 70% (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) sequence identity, preferably at least about 90% sequence identity, to the amino acid sequence of any one of SEQ ID NOS: 31-47, depicted in Table 5.

In a particular aspect, the cyclodextrin glucanotransferase comprises or consists of the amino acid sequence according to SEQ ID NO: 34, or comprises or consists of an amino acid sequence having at least about 70% (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) sequence identity, preferably at least about 90% sequence identity, to the amino acid sequence according to SEQ ID NO: 34.

In another particular aspect, the cyclodextrin glucanotransferase comprises or consists of the amino acid sequence according to SEQ ID NO: 39, or comprises or consists of an amino acid sequence having at least about 70% (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) sequence identity, preferably at least about 90% sequence identity, to the amino acid sequence according to SEQ ID NO: 39.

In another particular aspect, the cyclodextrin glucanotransferase comprises or consists of the amino acid sequence according to SEQ ID NO: 40, or comprises or consists of an amino acid sequence having at least about 70% (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) sequence identity, preferably at least about 90% sequence identity, to the amino acid sequence according to SEQ ID NO: 40.

In another particular aspect, the cyclodextrin glucanotransferase comprises or consists of the amino acid sequence according to SEQ ID NO: 41, or comprises or consists of an amino acid sequence having at least about 70% (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) sequence identity, preferably at least about 90% sequence identity, to the amino acid sequence according to SEQ ID NO: 41.

In another particular aspect, the cyclodextrin glucanotransferase comprises or consists of the amino acid sequence according to SEQ ID NO: 47, or comprises or consists of an amino acid sequence having at least about 70% (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater) sequence identity, preferably at least about 90% sequence identity, to the amino acid sequence according to SEQ ID NO: 47.

TABLE 5
Non-limiting examples of cyclodextrin glucanotransferase enzymes

| | SEQ ID NO: | Sequence (5′ to 3′) |
|---|---|---|
| Wild-type | SEQ ID NO: | MKRFMKLTAVWTLWLSLTLGLLSPVHAAPDTSVSNKQNFST |
| Bacillus sp. | 25 | DVIYQIFTDRFSDGNPANNPTGAAFDGSCTNLRLYCGGDW |
| (strain no. | | QGIINKINDGYLTGMGITAIWISQPVENIYSVINYSGVHNTAY |
| 38-2) | | HGYWARDFKKTNPAYGTMQDFKNLIDTAHAHNIKVIIDFAPN |
| cyclodextrin | | HTSPASSDDPSFAENGRLYDNGNLLGGYTNDTQNLFHHYG |
| glucanotrans- | | GTDFSTIENGIYKNLYDLADLNHNNSSVDVYLKDAIKMWLDL |
| ferase | | GVDGIRVDAVKHMPFGWQKSFMSTINNYKPVFNFGEWFLG |
| | | VNEISPEYHQFANESGMSLLDFPFAQKARQVFRDNTDNMY |
| | | GLKAMLEGSEVDYAQVNDQVTFIDNHDMERFHTSNGDRRK |
| | | LEQALAFTLTSRGVPAIYYGSEQYMSGGNDPDNRARIPSFS |
| | | TTTTAYQVIQKLAPLRKSNPAIAYGSTQERWINNDVIIYERKF |
| | | GNNVAVVAINRNMNTPASITGLVTSLPQGSYNDVLGGILNG |
| | | NTLTVGAGGAASNFTLAPGGTAVWQYTTDATAPINGNVGP |
| | | MMAKAGVTITIDGRASARQGTVYFGTTAVTGADIVAWEDTQ |
| | | IQVKILRVPGGIYDIRVANAAGAASNIYDNFEVLTGDQVTVRF |
| | | VINNATTALGQNVFLTGNVSELGNWDPNNAIGPMYNQVVY |
| | | QYPTWYYDVSVPAGQTIEFKFLKKQGSTVTWEGGANRTFT |
| | | TPTSGTATVNVNWQP |
| Wild-type B. | SEQ ID NO: | MKKFLKSTAALALGLSLTFGLFSPAQAAPDTSVSNKQNFST |
| circulans | 26 | DVIYQIFTDRFSDGNPANNPTGAAFDGTCTNLRLYCGGDW |
| strain 251 | | QGIINKINDGYLTGMGVTAIWISQPVENIYSIINYSGVNNTAY |
| cyclodextrin | | HGYWARDFKKTNPAYGTIADFQNLIAAAHAKNIKVIIDFAPNH |
| glucanotrans- | | TSPASSDQPSFAENGRLYDNGTLLGGYTNDTQNLFHHNGG |
| ferase | | TDFSTTENGIYKNLYDLADLNHNNSTVDVYLKDAIKMWLDL |
| | | GIDGIRMDAVKHMPFGWQKSFMAAVNNYKPVFTFGEWFLG |
| | | VNEVSPENHKFANESGMSLLDFRFAQKVRQVFRDNTDNMY |
| | | GLKAMLEGSAADYAQVDDQVTFIDNHDMERFHASNANRRK |
| | | LEQALAFTLTSRGVPAIYYGTEQYMSGGTDPDNRARIPSFS |
| | | TSTTAYQVIQKLAPLRKCNPAIAYGSTQERWINNDVLIYERK |
| | | FGSNVAVVAVNRNLNAPASISGLVTSLPQGSYNDVLGGLLN |
| | | GNTLSVGSGGAASNFTLAAGGTAVWQYTAATATPTIGHVG |
| | | PMMAKPGVTITIDGRGFGSSKGTVYFGTTAVSGADITSWED |
| | | TQIKVKIPAVAGGNYNIKVANAAGTASNVYDNFEVLSGDQV |
| | | SVRFVVNNATTALGQNVYLTGSVSELGNWDPAKAIGPMYN |
| | | QVVYQYPNWYYDVSVPAGKTIEFKFLKKQGSTVTWEGGSN |
| | | HTFTAPSSGTATINVNWQP |
| Wild-type B. | SEQ ID NO: | APDTSVSNKQNFSTDVIYQIFTDRFSDGNPANNPTGAAFDG |
| circulans | 27 | TCTNLRLYCGGDWQGIINKINDGYLTGMGVTAIWISQPVENI |
| strain 251 | | YSIINYSGVNNTAYHGYWARDFKKTNPAYGTIADFQNLIAAA |
| cyclodextrin | | HAKNIKVIIDFAPNHTSPASSDQPSFAENGRLYDNGTLLGGY |
| glucanotrans- | | TNDTQNLFHHNGGTDFSTTENGIYKNLYDLADLNHNNSTVD |
| ferase (mature | | VYLKDAIKMWLDLGIDGIRMDAVKHMPFGWQKSFMAAVNN |
| chain) | | YKPVFTFGEWFLGVNEVSPENHKFANESGMSLLDFRFAQK |
| | | VRQVFRDNTDNMYGLKAMLEGSAADYAQVDDQVTFIDNHD |
| | | MERFHASNANRRKLEQALAFTLTSRGVPAIYYGTEQYMSG |
| | | GTDPDNRARIPSFSTSTTAYQVIQKLAPLRKCNPAIAYGSTQ |
| | | ERWINNDVLIYERKFGSNVAVVAVNRNLNAPASISGLVTSLP |
| | | QGSYNDVLGGLLNGNTLSVGSGGAASNFTLAAGGTAVWQ |
| | | YTAATATPTIGHVGPMMAKPGVTITIDGRGFGSSKGTVYFG |
| | | TTAVSGADITSWEDTQIKVKIPAVAGGNYNIKVANAAGTASN |
| | | VYDNFEVLSGDQVSVRFVVNNATTALGQNVYLTGSVSELG |
| | | NWDPAKAIGPMYNQVVYQYPNWYYDVSVPAGKTIEFKFLK |
| | | KQGSTVTWEGGSNHTFTAPSSGTATINVNWQP |
| Cyclodextrin | SEQ ID NO: | APDTSVSNKQNFSTDVIYQIFTDRFSDGNPRNNPTGAAFDG |
| glucanotrans- | 28 | TCTNLRLYCGGDWQGIINKINDGYLTGMGVTAIWISQPVENI |
| ferase A31R | | YSIINYSGVNNTAYHGYWARDFKKTNPAYGTIADFQNLIAAA |
| | | HAKNIKVIIDFAPNHTSPASSDQPSFAENGRLYDNGTLLGGY |
| | | TNDTQNLFHHNGGTDFSTTENGIYKNLYDLADLNHNNSTVD |
| | | VYLKDAIKMWLDLGIDGIRMDAVKHMPFGWQKSFMAAVNN |
| | | YKPVFTFGEWFLGVNEVSPENHKFANESGMSLLDFRFAQK |
| | | VRQVFRDNTDNMYGLKAMLEGSAADYAQVDDQVTFIDNHD |
| | | MERFHASNANRRKLEQALAFTLTSRGVPAIYYGTEQYMSG |
| | | GTDPDNRARIPSFSTSTTAYQVIQKLAPLRKCNPAIAYGSTQ |
| | | ERWINNDVLIYERKFGSNVAVVAVNRNLNAPASISGLVTSLP |
| | | QGSYNDVLGGLLNGNTLSVGSGGAASNFTLAAGGTAVWQ |
| | | YTAATATPTIGHVGPMMAKPGVTITIDGRGFGSSKGTVYFG |
| | | TTAVSGADITSWEDTQIKVKIPAVAGGNYNIKVANAAGTASN |
| | | VYDNFEVLSGDQVSVRFVVNNATTALGQNVYLTGSVSELG |
| | | NWDPAKAIGPMYNQVVYQYPNWYYDVSVPAGKTIEFKFLK |
| | | KQGSTVTWEGGSNHTFTAPSSGTATINVNWQP |
| Cyclodextrin | SEQ ID NO: | APDTSVSNKQNFSTDVIYQIFTDRFSDGNPPNPTGAAFDGT |
| glucanotrans- | 29 | CTNLRLYCGGDWQGIINKINDGYLTGMGVTAIWISQPVENIY |
| ferase A31P | | SIINYSGVNNTAYHGYWARDFKKTNPAYGTIADFQNLIAAAH |
| | | AKNIKVIIDFAPNHTSPASSDQPSFAENGRLYDNGTLLGGYT |
| | | NDTQNLFHHNGGTDFSTTENGIYKNLYDLADLNHNNSTVDV |
| | | YLKDAIKMWLDLGIDGIRMDAVKHMPFGWQKSFMAAVNNY |
| | | KPVFTFGEWFLGVNEVSPENHKFANESGMSLLDFRFAQKV |
| | | RQVFRDNTDNMYGLKAMLEGSAADYAQVDDQVTFIDNHD |
| | | MERFHASNANRRKLEQALAFTLTSRGVPAIYYGTEQYMSG |
| | | GTDPDNRARIPSFSTSTTAYQVIQKLAPLRKCNPAIAYGSTQ |
| | | ERWINNDVLIYERKFGSNVAVVAVNRNLNAPASISGLVTSLP |
| | | QGSYNDVLGGLLNGNTLSVGSGGAASNFTLAAGGTAVWQ |
| | | YTAATATPTIGHVGPMMAKPGVTITIDGRGFGSSKGTVYFG |
| | | TTAVSGADITSWEDTQIKVKIPAVAGGNYNIKVANAAGTASN |
| | | VYDNFEVLSGDQVSVRFVVNNATTALGQNVYLTGSVSELG |
| | | NWDPAKAIGPMYNQVVYQYPNWYYDVSVPAGKTIEFKFLK |
| | | KQGSTVTWEGGSNHTFTAPSSGTATINVNWQP |
| Cyclodextrin | SEQ ID NO: | APDTSVSNKQNFSTDVIYQIFTDRFSDGNPTNPTGAAFDGT |
| glucanotrans- | 30 | CTNLRLYCGGDWQGIINKINDGYLTGMGVTAIWISQPVENIY |
| ferase A31T | | SIINYSGVNNTAYHGYWARDFKKTNPAYGTIADFQNLIAAAH |
| | | AKNIKVIIDFAPNHTSPASSDQPSFAENGRLYDNGTLLGGYT |
| | | NDTQNLFHHNGGTDFSTTENGIYKNLYDLADLNHNNSTVDV |
| | | YLKDAIKMWLDLGIDGIRMDAVKHMPFGWQKSFMAAVNNY |
| | | KPVFTFGEWFLGVNEVSPENHKFANESGMSLLDFRFAQKV |
| | | RQVFRDNTDNMYGLKAMLEGSAADYAQVDDQVTFIDNHD |
| | | MERFHASNANRRKLEQALAFTLTSRGVPAIYYGTEQYMSG |
| | | GTDPDNRARIPSFSTSTTAYQVIQKLAPLRKCNPAIAYGSTQ |
| | | ERWINNDVLIYERKFGSNVAVVAVNRNLNAPASISGLVTSLP |
| | | QGSYNDVLGGLLNGNTLSVGSGGAASNFTLAAGGTAVWQ |
| | | YTAATATPTIGHVGPMMAKPGVTITIDGRGFGSSKGTVYFG |
| | | TTAVSGADITSWEDTQIKVKIPAVAGGNYNIKVANAAGTASN |
| | | VYDNFEVLSGDQVSVRFVVNNATTALGQNVYLTGSVSELG |
| | | NWDPAKAIGPMYNQVVYQYPNWYYDVSVPAGKTIEFKFLK |
| | | KQGSTVTWEGGSNHTFTAPSSGTATINVNWQP |
| Wild-type | SEQ ID NO: | MKSRYKRLTSLALSLSMALGISLPAWASPDTSVDNKVNFST |
| Paenibacillus | 31 | DVIYQIVTDRFADGDRTNNPAGDAFSGDRSNLKLYFGGDW |
| macerans | | QGIIDKINDGYLTGMGVTALWISQPVENITSVIKYSGVNNTSY |
| cyclodextrin | | HGYWARDFKQTNDAFGDFADFQNLIDTLTLITSRSDRLRPQ |
| glucanotrans- | | PHVSGRAGTNPGFAENGALYDNGSLLGAYSNDTAGLFHHN |
| ferase | | GGTDFSTIEDGIYKNLYDLADINHNNNAMDAYFKSAIDLWLG |
| (PMcgt1) | | MGVDGIRFDAVKQYPFGWQKSFVSSIYGGDHPVFTFGEWY |
| | | LGADQTDGDNIKFANESGMNLLDFEYAQEVREVFRDKTET |
| | | MKDLYEVLASTESQYDYINNMVTFIDNHDMDRFQVAGSGT |
| | | RATEQALALTLTSRGVPAIYYGTEQYMTGDGDPNNRAMMT |
| | | SFNTGTTAYKVIQALAPLRKSNPAIAYGTTTERWVNNDVLIIE |
| | | RKFGSSAALVAINRNSSAAYPISGLLSSLPAGTYSDVLNGLL |
| | | NGNSITVGSGGAVTNFTLAAGGTAVWQYTAPETSPAIGNVG |
| | | PTMGQPGNIVTIDGRGFGGTAGTVYFGTTAVTGSGIVSWED |
| | | TQIKAVIPKVAAGKTGVSVKTSSGTASNTFKSFNVLTGDQVT |
| | | VRFLVNQANTNYGTNVYLVGNAAELGTWDPNKAIGPMYNQ |
| | | VIAKYPSWYYDVSVPAGTKLDFKFIKKGGGTVTWEGGGNH |
| | | TYTTPASGVGTVTVDWQN |
| Wild-type | SEQ ID NO: | SPDTSVDNKVNFSTDVIYQIVTDRFADGDRTNNPAGDAFSG |
| Paenibacillus | 32 | DRSNLKLYFGGDWQGIIDKINDGYLTGMGVTALWISQPVENI |
| macerans | | TSVIKYSGVNNTSYHGYWARDFKQTNDAFGDFADFQNLIDT |
| cyclodextrin | | LTLITSRSDRLRPQPHVSGRAGTNPGFAENGALYDNGSLLG |
| glucanotrans- | | AYSNDTAGLFHHNGGTDFSTIEDGIYKNLYDLADINHNNNA |
| ferase | | MDAYFKSAIDLWLGMGVDGIRFDAVKQYPFGWQKSFVSSIY |
| (PMcgt1) | | GGDHPVFTFGEWYLGADQTDGDNIKFANESGMNLLDFEYA |
| mature chain | | QEVREVFRDKTETMKDLYEVLASTESQYDYINNMVTFIDNH |
| | | DMDRFQVAGSGTRATEQALALTLTSRGVPAIYYGTEQYMT |
| | | GDGDPNNRAMMTSFNTGTTAYKVIQALAPLRKSNPAIAYGT |
| | | TTERWVNNDVLIIERKFGSSAALVAINRNSSAAYPISGLLSSL |
| | | PAGTYSDVLNGLLNGNSITVGSGGAVTNFTLAAGGTAVWQ |
| | | YTAPETSPAIGNVGPTMGQPGNIVTIDGRGFGGTAGTVYFG |
| | | TTAVTGSGIVSWEDTQIKAVIPKVAAGKTGVSVKTSSGTASN |
| | | TFKSFNVLTGDQVTVRFLVNQANTNYGTNVYLVGNAAELGT |
| | | WDPNKAIGPMYNQVIAKYPSWYYDVSVPAGTKLDFKFIKKG |
| | | GGTVTWEGGGNHTYTTPASGVGTVTVDWQN |
| Wild-type | SEQ ID NO: | MKSRYKRLTSLALSLSMALGISLPAWASPDTSVDNKVNFST |
| Paenibacillus | 33 | DVIYQIVTDRFADGDRTNNPAGDAFSGDRSNLKLYFGGDW |
| macerans | | QGIIDKINDGYLTGMGVTALWISQPVENITSVIKYSGVNNTSY |
| cyclodextrin | | HGYWARDFKQTNDAFGDFADFQNLIDTAHAHNIKVVIDFAP |
| glucanotrans- | | NHTSPADRDNPGFAENGGMYDNGSLLGAYSNDTAGLFHH |
| ferase | | NGGTDFSTIEDGIYKNLYDLADINHNNNAMDAYFKSAIDLWL |
| (PMcgt2) | | GMGVDGIRFDAVKHMPFGWQKSFVSSIYGGDHPVFTFGE |
| | | WYLGADQTDGDNIKFANESGMNLLDFEYAQEVREVFRDKT |
| | | ETMKDLYEVLASTESQYDYINNMVTFIDNHDMDRFQVAGSG |
| | | TRATEQALALTLTSRGVPAIYYGTEQYMTGDGDPNNRAMM |
| | | TSFNTGTTAYKVIQALAPLRKSNPAIAYGTTTERWVNNDVLII |
| | | ERKFGSSAALVAINRNSSAAYPISGLLSSLPAGTYSDVLNGL |
| | | LNGNSITVGSGGAVTNFTLAAGGTAVWQYTAPETSPAIGNV |
| | | GPTMGQPGNIVTIDGRGFGGTAGTVYFGTTAVTGSGIVSW |
| | | EDTQIKAVIPKVAAGKTGVSVKTSSGTASNTFKSFNVLTGDQ |
| | | VTVRFLVNQANTNYGTNVYLVGNAAELGSWDPNKAIGPMY |
| | | NQVIAKYPSWYYDVSVPAGTKLDFKFIKKGGGTVTWEGGG |
| | | NHTYTTPASGVGTVTVDWQN |
| Wild-type | SEQ ID NO: | SPDTSVDNKVNFSTDVIYQIVTDRFADGDRTNNPAGDAFSG |
| Paenibacillus | 34 | DRSNLKLYFGGDWQGIIDKINDGYLTGMGVTALWISQPVENI |
| macerans | | TSVIKYSGVNNTSYHGYWARDFKQTNDAFGDFADFQNLIDT |
| cyclodextrin | | AHAHNIKVVIDFAPNHTSPADRDNPGFAENGGMYDNGSLL |
| glucanotrans- | | GAYSNDTAGLFHHNGGTDFSTIEDGIYKNLYDLADINHNNN |
| ferase | | AMDAYFKSAIDLWLGMGVDGIRFDAVKHMPFGWQKSFVSS |
| (PMcgt2) | | IYGGDHPVFTFGEWYLGADQTDGDNIKFANESGMNLLDFE |
| mature | | YAQEVREVFRDKTETMKDLYEVLASTESQYDYINNMVTFID |
| protein | | NHDMDRFQVAGSGTRATEQALALTLTSRGVPAIYYGTEQY |
| | | MTGDGDPNNRAMMTSFNTGTTAYKVIQALAPLRKSNPAIAY |
| | | GTTTERWVNNDVLIIERKFGSSAALVAINRNSSAAYPISGLLS |
| | | SLPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| R146A | 35 | DRSNLKLYFGGDWQGIIDKINDGYLTGMGVTALWISQPVENI |
| | | TSVIKYSGVNNTSYHGYWARDFKQTNDAFGDFADFQNLIDT |
| | | AHAHNIKVVIDFAPNHTSPADADNPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| R146P | 36 | DRSNLKLYFGGDWQGIIDKINDGYLTGMGVTALWISQPVENI |
| | | TSVIKYSGVNNTSYHGYWARDFKQTNDAFGDFADFQNLIDT |
| | | AHAHNIKVVIDFAPNHTSPADPDNPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| D147A | 37 | DRSNLKLYFGGDWQGIIDKINDGYLTGMGVTALWISQPVENI |
| | | TSVIKYSGVNNTSYHGYWARDFKQTNDAFGDFADFQNLIDT |
| | | AHAHNIKVVIDFAPNHTSPADRANPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| D147P | 38 | DRSNLKLYFGGDWQGIIDKINDGYLTGMGVTALWISQPVENI |
| | | TSVIKYSGVNNTSYHGYWARDFKQTNDAFGDFADFQNLIDT |
| | | AHAHNIKVVIDFAPNHTSPADRPNPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| R146A D147P | 39 | DRSNLKLYFGGDWQGIIDKINDGYLTGMGVTALWISQPVENI |
| | | TSVIKYSGVNNTSYHGYWARDFKQTNDAFGDFADFQNLIDT |
| | | AHAHNIKVVIDFAPNHTSPADAPNPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| R146P | 40 | DRSNLKLYFGGDWQGIIDKINDGYLTGMGVTALWISQPVENI |
| D147A | | TSVIKYSGVNNTSYHGYWARDFKQTNDAFGDFADFQNLIDT |
| | | AHAHNIKVVIDFAPNHTSPADPANPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| R146P | 41 | DRSNLKLYFGGDWQGIIDKINDGYLTGMGVTALWISQPVENI |
| D147P | | TSVIKYSGVNNTSYHGYWARDFKQTNDAFGDFADFQNLIDT |
| | | AHAHNIKVVIDFAPNHTSPADPPNPGFAENGGMYDNGSLLG |
| | | AYSNDTAGLFHHNGGTDFSTIEDGIYKNLYDLADINHNNNA |
| | | MDAYFKSAIDLWLGMGVDGIRFDAVKHMPFGWQKSFVSSI |
| | | YGGDHPVFTFGEWYLGADQTDGDNIKFANESGMNLLDFEY |
| | | AQEVREVFRDKTETMKDLYEVLASTESQYDYINNMVTFIDN |
| | | HDMDRFQVAGSGTRATEQALALTLTSRGVPAIYYGTEQYM |
| | | TGDGDPNNRAMMTSFNTGTTAYKVIQALAPLRKSNPAIAYG |
| | | TTTERWVNNDVLIIERKFGSSAALVAINRNSSAAYPISGLLSS |
| | | LPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt1 | SEQ ID NO: | SPDTSVDNKVNFSTDVIYQIVTDRFADGDRTNNPAGDAFSG |
| D372K | 42 | DRSNLKLYFGGDWQGIIDKINDGYLTGMGVTALWISQPVENI |
| | | TSVIKYSGVNNTSYHGYWARDFKQTNDAFGDFADFQNLIDT |
| | | LTLITSRSDRLRPQPHVSGRAGTNPGFAENGALYDNGSLLG |
| | | AYSNDTAGLFHHNGGTDFSTIEDGIYKNLYDLADINHNNNA |
| | | MDAYFKSAIDLWLGMGVDGIRFDAVKQYPFGWQKSFVSSIY |
| | | GGDHPVFTFGEWYLGADQTDGDNIKFANESGMNLLDFEYA |
| | | QEVREVFRDKTETMKDLYEVLASTESQYDYINNMVTFIDNH |
| | | DMDRFQVAGSGTRATEQALALTLTSRGVPAIYYGTEQYMT |
| | | GDGKPNNRAMMTSFNTGTTAYKVIQALAPLRKSNPAIAYGT |
| | | TTERWVNNDVLIIERKFGSSAALVAINRNSSAAYPISGLLSSL |
| | | PAGTYSDVLNGLLNGNSITVGSGGAVTNFTLAAGGTAVWQ |
| | | YTAPETSPAIGNVGPTMGQPGNIVTIDGRGFGGTAGTVYFG |
| | | TTAVTGSGIVSWEDTQIKAVIPKVAAGKTGVSVKTSSGTASN |
| | | TFKSFNVLTGDQVTVRFLVNQANTNYGTNVYLVGNAAELGT |
| | | WDPNKAIGPMYNQVIAKYPSWYYDVSVPAGTKLDFKFIKKG |
| | | GGTVTWEGGGNHTYTTPASGVGTVTVDWQN |
| PMcgt1 Y89R | SEQ ID NO: | SPDTSVDNKVNFSTDVIYQIVTDRFADGDRTNNPAGDAFSG |
| | 43 | DRSNLKLYFGGDWQGIIDKINDGYLTGMGVTALWISQPVENI |
| | | TSVIKRSGVNNTSYHGYWARDFKQTNDAFGDFADFQNLIDT |
| | | LTLITSRSDRLRPQPHVSGRAGTNPGFAENGALYDNGSLLG |
| | | AYSNDTAGLFHHNGGTDFSTIEDGIYKNLYDLADINHNNNA |
| | | MDAYFKSAIDLWLGMGVDGIRFDAVKQYPFGWQKSFVSSIY |
| | | GGDHPVFTFGEWYLGADQTDGDNIKFANESGMNLLDFEYA |
| | | QEVREVFRDKTETMKDLYEVLASTESQYDYINNMVTFIDNH |
| | | DMDRFQVAGSGTRATEQALALTLTSRGVPAIYYGTEQYMT |
| | | GDGDPNNRAMMTSFNTGTTAYKVIQALAPLRKSNPAIAYGT |
| | | TTERWVNNDVLIIERKFGSSAALVAINRNSSAAYPISGLLSSL |
| | | PAGTYSDVLNGLLNGNSITVGSGGAVTNFTLAAGGTAVWQ |
| | | YTAPETSPAIGNVGPTMGQPGNIVTIDGRGFGGTAGTVYFG |
| | | TTAVTGSGIVSWEDTQIKAVIPKVAAGKTGVSVKTSSGTASN |
| | | TFKSFNVLTGDQVTVRFLVNQANTNYGTNVYLVGNAAELGT |
| | | WDPNKAIGPMYNQVIAKYPSWYYDVSVPAGTKLDFKFIKKG |
| | | GGTVTWEGGGNHTYTTPASGVGTVTVDWQN |
| PMcgt1 | SEQ ID NO: | SPDTSVDNKVNFSTDVIYQIVTDRFADGDRTNNPAGDAFSG |
| D372K Y89R | 44 | DRSNLKLYFGGDWQGIIDKINDGYLTGMGVTALWISQPVENI |
| | | TSVIKRSGVNNTSYHGYWARDFKQTNDAFGDFADFQNLIDT |
| | | LTLITSRSDRLRPQPHVSGRAGTNPGFAENGALYDNGSLLG |
| | | AYSNDTAGLFHHNGGTDFSTIEDGIYKNLYDLADINHNNNA |
| | | MDAYFKSAIDLWLGMGVDGIRFDAVKQYPFGWQKSFVSSIY |
| | | GGDHPVFTFGEWYLGADQTDGDNIKFANESGMNLLDFEYA |
| | | QEVREVFRDKTETMKDLYEVLASTESQYDYINNMVTFIDNH |
| | | DMDRFQVAGSGTRATEQALALTLTSRGVPAIYYGTEQYMT |
| | | GDGKPNNRAMMTSFNTGTTAYKVIQALAPLRKSNPAIAYGT |
| | | TTERWVNNDVLIIERKFGSSAALVAINRNSSAAYPISGLLSSL |
| | | PAGTYSDVLNGLLNGNSITVGSGGAVTNFTLAAGGTAVWQ |
| | | YTAPETSPAIGNVGPTMGQPGNIVTIDGRGFGGTAGTVYFG |
| | | TTAVTGSGIVSWEDTQIKAVIPKVAAGKTGVSVKTSSGTASN |
| | | TFKSFNVLTGDQVTVRFLVNQANTNYGTNVYLVGNAAELGT |
| | | WDPNKAIGPMYNQVIAKYPSWYYDVSVPAGTKLDFKFIKKG |
| | | GGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| D372K | 45 | DRSNLKLYFGGDWQGIIDKINDGYLTGMGVTALWISQPVENI |
| | | TSVIKYSGVNNTSYHGYWARDFKQTNDAFGDFADFQNLIDT |
| | | AHAHNIKVVIDFAPNHTSPADRDNPGFAENGGMYDNGSLL |
| | | GAYSNDTAGLFHHNGGTDFSTIEDGIYKNLYDLADINHNNN |
| | | AMDAYFKSAIDLWLGMGVDGIRFDAVKHMPFGWQKSFVSS |
| | | IYGGDHPVFTFGEWYLGADQTDGDNIKFANESGMNLLDFE |
| | | YAQEVREVFRDKTETMKDLYEVLASTESQYDYINNMVTFID |
| | | NHDMDRFQVAGSGTRATEQALALTLTSRGVPAIYYGTEQY |
| | | MTGDGKPNNRAMMTSFNTGTTAYKVIQALAPLRKSNPAIAY |
| | | GTTTERWVNNDVLIIERKFGSSAALVAINRNSSAAYPISGLLS |
| | | SLPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 Y89R | SEQ ID NO: | SPDTSVDNKVNFSTDVIYQIVTDRFADGDRTNNPAGDAFSG |
| | 46 | DRSNLKLYFGGDWQGIIDKINDGYLTGMGVTALWISQPVENI |
| | | TSVIKRSGVNNTSYHGYWARDFKQTNDAFGDFADFQNLIDT |
| | | AHAHNIKVVIDFAPNHTSPADRDNPGFAENGGMYDNGSLL |
| | | GAYSNDTAGLFHHNGGTDFSTIEDGIYKNLYDLADINHNNN |
| | | AMDAYFKSAIDLWLGMGVDGIRFDAVKHMPFGWQKSFVSS |
| | | IYGGDHPVFTFGEWYLGADQTDGDNIKFANESGMNLLDFE |
| | | YAQEVREVFRDKTETMKDLYEVLASTESQYDYINNMVTFID |
| | | NHDMDRFQVAGSGTRATEQALALTLTSRGVPAIYYGTEQY |
| | | MTGDGDPNNRAMMTSFNTGTTAYKVIQALAPLRKSNPAIAY |
| | | GTTTERWVNNDVLIIERKFGSSAALVAINRNSSAAYPISGLLS |
| | | SLPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |
| PMcgt2 | SEQ ID NO: | SPDTSVDNKVNFSTDVIYQIVTDRFADGDRTNNPAGDAFSG |
| D372K Y89R | 47 | DRSNLKLYFGGDWQGIIDKINDGYLTGMGVTALWISQPVENI |
| | | TSVIKRSGVNNTSYHGYWARDFKQTNDAFGDFADFQNLIDT |
| | | AHAHNIKVVIDFAPNHTSPADRDNPGFAENGGMYDNGSLL |
| | | GAYSNDTAGLFHHNGGTDFSTIEDGIYKNLYDLADINHNNN |
| | | AMDAYFKSAIDLWLGMGVDGIRFDAVKHMPFGWQKSFVSS |
| | | IYGGDHPVFTFGEWYLGADQTDGDNIKFANESGMNLLDFE |
| | | YAQEVREVFRDKTETMKDLYEVLASTESQYDYINNMVTFID |
| | | NHDMDRFQVAGSGTRATEQALALTLTSRGVPAIYYGTEQY |
| | | MTGDGKPNNRAMMTSFNTGTTAYKVIQALAPLRKSNPAIAY |
| | | GTTTERWVNNDVLIIERKFGSSAALVAINRNSSAAYPISGLLS |
| | | SLPAGTYSDVLNGLLNGNSITVGSGGAVTNFTLAAGGTAVW |
| | | QYTAPETSPAIGNVGPTMGQPGNIVTIDGRGFGGTAGTVYF |
| | | GTTAVTGSGIVSWEDTQIKAVIPKVAAGKTGVSVKTSSGTAS |
| | | NTFKSFNVLTGDQVTVRFLVNQANTNYGTNVYLVGNAAEL |
| | | GSWDPNKAIGPMYNQVIAKYPSWYYDVSVPAGTKLDFKFIK |
| | | KGGGTVTWEGGGNHTYTTPASGVGTVTVDWQN |

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 25. In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 26 or 27.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 27, and an amino acid substitution at amino acid position 31 relative to SEQ ID NO: 27. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 27, and the amino acid substitution A31R relative to SEQ ID NO: 27. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 27, and the amino acid substitution A31P relative to SEQ ID NO: 27. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 27, and the amino acid substitution A31T relative to SEQ ID NO: 27.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, and an amino acid substitution at amino acid position 146 relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, and the amino acid substitution R146A relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, and the amino acid substitution R146P relative to SEQ ID NO: 34.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, and an amino acid substitution at amino acid position 147 relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, and the amino acid substitution D147P relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, and the amino acid substitution D147A relative to SEQ ID NO: 34.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, an amino acid substitution at amino acid position 146 relative to SEQ ID NO: 34, and an amino acid substitution at amino acid position 147 relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, the amino acid substitution R146A relative to SEQ ID NO: 34, and the amino acid substitution D147P relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, the amino acid substitution R146P relative to SEQ ID NO: 34, and the amino acid substitution D147A relative to SEQ ID NO: 34. In some cases, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NO: 34, the amino acid substitution R146P relative to SEQ ID NO: 34, and the amino acid substitution D147P relative to SEQ ID NO: 34.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 32 or 34, and an amino acid substitution at amino acid position 372 relative to SEQ ID NOS: 32 or 34. In some cases, the variant cyclodextrin glucanotransferase comprises or consists of an amino acid sequence having at least about 70% sequence (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 32 or 34, and the amino acid substitution D372K relative to SEQ ID NOS: 32 or 34.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 32 or 34, and an amino acid substitution at amino acid position 89 relative to SEQ ID NOS: 32 or 34. In some cases, the variant cyclodextrin glucanotransferase comprises or consists of an amino acid sequence having at least about 70% sequence (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 32 or 34, and the amino acid substitution Y89R relative to SEQ ID NOS: 32 or 34.

In some aspects, the variant cyclodextrin glucanotransferase comprises or consists of an amino acid sequence having at least about 70% sequence identity (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 32 or 34, an amino acid substitution at amino acid position 372 relative to SEQ ID NOS: 32 or 34, and an amino acid substitution at amino acid position 89 relative to SEQ ID NOS: 32 or 34. In some cases, the variant cyclodextrin glucanotransferase comprises or consists of an amino acid sequence having at least about 70% sequence (e.g., at least about 75%, at least about 80%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, or greater), preferably at least about 90% sequence identity, to the amino acid sequence of SEQ ID NOS: 32 or 34, the amino acid substitution D372K relative to SEQ ID NOS: 32 or 34, and the amino acid substitution Y89R relative to SEQ ID NOS: 32 or 34.

In some embodiments, the cyclodextrin glucanotransferase is derived from a microbial cell. In some cases, the cyclodextrin glucanotransferase is isolated and/or purified from a microbial cell. In some cases, the microbial cell is a bacterial cell. In some cases, the bacterial cell is Escherichia coli. In some embodiments, the cyclodextrin glucanotransferase is derived from Bacillus sp. (strain no. 38-2). In some embodiments, the cyclodextrin glucanotransferase is derived from B. circulans strain 251. In some embodiments, the cyclodextrin glucanotransferase may be produced within a microbial cell. In some embodiments, the cyclodextrin glucanotransferase is expressed in a recombinant host cell (e.g., from a recombinant polynucleotide). In some cases, the cyclodextrin glucanotransferase is recombinantly produced. In some cases, the cyclodextrin glucanotransferase is produced (e.g., recombinantly produced) in a yeast cell. In some cases, the yeast cell is a Pichia yeast cell, such as a Pichia pastoris cell.

In various aspects, the methods provided herein produce a higher ratio of beta-cyclodextrin to alpha-cyclodextrin, gamma-cyclodextrin, or both. For example, in some cases, the methods provided herein provide ratios of beta-cyclodextrin to alpha-cyclodextrin, gamma-cyclodextrin, or both, of at least 2:1, at least 3:1, at least 4:1, at least 5:1, at least 6:1, at least 7:1, at least 8:1, at least 9:1, at least 10:1, at least 20:1, at least 30:1, at least 40:1, at least 50:1, at least 60:1, at least 70:1, at least 80:1, at least 90:1, at least 100:1, or greater. In a preferred embodiment, the methods provided herein provide ratios of beta-cyclodextrin to alpha-cyclodextrin of at least 10:1. For example, the ratios may be at least 20:1, at least 30:1, at least 40:1, at least 50:1, at least 60:1, at least 70:1, at least 80:1, at least 90:1, at least 100:1, or greater. In a preferred embodiment, the methods provided herein provide ratios of beta-cyclodextrin to gamma-cyclodextrin of at least 5:1. For example, the ratios may be at least 10:1, at least 20:1, at least 30:1, at least 40:1, at least 50:1, at least 60:1, at least 70:1, at least 80:1, at least 90:1, at least 100:1, or greater. In a preferred embodiment, the methods provided herein provide ratios of beta-cyclodextrin to both alpha- and gamma-cyclodextrin of at least 3.5:1. For example, the ratios may be at least 5:1, at least 10:1, at least 20:1, at least 30:1, at least 40:1, at least 50:1, at least 60:1, at least 70:1, at least 80:1, at least 90:1, at least 100:1, or greater.

Methods are outlined throughout the disclosure for attaining robust enzyme activity in each step to obtain higher yields of beta-cyclodextrin than is currently achievable. In some embodiments, the first enzymatic step of converting sucrose to amylose (e.g., as described herein) is carried out for a first time period, thereby enabling catalytic conversion of sucrose to amylose, followed by the second enzymatic step of converting the amylose to beta-cyclodextrin (e.g., as described herein), which is carried out for a second time period, thereby enabling catalytic conversion of amylose to beta-cyclodextrin. In some embodiments, the first enzymatic reaction (e.g., converting sucrose to amylose, e.g., as described herein) and the second enzymatic reaction (e.g., converting amylose to beta-cyclodextrin, e.g., as described herein) are carried out in the same reservoir (e.g., one-pot synthesis method).

In some embodiments, the first time period is at least 30 minutes, at least 45 minutes, at least 60 minutes, at least 85 minutes, at least 90 minutes, at least 105 minutes, at least 120 minutes, at least 135 minutes, at least 150 minutes, at least 165 minutes, at least 180 minutes, at least 195 minutes, at least 210 minutes, at least 225 minutes, at least 240 minutes, at least 255 minutes, at least 270 minutes, at least 285 minutes, or at least 300 minutes. In some embodiments, the second time period is at least 30 minutes, at least 45 minutes, at least 60 minutes, at least 85 minutes, at least 90 minutes, at least 105 minutes, at least 120 minutes, at least 135 minutes, at least 150 minutes, at least 165 minutes, at least 180 minutes, at least 195 minutes, at least 210 minutes, at least 225 minutes, at least 240 minutes, at least 255 minutes, at least 270 minutes, at least 285 minutes, or at least 300 minutes. In some embodiments, the first time period is shorter than the second time period. In some embodiments, the first time period is longer than the second time period. In some embodiments, the first time period is the same or substantially the same length as the second time period. In some embodiments, sucrose is added to the reaction reservoir in batches. In some embodiments, the enzymes used in the first enzymatic reaction step (e.g., to convert sucrose to amylose, e.g., as described herein) are added once at the beginning of the reaction period and then again after a period of time has elapsed to expedite the catalytic activity. In some embodiments, sucrose is added once at the beginning of the reaction period and then again after a period of time has elapsed to replenish the sucrose. In some embodiments, the enzymes involved in the first enzymatic reaction step (e.g., to convert sucrose to amylose, e.g., as described herein) are added at the same time as the enzymes involved in the second enzymatic reaction step (e.g., to convert amylose to beta-cyclodextrin) in the same reaction reservoir. In some embodiments, the enzymes involved in the first enzymatic reaction step (e.g., to convert sucrose to amylose, e.g., as described herein) are added at a different time than (e.g., before) the enzymes involved in the second enzymatic reaction step (e.g., to convert amylose to beta-cyclodextrin).

In some embodiments, the sucrose concentration is maximized for highly efficient conversion to amylose. In some embodiments, the starting concentration of sucrose in the reaction is at least about 50 g/L. In some embodiments, the starting concentration of sucrose in the reaction is at least about 100 g/L. In some embodiments, the starting concentration of sucrose in the reaction is at least about 150 g/L. In some embodiments, the starting concentration of sucrose in the reaction is at least about 200 g/L. In some embodiments, the starting concentration of sucrose in the reaction is at least about 250 g/L. In some embodiments, the starting concentration of sucrose in the reaction is at least about 300 g/L. In some embodiments, the starting concentration of sucrose in the reaction is at least about 350 g/L.

In some embodiments, the reaction time is an important consideration for obtaining maximum yield of beta-cyclodextrin. In some embodiments, production of beta-cyclodextrin may be accompanied by breakdown of the product to glucose, maltose, and other sugars. It is therefore important to obtain beta-cyclodextrin without allowing its breakdown. In some embodiments, the total (e.g., method step (a) and method step (b)) reaction is carried out for no more than 12 hours. In some embodiments, the total (e.g., method step (a) and method step (b)) reaction is carried out for no more than 8 hours. In some embodiments, the total reaction is carried out for no more than 7 hours. In some embodiments, the total reaction is carried out for no more than 6 hours. In some embodiments, the total reaction is carried out for no more than 5 hours. In some embodiments, the total reaction is carried out for no more than 4 hours. In some embodiments, the total reaction is carried out for no more than 3 hours. In some embodiments, the total reaction is carried out for no more than 2 hours. In some embodiments, the total reaction is carried out for no more than 1 hour.

Temperature is an important consideration for maximizing the yield of beta-cyclodextrin. In some embodiments, one or more of the enzymatic reactions is carried out at from about 30° C. to about 55° C., such as from about 40° C. to about 50° C. In some embodiments, one or more of the enzymatic reactions is carried out at about 40° C. In some embodiments, one or more of the enzymatic reactions is carried out at about 41° C. In some embodiments, one or more of the enzymatic reactions is carried out at about 42° C. In some embodiments, one or more of the enzymatic reactions is carried out at about 43° C. In some embodiments, one or more of the enzymatic reactions is carried out at about 44° C. In some embodiments, one or more of the enzymatic reactions is carried out at about 45° C. In some embodiments, one or more of the enzymatic reactions is carried out at about 46° C. In some embodiments, one or more of the enzymatic reactions is carried out at about 47° C. In some embodiments, one or more of the enzymatic reactions is carried out at about 48° C. In some embodiments, one or more of the enzymatic reactions is carried out at about 49° C. In some embodiments, one or more of the enzymatic reactions is carried out at about 50° C. Preferably, one or more of the reactions is carried out at about 45° C.

In some embodiments, the enzymatic reaction of step (a) is carried out at from about 40° C. to about 55° C., such as from about 45° C. to about 50° C. In some embodiments, the enzymatic reaction of step (b) is carried out at from about 40° C. to about 50° C. Step (a) and step (b) may be carried out at different temperatures, or preferably step (a) and step (b) are carried out at about the same temperature. Where step (a) involves the use of a single enzyme (e.g. amylosucrase), the enzymatic reaction of step (a) is preferably carried out at about 45° C. In this embodiment, the enzymatic reaction of step (b) is preferably also carried out at about 45° C. Where step (a) involves the use of at least two enzymes (e.g., sucrose phosphorylase and alpha-glucan phosphorylase), the enzymatic reaction of step (a) is preferably carried out at about 45° C. or at about 50° C. In this embodiment, the enzymatic reaction of step (b) is preferably also carried out at about 45° C. or at about 50° C. respectively.

In a one-pot synthesis, it is taken into consideration that the enzyme mixture(s) should be maximally functional even though the optimum temperature for each enzyme may be slightly different.

In some embodiments, the reaction is carried out in a reservoir having a reservoir volume of from about 1 mL to about 1,000,000 L. For example, the reaction may be carried out in a reservoir having a reservoir volume of from about 100 mL to about 10 L, such as a reservoir volume of about 500 mL or about 10 L.

In some embodiments, the total reaction volume is from about 1 mL to about 1,000,000 L. For example, the total reaction volume may be from about 100 mL to about 10 L, such as a total reaction volume of about 500 mL or about 5 L. In some embodiments, the total reaction volume is less than the reservoir volume. For example, a total reaction volume of about 5 L may be used in a reaction carried out in a reservoir having a reservoir volume of about 10 L.

In some embodiments, the reaction is carried out in a stirred tank reactor (STR), a loop reactor, a plug flow reactor, a single or multi-stage continuous stirred tank reactor, or any other suitable reactor known in the art. In some embodiments, the reaction is carried out in a stirred tank reactor, wherein the reaction is stirred at from about 100 to about 200 rpm, such as about 160 rpm.

The pH of the reaction mixture may be an important consideration for maximizing the yield of beta-cyclodextrin. In some embodiments, one or more of the enzymatic reactions is carried out at a pH of from about 6 to about 8, for example the pH may be from about 6.5 to about 7.5. In a preferred embodiment, one or more of the enzymatic reactions is carried out at a pH of from about 7.0 to about 7.5. Preferably, step (a) is carried out at a pH of from about 7.0 to about 7.5. Preferably, step (b) is carried out at a pH of from about 7.0 to about 7.5. Step (a) and step (b) may be carried out at different pH, but preferably step (a) and step (b) are carried out at the same pH.

In some embodiments, one or more of the enzymatic reactions is carried out in a reaction mixture comprising a buffer. Any suitable buffer known in the art may be used. For example, the buffer may be selected from the group consisting of sodium citrate, disodium hydrogen phosphate, and Tris-HCl. The buffer may be present in the reaction mixture at a concentration of from about 50 mM to about 200 mM, for example at about 100 mM.

In some embodiments, one or more of the enzymatic reactions is carried out in a reaction mixture comprising an organic solvent, preferably toluene. The reaction mixture preferably also comprises water. Without wishing to be bound by any theory set out herein, the inventors have identified that addition of the organic solvent surprisingly increases the yield of the beta-cyclodextrin obtained from the enzymatic reactions. For example, the addition of the organic solvent may increase the yield of the beta-cyclodextrin by at least about 5%, for example by at least about 10%, for example by at least about 15%, for example by at least about 20%, for example by at least about 50%, for example by at least about 100%, for example by at least about 150%, for example by at least about 200%, for example by at least about 250%, for example by at least about 300%, for example by at least about 350%, for example by at least about 400% compared to the yield obtained from the enzymatic reactions carried out without the organic solvent. It is believed that the addition of the organic solvent increases the yield of the beta-cyclodextrin by decreasing the solubility of the beta-cyclodextrin in the reaction mixture, thereby causing the beta-cyclodextrin to precipitate, which reduces the concentration of beta-cyclodextrin in the reaction mixture. This prevents breakdown of the beta-cyclodextrin by the enzymes.

In some embodiments, the amount of the organic solvent (preferably toluene) in the reaction mixture is from about 0.1% to about 40% v/v of the reaction mixture, such as from about 1% to about 35% v/v, such as from about 5% to about 25% v/v.

In some embodiments, the organic solvent is introduced at the start, or during, the enzymatic reaction of step (a). In some preferred embodiments, the organic solvent is introduced at the start, or during, the enzymatic reaction of step (b). For example, in embodiments where the total (e.g., method step (a) and method step (b)) reaction is carried out for no more than 8 hours, the organic solvent may be introduced about 1 hour after the start of enzymatic reaction (b).

In some embodiments, the enzyme used in step (a) is amylosucrase. In some embodiments, the starting concentration of amylosucrase in the reaction mixture is from about 1 to about 30 U/mL, for example from about 5 to about 25 U/mL, for example from about 8 to about 25 U/mL.

In some embodiments, the enzyme mixture used in step (a) comprises sucrose phosphorylase and alpha-glucan phosphorylase. In some embodiments, the starting concentration of sucrose phosphorylase in the reaction mixture is from about 1 to about 30 U/mL, for example from about 5 to about 25 U/mL, for example from about 8 to about 25 U/mL. In some embodiments, the starting concentration of alpha-glucan phosphorylase in the reaction mixture is from about 1 to about 30 U/mL, for example from about 5 to about 25 U/mL, for example from about 8 to about 25 U/mL.

In some embodiments, the enzymes are provided in whole cell lysate, preferably wherein the ratio of the starting concentration (measured as volume of whole cell lysate) of enzymes in step (b) to the enzymes in step (a) is from about 1:1 to about 50:1, such as from about 2:1 to about 50:1, such as from about 5:1 to about 40:1, such as from about 10:1 to about 30:1. In a preferred embodiment, the ratio is about 20:1.

In certain embodiments, any one of the enzymatic reactions provided herein (e.g., the first enzymatic reaction to convert sucrose to amylose and/or the second enzymatic reaction to convert amylose to beta-cyclodextrin) may take place within a microbial host cell. In some cases, the microbial cell is a bacterial cell. In some cases, the bacterial cell is Escherichia coli. For example, the microbial host cell may comprise one or more heterologous nucleic acid molecules that encode for one or more the enzymes provided herein. The microbial host cell may express one or more of the enzymes provided herein. In some cases, the microbial host cell can be fed sucrose and/or one or more intermediates of the enzymatic reaction. For example, sucrose may be fed to the microbial host cell, and the conversion of sucrose to beta-cyclodextrin may occur within the microbial host cell.

In some embodiments, one or more of the enzymes used in the enzymatic reactions provided herein may be immobilized on a resin. For example, the enzymes may be covalently linked to a resin. Alternatively, the enzymes may be non-covalently linked to the resin. For example, the enzymes may be linked to a Ni-resin via a His-tag. For example, the enzyme of (a) may be a variant amylosucrase (for example wherein the variant amylosucrase may comprise or consist of an amino acid sequence according to SEQ ID NO: 3) and the enzyme may be immobilized on a resin. Alternatively, or additionally, the enzyme of (b) may be a variant cyclodextrin glucanotransferase (for example wherein the variant cyclodextrin glucanotransferase may comprise or consist of an amino acid sequence according to SEQ ID NO: 28) and the enzyme may be immobilized on a resin. Optionally, the enzyme or enzyme mixture of (a) and the enzyme of (b) are immobilized on the same resin.

The immobilized resin enzymes may be re-used in the methods described herein. However, the present inventors have found that the beta-cyclodextrin yield tends to decrease when the immobilized resin enzymes are re-used, which is believed to be due to the enzyme leaching from the resin during use which results in a lower enzymatic conversion. It would therefore be desirable to improve the enzyme stability on the resin and hence prevent enzyme leaching, because this would allow the immobilized resin enzymes to be re-used more often and/or with a higher rate of enzymatic conversion, thereby increasing the yield of the reaction.

The present inventors have found that enzyme stability may be improved by using freeze-dried enzymes, by spray drying the enzymes, and/or by introducing additives.

In some embodiments, the enzymes are provided in a cell slurry or in whole cell lysate. For example, a cell slurry comprising recombinant cells expressing the enzymes may be suspended in buffer (such as sodium citrate buffer), lysed, and centrifuged to provide a whole cell lysate comprising the enzymes. Methods of cell lysis are known in the art. For example, the cells may be lysed by homogenization, chemical lysis, sonication, freeze/thaw, lytic enzymes, acidic lysis, and/or alkaline lysis. In a preferred embodiment, the cells are lysed by homogenization.

In some embodiments, the cell slurry or whole cell lysate further comprises an additive. In some embodiments, the additive is selected from the group consisting of PEG, maltose, sorbitol, sucrose, glucose, mannitol, lactose, milk powder, starch, and combinations thereof. In some embodiments, the additive is added in an amount of from about 0.1% w/v to about 10% w/v of the cell slurry or whole cell lysate, for example from about 0.5% w/v to about 5% w/v. For example, the additive may be added at 0.5% w/v, 1.0% w/v, or 5% w/v of the cell slurry or whole cell lysate. In a preferred embodiment, the additive is mannitol, sorbitol, sucrose, or a combination thereof.

In some embodiments, the cell slurry or cell lysate may be freeze-dried. For example, cell slurry or cell lysate may be freeze-dried over 2 days. Methods of freeze-drying are known in the art.

The inventors have found that the addition of an additive to the cell slurry or whole cell lysate (as described above) increases the enzyme stability compared to a cell slurry or whole cell lysate which does not contain an additive, and that freeze-drying the cell slurry or whole cell lysate (as described above) increases the enzyme stability compared to a cell slurry or whole cell lysate which has not been freeze-dried. The cell slurry or cell lysate may be resuspended and shaken to redissolve prior to use in the methods described herein.

In some embodiments, the methods described herein produce a composition comprising at least 18 g/L of beta-cyclodextrin. In some embodiments, the methods produce a composition comprising at least 25 g/L of beta-cyclodextrin, at least 30 g/L of beta-cyclodextrin, at least 40 g/L of beta-cyclodextrin, at least 50 g/L beta-cyclodextrin, or at least 60 g/L beta-cyclodextrin. In a preferred embodiment, the methods described herein produce a composition comprising at least 50 g/L of beta-cyclodextrin.

In some embodiments, the percentage yield of beta-cyclodextrin is at least about 10%, for example at least about 20%, for example at least about 30%, for example at least about 40%, or for example at least about 50%, for example at least about 60%, wherein the percentage yield is calculated by dividing the total amount of beta-cyclodextrin produced in the methods described herein by the maximum theoretical amount of beta-cyclodextrin which could be produced from the starting sucrose reagent.

Also provided herein are compositions comprising cyclodextrin, wherein the cyclodextrin comprises beta-cyclodextrin and may optionally further comprise alpha-cyclodextrin, gamma-cyclodextrin, or any combination thereof, and wherein the composition comprising cyclodextrin comprises beta-cyclodextrin in an amount and/or concentration greater than alpha-cyclodextrin, gamma-cyclodextrin, or both. Preferably, the compositions are obtained from the methods provided herein. In some cases, the composition does not comprise alpha-cyclodextrin and/or gamma-cyclodextrin. Preferably, the composition comprises ratios of beta-cyclodextrin to alpha-cyclodextrin, ratios of beta-cyclodextrin to gamma-cyclodextrin, or both ratios of beta-cyclodextrin and ratios of beta-cyclodextrin to alpha-cyclodextrin, of at least 2:1, at least 3:1, at least 4:1, at least 5:1, at least 6:1, at least 7:1, at least 8:1, at least 9:1, at least 10:1, at least 20:1, at least 30:1, at least 40:1, at least 50:1, at least 60:1, at least 70:1, at least 80:1, at least 90:1, at least 100:1, or greater. Preferably, the composition comprises ratios of beta-cyclodextrin to alpha-cyclodextrin, ratios of beta-cyclodextrin to gamma-cyclodextrin, or both ratios of beta-cyclodextrin and ratios of beta-cyclodextrin to alpha-cyclodextrin, of at least 10:1, such as at least 20:1, at least 30:1, at least 40:1, at least 50:1, at least 60:1, at least 70:1, at least 80:1, at least 90:1, at least 100:1, or greater.

In a preferred embodiment, the present invention provides a method of producing a composition comprising cyclodextrin, the method comprising: (a) contacting sucrose with an enzyme or an enzyme mixture capable of converting sucrose to amylose under conditions that permit the conversion of the sucrose to amylose, thereby producing amylose; (b) contacting the amylose produced in (a) with cyclodextrin glucanotransferase, thereby producing the composition comprising cyclodextrin, wherein the cyclodextrin glucanotransferase in (b) is a variant enzyme capable of producing a greater amount and/or concentration of beta-cyclodextrin than alpha-cyclodextrin, gamma-cyclodextrin, or both, relative to a wild-type enzyme capable of converting amylose to cyclodextrin, wherein the composition comprising cyclodextrin comprises beta-cyclodextrin, and may optionally further comprise alpha-cyclodextrin, gamma-cyclodextrin, or any combination thereof, and preferably wherein the ratio of beta-cyclodextrin to alpha-cyclodextrin, gamma-cyclodextrin, or both in the composition is at least 10:1, wherein steps (a) and (b) are carried out simultaneously, wherein steps (a) and (b) are carried out at from about 45° C. to about 55° C., wherein steps (a) and (b) are carried out at a pH of from about 7.0 to about 7.5, wherein steps and (b) are carried out in a reaction mixture comprising water and an organic solvent (preferably toluene), and wherein the total reaction is carried out for no more than 8 hours.

Also provided herein is beta-cyclodextrin. Preferably, the beta-cyclodextrin is obtained from the methods provided herein.

Also provided herein is the use of sucrose as a starting material for the manufacture of beta-cyclodextrin. Also provided herein is the use of sucrose in a method for producing beta-cyclodextrin, wherein the method does not use starch.

Also provided herein is the use of any one of the enzymes, or enzyme mixtures, capable of converting sucrose to amylose described herein for converting sucrose into amylose.

Also provided herein is the use of any one of the variant enzymes capable of converting amylose to cyclodextrin described herein for converting amylose to cyclodextrin and/or for producing a greater amount and/or concentration of beta-cyclodextrin than alpha-cyclodextrin, gamma-cyclodextrin, or both.

Also provided herein is the use of any one of the enzymes, or enzyme mixtures, described herein for the manufacture of beta-cyclodextrin, wherein the manufacture does not require starch as a starting material.

Also provided herein is any one of the enzymes, or enzyme mixtures, described herein. For example, provided herein is an enzyme comprising or consisting of an amino acid sequence of any one of SEQ ID NOs: 1-48. Also provided herein is an enzyme comprising or consisting of an amino acid sequence having at least about 70% sequence identity, preferably at least about 90% sequence identity, to the amino acid sequence of any one of SEQ ID NOs: 1-48.

Preferably, the enzyme is a variant amylosucrase enzyme comprising or consisting of an amino acid sequence of any one of SEQ ID NOs: 3-16 or 48. Also provided herein is an enzyme comprising or consisting of an amino acid sequence having at least about 70% sequence identity, preferably at least about 90% sequence identity, to the amino acid sequence of any one of SEQ ID NOs: 3-16 or 48.

Preferably the enzyme is a variant sucrose phosphorylase enzyme comprising or consisting of an amino acid sequence of SEQ ID NO: 20. Also provided herein is an enzyme comprising or consisting of an amino acid sequence having at least about 70% sequence identity, preferably at least about 90% sequence identity, to the amino acid sequence of SEQ ID NO: 20.

Preferably the enzyme is a variant alpha-glucan phosphorylase enzyme comprising or consisting of an amino acid sequence of SEQ ID NO: 24. Also provided herein is an enzyme comprising or consisting of an amino acid sequence having at least about 70% sequence identity, preferably at least about 90% sequence identity, to the amino acid sequence of SEQ ID NO: 24.

Preferably the enzyme is a variant cyclodextrin glucanotransferase enzyme comprising or consisting of an amino acid sequence of any one of SEQ ID NOs: 28-30 or 35-47. Also provided herein is an enzyme comprising or consisting of an amino acid sequence having at least about 70% sequence identity, preferably at least about 90% sequence identity, to the amino acid sequence of any one of SEQ ID NOs: 28-30 or 35-47.

Also provided herein is an enzyme composition comprising one or more of the enzymes described herein.

Also provided herein is a gene encoding any one of the variant enzymes described herein. Also provided herein is a vector encoding any one of the variant enzymes described herein.

Also provided herein is a recombinant host cell comprising any one of the genes, vectors or enzymes described herein.

Also provided herein is the use of an organic solvent, preferably toluene, for increasing the yield of beta-cyclodextrin obtained in a method for producing beta-cyclodextrin, such as the beta-cyclodextrin obtained from any one of the methods described herein.

### Purification Methods

Also provided herein is a method of purifying beta-cyclodextrin, the method comprising the steps of:
i. providing a crude composition comprising beta-cyclodextrin;
ii. obtaining a first precipitate comprising beta-cyclodextrin from the crude composition, for example by: filtering the crude composition, subjecting the crude composition to centrifugation, subjecting the crude composition to a settling operation, and/or washing with water;
iii. dissolving the first precipitate to obtain a first solution comprising beta-cyclodextrin, for example by dissolving the first precipitate in water;
iv. filtering the first solution to obtain a second solution comprising beta-cyclodextrin; and
v. crystallizing and/or precipitating the second solution to obtain a purified beta-cyclodextrin composition.
   Steps (ii) and/or (iv)

The filtration step (iv) may remove insoluble material.

In some embodiments, steps (ii) and/or (iv) comprise washing the material obtained by filtration, for example with water or alkaline water.

In some embodiments, step (iv) comprises filtration through a filter aid. In some embodiments, the filter aid comprises silicon dioxide. One example of a suitable filter aid is 1% Celite®, which is commercially available from Sigma-Aldrich. The use of a filter aid may be advantageous in order to reduce the overall filtration time of step (iv).

The filtration step (iv) may be conducted at a temperature from about 4° C. to about 25° C.

Dissolution Step (iii)

In some embodiments, step (iii) comprises dissolving the first precipitate in an alkaline solution. The precipitate may be dissolved in NaOH, for example in 1M NaOH, for example by adding multiple (e.g., five) volumes of 1M NaOH.

In some embodiments, step (iii) may comprise heating the solution until the beta-cyclodextrin dissolves. For example, this may require heating the solution to about 60° C. or more, for example to about 65° C. or more, for example to about 70° C. or more, for example to about 75° C. or more. The temperature of the solution may then be lowered, for example lowered by about 5° C. or more, prior to the subsequent steps.

### Crystallization Step (v)

Step (v) may comprise neutralizing the second solution, optionally wherein the neutralization comprises the addition of HCl. For example, the neutralization may comprise the addition of 6M HCl.

Step (v) may comprise seeding the second solution with crystalline beta-cyclodextrin.

In some embodiments, step (v) may further comprise heating the solution until the beta-cyclodextrin dissolves. For example, this may require heating the solution to about 60° C. or more, for example to about 65° C. or more, for example to about 70° C. or more, for example to about 75° C. or more. In a preferred embodiment, the solution is heated to about 75° C. The temperature of the solution may then be lowered, for example lowered by about 5° C. or more, before seeding with crystalline beta-cyclodextrin. In a preferred embodiment, the solution is heated to about 75° C. and then lowered to about 70° C. prior to seeding.

In some embodiments, step (v) may comprise cooling the solution to below room temperature after seeding, for example to about 20° C. or less, about 15° C. or less, about 10° C. or less, or about 5° C. or less. In a preferred embodiment, the solution is cooled to about 4° C. In some embodiments, the solution is cooled over about 1 to about 12 hours. In some embodiments, the solution is cooled over about 1 hour, about 2 hours, about 3 hours, about 4 hours, about 5 hours, about 6 hours, about 7 hours, about 8 hours, about 9 hours, about 10 hours, about 11 hours, or about 12 hours. In a preferred embodiment, the solution is cooled to about 4° C. over about 4 hours.

The seeded solution may be maintained under conditions suitable for beta-cyclodextrin crystal formation. For example, the solution may be maintained below room temperature, for example at about 20° C. or less, about 15° C. or less, about 10° C. or less, or about 5° C. about. In a preferred embodiment, the solution is maintained at about 4° C. In some embodiments, the solution is maintained below room temperature for at least about 1 hour, at least about 2 hours, at least about 3 hours, at least about 4 hours, at least about 5 hours, at least about 6 hours, at least 7 about hours, at least about 8 hours, at least about 9 hours, at least about 10 hours, at least about 11 hours, or at least about 12 hours. Preferably, the solution is maintained for 12 or more hours at about 4° C.

The crystallization step (v) may comprise a filtration step. The filtration step may comprise vacuum filtration.

In some embodiments, step (v) further comprises washing the composition with water.

In some embodiments, step (v) further comprises drying the composition, optionally wherein the composition is dried (e.g. in a vacuum oven) at about 45° C.

### Precipitation Step (v)

Step (v) may comprise neutralizing the second solution, optionally wherein the neutralization comprises the addition of HCl. For example, the neutralization may comprise the addition of about 6M HCl.

Step (v) may comprise the addition of an anti-solvent. An anti-solvent may increase the yield of purified beta-cyclodextrin in the composition obtained by the purification method. An anti-solvent is a solvent in which beta-cyclodextrin is poorly soluble, for example a solvent in which beta-cyclodextrin does not dissolve at about 50° C. and at about 60° C. The anti-solvent may be THF, AcN, EtOH, toluene, acetone, or a mixture of acetone and water (for example, a mixture of 10:90, or 20:80, or 30:70, or 40:60, or 50:50, or 60:40, or 70:30, or 80:20, or 90:10 acetone:water). In some embodiments, where the anti-solvent is a mixture of acetone and water, the mixture may be between 10-90%, between 20-80%, between 30-70%, between 40-60%, or about 50% acetone. Preferably, the anti-solvent used is a mixture of acetone and water, such as a mixture of 50% acetone and 50% water.

In some embodiments, step (v) may comprise cooling the solution to below room temperature after addition of anti-solvent, for example to about 20° C. or less, about 15° C. or less, about 10° C. or less, or about 5° C. or less. In a preferred embodiment, the solution is cooled to about 4° C. In some embodiments, the solution is cooled over about 1 to about 12 hours. In some embodiments, the solution is cooled over about 1 hour, about 2 hours, about 3 hours, about 4 hours, about 5 hours, about 6 hours, about 7 hours, about 8 hours, about 9 hours, about 10 hours, about 11 hours, or about 12 hours. In a preferred embodiment, the solution is cooled to about 4° C. over about 4 hours.

The solution may be maintained under conditions suitable for beta-cyclodextrin precipitate formation. For example, the solution may be maintained below room temperature, for example at about 20° C. or less, about 15° C. or less, about 10° C. or less, or about 5° C. about. In a preferred embodiment, the solution is maintained at about 4° C. In some embodiments, the solution is maintained below room temperature for at least about 1 hour, at least about 2 hours, at least about 3 hours, at least about 4 hours, at least about 5 hours, at least about 6 hours, at least 7 about hours, at least about 8 hours, at least about 9 hours, at least about 10 hours, at least about 11 hours, or at least about 12 hours. Preferably, the solution is maintained for 12 or more hours at about 4° C.

In some embodiments, the solution is cooled to about 4° C. over about 4 hours, and then held for about 12 hours at about 4° C.

The precipitation of step (v) may comprise a filtration step. The filtration step may comprise vacuum filtration.

In some embodiments, step (v) further comprises washing the composition with water.

In some embodiments, step (v) further comprises drying the composition, optionally wherein the composition is dried (e.g. in a vacuum) at about 45° C.

### Compositions

Preferably, the crude composition of step (i) is obtained via any one of the enzymatic methods described and claimed herein.

In some embodiments, the crude composition is cooled prior to step (ii). For example, the crude composition may be allowed to cool to room temperature for at least about 3 hours, and then cooled to about 4° C. for at least about 3 hours.

Also provided herein is a purified beta-cyclodextrin composition. The purified beta-cyclodextrin composition may be obtained from any one of the purification methods described and claimed herein. The beta-cyclodextrin in the composition may have a purity of 75 wt % or more, such as 80 wt % or more, such as 85 wt % or more, such as 90 wt % or more, or such as 95 wt % or more.

The purity of beta-cyclodextrin may be measured by ¹H-NMR, and may provide the anhydrous amount of beta-cyclodextrin.

Preferably, the purified beta-cyclodextrin composition consists essentially of beta-cyclodextrin and optionally water, and preferably consists of beta-cyclodextrin and optionally water. The purified beta-cyclodextrin composition may comprise 2 wt % or less of toluene, such as no toluene. The purified beta-cyclodextrin composition may comprise 1 wt % or less of sucrose, fructose and/or amylose, such as no sucrose, fructose and/or amylose. The purified beta-cyclodextrin composition may comprise 5 wt % or less, preferably 1 wt % or less, of alpha and/or gamma-cyclodextrin, such as no alpha and/or gamma-cyclodextrin.

The beta-cyclodextrin recovery from the purification methods described herein may be at least 50%, at least 60%, at least 70%, or at least 80%. In other words, the amount of beta-cyclodextrin in the purified composition may be at least 50% (or at least 60%, at least 70% or at least 80%) of the amount of beta-cyclodextrin in the crude composition. The amount of beta-cyclodextrin, and any other components, in the composition may be measured by ¹H-NMR (in wt %) or by HLPC-ELSD (in g/L).

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described. Unless otherwise stated, % values of concentration should be interpreted as % weight.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/m L to 80 mg/m L.”

As used herein, the term “filtering” or “filtration” expressly include nanofiltering and nanofiltration.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

### EXAMPLES

### Example 1: Analytical Methods

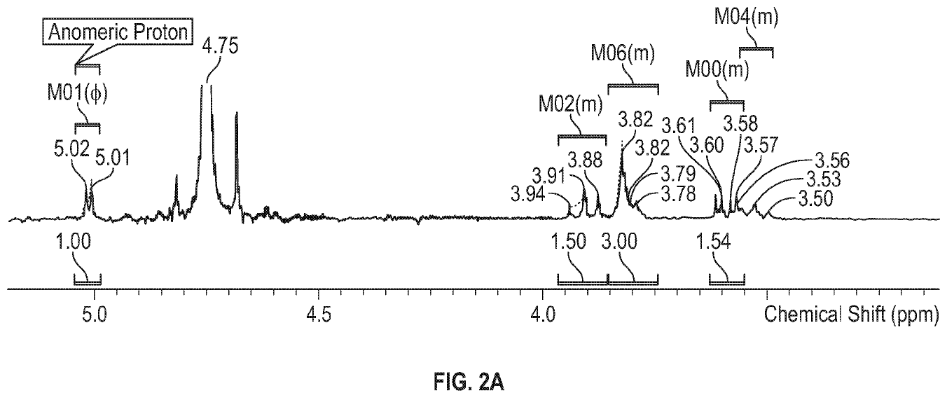

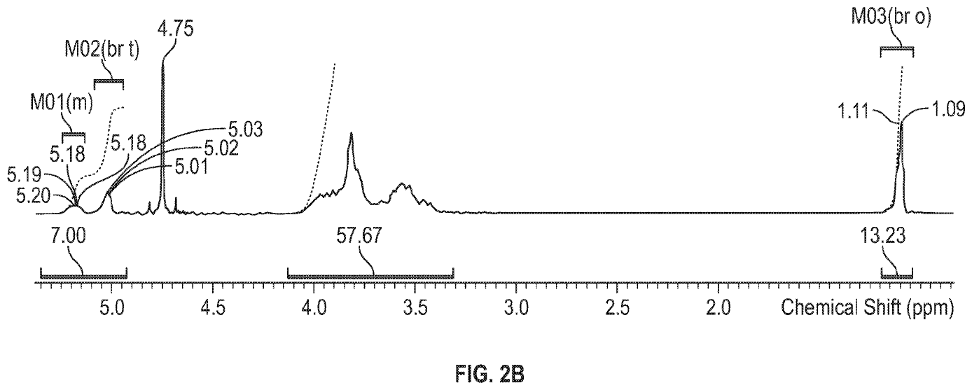

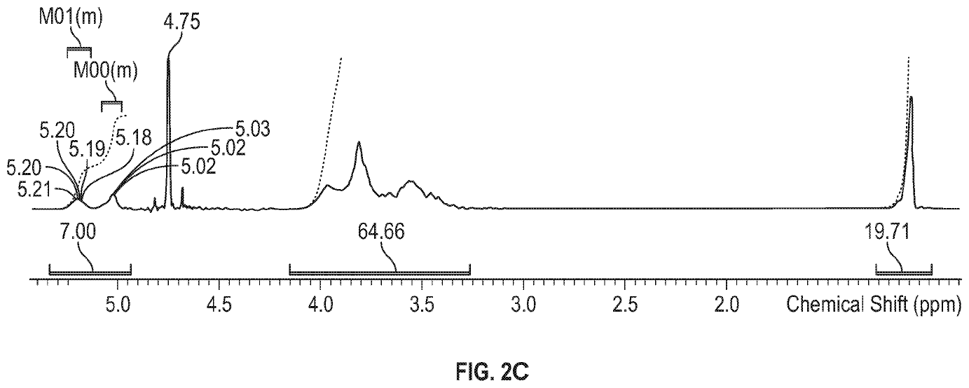

¹H NMR: HPBCD was prepared using the methods described herein. ¹H NMR spectra were collected using a Varian 300 MHz NMR instrument. Spectra were collected under default conditions (32 scans, D₁=1 second, acquisition time=5 seconds) and referenced to the residual solvent peak in D₂O. ¹H-NMR analysis of unfunctionalized β-cyclodextrin showed a clean doublet at 5.01 ppm corresponding to the anomeric protons of the backbone. Two samples of commercially available racemic HPBCD of different molecular weights were analyzed and degree of substitution was calculated following the USP described method. Both samples showed two broad signals at 5.02 and 5.19 ppm in the region corresponding to the anomeric protons of the backbone as well as a broad doublet at 1.1 ppm corresponding to the methyl group of the hydroxypropyl group. Example spectra are provided in FIG. 2.

The two broad signals in the anomeric region are likely due to differences in the functionalization site on PCD. Degree of substitution (D.S.) can then be calculated by comparing the integral ratio of the methyl doublet with both signals in the anomeric region. The D.S. for each sample was calculated as shown below in Equation 1. Using this method for determination of D.S., the molecular weight for each HPBCD sample was calculated and good agreement within <5% error was observed with the manufacturer provided molecular weight. A summary of data from these analyses is provided below in Table 6.

$$D . S . = 7 \frac{{}^{H} methyl / 3}{{}^{H} anomeric} = 7 \frac{13.23 / 3}{7} = 4.4 \qquad ( 1 )$$

TABLE 6
Summary of results from analysis of
commercial samples of βCD and HPBCD

| | | | Degree | | |
|---|---|---|---|---|---|
| | | | of | Manufac- | |
| | | | substi- | turer | Calcu- |
| | Sup- | | tution | provided | lated |
| Compound | plier | Lot # | (D.S.)^{a} | MW | MW^{b} |
| β-cyclodextrin | Combi- | B18713 | — | 1135 | — |
| | blocks | | | | |
| hydroxypropyl-β- | Sigma | MKCM0084 | 4.4 | 1380 | 1391 |
| cyclodextrin | Aldrich | | | | |
| hydroxypropyl-β- | Sigma | MKCM2836 | 6.6 | 1540 | 1517 |
| cyclodextrin | Aldrich | | | | |

^{a}Calculated by integration of entire anomeric proton region (4.9-5.3 ppm) and comparing ratio to integration of methyl doublet (1.1 ppm).
^{b}Calculating as follows: MW_{HPBCD} = MW_{bCD} + MW_{PO}*D.S

HPLC with ELSD detector: An HPLC method was developed to separate racemic HPBCD and βCD. The order of elution with this method is described in Table 7 below.

TABLE 7
HPLC-ELSD retention times

| | | Relative |
|---|---|---|
| | Retention | Retention |
| Compound | time (min) | time (RRT) |
| Unknown (Likely NaCl or propylene glycol. | 2.530 | 0.207 |
| Present only in crude reaction mixtures. | | |
| Disappears following purification by | | |
| nanofiltration) | | |
| β-cyclodextrin | 5.446 | 0.446 |
| Hydroxypropyl-β-cyclodextrin | 12.203 | 1 |

Gas Chromatography: A gas chromatography method was developed to determine presence of propylene glycol in samples. The order of elution with this method is described in Table 8 below.

TABLE 8
Gas Chromatography retention times

| | Retention | Relative Retention |
|---|---|---|
| Compound | time (min) | time (RRT) |
| Propylene glycol | 6.167 | 1 |

### Example 2: Process Development for HPBCD

Degree of substitution and product distribution were primary targets for process development. Previously, degree of substitution (D.S.) was determined by ¹H-NMR after lengthy purification and removal of water. The HPLC-ELSD data provided an alternative and more efficient approach to perform this analysis. It was observed that the retention time by HPLC is correlated directly with D.S. of HPBCD. Analysis of HPLC data also provides information regarding the product distribution of the resulting HPBCD.

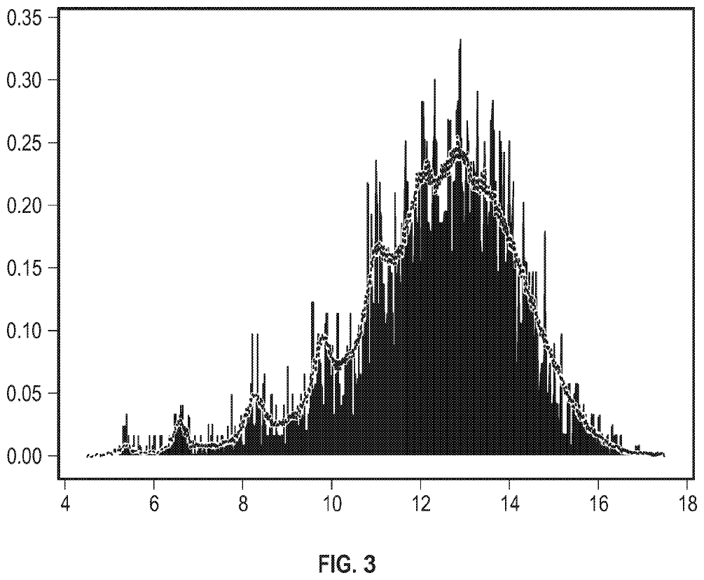

Monte Carlo Rejection Sampling of HPLC-ELSD data: In this statistical approach, the HPLC-ELSD data from each sample was treated as a surrogate for a product distribution function. By utilizing a Monte Carlo rejection sampling approach, an approximate population was generated which allowed for statistical analysis. An example is provided in FIG. 3.

HPLC-ELSD was collected for a large set of HPBCD samples. Statistical parameters and corresponding D.S. are provided below in Table 9. Key parameters for characterizing the narrowness of the product distribution for HPBCD were identified as the standard deviation, variance, and skewness. It is expected that a combination of these statistical parameters can be used to estimate the D.S. of samples without isolation.

TABLE 9
Summary of D.S. and statistical parameters for HPBCD samples

| | | | | | | Skew- |
|---|---|---|---|---|---|---|
| Sample | DS | Mean | Median | StdDev | Variance | ness |
| MC04-65 | 1.9 | 7.858 | 6.916 | 2.389 | 5.707 | 0.889 |
| MC04-47-A | 3.2 | 8.85 | 8.53 | 2.87 | 8.26 | 0.49 |
| MC04-56 | 4.5 | 10.9682 | 11.2886 | 2.3423 | 5.4868 | −0.4311 |
| MC04-63 | 5.2 | 11.529 | 11.816 | 2.255 | 5.0875 | −0.5669 |
| MC04-79 | 5.6 | 11.632 | 11.87 | 2.0242 | 4.09798 | −0.5813 |
| MC04-70 | 6.1 | 12.266 | 12.595 | 2.402 | 5.772 | −0.5826 |
| MC04-74 | 6.2 | 12.238 | 12.464 | 2.2098 | 4.884 | −0.5615 |
| MC04-74-A | 6.2 | 12.2035 | 12.45 | 2.1899 | 4.796 | −0.5863 |
| MC04-84-A | 6.5 | 12.381 | 12.58 | 1.8177 | 3.3044 | −0.6676 |
| KN01-69-5 | 6.8 | 12.25 | 12.47 | 1.91 | 3.66 | −0.73 |
| MC04-86 | 6.9 | 12.684 | 12.843 | 1.7069 | 2.914 | −0.6756 |
| MC04-26 | 7 | 12.357 | 12.577 | 1.849 | 3.4196 | −0.6479 |
| Cavitron HP7 | 7.2 | 12.24 | 12.27 | 1.04 | 1.09 | −0.425 |
| MC04-83-A | 9.2 | 13.613 | 13.7717 | 1.5774 | 2.4883 | −0.779 |
| MC04-82 | 9.3 | 13.809 | 13.9311 | 1.583 | 2.5067 | −0.6124 |
| MC04-33-A | 10.7 | 14.469 | 14.577 | 1.422 | 2.0213 | −0.5728 |

An initial, simple parametric fit was performed using a combination of statistical terms (single and cross terms) with a select number of data points being excluded for validation purposes. This parametric equation is shown below in Equation 2.

$$D . S . = - 13.04 + 1.669 \cdot Mean + 0.361 \cdot Skewness \cdot Variance \qquad ( 2 )$$

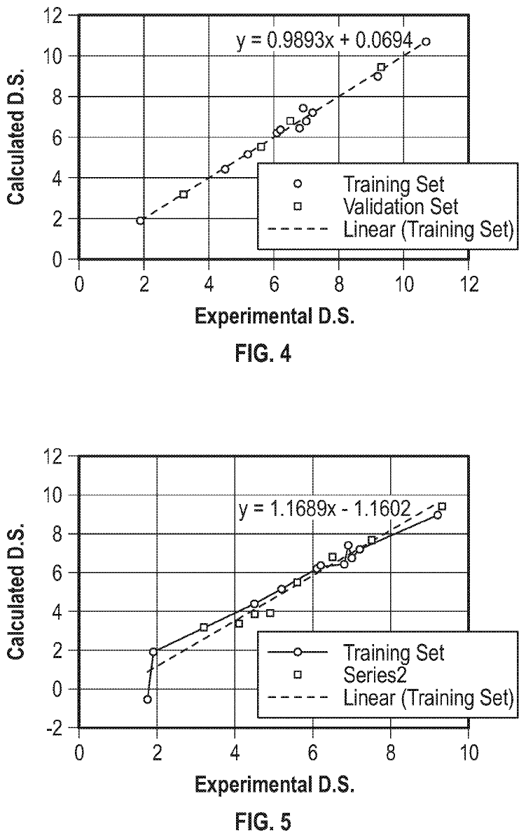

Using this parametric equation, D.S. estimations were made for the samples shown in Table 9. A plot of predicted vs. actual values is provided in FIG. 4 which includes the validation samples. Overall a good fit was obtained using this simple parametric equation. There is greater deviation in the range of D.S of 7. Samples that lie in this region can be further validated by ¹H-NMR after purification to ensure accuracy.

Experiments KC07-62 and XD03-69 were both run with conditions on the low end of the temperature and residence time design space. Therefore, the resulting D.S. of the HPBCD product was relatively low. Initially, this data was outside of the boundaries of the statistical model and gave negative estimated values for D.S (see FIG. 5). One sample, KC07-62-5, was purified on TFF and analyzed by NMR to determine the D.S. The results are in Table 10 below.

TABLE 10
Calculated D.S. from NMR data

| | | Anomeric Proton Peak |
|---|---|---|
| Sample | D.S. | Ratio (5.20 ppm/5.02 ppm) |
| KC07-62-5-TFF | 1.71 | 0.15 |

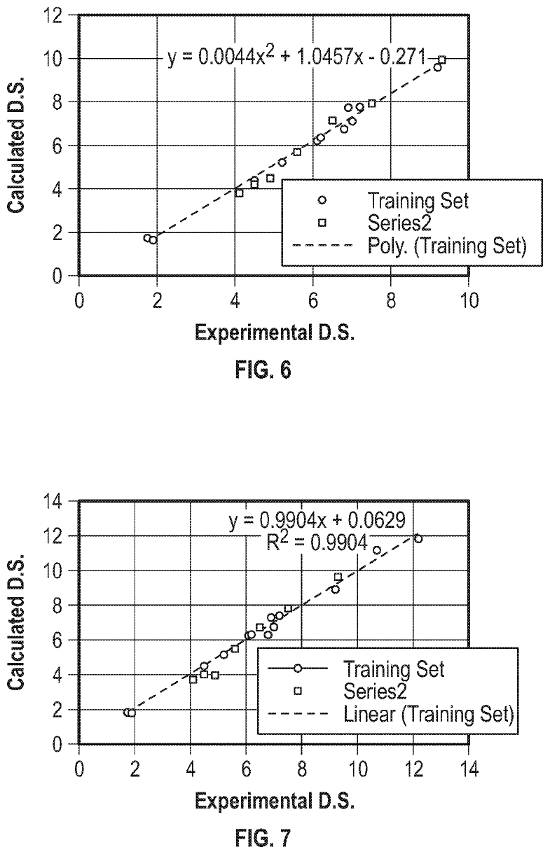

Attempts to incorporate this datapoint into the training set for a revised model was unsuccessful. As such, a revised model was generated with the assistance of the JMP software suite incorporating this new data point. This resulted in an improved model to estimate D.S. data based on ELSD data. This parametric equation is shown below in Equation 3. A plot of predicted vs. actual using this revised model is provided in FIG. 6. Associated statistics for the fitted equation are provided below in Table 11. All previously reported data was re-analyzed using the updated statistical model. The results did not change by more than ˜5% for the calculated D.S. values of individual samples.

$$D . S . = - 1.375 - 0.1784 \cdot Variance + 1.6674 \cdot Skewness + 0.4944 \cdot Kurtosis + 0.06045 \cdot {Median}^{2} \qquad ( 3 )$$

TABLE 11
Summary of fit for revised parametric model

| | |
|---|---|
| RSquare | 0.994642 |
| RSquare Adj | 0.991963 |
| Root Mean Square Error | 0.222425 |
| Mean of Response | 6.126923 |
| Observations (or Sum Wgts) | 13 |

To further validate the statistical method using ELSD data, a sample on the high end of the D.S. range was purified by TFF and analyzed via proton NMR. The sample was determined to have a D.S. of 12.2, which was about 15% off from the value of 10.5 determined using the second version of the model. The equation was updated using a model data set that included the data point with a D.S. above 12 and is shown in Equation 4. Table 12 shows the calculated D.S. from the proton NMR data. FIG. 7 shows the updated model fit.

$$D . S . = - 1.956 - 0.294 \cdot Variance + 2.299 \cdot Skewness - 0.043 \cdot Kurtosis + 0.07096 \cdot {Median}^{2} \qquad ( 4 )$$

TABLE 12
Calculated D.S. from NMR data

| | | Anomeric Proton Peak Ratio |
|---|---|---|
| Sample | D.S. | (5.20 ppm/5.02 ppm) |
| KC07-64-6-TFF | 12.2 | 1.88 |

The updated parametric equation resulted in a predicted D.S. value for sample KC07-64-6 of 11.8, which is only about 3% error from the NMR-determined D.S. value.

### Example 3: HPBCD Reactor Flow Build

A reactor system to allow efficient and semi-automated experimentation was constructed to facilitate the experimental workflow. A depiction of the process flow diagram for this reactor system is provided in FIG. 1. Due to low flowrates required for some of the experiments, pressurized feed tanks and a syringe pump were used. All material flow was monitored using mass flow meters or controllers. The flowrate from the pressurized feed tanks was controlled using mass flow controllers. The plug-flow reactor portion of the setup is two 30-mL coils of ⅛″ OD tubing, which were temperature controlled using an external TCU. The propylene oxide was dosed in two places, before the first PFR, and then before the second. The reactor effluent was collected and immediately quenched with acid.

The HPBCD process was run in the flow reactor to test system repeatability for a target degree of substitution of 7. The reaction conditions are shown in Table 13. The process flow conditions are shown in Table 14.

TABLE 13
Reaction Conditions for experiments KC07-43 and KC07-47

| Temperature | 50° C. |
|---|---|
| β-Cyclodextrin (equiv) | 1 |
| NaOH (equiv) | 7 |
| Water (V, mL/g β-Cyclodextrin) | 2.6 |
| rac-propylene oxide stream 1 (equiv) | 13 |
| rac-propylene oxide stream 2 (equiv) | 13 |

TABLE 14
Flow rate conditions for experiments KC07-43 and KC07-47

| Temperature | 50° C. |
|---|---|
| β-cyclodextrin stream (g/min) | 1.49 |
| rac-propylene oxide stream 1 | 0.26 |
| (g/min) | |
| rac-propylene oxide stream 2 | 0.26 |
| (g/min) | |
| Residence time (min) | 35 |

The same conditions were run for both experiments KC07-43 and KC07-47. The reactor design had to be adjusted to use a PID-controlled diaphragm pump instead of the auto-refill syringe pump. In each flow run, the back pressure was held at ˜30 psi using a spring-loaded BPR. The reaction was allowed to equilibrate for 30 minutes, and then samples were collected in 30-minute increments for the following 6 approximate residence times. The effluent was collected and continuously quenched with aqueous hydrochloric acid. Each sample was diluted in ultrapure water and analyzed via the ELSD HPLC method. The statistical analysis method was used to determine the D.S. value. The calculated D.S. values for the HPBCD samples are provided in Table 15.

TABLE 15
Calculated D.S. values for HPBCD samples
collected during KC07-43 and KC07-47

| | Sample | |
|---|---|---|
| Experiment | Collection Time | D.S. |
| KC07-43 | 0-30 min | 6.48 |
| | 30-60 min | 7.61 |
| | 60-90 min | 7.60 |
| | 90-120 min | 7.60 |
| | 120-150 min | 7.70 |
| | 150-180 min | 7.75 |
| KC07-47 | 0-30 min | — |
| | 30-60 min | 7.14 |
| | 60-90 min | 7.26 |
| | 90-120 min | 7.45 |
| | 120-150 min | 7.34 |
| | 150-180 min | 7.42 |

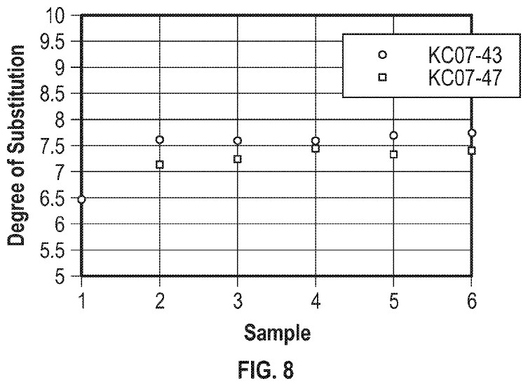

Between the two experiments and over time throughout the reaction, the D.S. was determined to be between 7.3-7.7, which is a small range of error of 5-6% similar to what would be observed by ¹H-NMR. The degree of substitution was steady across both experiments for the duration of each experiment, as illustrated in FIG. 8. Sample KC07-43-5 was purified by TFF on an XN45 flatsheet membrane for ˜12 diafiltration volumes and a ¹H NMR was taken to determine the D.S. and validate the HPLC method. The ¹H-NMR results are shown in Table 16.

TABLE 16
NMR data for purified sample KC07-43-5

| | | Anomeric Proton Peak |
|---|---|---|
| Sample | D.S. | Ratio (5.20 ppm/5.02 ppm) |
| KC07-43-5-TFF | 7.51 | 0.81 |

The ¹H NMR and HPLC data determined a D.S. value for the same sample within approximately 2.5% supporting that estimating the D.S. using the ELSD data is a viable approach.

### Example 4: Quench Study for HPBCD Flow Process

In the previous experiments, the reactor effluent was quenched continuously with 3 M aqueous hydrochloric acid. However, maintaining a quench to non-basic conditions would require additional automation using a pH meter. Another experiment was run to test the effectiveness of two other types of acid quenches: 3 M acetic acid, and Amberlyst 35 dry resin.

The same conditions were run as KC07-43 and 47, and representative samples were taken over each residence time following an equilibration period of one hour. Each sample within the residence time was quenched with one of the three quench solutions/resin. For ˜10 mL of reactor effluent, 7 mL of each quench solution was required for pH neutralization, and about 5 g of resin in the case of the Amberlyst. The Amberlyst quench was very exothermic and developed slower than the two aqueous acids. The acid solution quenches were immediate, and the samples quenched with acetic acid remained at a pH of 6-7. The pH did not drift towards 10 as in the case with the samples quenched with HCl. A summary of the D.S. values for each sample is in Table 17.

TABLE 17
Calculated D.S. values for quench samples of KC07-49

| | | |
|---|---|---|
| | Acetic Acid | Amberlyst 35 |
| HCl Quench | Quench | Quench |

| | | Time | | Time | | Time |
|---|---|---|---|---|---|---|
| Sample | D.S. | (min) | D.S. | (min) | D.S. | (min) |
| 1 | 7.56 | 61 | 7.43 | 69 | — | — |
| 2 | 7.49 | 92 | 7.34 | 99 | 7.01 | 105 |
| 3 | 7.56 | 121 | 7.49 | 126 | 7.25 | 134 |
| 4 | 7.42 | 150 | 7.31 | 155 | 6.99 | 162 |

The D.S. values calculated for the Amberlyst 35 samples are slightly lower than those of the aqueous acids, which is likely due to those HPLC samples being more concentrated. Across the samples quenched with the aqueous acids, the D.S. values are very consistent and there are no major differences in the chromatograms. Moving forward, the quench will be done with acetic acid since it is easier to use to reach a steady, neutral pH and will allow for easier and more robust automated experimentation.

### Example 5: Design of Experiment

The preliminary plan for the Design of Experiment (DoE) for this process optimization included 5 parameters and tested across the ranges summarized in Table 18.

TABLE 18
Initial ranges for DoE parameters.

| Parameter | Range | |
|---|---|---|
| Temperature | 30-60° | C. |
| Residence Time | 30-70 | minutes |
| Propylene oxide feed 1 | 7-15 | equivalents |
| Propylene oxide feed 2 | 3.5-15 | equivalents |
| NaOH in starting material solution | 5-10 | equivalents |

A 28-experiment plan was prepared using a central composite experimental design with orthogonal axial points for the given ranges. The DoE plan included very low flow rates for some of the conditions using the reactor setup. The equipment was assessed to ensure it could reach all conditions present in the DoE plan.

Flow run experiments were performed according to conditions laid out in the DoE plan. The conditions corresponding to experiment names are in Table 19. Flow rates for the DoE experiments are provided in Table 20.

TABLE 19
DoE conditions in Flow Experiments

| | Temperature | Residence | PO 1 | PO 2 | NaOH |
|---|---|---|---|---|---|
| Experiment | (° C.) | time (min) | (eq.) | (eq.) | (eq.) |
| KC07-56 | 60 | 70 | 7 | 3.5 | 5 |
| KC07-58 | 60 | 30 | 15 | 3.5 | 5 |
| KC07-60 | 60 | 30 | | 15 | 5 |
| KC07-62 | 30 | 30 | 7 | 3.5 | 5 |
| KC07-64 | 60 | 70 | 15 | 15 | 5 |
| KC07-66 | 45 | 50 | 4.57 | 9.25 | 7.5 |
| XD03-68 | 30 | 70 | 15 | 3.5 | 5 |
| XD03-69 | 30 | 30 | 15 | 15 | 5 |
| XD03-70 | 30 | 70 | 7 | 15 | 5 |
| XD03-72 | 45 | 50 | 11 | 9.25 | 7.5 |
| KC07-68 | 45 | 50 | 17.43 | 9.25 | 7.5 |
| KC07-70 | 60 | 30 | 15 | 15 | 10 |
| KC07-72 | 60 | 30 | 7 | 3.5 | 10 |
| KC07-75 | 45 | 50 | 11 | 18.49 | 7.5 |
| KC07-77 | 60 | 70 | 7 | 15 | 10 |
| KC07-78 | 20.9 | 50 | 11 | 9.25 | 7.5 |
| KC07-79 | 69.1 | 50 | 11 | 9.25 | 7.5 |
| KC07-80 | 60 | 70 | 15 | 3.5 | 10 |
| KC07-81 | 45 | 17.9 | 11 | 9.25 | 7.5 |
| KC07-82 | 30 | 70 | 15 | 15 | 10 |
| KC07-83 | 30 | 30 | 15 | 3.5 | 10 |
| KC07-84 | 45 | 50 | 11 | 9.25 | 11.5 |
| KC07-85 | 45 | 50 | 11 | 9.25 | 3.5 |
| KC07-86 | 30 | 30 | 7 | 15 | 10 |
| KC07-87 | 30 | 70 | 7 | 3.5 | 10 |
| MC05-62 | 45 | 50 | 11 | 0.008 | 7.5 |
| MC05-64 | 45 | 82.1 | 11 | 9.25 | 7.5 |

TABLE 20
Flow rates for DoE experiments

| | βCD Flow Rate | PO 1 Flow Rate | PO 2 Flow |
|---|---|---|---|
| Experiment | (g/min) | (g/min) | Rate (g/min) |
| KC07-56 | 0.82 | 0.08 | 0.04 |
| KC07-58 | 1.70 | 0.34 | 0.08 |
| KC07-60 | 1.77 | 0.16 | 0.35 |
| KC07-62 | 1.91 | 0.18 | 0.09 |
| KC07-64 | 0.69 | 0.14 | 0.14 |
| KC07-66 | 1.20 | 0.07 | 0.15 |
| XD03-68 | 0.73 | 0.15 | 0.03 |
| XD03-69 | 1.59 | 0.32 | 0.32 |
| XD03-70 | 0.76 | 0.07 | 0.15 |
| XD03-72 | 1.09 | 0.16 | 0.13 |
| KC07-68 | 0.99 | 0.23 | 0.12 |
| KC07-70 | 1.71 | 0.34 | 0.34 |
| KC07-72 | 2.07 | 0.19 | 0.10 |
| KC07-75 | 1.14 | 0.17 | 0.28 |
| KC07-77 | 0.82 | 0.08 | 0.16 |
| KC07-78 | 1.08 | 0.16 | 0.13 |
| KC07-79 | 1.08 | 0.16 | 0.13 |
| KC07-80 | 0.79 | 0.16 | 0.04 |
| KC07-81 | 3.03 | 0.44 | 0.37 |
| KC07-82 | 0.73 | 0.15 | 0.15 |
| KC07-83 | 1.83 | 0.36 | 0.09 |
| KC07-84 | 1.12 | 0.16 | 0.14 |
| KC07-85 | 1.07 | 0.16 | 0.13 |
| KC07-86 | 1.91 | 0.18 | 0.38 |
| KC07-87 | 0.89 | 0.08 | 0.04 |
| MC05-62 | 1.20 | 0.18 | 0.00 |
| MC05-64 | 0.68 | 0.10 | 0.08 |

To encompass all flow conditions for the DoE, the reactor setup was adjusted. A diaphragm pump was used to deliver the βGD stream using PID control. The two propylene oxide streams were delivered by a syringe pump, monitoring the flow rates through mass flow meters.

For each flow run, each residence time was collected as a fraction and a sample from each was diluted and analyzed on the ELSD HPLC method. Table 21 summarizes the timing of the fraction collection and the determined D.S. value for each.

TABLE 21
Summary of fractions collected in DoE experiments

| Experiment | Sample | Time (min) | D.S. |
|---|---|---|---|
| KC07-56 | 1 | 0-70 | N.D. |
| | 2 | 70-140 | 1.5 |
| | 3 | 140-210 | 5.0 |
| | 4 | 210-280 | 5.2 |
| | 5 | 280-350 | 5.3 |
| | 6 | 350-420 | 5.5 |
| KC07-58 | 1 | 0-30 | 0.8 |
| | 2 | 30-60 | 6.0 |
| | 3 | 60-90 | 7.8 |
| | 4 | 90-120 | 8.4 |
| | 5 | 120-150 | 8.0 |
| KC07-60 | 1 | 0-30 | 2.3 |
| | 2 | 30-60 | 6.2 |
| | 3 | 60-90 | 7.1 |
| | 4 | 90-120 | 7.8 |
| | 5 | 120-150 | 8.0 |
| | 6 | 150-180 | 7.7 |
| KC07-62* | 1 | 0-30 | N.D. |
| | 2 | 30-60 | 2.6 |
| | 3 | 60-90 | 2.3 |
| | 4 | 90-120 | 1.9 |
| | 5 | 120-150 | 1.8 |
| | 6 | 150-180 | 1.8 |
| KC07-64 | 1 | 0-70 | 8.1 |
| | 2 | 70-140 | 11.3 |
| | 3 | 140-210 | 11.5 |
| | 4 | 210-280 | 11.7 |
| | 5 | 280-350 | 11.8 |
| | 6 | 350-420 | 11.8 |
| KC07-66 | 1 | 0-50 | N.D. |
| | 2 | 50-100 | 2.8 |
| | 3 | 100-150 | 4.4 |
| | 4 | 150-200 | 4.5 |
| | 5 | 200-250 | 4.6 |
| | 6 | 250-300 | 4.6 |
| XD03-68 | 1 | 0-70 | 3.1 |
| | 2 | 70-140 | 3.4 |
| | 3 | 140-210 | 3.5 |
| | 4 | 210-280 | 3.7 |
| | 5 | 280-350 | 3.7 |
| XD03-69* | 1 | 0-30 | 2.6 |
| | 2 | 30-60 | 2.3 |
| | 3 | 60-90 | 2.3 |
| | 4 | 90-120 | 2.1 |
| | 5 | 120-150 | 2.2 |
| | 6 | 150-180 | 2.0 |
| XD03-70 | 1 | 0-70 | N.D. |
| | 2 | 70-140 | 2.7 |
| | 3 | 140-210 | 2.8 |
| | 4 | 210-280 | 2.8 |
| | 5 | 280-350 | 2.8 |
| | 6 | 350-420 | 2.8 |
| XD03-72 | 1 | 0-50 | N.D. |
| | 2 | 50-100 | 4.5 |
| | 3 | 100-150 | 6.7 |
| | 4 | 150-200 | 6.9 |
| | 5 | 200-250 | 7.1 |
| | 6 | 250-300 | 7.1 |
| KC07-68 | 1 | 0-50 | 1.4 |
| | 2 | 50-100 | 5.7 |
| | 3 | 100-150 | 7.2 |
| | 4 | 150-200 | 7.5 |
| | 5 | 200-250 | 8.0 |
| | 6 | 250-300 | 8.2 |
| KC07-70 | 1 | 0-30 | 1.9 |
| | 2 | 30-60 | 7.1 |
| | 3 | 60-90 | 8.8 |
| | 4 | 90-120 | 9.2 |
| | 5 | 120-150 | 9.3 |
| | 6 | 150-180 | 9.2 |
| KC07-72 | 1 | 0-30 | N.D. |
| | 2 | 30-60 | 2.5 |
| | 3 | 60-90 | 3.7 |
| | 4 | 90-120 | 3.7 |
| | 5 | 120-150 | 3.8 |
| | 6 | 150-180 | 3.9 |
| KC07-75 | 1 | 0-50 | 3.6 |
| | 2 | 50-100 | 6.5 |
| | 3 | 100-150 | 6.7 |
| | 4 | 150-200 | 7.0 |
| | 5 | 200-250 | 6.8 |
| | 6 | 250-300 | 6.7 |
| KC07-77 | 1 | 0-70 | 3.4 |
| | 2 | 70-140 | 7.4 |
| | 3 | 140-210 | 8.0 |
| | 4 | 210-280 | 8.0 |
| | 5 | 280-350 | 8.4 |
| KC07-78 | 1 | 0-50 | N.D. |
| | 2 | 50-100 | 1.9 |
| | 3 | 100-150 | 1.9 |
| | 4 | 150-200 | 2.5 |
| KC07-79 | 1 | 0-50 | 8.5 |
| | 2 | 50-100 | 8.4 |
| | 3 | 100-150 | 8.2 |
| | 4 | 150-200 | 8.7 |
| KC07-80 | 1 | 0-70 | 3.1 |
| | 2 | 70-140 | 6.6 |
| | 3 | 140-210 | 7.3 |
| | 4 | 210-280 | 8.3 |
| KC07-81 | 1 | 0-18 | 2.6 |
| | 2 | 18-36 | 2.8 |
| | 3 | 36-54 | 2.8 |
| | 4 | 54-72 | 2.8 |
| KC07-82 | 1 | 0-70 | 2.8 |
| | 2 | 70-140 | 3.9 |
| | 3 | 140-210 | 3.8 |
| | 4 | 210-280 | 3.8 |
| KC07-83 | 1 | 0-30 | 2.3 |
| | 2 | 30-60 | 2.3 |
| | 3 | 60-90 | 2.4 |
| | 4 | 90-120 | 2.3 |
| KC07-84 | 1 | 0-50 | 2.3 |
| | 2 | 50-100 | 6.5 |
| | 3 | 100-150 | 6.9 |
| | 4 | 150-200 | 7.3 |
| KC07-85 | 1 | 0-50 | 7.3 |
| | 2 | 50-100 | 6.3 |
| | 3 | 100-150 | 6.3 |
| | 4 | 150-200 | 6.3 |
| KC07-86 | 1 | 0-30 | 1.8 |
| | 2 | 30-60 | 1.8 |
| | 3 | 60-90 | 1.9 |
| | 4 | 90-120 | 1.9 |
| KC07-87 | 1 | 0-70 | 2.6 |
| | 2 | 70-140 | 3.1 |
| | 3 | 140-210 | 3.1 |
| | 4 | 210-280 | 3.1 |
| MC05-62 | 1 | 0-50 | 1.7 |
| | 2 | 50-100 | 4.2 |
| | 3 | 100-150 | 4.5 |
| | 4 | 150-200 | 4.8 |
| MC05-64 | 1 | 0-82 | 1.3 |
| | 2 | 82-164 | 7.5 |
| | 3 | 164-246 | 8.0 |
| | 4 | 246-328 | 8.6 |

Statistical parameters were determined for the samples from the LC data. Upon completion of the experiments in the DoE, the data was tabulated into the JMP DoE. The two variables that were modeled are D.S. and variance. The model was created by the standard least squares method and the two variables were fit separately. All linear effects and all second-degree cross effects were included in the initial creation of the model. Effects with large P values (above 0.05) were removed, as the likelihood that they affect the outcome is low.

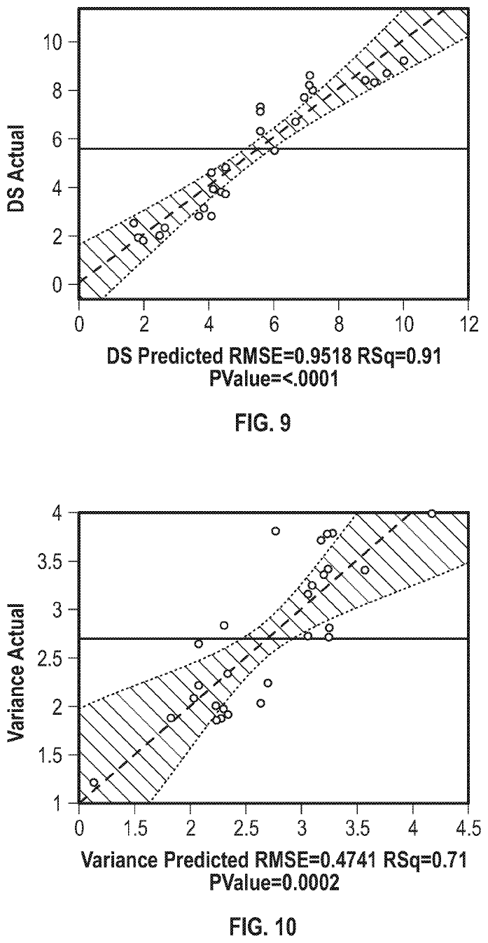

JMP Model for D.S.: The main effects for D.S. in order of relevance were temperature, residence time, eq. of PO 1, eq. of PO 2, temperature*PO 1, and temperature*PO 2. The equivalents of NaOH did not appear to have any strong effects on the model. The R² value is equal to 0.91. The low P-value of <0.0001 indicates that it is very likely the factors do influence the outcome of the D.S. FIG. 9 shows a plot of the actual D.S. versus the predicted D.S.

JMP Model for Variance: The main effects for variance in order of relevance were temperature, PO 1, temperature*residence time, PO 2, NaOH, and residence time (not a factor on its own, but residence time must stay included due to the third effect which includes it.) The fit for variance only has an R² value of 0.71, which isn't as strong as the model for D.S., but still shows a correlation (P-value=0.0002.) FIG. 10 shows a plot of the actual variance versus the predicted variance.

One possible reason for the weaker fit is that the ELSD method was not capable of separating HPBD with D.S. values >7. This leads to seemingly lower variance (sharper peaks and less D.S. distribution) but may not be reflective of the true variance. This effect can be seen more readily below in FIG. 18 which shows a general decreasing trend for variance with increasing D.S. after a certain D.S. has been achieved. In this case an alternative method for quantifying product distribution will be required (MALDI or ESI). SEC-MALLS analysis has been explored briefly with these materials and will be reexamined for efficacy.

### Example 6: DoE Model Validation

Various conditions (to reach D.S.=5-9) were chosen to test the accuracy of the model created in JMP to predict the degree of substitution and variance. The conditions and results are described in Tables 22-25.

TABLE 22
Experimental Parameters and predicted D.S. variance values

| | | Resi- | | | | | Pre- |
|---|---|---|---|---|---|---|---|
| | Temper- | dence | | | | Pre- | dicted |
| Exper- | ature | time | PO 1 | PO 2 | NaOH | dicted | Vari- |
| iment | (° C.) | (min) | (eq.) | (eq.) | (eq.) | D.S. | ance |
| KC07-88 | 53.2 | 30 | 13.95 | 10.75 | 5 | 7.2 | 2.1 |
| KC07-89 | 40.3 | 36.5 | 14.4 | 15 | 5 | 5.3 | 2.2 |
| KC07-90 | 57.4 | 57 | 13.48 | 9.75 | 5 | 9.0 | 1.7 |
| KC07-91 | 58.4 | 70 | 7.15 | 7.5 | 5 | 6.9 | 2.0 |

TABLE 23
Flow rates for model validation experiments

| | βCD Flow Rate | PO 1 Flow Rate | PO 2 Flow |
|---|---|---|---|
| Experiment | (g/min) | (g/min) | Rate (g/min) |
| KC07-88 | 1.65 | 0.31 | 0.24 |
| KC07-89 | 1.32 | 0.25 | 0.26 |
| KC07-90 | 0.88 | 0.16 | 0.11 |
| KC07-91 | 0.79 | 0.08 | 0.08 |

TABLE 24
D.S. Results and LC data for DoE model validation experiments.

| Experiment | Sample | Time (min) | D.S. |
|---|---|---|---|
| KC07-88 | 1 | 0-30 | 2.2 |
| | 2 | 30-60 | 6.9 |
| | 3 | 60-90 | 7.6 |
| | 4 | 90-120 | 7.7 |
| KC07-89 | 1 | 0-36.5 | 2.8 |
| | 2 | 36.5-73 | 3.9 |
| | 3 | 73-109.5 | 4.0 |
| | 4 | 109.5-145.5 | 4.0 |
| KC07-90 | 1 | 0-57 | 9.6 |
| | 2 | 57-114 | 10.4 |
| | 3 | 114-171 | 10.4 |
| | 4 | 171-228 | 10.3 |
| KC07-91 | 1 | 0-70 | 2.6 |
| | 2 | 70-140 | 6.2 |
| | 3 | 140-210 | 6.9 |
| | 4 | 210-280 | 7.3 |

TABLE 25
D.S. and statistical parameters determined
for HPBCD samples in DoE model validation

| Exper- | Sam- | | | Me- | | Vari- | Skew- | Kur- |
|---|---|---|---|---|---|---|---|---|
| iment | ple | D.S. | Mean | dian | Sigma | ance | ness | tosis |
| KC07-88 | 1 | 2.2 | 8.68 | 9.04 | 2.52 | 6.36 | 0.05 | −1.27 |
| | 2 | 6.9 | 12.26 | 12.37 | 1.43 | 2.05 | −0.61 | 1.07 |
| | 3 | 7.6 | 12.51 | 12.59 | 1.34 | 1.81 | −0.51 | 0.77 |
| | 4 | 7.7 | 12.59 | 12.68 | 1.33 | 1.76 | −0.50 | 0.82 |
| KC07-89 | 1 | 2.8 | 9.17 | 9.39 | 2.01 | 4.06 | −0.17 | −0.80 |
| | 2 | 3.9 | 10.35 | 10.57 | 1.75 | 3.07 | −0.50 | −0.04 |
| | 3 | 4.0 | 10.41 | 10.60 | 1.74 | 3.04 | −0.50 | 0.04 |
| | 4 | 4.0 | 10.45 | 10.65 | 1.73 | 3.00 | −0.53 | 0.08 |
| KC07-90 | 1 | 9.6 | 13.33 | 13.38 | 1.22 | 1.49 | −0.30 | 0.21 |
| | 2 | 10.4 | 13.62 | 13.65 | 1.16 | 1.36 | −0.20 | 0.06 |
| | 3 | 10.4 | 13.63 | 13.67 | 1.16 | 1.34 | −0.24 | 0.09 |
| | 4 | 10.3 | 13.63 | 13.67 | 1.17 | 1.38 | −0.27 | 0.19 |
| KC07-91 | 1 | 2.6 | 8.87 | 9.07 | 2.28 | 5.20 | 0.11 | −0.94 |
| | 2 | 6.2 | 11.92 | 12.05 | 1.50 | 2.26 | −0.64 | 0.91 |
| | 3 | 6.9 | 12.28 | 12.37 | 1.39 | 1.94 | −0.58 | 1.05 |
| | 4 | 7.3 | 12.38 | 12.47 | 1.37 | 1.88 | −0.53 | 0.89 |

The predicted D.S. and variance were quite close (<8% error) to the experimental values for KC07-88 and KC07-91, the experiments with D.S. close to 7. The model was the weaker on the low and high ends of the design space for D.S.=5 and 9. Table 26 shows a summary of the actual and predicted D.S. and variance.

TABLE 26
Summary of actual vs. predicted D.S. and variance

| | Pre- | Ac- | Updated | Pre- | Ac- | Updated |
|---|---|---|---|---|---|---|
| Exper- | dicted | tual | Model | dicted | tual | Model |
| iment | DS | DS | DS | Variance | Variance | Variance |
| KC07-88 | 7.2 | 7.7 | 7.6 | 2.1 | 1.8 | 2.1 |
| KC07-89 | 5.3 | 4.0 | 5.0 | 2.2 | 3.0 | 2.3 |
| KC07-90 | 9.0 | 10.3 | 9.4 | 1.7 | 1.4 | 1.6 |
| KC07-91 | 6.9 | 7.3 | 7.3 | 2.0 | 1.9 | 2.1 |

The data points from these four additional experiments were included in the model and it was reprocessed. This brought the predicted values very close to the actual result for both D.S. and variance for the experiments for D.S.=7. The predicted results for the low and high end of the design space were also tightened closer to the actual values. It can be concluded that the model is very strong for predicting the degree of substitution near the center point of the design space (D.S.=7).

An experiment (KC07-92) was performed to directly test the effect of NaOH equivalents on resulting variance in HPBCD. This was run under the same conditions as experiment KC07-88, but with 10 equivalents of NaOH instead of 5. The conditions are in Tables 27 and 28 below, followed by the results in Table 29 and statistical data in Table 30.

TABLE 27
Experimental conditions for KC07-92

| | Temperature | Residence time | PO 1 | PO 2 | NaOH |
|---|---|---|---|---|---|
| Experiment | (° C.) | (min) | (eq.) | (eq.) | (eq.) |
| KC07-92 | 53.2 | 30 | 13.95 | 10.75 | 10 |

TABLE 28
Flow rates for KC07-92

| | βCD Flow Rate | PO 1 Flow Rate | PO 2 Flow |
|---|---|---|---|
| Experiment | (g/min) | (g/min) | Rate (g/min) |
| KC07-92 | 1.77 | 0.33 | 0.25 |

TABLE 29
Data from KC07-92

| Experiment | Sample | Time (min) | D.S. |
|---|---|---|---|
| KC07-92 | 1-2 | 0-60 | 5.9 |
| | 3 | 60-90 | 7.7 |
| | 4 | 90-120 | 7.6 |

TABLE 30
Statistical Data from KC07-92

| Exper- | Sam- | | | Me- | | Vari- | Skew- | Kur- |
|---|---|---|---|---|---|---|---|---|
| iment | ple | D.S. | Mean | dian | Sigma | ance | ness | tosis |
| KC07-92 | 1-2 | 5.9 | 12.07 | 12.32 | 1.88 | 3.54 | −0.82 | 0.84 |
| | 3 | 7.7 | 12.73 | 12.85 | 1.51 | 2.29 | −0.60 | 0.86 |
| | 4 | 7.6 | 12.73 | 12.85 | 1.51 | 2.29 | −0.62 | 0.92 |

The resulting D.S. was very close to that of KC07-88, but the variance increased from 1.8 to 2.3. This shows a direct correlation between NaOH equivalents and product distribution as predicted by the response surface.

### Example 7: Development of HPBCD Isolation by Precipitation

Efforts were made to develop a process for isolation of HPBCD by precipitation, rather than by spray-drying or lyophilization. An experiment (MC05-46) was performed using a stock solution of previously isolated HPBCD. The procedure is captured in Table 31 below.

TABLE 31
MC05-46 operations

| Operation | Description | Material |
|---|---|---|
| Form HPBCD | Dissolve HPBCD (lot KN01-69-5) | 20.1 g HPBCD 47 g |
| solution | | DI water |
| Azeotropic | Add ethanol, distill via rotovap with 40° C. bath, 100-20 mbar | 400 mL EtOH (20 V) |
| drying strip 1 | pressure | added. Distilled to |
| | | 57.5 g total mass |
| | | remaining |
| Azeotropic | Add ethanol, distill via rotovap with 40° C. bath, 100-20 mbar | 400 mL EtOH (20 V) |
| drying strip 2 | pressure | Distilled to 72.0 g |
| | | total mass remaining |
| Azeotropic | Add ethanol, distill via rotovap with 40° C. bath, 100-20 mbar | 400 mL EtOH (20 V) |
| drying strip 3 | pressure | Distilled to 79.6 g |
| | | total mass remaining |
| Final ethanol | Added back ethanol to achieve 100 g total solution mass | 20.4 g EtOH added |
| addition | Mixture remains a colorless solution throughout azeotropic | |
| | drying. | |
| Precipitation | Solution is warmed with magnetic stirring to 40° C. Acetone is | 400 mL acetone |
| with acetone | charged over 30 minutes. HPBCD precipitates over the course | added over 30 min |
| | of this addition. | |
| Cool to 0° C. | The mixture is cooled to 0° C. over 2 hours | |
| Filtration | The mixture is filtered using a disposable filter funnel. Solid | 465 mL mother |
| | settles well when stirring is stopped and filters quickly. | liquor |
| | | obtained |
| Drying | The filter cake is dried at ambient temperature in a vacuum oven | 11.0 g HPBCD |
| | for 65 hours. Dry solid is given lot # MC05-46-A | recovered |

The solid isolated from this process was analyzed using a number of techniques.

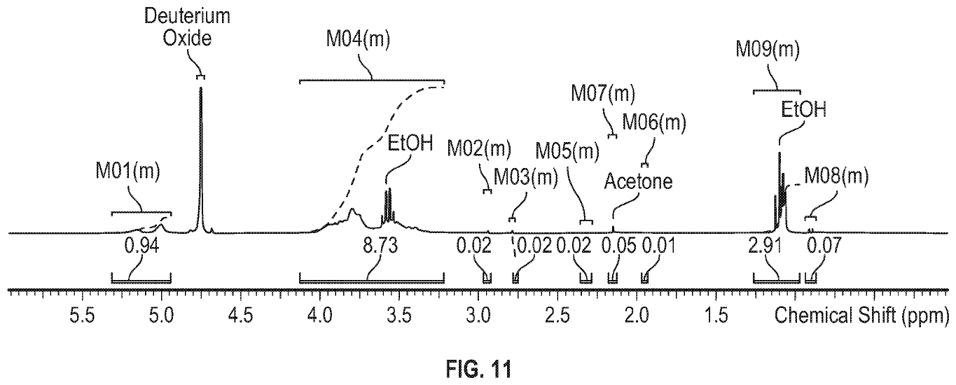

¹H NMR of the isolated solid showed ethanol and acetone still present in the solid despite several days of drying in a vacuum oven. A number of low-level peaks are also present, which were not in the starting material for this experiment. The origin of these is unclear. The ¹H NMR data is shown in FIG. 11.

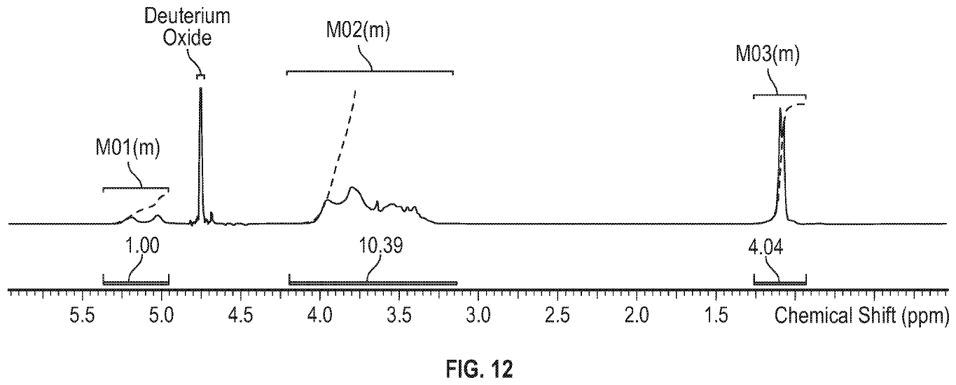

In order to determine the D.S. of material remaining in the mother liquor, the mother liquor was concentrated to dryness via rotovap, re-dissolved in water, and dried via lyophilization. The resulting solid was given lot #MC05-46-A and analyzed by ¹H NMR. The ¹H NMR spectrum is shown in FIG. 12.

The D.S. of the material remaining in the mother liquor calculated using Equation 1 is 9.4, which is a substantial increase from the D.S. of the input material. Use of this approach to fractionate HPBCD and provide material of narrow distribution would require a much larger amount of dedicated development.

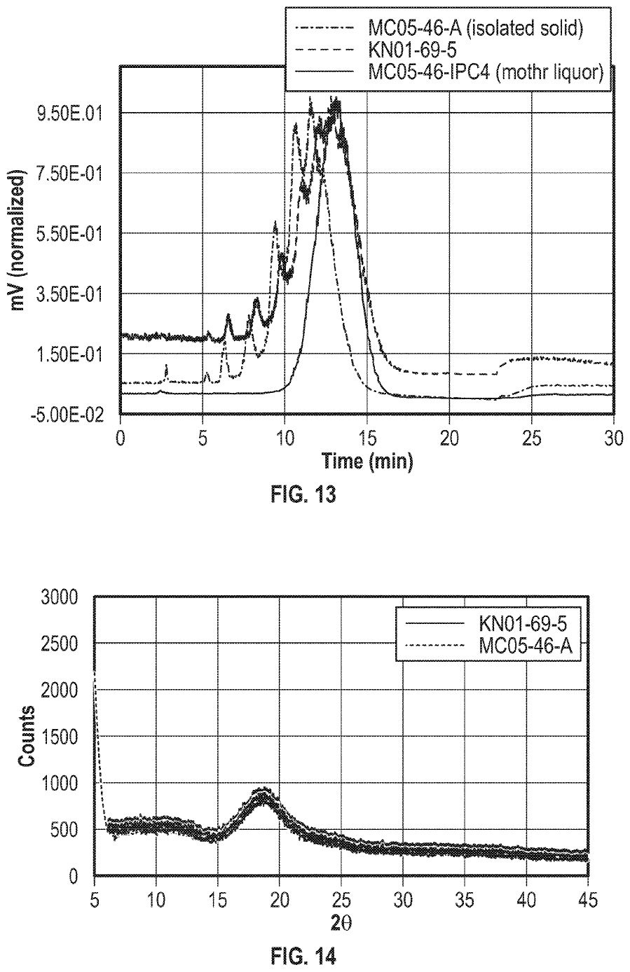

Both the isolated solid and the mother liquor were analyzed by HPLC-ELSD. These chromatograms are overlayed in FIG. 13, along with a chromatogram of the ingoing material, lot #KN01-69-5.

It is clear that D.S. has a substantial effect on the solubility of HPBCD under these precipitation conditions. The isolated solid eluted earlier than the starting material (peak centered at 11 minutes rather than 12.5 minutes), indicating lower D.S. HPBCD in the mother liquor elutes later (peak centered at 13 minutes), indicating higher D.S. Lower D.S. material had a lower solubility in the ethanol/acetone solvent system used for isolation, and is preferentially isolated, leaving higher D.S. material in the mother liquor. This isolation procedure was performed relatively quickly, with no extended granulation times beyond two hours of cooling time. An extended stir may help increase the yield of higher D.S. material, as well as altering the composition of the solvent system used to precipitate the material.

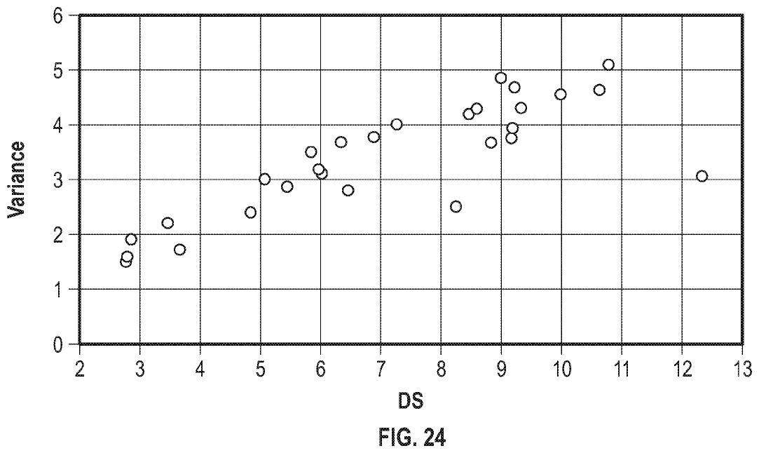

The isolated solid was analyzed using a Bruker D2 Phaser PXRD instrument to assess crystallinity. This PXRD pattern is captured in FIG. 24, overlayed with that of the starting material. The x ray diffraction patterns of the ingoing material, which was isolated by lyophilization, and the precipitated material are identical, and do not show crystallinity.

The bulk density of the isolated solid was determined by submerging a known mass into hexane in a graduated cylinder and recording the change in volume. The density determined in this manner was 1.25 g/mL. The density was also approximated by placing a known mass of dry material into a graduated cylinder. By this method, the density was 0.37 g/mL.

### Example 8: Attempted Fractionation of HPBCD of Varying D.S. Based on Solubility

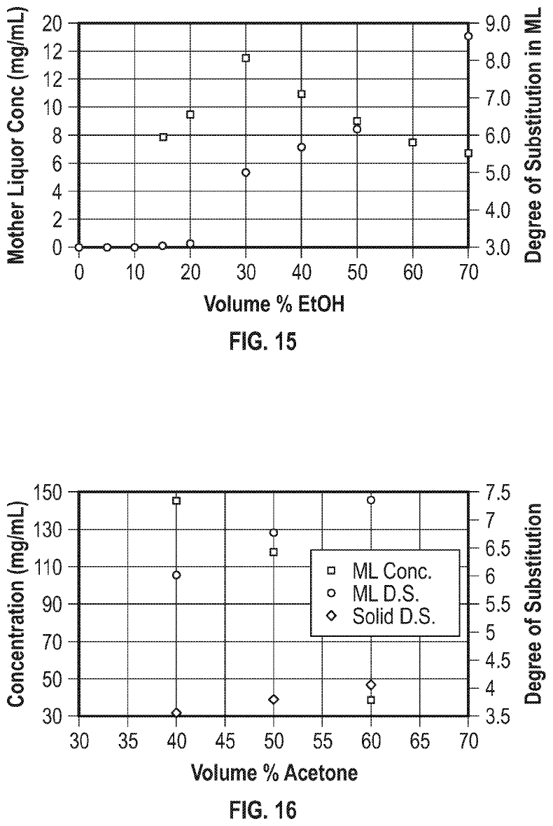

Studies were done in an ethanol/acetone solvent system to determine the volume ratio of the two solvents at which certain high/low D.S. HPBCD will selectively precipitate or dissolve. In experiment KC07-95, 10 g of dry HPBCD (lot KN01-69-5) was slurried in 4 volumes of acetone. Ethanol was added to the solution stepwise, and the slurry was allowed to settle before the mother liquor was sampled at each stage. The mother liquor concentration and D.S. of the material in the mother liquor is shown in FIG. 15.

The HPBCD appeared to start dissolving between 10-20 vol % EtOH. At 30% EtOH, about one third of the HPBCD had gone into solution, and the D.S. of that material was ˜8, which is considerably higher than the bulk HPBCD, which has a D.S. of ˜6.3 as calculated from HPLC-ELSD data.

This study was then performed in reverse in KC07-96 starting by dissolving HPBCD from the same lot in pure ethanol. Acetone was then added in steps to track the amount of low D.S. HPBCD that precipitates out first. The results are shown in FIG. 16.

Most material precipitates between 50-60 volume % acetone, with the D.S. of the mother liquor increasing with each acetone addition. The LC data of the samples taken throughout these experiments are in Table 32.

TABLE 32
Summary of fractionation experiments (KC07-95 and KC07-96)

| | | | Concentration |
|---|---|---|---|
| Sample | Description | D.S. | (mg/mL) |
| KC07-95-1 | Mother liquor of 100% | N/A | 0 |
| | acetone HPBCD slurry | | |
| KC07-95-2 | Mother liquor of 5% | N/A | 0 |
| | EtOH/95% Acetone mixture | | |
| KC07-95-3 | Mother liquor of 10% EtOH/ | N/A | 0 |
| | 90% Acetone mixture | | |
| KC07-95-4 | Mother liquor of 15% | 6.0 | 1.8 |
| | EtOH/90% Acetone mixture | | |
| KC07-95-5 | Mother liquor of 20% EtOH/ | 6.6 | 3.0 |
| | 80% Acetone mixture | | |
| KC07-95-6 | Mother liquor of 30% EtOH/ | 8.1 | 53.8 |
| | 70% Acetone mixture | | |
| KC07-95-7 | Mother liquor of 40% EtOH/ | 7.1 | 72.1 |
| | 60% Acetone mixture | | |
| KC07-95-8 | Mother liquor of 50% EtOH/ | 6.4 | 85.1 |
| | 50% Acetone mixture | | |
| KC07-95-9 | Mother liquor of 60% EtOH/ | 5.8 | 72.7 |
| | 40% Acetone mixture | | |
| KC07-95-10 | Mother liquor of 70% EtOH/ | 5.5 | 151.3 |
| | 30% Acetone mixture | | |
| KC07-96-1-ML | Mother liquor of 40% | 6.0 | 145.0 |
| | Acetone/60% EtOH mixture | | |
| KC07-96-1-sol | Solids of 40% Acetone/60% | 3.6 | N/A |
| | EtOH mixture | | |
| KC07-96-2-ML | Mother liquor of 50% | 6.8 | 118.0 |
| | Acetone/50% EtOH mixture | | |
| KC07-96-2-sol | Solids of 50% Acetone/50% | 3.8 | N/A |
| | EtOH mixture | | |
| KC07-96-3-ML | Mother liquor of 60% | 7.3 | 39.2 |
| | Acetone/40% EtOH mixture | | |
| KC07-96-3-sol | Solids of 60% Acetone/40% | 4.1 | N/A |
| | EtOH mixture | | |

From these studies, it is clear that HPBCD can be precipitated to remove either high or low-end D.S. material. An experiment was done to test removing the high and low end D.S. material from a sample by first dissolving the high D.S. HPBCD and discarding the mother liquor, and then remove the low D.S. HPBD by precipitation. The goal of this is to move the D.S. of the bulk material closer to 7 and to improve the product distribution. This was carried out in experiment KC07-99, summarized in Table 33.

TABLE 33
Summary of fractionation experiment KC07-99

| | | | Vari- |
|---|---|---|---|
| Description | Sample | D.S. | ance |
| Starting material, dry HPBCD | KC07-99-SM | 6.4 | 2.8 |
| Slurry 10 g HPBCD (KN01-69-5) in 4 | KC07-99-ML1 | 9.1 | 1.7 |
| vol. acetone, then slowly add in EtOH | KC07-99-sol1 | 5.7 | 3.3 |
| until it reaches 30 vol %. Filter | | | |
| off solids from mother liquor. | | | |
| Dissolve solids into ~3 vol. | KC07-99-sol2 | 4.0 | 3.7 |
| EtOH. Add acetone slowly up to 45 vol | KC07-99-ML2 | 6.8 | 2.4 |
| %. Filter off solids from mother liquor. | | | |

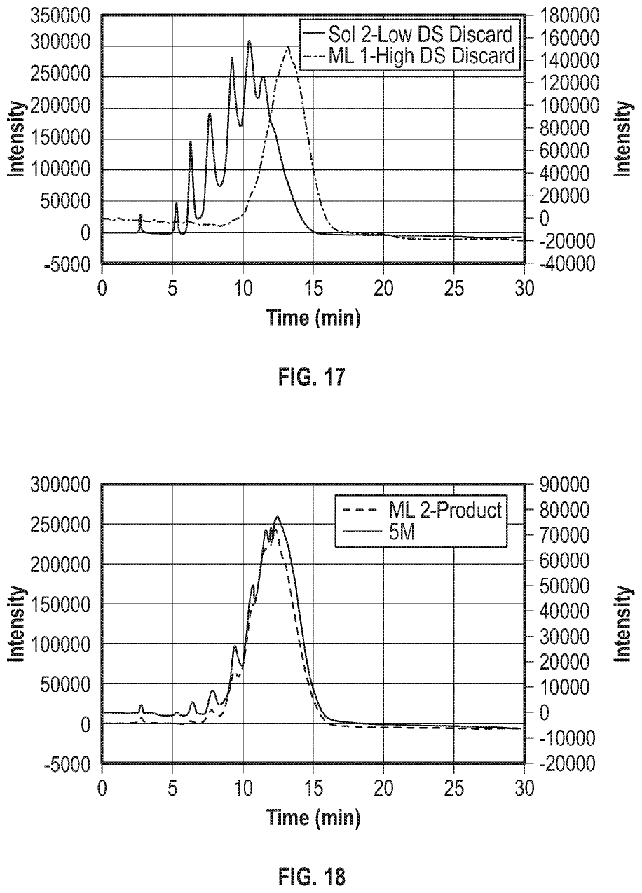

FIGS. 17 and 18 overlay the ELSD data from this experiment. FIG. 17 shows the fractions that were part of the discarded material (low and high D.S. HPBCD.) FIG. 18 shows the starting material trace overlayed with the “product” from this process. The product distribution was slightly improved, and the overall D.S. as determined by HPLC-ELSD was shifted from 6.4 to 6.8. The approximate yield of this study was 50% based on the ELSD calibration curve. With a lower yield, the D.S. is likely able to be shifted even closer to 7. Results indicated that while some fractionation is possible with ethanol/acetone solvent systems, the process is low yielding and grants only partial material upgrades.

To isolate a few grams of the high DS material like KC07-99-ML1, the first step of the experiment was repeated. 10 grams of KN01-69-5 HPBCD was slurried in 4 volumes of acetone. Ethanol was added slowly to reach 30 vol %. After stirring for a few minutes, the mother liquor was filtered off from the solids. The resulting mother liquor was stripped down to a solid, redissolved in water, and lyophilized to yield 2.1 grams of solids. The solids were analyzed by MALDI-TOF to determine the DS and product distribution, the data for which is shown in Table 34.

TABLE 34
MALDI-TOF Data for KC08-03-ML

| Sample | Mean D.S. | Median D.S. | Std. Dev. | Variance |
|---|---|---|---|---|
| KC08-03-ML | 9.21 | 9.0 | 1.82 | 3.32 |

### Example 9: MALDI-TOF Analysis of Functionalized Cyclodextrin Materials

Due to current limitations in accurately assessing the product distribution of functionalized cyclodextrin compounds (HPACD, HPBCD, and HPGCD) MALDI-TOF has been proposed as a superior alternative to analyze these materials. MALDI analysis should provide definitive understanding of the product distribution of these products.

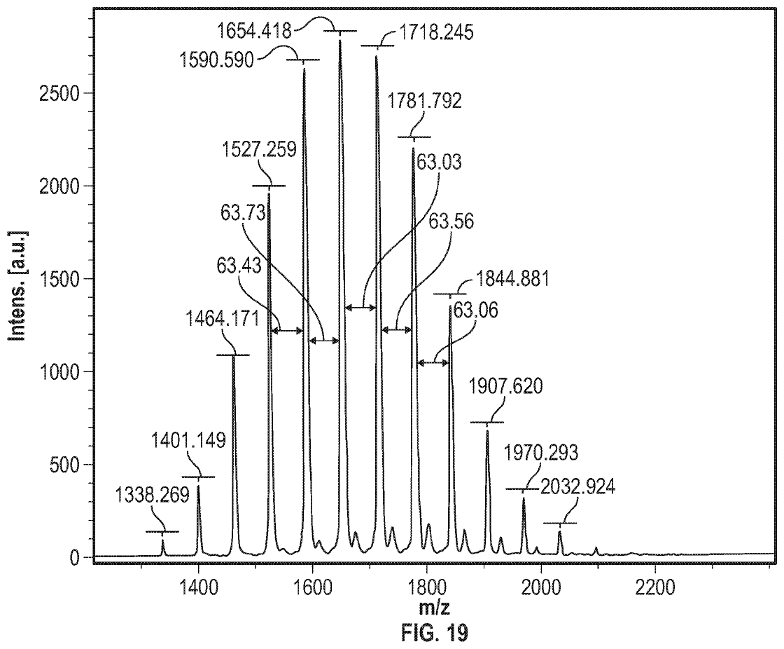

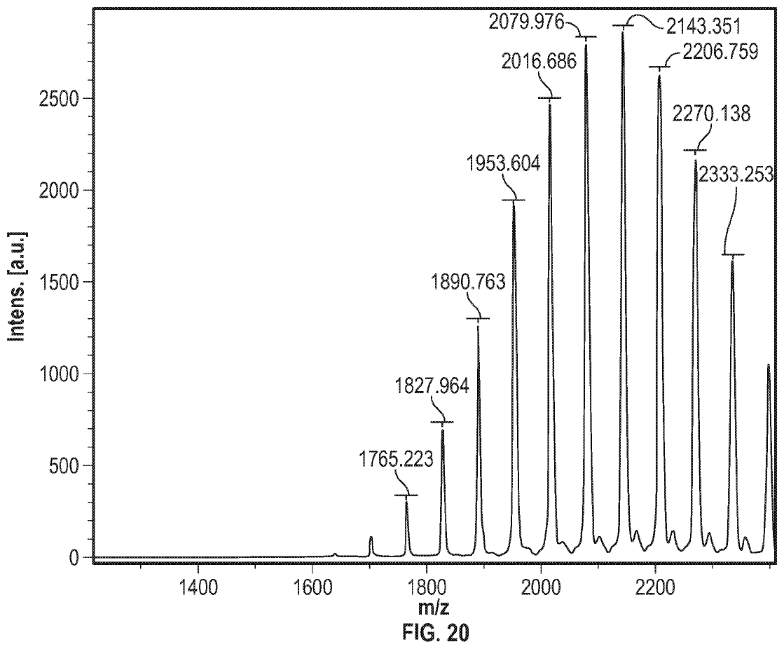

An initial set of feasibility experiments was carried out using purified HPBCD (lot KN01-69-5) and purified HPGCD (lot MC05-37-A). These experiments were carried out without using an internal or external reference for calibration of the time-of-flight (TOF). Raw data for analysis of these materials using a 2,5-dihydroxybenzoic acid matrix are provided in FIGS. 19 and 20.

As can be seen in FIGS. 19 and 20, MALDI-TOF worked quite well for both of these samples. Due to not using a calibrant, the measured m/z values and spacings were not accurate. A simple correction can be applied without using a calibrant by assuming the expected m/z values for the sodium ions of these species. The corrected data is provided below in Table 35. Future experiments will incorporate a calibration step with an appropriate standard such as unfunctionalized beta-cyclodextrin.

TABLE 35
Tabulated experimental and corrected data
for MALDI-TOF feasibility experiments

| | | | | Molecular | Calculated |
|---|---|---|---|---|---|
| | Peak | Observed | Corrected | weight | D.S. |
| Sample | number | [M + Na]⁺ | [M + Na]⁺ | of peak | of peak |
| KN01-69-5 | 1 | 1338.269 | 1216.194 | 1193.204 | 1.002 |
| (HPBCD, D.S. | 2 | 1401.149 | 1273.918 | 1250.928 | 1.996 |
| 6.9) | 3 | 1464.171 | 1331.772 | 1308.782 | 2.992 |
| | 4 | 1527.259 | 1389.687 | 1366.697 | 3.989 |
| | 5 | 1590.69 | 1447.917 | 1424.927 | 4.992 |
| | 6 | 1654.418 | 1506.419 | 1483.429 | 5.999 |
| | 7 | 1718.246 | 1565.013 | 1542.023 | 7.008 |
| | 8 | 1781.792 | 1623.348 | 1600.358 | 8.012 |
| | 9 | 1844.881 | 1681.264 | 1658.274 | 9.010 |
| | 10 | 1907.62 | 1738.858 | 1715.869 | 10.001 |
| | 11 | 1970.293 | 1796.392 | 1773.402 | 10.992 |
| | 12 | 2032.924 | 1853.887 | 1830.898 | 11.982 |
| MC05-37-A | 1 | 1639.700 | 1495.641 | 1472.651 | 3.023 |
| (HPGCD, D.S. | 2 | 1702.460 | 1553.362 | 1530.372 | 4.016 |
| 9.3) | 3 | 1765.223 | 1611.085 | 1588.095 | 5.010 |
| | 4 | 1827.984 | 1668.806 | 1645.816 | 6.004 |
| | 5 | 1890.763 | 1726.544 | 1703.554 | 6.998 |
| | 6 | 1953.604 | 1784.339 | 1761.349 | 7.993 |
| | 7 | 2016.686 | 1842.355 | 1819.365 | 8.992 |
| | 8 | 2079.978 | 1900.565 | 1877.575 | 9.995 |
| | 9 | 2143.351 | 1958.849 | 1935.859 | 10.998 |
| | 10 | 2206.759 | 2017.165 | 1994.176 | 12.002 |
| | 11 | 2270.138 | 2075.455 | 2052.465 | 13.006 |
| | 12 | 2333.253 | 2133.502 | 2110.512 | 14.005 |
| | 13 | 2396.370 | 2191.551 | 2168.561 | 15.005 |

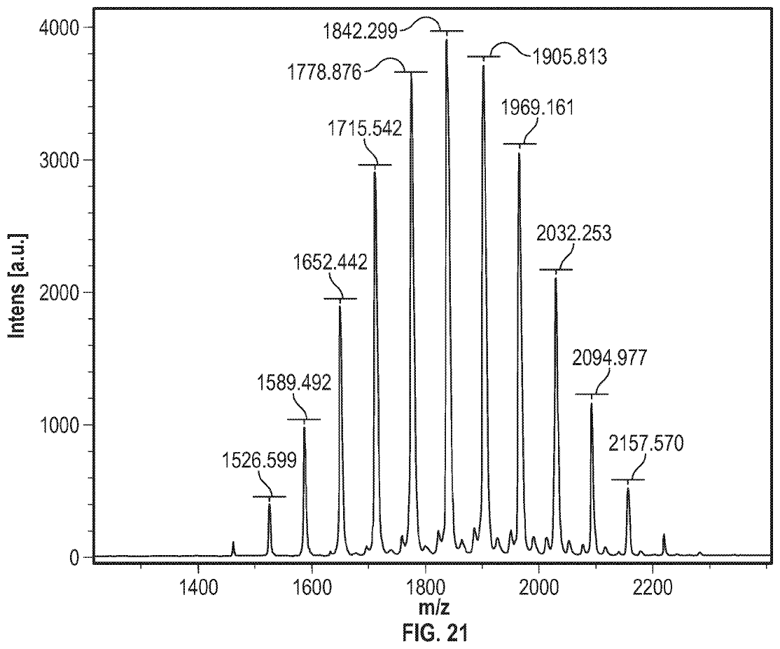

Ideally, MALDI-TOF would allow analysis of crude unpurified samples after the process to allow for facile and accurate analysis of the product D.S. and the product distribution. This would then be able to be directly applied to the reserved process samples from the DoE dataset and improve the overall accuracy of the response surface. To test this, a crude process sample was analyzed using the same matrix as above. This worked similarly as well as the purified samples. The raw data is provided in FIG. 21. This was sample KC07-60-6 with an expected D.S. of 7.7 as determined by HPLC-ELSD. Similarly as above a calibrant was not used with analysis of this sample resulting in inaccurate m/z values. A similar correction as above was applied to the data using the expected m/z values and is shown in Table 36. Future experiments will incorporate a calibration step for accuracy.

TABLE 36
Tabulated experimental and corrected data
for MALDI-TOF feasibility experiments

| | | | | Molecular | Calculated |
|---|---|---|---|---|---|
| | Peak | Observed | Corrected | weight | D.S. |
| Sample | number | [M + Na]⁺ | [M + Na]⁺ | of peak | of peak |
| KC07-60-6 | 1 | 1463.710 | 1332.758 | 1309.768 | 3.009 |
| (HPBCD, D.S. | 2 | 1526.599 | 1390.565 | 1367.576 | 4.004 |
| 7.7) | 3 | 1589.492 | 1448.377 | 1425.387 | 5.000 |
| | 4 | 1652.442 | 1506.240 | 1483.250 | 5.996 |
| | 5 | 1715.542 | 1564.242 | 1541.252 | 6.995 |
| | 6 | 1778.876 | 1622.458 | 1599.469 | 7.997 |
| | 7 | 1842.299 | 1680.757 | 1657.767 | 9.001 |
| | 8 | 1905.813 | 1739.139 | 1716.149 | 10.006 |
| | 9 | 1969.161 | 1797.368 | 1774.379 | 11.009 |
| | 10 | 2032.253 | 1855.363 | 1832.373 | 12.007 |
| | 11 | 2094.977 | 1913.018 | 1890.029 | 13.000 |
| | 12 | 2157.570 | 1970.554 | 1947.564 | 13.991 |
| | 13 | 2220.160 | 2028.087 | 2005.097 | 14.981 |

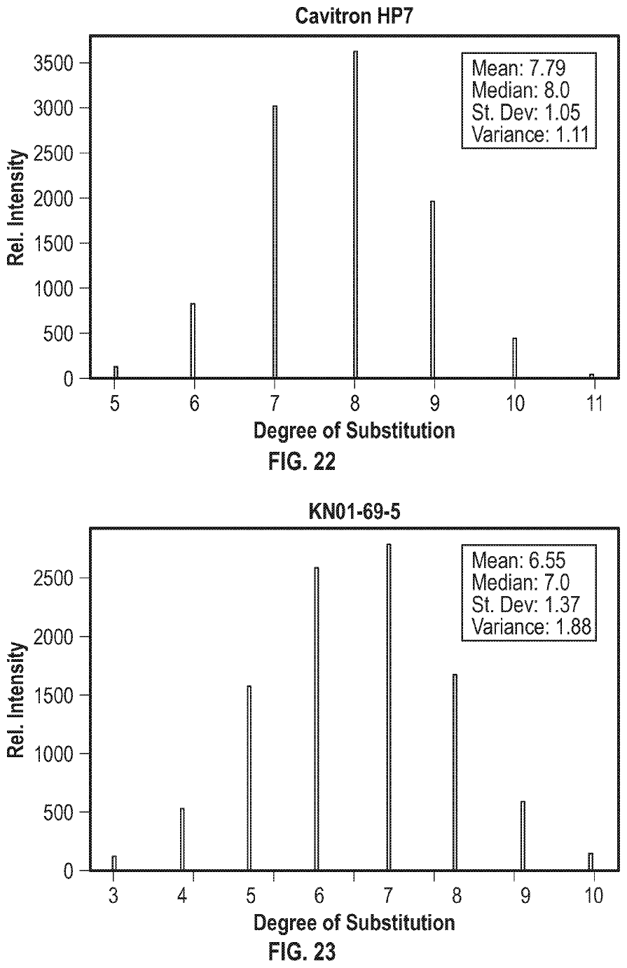

After validating MALDI-TOF for analysis of these materials, the previous two lots were analyzed again incorporating a calibration step. The resulting spectra were then analyzed converting the mass of each signal into the corresponding D.S. By taking the area under each species, the average D.S. and the standard deviation across the product distribution was then determined. These are summarized in FIGS. 22 and 23. The Cavitron HP7 material showed 7 distinct species above the limit of detection under the acquisition parameters with 5 major species being observed. The KN01-69-5 material showed 8 distinct species with overall a broader distribution. As expected based on HPLC-ELSD data the Cavitron HP7 showed a narrower product distribution, however overall the two lots were reasonably similar.

Once MALDI-TOF was confirmed to be feasible to determine degree of substitution and product distribution for the crude HPBCD samples, all the samples from the DoE could be analyzed. Table 37 includes the summary of all MALDI-TOF data for this work. Overall, the resulting D.S. is shifted slightly higher when compared to the ELSD data. The MALDI-TOF data is likely more accurate since the peaks are well separated, unlike the higher D.S. material on the ELSD column.

TABLE 37
DoE MALDI-TOF Data Summary

| DoE Flow | | | | |
|---|---|---|---|---|
| Run Expt. | Mean D.S. | Median D.S. | Std. Dev. | Variance |
| KC07-56 | 6.86 | 7 | 1.94 | 3.76 |
| KC07-58 | 9.16 | 9 | 1.93 | 3.74 |
| KC07-60 | 8.82 | 9 | 1.91 | 3.66 |
| KC07-62 | 2.87 | 3 | 1.38 | 1.92 |
| KC07-64 | 12.31 | 12 | 1.74 | 3.04 |
| KC07-66 | 6.33 | 6 | 1.92 | 3.67 |
| XD03-68 | 5.97 | 6 | 1.79 | 3.19 |
| XD03-69 | 3.66 | 4 | 1.31 | 1.73 |
| XD03-70 | 5.45 | 5 | 1.70 | 2.87 |
| XD03-72 | 9.17 | 9 | 1.98 | 3.93 |
| KC07-68 | 9.30 | 9 | 2.08 | 4.31 |
| KC07-70 | 10.75 | 11 | 2.25 | 5.07 |
| KC07-72 | 5.82 | 6 | 1.87 | 3.49 |
| KC07-75 | 8.58 | 9 | 2.07 | 4.29 |
| KC07-77 | 10.61 | 11 | 2.15 | 4.62 |
| KC07-78 | 3.46 | 3 | 1.49 | 2.22 |
| KC07-79 | 9.22 | 9 | 2.16 | 4.67 |
| KC07-80 | 8.97 | 9 | 2.20 | 4.83 |
| KC07-81 | 4.83 | 5 | 1.55 | 2.40 |
| KC07-82 | 6.01 | 6 | 1.76 | 3.11 |
| KC07-83 | 2.79 | 3 | 1.26 | 1.59 |
| KC07-84 | 8.23 | 8 | 1.59 | 2.52 |
| KC07-85 | 7.27 | 7 | 2.00 | 4.00 |
| KC07-86 | 2.76 | 3 | 1.22 | 1.50 |
| KC07-87 | 5.05 | 5 | 1.73 | 3.00 |
| MC05-62 | 6.45 | 6 | 1.67 | 2.79 |
| MC05-64 | 9.97 | 10 | 2.13 | 4.55 |
| KC07-93 | 8.45 | 8 | 2.05 | 4.19 |

The MALDI-TOF data was brought into JMP to create a statistical model to be able to predict D.S. and variance for certain process parameters. The model was created in the same way as before, by first bringing in all effects (temperature, residence time, propylene oxide 1 equiv., propylene oxide 2 equiv., and NaOH equiv.) and all cross effects. The model for D.S. and variance were fit together, and the effects that were not contributing strongly to the model were removed.

The R² value for the D.S. model is 0.93, which shows that there is a strong correlation between the effects and the resulting D.S. For variance, the R² value is 0.78. The model is not as strong for predicting variance. It has been observed that the variance is generally higher for material with a higher D.S., as shown in FIG. 24. It seems that the parameters that affect D.S. also affect the variance, and that with this reactor setup we are unable to fully decouple one from the other. We are currently studying the data to determine if there are any correlations between the variance and other factors in the experiment that aren't directly in the JMP model.

The prediction profiler was used again to determine the conditions that would minimize variance while targeting a D.S. of 7. These conditions were tested in the model validation studies. Flow experiments were done on the DoE reactor to validate the model created in JMP using the MALDI-TOF data. The conditions are summarized in Tables 38 and 39.

TABLE 38
Experimental parameters and predicted D.S. and variance values

| | | Resi- | | | | | Pre- |
|---|---|---|---|---|---|---|---|
| | Temper- | dence | | | | Pre- | dicted |
| Exper- | ature | time | PO 1 | PO 2 | NaOH | dicted | Vari- |
| iment | (° C.) | (min) | (eq.) | (eq.) | (eq.) | D.S. | ance |
| KC08-04 | 40.9 | 30 | 15 | 15 | 7.97 | 7.0 | 2.9 |
| KC08-05 | 53.4 | 41.3 | 7 | 6.75 | 5 | 7.0 | 3.4 |
| KC08-06 | 30.0 | 70 | 7 | 3.5 | 5 | 6.5 | 3.7 |

TABLE 39
Flow rates for model validation experiments

| | βCD Flow | PO 1 Flow | PO 2 Flow |
|---|---|---|---|
| Experiment | Rate (g/min) | Rate (g/min) | Rate (g/min) |
| KC08-04 | 1.65 | 0.33 | 0.33 |
| KC08-05 | 1.36 | 0.13 | 0.12 |
| KC08-06 | 0.83 | 0.08 | 0.04 |

The fourth residence time was collected for each flow run and prepared for analysis on MALDI-TOF. The results are in Table 40.

TABLE 40
MALDI-TOF data from model validation experiments

| Experiment | Mean D.S. | Median D.S. | Std. Dev. | Variance |
|---|---|---|---|---|
| KC08-04 | 5.91 | 6.0 | 1.78 | 3.16 |
| KC08-05 | 7.20 | 7.0 | 1.78 | 3.17 |
| KC08-06 | 6.71 | 7.0 | 1.86 | 3.46 |

The D.S. for KC08-04 was lower than the model predicted value by about 1, while the other two were quite close, within 0.2 degrees of substitution. This is likely because some of the process parameters for KC08-04 were on the very edge of the design space. The variance was predicted within ˜0.25 for all validation studies. These values will be added into the JMP model to further increase the ability to predict D.S. and variance outcomes.

It was hypothesized that an effect on variance could be the dual injection of propylene oxide, and that a single injection would result in a lower variance. Two past experiments (KC07-56 and KC07-85) were replicated with the only difference being that the propylene oxide was delivered in one injection in a slightly lower amount. The conditions are in Table 41, with the results following in Table 42. The results from the original experiments have been included in the results table.

TABLE 41
Experimental conditions for KC08-07 and KC08-08

| | | Resi- | | | | βCD | PO 1 |
|---|---|---|---|---|---|---|---|
| | Temper- | dence | | | | Flow | Flow |
| Exper- | ature | time | PO 1 | PO 2 | NaOH | Rate | Rate |
| iment | (° C.) | (min) | (eq.) | (eq.) | (eq.) | (g/min) | (g/min) |
| KC08-07 | 60 | 70 | 10 | 0 | 5 | 0.80 | 0.11 |
| KC08-08 | 45 | 50 | 16.2 | 0 | 3.5 | 1.06 | 0.23 |

TABLE 42
Summary of results from single PO injection experiments

| | Injections | | | |
|---|---|---|---|---|
| | of | | | |
| | Propylene | | | |
| Experiment | Oxide | Mean D.S. | Std. Dev. | Variance |
| KC08-07 | Single | 5.77 | 1.66 | 2.76 |
| KC07-56 | Double | 6.86 | 1.94 | 3.76 |
| KC08-08 | Single | 6.94 | 1.56 | 2.44 |
| KC07-85 | Double | 7.27 | 2.00 | 4.00 |

In both cases, the resulting variance was significantly lower than in the experiments with two propylene oxide injections. The D.S. was also lower but could be due to the slightly lower amount of propylene oxide used in total. The amount of propylene oxide will be increased in future experiments, but it seems apparent that there is a correlation between the single injection and lower variance.

The other parameter that was tested to see if it influences variance was the total flow rate. The reactor volume was increased by a factor of two, with 60 additional mL of ⅛″ OD tubing being added on to the reactor. The two experiments KC07-84 and KC07-85 were replicated in this larger reactor. The same reaction conditions were carried out, including residence time, and therefore the flow rates were double. The conditions are summarized in Table 43, and the results are summarized in Table 44.

TABLE 40
Experimental conditions for KC08-09 and KC08-10

| | | Residence | | | | βCD Flow | PO 1 Flow | PO 2 Flow |
|---|---|---|---|---|---|---|---|---|
| | Temperature | time | PO 1 | PO 2 | NaOH | Rate | Rate | Rate |
| Experiment | (° C.) | (min) | (eq.) | (eq.) | (eq.) | (g/min) | (g/min) | (g/min) |
| KC08-09 | 45 | 50 | 11 | 9.25 | 3.5 | 2.14 | 0.31 | 0.26 |
| KC08-10 | 45 | 50 | 11 | 9.25 | 11.5 | 2.24 | 0.33 | 0.28 |

TABLE 44
Summary of results from larger volume reactor experiments

| | Total Flow | | | |
|---|---|---|---|---|
| Experiment | Rate (g/min) | Mean D.S. | Std. Dev. | Variance |
| KC08-09 | 2.71 | 6.83 | 1.55 | 2.39 |
| KC07-85 | 1.36 | 7.27 | 2.00 | 4.00 |
| KC08-10 | 2.85 | 7.61 | 2.21 | 4.89 |
| KC07-84 | 1.42 | 8.23 | 1.59 | 2.52 |

For experiment KC08-09, the D.S. ended up being slightly lower than the experiment it was based on, while the variance was significantly lower. For KC08-10, the D.S. was also slightly lower, while the variance was much higher than the experiment it was based on. A clear correlation was not made based on these two experiments. Further testing is required with the larger volume reactor to determine if linear velocity influences variance.

In addition to the experimental work, a tool has been built to measure viscosity of fluids (feedstock material and reaction stream) at varying temperatures. This measurement will allow for the calculation of Reynold's number as well as other dimensionless values to further assess for effects on variance.

### Example 10: Investigation of Oligomeric Substitution Through Methanolysis of HPBCD

During the synthesis of HPBCD from β-cyclodextrin and propylene oxide, it is possible for the 2-hydroxypropyl groups on functionalized HPBCD to react with additional propylene oxide. This results in oligomer-like side chains of propylene glycol on the molecule, which are difficult to distinguish analytically. Malanga et al. (J. Pharm. Sci. 2016. 9, 2921-2931) demonstrated a method by which HPBCD is broken down into individual functionalized glucose molecules, which are then identified via mass spectrometry. The following methanolysis procedure, described in Tables 45 and 46, was adapted from Malanga et al. and performed with D.S.=6.8 HPBCD (lot KN01-69-5).

TABLE 45
MC05-79 mol table

| | | Den- | | | | | |
|---|---|---|---|---|---|---|---|
| | | sity | | Vol | | | |
| | | (g/ | | (mL/ | | Mass | Vol |
| Compound | MW | mL) | Equiv | g) | mmol | (g) | (mL) |
| HPBCD | 1529.86 | | 1 | | 3.01 | 4.61095 | |
| H2SO4 | 98.08 | 1.84 | 6.2 | | 18.76 | 1.84 | 1 |
| (conc) | | | | | | | |
| Methanol | 32.04 | 0.791 | 204.8 | 5.4 | 617.2 | 19.8 | 25 |
| Total | | | | | | 26.2 | |

TABLE 46
MC04-79 procedure

| Operation | Description | Material(s) |
|---|---|---|
| 1 | HPBCD and methanol are charged to a 50 mL | 4.61095 g HPBCD, 25 mL |
| | jacketed reactor equipped with magnetic stirring | methanol |
| | and reflux condenser at 5° C. | |
| 2 | The mixture is stirred at room temperature until | |
| | HPBCD is fully dissolved. | |
| 3 | Concentrated sulfuric acid is added to the | 1 mL concentrated sulfuric |
| | mixture. | acid |
| 4 | The mixture is heated to 70° C. | |
| 5 | The mixture is held at 70° C., with stirring for 43 | |
| | hours | |
| 6 | The mixture is cooled to RT. | |
| 7 | Methanol is added to dilute the mixture for | 100 mL methanol |
| | workup. | |
| 8 | The mixture is neutralized with NaOH | 10% aqueous NaOH |
| | | sufficient |
| | | to reach pH = 10 |
| 9 | The mixture is filtered through a disposable filter | |
| | funnel | |
| 10 | The mixture is treated with Darco G-60 | Approx. 1 g Darco G-60 |
| 11 | The mixture is filtered through a pad of celite to | |
| | remove Darco. | |
| 12 | The mixture is concentrated to dryness via | Results in an amber oil |
| | rotovap. | |

The resulting methanolyzed HPBCD was dissolved to form a 10% mixture in 0.1% formic acid in 1:1 acetonitrile:water and analyzed by direct injection into a Waters Acquity QDa detector. The mass spectrum pictured in FIG. 25 was obtained. Masses corresponding to methylated glucose bearing 0 through 5 2-hydroxypropyl groups were observed, indicating the presence of oligomer-like side chains in the KN01-95-5 lot of HPBCD. However, it is still not possible to distinguish between, for example, a glucose subunit substituted at two positions, and one substituted with a two-member propylene glycol oligomer, as these have identical masses.

Having described the invention in detail, it will be apparent that modifications and variations are possible without departing from the scope of the invention defined in the appended claims.

### Embodiments

1. A hydroxypropyl-β-cyclodextrin (HPBCD) reactor system comprising:
   (a) a propylene oxide feed;
   (b) a β-cyclodextrin feed;
   (c) a mass flow meter or controller; and
   (d) a static mixer.
2. The reactor system of embodiment 1, wherein the propylene oxide feed is pressurized.
3. The reactor system of embodiment 1, wherein the β-cyclodextrin feed is pressurized.
4. The reactor system of embodiment 1, comprising at least two propylene oxide feeds.
5. The reactor system of embodiment 4, wherein the at least two propylene oxide feeds are operably connected to a separate mass flow meter or controller.
6. The reactor system of embodiment 1, further comprising a back pressure regulator.
7. The reactor system of embodiment 1, further comprising a mass flow controller.
8. The reactor system of embodiment 1, further comprising a temperature controller.
9. The reactor system of embodiment 1, wherein the β-cyclodextrin feed comprises NaOH.
10. The reactor system of embodiment 1, wherein the static mixer is a helical static mixer.
11. The reactor system of embodiment 1, wherein one or more of the feeds is operably connected to a syringe pump.
12. The reactor system of embodiment 1, further comprising a coil of tubing.
13. The reactor system of embodiment 1, further comprising a plug flow reactor.
14. The reactor system of embodiment 13, wherein the plug flow reactor comprises at least two coils of tubing and a temperature control unit.
15. The reactor system of embodiment 1, wherein the propylene oxide is dosed in at least two places.
16. The reactor system of embodiment 13, wherein at least one dose of propylene oxide is dosed before the plug flow reactor.
17. The reactor system of embodiment 14, wherein at least one dose of propylene oxide is dosed before the first coil tubing and at least another dose of propylene oxide is dosed before the second coil tubing.
18. The reactor system of embodiment 6, wherein the back pressure regulator is operably connected to a plug flow reactor or a coil of tubing.
19. The reactor system of embodiment 1, further comprising a collection tank.
20. The reactor system of embodiment 19, wherein the collection tank is operably connected to an acid feed.
21. The reactor system of embodiment 8, wherein the temperature control unit maintains a temperature from about 30° C. to about 60° C.
22. The reactor system of embodiment 19, wherein the system provides a total residence time from about 30 minutes to about 70 minutes.
23. The reactor system of embodiment 1, wherein a first propylene oxide feed provides a concentration from about 7 to about 15 equivalents and a second propylene oxide feed provides a concentration from about 3.5 to about 15 equivalents.
24. The reactor system of embodiment 9, wherein the β-cyclodextrin feed comprises a concentration from about 5 to about 10 equivalents of NaOH.
25. The reactor system of embodiment 20, wherein the acid feed comprises hydrochloric acid, sulfuric acid, lactic acid, acetic acid, formic acid, citric acid, oxalic acid, uric acid, malic acid, fumaric acid, tartaric acid, or a combination thereof.
26. A method of manufacturing a hydroxypropyl-β-cyclodextrin (HPBCD) mixture comprising:
   (a) contacting a hydroxypropyl-β-cyclodextrin (HPBCD) mixture with at least two solvents, the HPBCD mixture comprising high degree substitution HPBCD and low degree substitution HPBCD;
   (b) dissolving the high degree substitution HPBCD in one of the solvents; and,
   (c) removing the low degree substitution HPBCD by precipitation.
27. A method of manufacturing a hydroxypropyl-β-cyclodextrin (HPBCD) mixture comprising:
   (a) contacting a hydroxypropyl-β-cyclodextrin (HPBCD) mixture with at least two solvents, the HPBCD mixture comprising high degree substitution HPBCD;
   (b) dissolving the high degree substitution HPBCD in one of the solvents to form a mother liquor;
   (c) filtering off the mother liquor.
28. The method of embodiment 27, further comprising lyophilizing the mother liquor to yield a solid.
29. The method of embodiment 28, further comprising analyzing the solid by MALDI-TOF to determine the degree of substitution.
30. The method of embodiments 26-29, wherein the at least two solvents comprise ethanol and acetone.
31. A composition comprising a methylated 2-hydroxypropyl-β-cyclodextrin (HPBCD) mixture having a degree of substitution from about 6.5 to about 9.5 and methylated glucose bearing from 0 to 5 2-hydroxypropyl groups.
32. The composition of embodiment 31, wherein the composition has a mass spectrum as depicted in FIG. 25.
33. A method of oligomeric substitution through methanolysis of a hydroxypropyl-β-cyclodextrin (HPBCD) mixture, the method comprising:
   (a) mixing HPBCD and methanol;
   (b) stirring until the HPBCD is dissolved;
   (c) adding an acid to the mixture;
   (d) heating the mixture to at least about 50 to about 90° C.;
   (e) stirring the mixture and maintaining the heat for at least about 24 hours;
   (f) neutralizing the mixture with a base; and,
   (g) filtering the mixture.
34. A method of purifying a hydroxypropyl-β-cyclodextrin (HPBCD) mixture comprising:
   (a) purifying a HPBCD mixture by nanofiltration;
   (b) collecting a nanofiltration permeate for a total of at least 5 diafiltration volumes; and,
   (c) lyophilizing a resulting retentate to yield a solid hydroxypropyl-β-cyclodextrin.
35. The method of embodiment 34, wherein the purifying occurs at a feed pressure from about 200 psi to about 400 psi.
36. The method of embodiment 34, wherein the purifying by nanofiltration comprises a flat sheet membrane.
37. The method of embodiment 34, wherein the flat sheet membrane comprises an area from 0.010 to 0.050 m².
38. The method of embodiment 34, comprising collecting a nanofiltration permeate for a total of at least 7 diafiltration volumes.
39. The method of embodiment 34, comprising collecting a nanofiltration permeate for a total of at least 10 diafiltration volumes.
40. A method of purifying a hydroxypropyl-β-cyclodextrin (HPBCD) mixture comprising:
   (a) purifying a HPBCD mixture by nanofiltration;
   (b) collecting a nanofiltration permeate for a total of at least 5 diafiltration volumes; and,
   (c) analyzing a resulting retentate for propylene glycol content.
41. The method of embodiment 40, further comprising lyophilizing the resulting retentate to yield a solid hydroxypropyl-β-cyclodextrin.
42. A method of manufacturing a hydroxypropyl-β-cyclodextrin (HPBCD) mixture comprising:
   (a) contacting a first propylene oxide feed with a beta-cyclodextrin feed to form a first reaction effluent, and
   (b) contacting a second propylene oxide feed with the first reaction effluent to form a second reaction effluent,
   (c) wherein the second reaction effluent comprises a mixture of HPBCD comprising unsubstituted beta-cyclodextrin molecules and beta-cyclodextrin molecules substituted at one or more hydroxyl positions by hydroxypropyl groups.
43. A composition produced by the method of any one of embodiments 26-30 or 33-42, the composition comprising a mixture of beta-cyclodextrin molecules substituted at one or more hydroxyl positions by hydroxypropyl groups, wherein: the mixture comprises from 0% to 0.3% unsubstituted beta-cyclodextrin (“DS-0”) or from 0% to 1% beta-cyclodextrin substituted with one hydroxypropyl group (“DS-1”), wherein the composition is suitable for intrathecal, intravenous, or intracerebroventricular administration to a patient in need thereof.
44. A composition produced by the method of any one of embodiments 26-30 or 33-42, the composition comprising a mixture of beta-cyclodextrin molecules substituted at one or more hydroxyl positions by hydroxypropyl groups, wherein: the mixture comprises from 0% to 1% unsubstituted beta-cyclodextrin (“DS-0”) and beta-cyclodextrin substituted with one hydroxypropyl group (“DS-1”); and, at least 70% of the beta-cyclodextrins have a DS within DSₐ±1σ, wherein σ is the standard deviation.
45. A composition produced by the method of any one of embodiments 26-30 or 33-42, the composition comprising a mixture of beta-cyclodextrin molecules substituted at one or more hydroxyl positions by hydroxypropyl groups, wherein: the mixture comprises from 0% to 1% unsubstituted beta-cyclodextrin (“DS-0”) and beta-cyclodextrin substituted with one hydroxypropyl group (“DS-1”); and, the mixture comprises from 1% to 10% beta-cyclodextrin substituted with seven hydroxypropyl groups (“DS-7”).
46. A composition produced by the method of any one of embodiments 26-30 or 33-42, the composition comprising a mixture of beta-cyclodextrin molecules substituted at one or more hydroxyl positions by hydroxypropyl groups, wherein: the mixture comprises from 0% to 1% unsubstituted beta-cyclodextrin (“DS-0”) and beta-cyclodextrin substituted with one hydroxypropyl group (“DS-1”); and, the mixture comprises no more than 25% beta-cyclodextrin substituted with four hydroxypropyl groups (“DS-4”).
47. A composition produced by the method of any one of embodiments 26-30 or 33-42, the composition comprising a mixture of beta-cyclodextrin molecules substituted at one or more hydroxyl positions by hydroxypropyl groups, wherein: the mixture comprises from 0% to 1% unsubstituted beta-cyclodextrin (“DS-0”) and beta-cyclodextrin substituted with one hydroxypropyl group (“DS-1”); and, the mixture comprises no more than 20% beta-cyclodextrin substituted with five hydroxypropyl groups (“DS-5”).
48. A composition produced by the method of any one of embodiments 26-30 or 33-42, the composition comprising mixture of beta-cyclodextrin molecules substituted at one or more hydroxyl positions by hydroxypropyl groups, wherein: the mixture comprises from 0% to 2.5% beta-cyclodextrin substituted with one hydroxypropyl group (“DS-1”), wherein the composition is suitable for intrathecal, intravenous, or intracerebroventricular administration to a patient in need thereof.
49. A composition produced by the method of any one of embodiments 26-30 or 33-42, the composition comprising a mixture of beta-cyclodextrin molecules substituted at one or more hydroxyl positions by hydroxypropyl groups, wherein: the mixture comprises from 0% to 1% unsubstituted beta-cyclodextrin (“DS-O”) and beta-cyclodextrin substituted with one hydroxypropyl group (“DS-1”); and, the mixture comprises from 5% to 25% beta-cyclodextrin substituted with six hydroxypropyl groups (“DS-6”).
50. A composition produced by the method of any one of embodiments 26-30 or 33-42, the composition comprising a mixture of beta-cyclodextrin molecules substituted at one or more hydroxyl positions by hydroxypropyl groups, wherein: the mixture comprises from 0% to 1% unsubstituted beta-cyclodextrin (“DS-”) and beta cyclodextrin substituted with one hydroxypropyl group (“DS-1”); and beta cyclodextrins having glucose units of the structure:

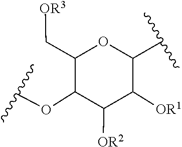

wherein R1, R2, and R3, independently for each occurrence, are —H or —HP, wherein HP comprises one or more hydroxypropyl groups, and the percentage of total occurrences of R1 and R2 combined that are HP ranges from 85% to 95% in the beta-cyclodextrin.

1. A hydroxypropyl-β-cyclodextrin (HPBCD) reactor system comprising:
(a) a propylene oxide feed;
(b) a β-cyclodextrin feed;
(c) a mass flow meter or controller; and
(d) a static mixer.

2. The reactor system of claim 1, wherein the propylene oxide feed is pressurized.

3. The reactor system of claim 1, wherein the β-cyclodextrin feed is pressurized.

4. The reactor system of claim 1, comprising at least two propylene oxide feeds.

5. The reactor system of claim 4, wherein the at least two propylene oxide feeds are operably connected to a separate mass flow meter or controller.

6. The reactor system of claim 1, further comprising a back pressure regulator.

7.-8. (canceled)

9. The reactor system of claim 1, wherein the β-cyclodextrin feed comprises NaOH.

10. The reactor system of claim 1, wherein the static mixer is a helical static mixer.

11. The reactor system of claim 1, wherein one or more of the feeds is operably connected to a syringe pump.

12. The reactor system of claim 1, further comprising a coil of tubing.

13. The reactor system of claim 1, further comprising a plug flow reactor.

14. The reactor system of claim 13, wherein the plug flow reactor comprises at least two coils of tubing and a temperature control unit.

15. The reactor system of claim 1, wherein the propylene oxide is dosed in at least two places.

16. The reactor system of claim 13, wherein at least one dose of propylene oxide is dosed before the plug flow reactor.

17. The reactor system of claim 14, wherein at least one dose of propylene oxide is dosed before the first coil tubing and at least another dose of propylene oxide is dosed before the second coil tubing.

18. The reactor system of claim 6, wherein the back pressure regulator is operably connected to a plug flow reactor or a coil of tubing.

19. (canceled)

20. The reactor system of claim 191, further comprising a collection tank, wherein the collection tank is operably connected to an acid feed.

21. The reactor system of claim 1, further comprising a temperature control unit, wherein the temperature control unit maintains a temperature from about 30° C. to about 60° C.

22. The reactor system of claim 191, further comprising a collection tank, wherein the system provides a total residence time from about 30 minutes to about 70 minutes.

23. The reactor system of claim 1, wherein a first propylene oxide feed provides a concentration from about 7 to about 15 equivalents and a second propylene oxide feed provides a concentration from about 3.5 to about 15 equivalents.

24. The reactor system of claim 9, wherein the β-cyclodextrin feed comprises a concentration from about 5 to about 10 equivalents of NaOH.

25. The reactor system of claim 20, wherein the acid feed comprises hydrochloric acid, sulfuric acid, lactic acid, acetic acid, formic acid, citric acid, oxalic acid, uric acid, malic acid, fumaric acid, tartaric acid, or a combination thereof.

26. The reactor system of claim 1, further comprising a purification process including a vessel for contacting a crude mixture of HPBCD with activated carbon.

27. The reactor system of claim 26, wherein the purification process further comprises a sterile filter.

28. A method of manufacturing a hydroxypropyl-β-cyclodextrin (HPBCD) mixture comprising:
(a) contacting a hydroxypropyl-β-cyclodextrin (HPBCD) mixture with at least two solvents, the HPBCD mixture comprising high degree substitution HPBCD and low degree substitution HPBCD;
(b) dissolving the high degree substitution HPBCD in one of the solvents; and,
(c) removing the low degree substitution HPBCD by precipitation.

29. A method of manufacturing a hydroxypropyl-β-cyclodextrin (HPBCD) mixture comprising:
(a) contacting a hydroxypropyl-β-cyclodextrin (HPBCD) mixture with at least two solvents, the HPBCD mixture comprising high degree substitution HPBCD;
(b) dissolving the high degree substitution HPBCD in one of the solvents to form a mother liquor;
(c) filtering off the mother liquor.

30. The method of claim 29, further comprising lyophilizing the mother liquor to yield a solid.

31. The method of claim 30, further comprising analyzing the solid by MALDI-TOF to determine the degree of substitution.

32.-34. (canceled)

35. A method of oligomeric substitution through methanolysis of a hydroxypropyl-β-cyclodextrin (HPBCD) mixture, the method comprising:
(a) mixing HPBCD and methanol;
(b) stirring until the HPBCD is dissolved;
(c) adding an acid to the mixture;
(d) heating the mixture to at least about 50 to about 90° C.;
(e) stirring the mixture and maintaining the heat for at least about 24 hours;
(f) neutralizing the mixture with a base; and,
(g) filtering the mixture.

36. A method of purifying a hydroxypropyl-β-cyclodextrin (HPBCD) mixture comprising:
(a) purifying a HPBCD mixture by nanofiltration;
(b) collecting a nanofiltration permeate for a total of at least 5 diafiltration volumes; and,
(c) lyophilizing a resulting retentate to yield a solid hydroxypropyl-β-cyclodextrin.

37. The method of claim 36, wherein the purifying occurs at a feed pressure from about 200 psi to about 400 psi.

38. The method of claim 36, wherein the purifying by nanofiltration comprises a flat sheet membrane.

39. The method of claim 38, wherein the flat sheet membrane comprises an area from 0.010 to 0.050 m².

40. The method of claim 36, comprising collecting a nanofiltration permeate for a total of at least 7 diafiltration volumes.

41. The method of claim 36, comprising collecting a nanofiltration permeate for a total of at least 10 diafiltration volumes.

42. A method of purifying a hydroxypropyl-β-cyclodextrin (HPBCD) mixture comprising:
(a) purifying a HPBCD mixture by nanofiltration;
(b) collecting a nanofiltration permeate for a total of at least 5 diafiltration volumes; and,
(c) analyzing a resulting retentate for propylene glycol content.

43.-44. (canceled)

45. A method of manufacturing a hydroxypropyl-β-cyclodextrin (HPBCD) mixture comprising:
(a) contacting a first propylene oxide feed with a beta-cyclodextrin feed to form a first reaction effluent, and
(b) contacting a second propylene oxide feed with the first reaction effluent to form a second reaction effluent,
wherein the second reaction effluent comprises a mixture of HPBCD comprising unsubstituted beta-cyclodextrin molecules and beta-cyclodextrin molecules substituted at one or more hydroxyl positions by hydroxypropyl groups.

46.-53. (canceled)


SEQUENCE LISTING (48 sequences)

SEQ ID NO: 1 - protein, 644 aa, unidentified
  source 1..644: note = Organism is Cellulomonas carboniz T26
MRVSEPLHPSVTAAVAAARDPRTSAEHWAAIEARVAREWPRLERLFLEVYGEGERTRSELAALAHQLVVSAQERPADLRAVDVAREADPAWFTSHRMLGGVCYVDRYAGDLEGLRRHIPYLRELGLTYLHLMPLFEAPAENSDGGYAVSSYRRVNPALGTMEQLTALAAELRENGISLVLDFIFNHTSDEHEWARRALAGEREYEDYYWVFPDREMPDAYERTVREIFPDDHPGSFVPMPDSPDGSRTGRWIWATFHSFQWDLNYANPAVFRAMAGEMLFLANKGVDVLRMDAVAFIWKQLGTACESLPQAHLLIQAFNAALRIAAPGVLFKSEAIVHPDEVVQYISPDECQISYNPLQMALIWSSLATREANLLQQALERRHALPPGTAWVNYVRSHDDIGWTFADEDAAELGIDGFQHRRFLNAFYVDRFPGSFARGVPFQDNPRTGDCRISGTTASLAGLEARDPGAVDRILLAHSIVLSTGGIPLLYLGDEVGQLNDYSYRDQPGLAEDSRWVNRPWYPAQAYANRLVPSTAAGRVFRGLRHLLEVRRRTPELAGGTLVPFDAHNRHVVGYQRPGELDGVPTTVLCLASFADEPQAVEPLTLSGMPAEAEDLLTGATVDLRAGLVLRPHGFVWLRVRHAA

SEQ ID NO: 2 - protein, 636 aa, Neisseria polysaccharea
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLREIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 3 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLQEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 4 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLGEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 5 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLAEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 6 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLSEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 7 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLMEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 8 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLCEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 9 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLKEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 10 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLIEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 11 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLDEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 12 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLYEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 13 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLWEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 14 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLEEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 15 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLLEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 16 - protein, 636 aa, synthetic construct
MLTPTQQVGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLHEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA

SEQ ID NO: 17 - protein, 508 aa, Bifidobacterium longum
MKNKVQLITYADRLGDGTLSSMADILRTRFDGVYDGVHILPFFTPFDGADAGFDPIDHTKVDERLGSWDDVAELSKTHNIMVDAIVNHMSWESKQFQDVLEKGEESEYYPMFLTMSSVFPNGATEEDLAGIYRPRPGLPFTHYKFAGKTRLVWVSFTPQQVDIDTDSDKGWEYLMSIFDQMAASHVSYIRLDAVGYGAKEAGTSCFMTPKTFKLISRLREEGVKRGLEILIEVHSYYKKQVEIASKVDRVYDFALPPLLLHSLFTGHVEPVAHWTEIRPNNAVTVLDTHDGIGVIDIGSDQLDRSLKGLVPDEDVDNLVNTIHANTHGESQAATGAAASNLDLYQVNSTYYSALGCNDQHYLAARAVQFFLPGVPQVYYVGALAGRNDMELLRRTNNGRDINRHYYSTAEIDENLERPVVKALNALAKFRNELPAFDGEFSYEVDGDTSITFRWTAADGTSTAALTFEPGRGLGTDNATPVASLAWSDAAGDHETRDLLANPPIADID

SEQ ID NO: 18 - protein, 490 aa, Leuconostoc mesenteroides
MEIQNKAMLITYADSLGKNLKDVHQVLKEDIGDAIGGVHLLPFFPSTGDRGFAPADYTRVDAAFGDWADVEALGEEYYLMFDFMINHISRESVMYQDFKKNHDDSKYKDFFIRWEKFWAKAGENRPTQADVDLIYKRKDKAPTQEITFDDGTTENLWNTFGEEQIDIDVNSAIAKEFIKTTLEDMVKHGANLIRLDAFAYAVKKVDTNDFFVEPEIWDTLNEVREILTPLKAEILPEIHEHYSIPKKINDHGYFTYDFALPMTTLYTLYSGKTNQLAKWLKMSPMKQFTTLDTHDGIGVVDARDILTDDEIDYASEQLYKVGANVKKTYSSASYNNLDIYQINSTYYSALGNDDAAYLLSRVFQVFAPGIPQIYYVGLLAGENDIALLESTKEGRNINRHYYTREEVKSEVKRPVVANLLKLLSWRNESPAFDLAGSITVDTPTDTTIVVTRQDENGQNKAVLTADAANKTFEIVENGQTVMSSDNLTQN

SEQ ID NO: 19 - protein, 481 aa, Streptococcus mutans
MPIINKTMLITYADSLGKNLKELNENIENYFGDAVGGVHLLPFFPSTGDRGFAPIDYHEVDSAFGDWDDVKCLGEKYYLMFDFMINHISRQSKYYKDYQEKHEASAYKDLFLNWDKFWPKNRPTQEDVDLIYKRKDRAPKQEIQFADGSVEHLWNTFGEEQIDLDVTKEVTMDFIRSTIENLAANGCDLIRLDAFAYAVKKLDTNDFFVEPEIWTLLDKVRDIAAVSGAEILPEIHEHYTIQFKIADHDYYVYDFALPMVTLYSLYSSKVDRLAKWLKMSPMKQFTTLDTHDGIGVVDVKDILTDEEITYTSNELYKVGANVNRKYSTAEYNNLDIYQINSTYYSALGDDDQKYFLARLIQAFAPGIPQVYYVGFLAGKNDLELLESTKEGRNINRHYYSSEEIAKEVKRPVVKALLNLFTYRNQSAAFDLDGRIEVETPNEATIVIERQNKDGSHIAKAEINLQDMTYRVTENDQTISFE

SEQ ID NO: 20 - protein, 481 aa, synthetic construct
MPITNKTMLITYADSLGKNLKELNENIENYFGDAVGGVHLLPFFPSSGDRGFAPIDYHEVDPAFGDWDDVKRLGEKHYLMFDFMINHISRQSKYYKDYQEKHEASAYKDLFLNWDKFWPKNRPTQEDLDLIYKRKDRAPMQEIRFADGSVEHLWSTFGEEQIDLDVTKEVTMDFIRSTIENLAANGCDLIRLDAFAYAVKKLDTNDFFVEPEIWTLLDKVRDIAAVSGAEILPEIHEHYTIQFKIADHGYYVYDFALPMVTLYSLYSGKVDRLAKWLKMSPMKQFTTLDTHDGIGVVDVKDILTDEEITYTSNELYKVGANVNRKYSTAEYNNLDIYQINSTYYSALGDDDQKYFLARLIQAFAPGIPQVYYVGFLAGKNDLELLESTKEGRNINRHYYSSEEIAKEVKRPVVKALLNLFTYRNQSAAFDLDGRIEVETPNEATIVIERQNKDGSHIATAEINLQDMTYRVTENDQTISFE

SEQ ID NO: 21 - protein, 916 aa, Solanum tuberosum
TLSEKIHHPITEQGGESDLSSFAPDAASITSSIKYHAEFTPVFSPERFELPKAFFATAQSVRDSLLINWNATYDIYEKLNMKQAYYLSMEFLQGRALLNAIGNLELTGAFAEALKNLGHNLENVASQEPDAALGNGGLGRLASCFLDSLATLNYPAWGYGLRYKYGLFKQRITKDGQEEVAEDWLEIGSPWEVVRNDVSYPIKFYGKVSTGSDGKRYWIGGEDIKAVAYDVPIPGYKTRTTISLRLWSTQVPSADFDLSAFNAGEHTKACEAQANAEKICYILYPGDESEEGKILRLKQQYTLCSASLQDIISRFERRSGDRIKWEEFPEKVAVQMNDTHPTLCIPELMRILIDLKGLNWNEAWNITQRTVAYTNHTVLPEALEKWSYELMQKLLPRHVEIIEAIDEELVHEIVLKYGSMDLNKLEEKLTTMRILENFDLPSSVAELFIKPEISVDDDTETVEVHDKVEASDKVVTNDEDDTGKKTSVKIEAAAEKDIDKKTPVSPEPAVIPPKKVRMANLCVVGGHAVNGVAEIHSEIVKEEVFNDFYELWPEKFQNKTNGVTPRRWIRFCNPPLSAIITKWTGTEDWVLKTEKLAELQKFADNEDLQNEWREAKRSNKIKVVSFLKEKTGYSVVPDAMFDIQVKRIHEYKRQLLNIFGIVYRYKKMKEMTAAERKTNFVPRVCIFGGKAFATYVQAKRIVKFITDVGATINHDPEIGDLLKVVFVPDYNVSVAELLIPASDLSEHISTAGMEASGTSNMKFAMNGCIQIGTLDGANVEIREEVGEENFFLFGAQAHEIAGLRKERADGKFVPDERFEEVKEFVRSGAFGSYNYDDLIGSLEGNEGFGRADYFLVGKDFPSYIECQEKVDEAYRDQKRWTTMSILNTAGSYKFSSDRTIHEYAKDIWNIEAVEIA

SEQ ID NO: 22 - protein, 480 aa, unidentified
  source 1..480: note = Organism is S. tokodaii
MRKHLKGKAHKKLHMIISITAELGIDFGENFAGGLGVLEGDKFYASARLGIDYTVFTLFYRKGYTGNEEKQKELLKNLVKEWETEIELKKGKIKIEYLTYKLNTAKAIFINILSPDWAKRLNEKLYIENSEEDRFYKYLVLAKATEKYISEKIGWDKIKYVDLQEAYPSFLPLLKYFPRYRIIIHTPAPWGHPTFPARYFKEEFGFEFPFDPVVMTEIGLSSAVQGIVVSKKMLHHVSKTFPHHMHKIKAITNAVEIPRWRHPLLNNVKDLDDFIKKKKEVKKESLKKLGKESDKPTIGWVRRITQYKRPEFILRLIDELRDDVVFIIGGKAHPYEYYGVELEKKFKEYAQKRNNVIYVQGVDIQQMKLAIWSSDIWTFTPYSGWEASGTSFMKAGVNGVPSVASRDGAVPEIIKDGYNGWLYGEDRYELLPVDTYDREYEEFARKVKEALNKYYEVGYNAYHTFSDFCSMDRLMKEYAL

SEQ ID NO: 23 - protein, 796 aa, unidentified
  source 1..796: note = Organism is C. callunae
MSPEKQPLPAALVGSHVRAAAGTPADLATDRKFWTGLSRAVQERIADDWERTREAYGAARQQHYFSAEFLMGRALLNNLTNLGLVDEAAAATRELGHELTDILEIENDAALGNGGLGRLAACFLDSAVTQDYPVTGYGLLYRFGLFRQSFNEGFQVEKPDPWREEEYPFTIRRASDQLVVCFDDMKTRAIPYDMPITGYGTHNVGTLRLWKAEPWEEFDYDAFNSQRFTDAIIERERVSDICRVLYPNDTTYEGKKLRVRQQYFFTSASLQAMIQDHLAHHKDLSNFAEFHSVQLNDTHPVLAIPELMRLLMDEHDMGWEESWAIVSKTFAYTNHTVLTEALEQWDEQIFQQLFWRVWEIIAEIDRRFRLERAADGLDEETINRMAPIQHGTVHMAWIACYAAYSINGVAALHTEIIKAETLADWYALWPEKFNNKTNGVTPRRWLRMINPGLSDLLTRLSGSDDWVTDLDELKKLRSYADDKSVLEELRAIKAANKQDFAEWILERQGIEIDPESIFDVQIKRLHEYKRQLMNALYVLDLYFRIKEDGLTDIPARTVIFGAKAAPGYVRAKAIIKLINSIADLVNNDPEVSPLLKVVFVENYNVSPAEHILPASDVSEQISTAGKEASGTSNMKFMMNGALTLGTMDGANVEIVDSVGEENAYIFGARVEELPALRESYKPYELYETVPGLKRALDALDNGTLNDNNSGLFYDLKHSLIHGYGKDASDTYYVLGDFADYRETRDRMAADYASDPLGWARMAWINICESGRFSSDRTIRDYATEIWKLEPTPAVKK

SEQ ID NO: 24 - protein, 916 aa, synthetic construct
TLSEKIHHPITEQGGESDLSSFAPDAASITSSIKYHAELTPVFSPERFELPKAFFATAQSVRDSLLINWNATYDIYEKLNMKQAYYLSMEFLQGRALLNAIGNLELTGAFAEALKNLGHNLENVASQEPDAALGSGGLGRLASCFLDSLATLNYPAWGYGLRYKYGLFKQRITKDGQEEVAEDWLEIGSPWEVVRNDVSYPIKFYGKVSTGSDGKRYWIGGEDIKAVAYDVPIPGYKTRTTISLRLWSTQVPSADFDLSAFNAGEHTKACEAQANAEKICYILYPGDESEEGKILRLKQQYTLCSASLQDIISRFERRSGDRIKWEEFPEKVAVQMNDTHPTLCIPELMRILIDLKGLNWNEAWNITQRTVAYTNHTVLPEALEKWSYELMQKLLPRHVEIIEAIDEELVHEIVLKYGSMDLNKLEEKLTTMRILENFDLPSSVAELFIKPEISVDDDTETVEVHDKVEASDKVVTNDEDDTGKKTSVKIEAAAEKDIDKKTPVSPEPAVIPPKKVRMANLCVVGGHAVNGVAEIHSEIVKEEVFNDFYELWPEKFQNKTNGVTPRRWIRFCNPPLSAIITKWTGTEDWVLKTEKLAELQKFADNEDLQNEWREAKRSNKIKVVSFLKEKTGYSVVPDAMFDIQVKRIHEYKRQLLNIFGIVYRYKKMKEMTAAERKTNFVPRVCIFGGKAFATYVQAKRIVKFIIDVGATINHDPEIGDLLKVVFVPDYNVSVAELLIPASDLSEHISTAGMEASGTSNMKFAMNGCIQIGTLDGANVEIREEVGEENFFLFGAQAHEIAGLRKERADGKFVPDERFEEVKEFVRSGAFGSYNYDDLIGSLEGNEGFGRADYFLVGKDFPSYIECQEKVDEAYRDQKRWTTMSILNTAGSYKFSSDRTIHEYAKDIWNIEAVEIA

SEQ ID NO: 25 - protein, 712 aa, Bacillus sp.
MKRFMKLTAVWTLWLSLTLGLLSPVHAAPDTSVSNKQNFSTDVIYQIFTDRFSDGNPANNPTGAAFDGSCTNLRLYCGGDWQGIINKINDGYLTGMGITAIWISQPVENIYSVINYSGVHNTAYHGYWARDFKKTNPAYGTMQDFKNLIDTAHAHNIKVIIDFAPNHTSPASSDDPSFAENGRLYDNGNLLGGYTNDTQNLFHHYGGTDFSTIENGIYKNLYDLADLNHNNSSVDVYLKDAIKMWLDLGVDGIRVDAVKHMPFGWQKSFMSTINNYKPVFNFGEWFLGVNEISPEYHQFANESGMSLLDFPFAQKARQVFRDNTDNMYGLKAMLEGSEVDYAQVNDQVTFIDNHDMERFHTSNGDRRKLEQALAFTLTSRGVPAIYYGSEQYMSGGNDPDNRARIPSFSTTTTAYQVIQKLAPLRKSNPAIAYGSTQERWINNDVIIYERKFGNNVAVVAINRNMNTPASITGLVTSLPQGSYNDVLGGILNGNTLTVGAGGAASNFTLAPGGTAVWQYTTDATAPINGNVGPMMAKAGVTITIDGRASARQGTVYFGTTAVTGADIVAWEDTQIQVKILRVPGGIYDIRVANAAGAASNIYDNFEVLTGDQVTVRFVINNATTALGQNVFLTGNVSELGNWDPNNAIGPMYNQVVYQYPTWYYDVSVPAGQTIEFKFLKKQGSTVTWEGGANRTFTTPTSGTATVNVNWQP

SEQ ID NO: 26 - protein, 713 aa, Bacillus circulans
MKKFLKSTAALALGLSLTFGLFSPAQAAPDTSVSNKQNFSTDVIYQIFTDRFSDGNPANNPTGAAFDGTCTNLRLYCGGDWQGIINKINDGYLTGMGVTAIWISQPVENIYSIINYSGVNNTAYHGYWARDFKKTNPAYGTIADFQNLIAAAHAKNIKVIIDFAPNHTSPASSDQPSFAENGRLYDNGTLLGGYTNDTQNLFHHNGGTDFSTTENGIYKNLYDLADLNHNNSTVDVYLKDAIKMWLDLGIDGIRMDAVKHMPFGWQKSFMAAVNNYKPVFTFGEWFLGVNEVSPENHKFANESGMSLLDFRFAQKVRQVFRDNTDNMYGLKAMLEGSAADYAQVDDQVTFIDNHDMERFHASNANRRKLEQALAFTLTSRGVPAIYYGTEQYMSGGTDPDNRARIPSFSTSTTAYQVIQKLAPLRKCNPAIAYGSTQERWINNDVLIYERKFGSNVAVVAVNRNLNAPASISGLVTSLPQGSYNDVLGGLLNGNTLSVGSGGAASNFTLAAGGTAVWQYTAATATPTIGHVGPMMAKPGVTITIDGRGFGSSKGTVYFGTTAVSGADITSWEDTQIKVKIPAVAGGNYNIKVANAAGTASNVYDNFEVLSGDQVSVRFVVNNATTALGQNVYLTGSVSELGNWDPAKAIGPMYNQVVYQYPNWYYDVSVPAGKTIEFKFLKKQGSTVTWEGGSNHTFTAPSSGTATINVNWQP

SEQ ID NO: 27 - protein, 686 aa, Bacillus circulans
APDTSVSNKQNFSTDVIYQIFTDRFSDGNPANNPTGAAFDGTCTNLRLYCGGDWQGIINKINDGYLTGMGVTAIWISQPVENIYSIINYSGVNNTAYHGYWARDFKKTNPAYGTIADFQNLIAAAHAKNIKVIIDFAPNHTSPASSDQPSFAENGRLYDNGTLLGGYTNDTQNLFHHNGGTDFSTTENGIYKNLYDLADLNHNNSTVDVYLKDAIKMWLDLGIDGIRMDAVKHMPFGWQKSFMAAVNNYKPVFTFGEWFLGVNEVSPENHKFANESGMSLLDFRFAQKVRQVFRDNTDNMYGLKAMLEGSAADYAQVDDQVTFIDNHDMERFHASNANRRKLEQALAFTLTSRGVPAIYYGTEQYMSGGTDPDNRARIPSFSTSTTAYQVIQKLAPLRKCNPAIAYGSTQERWINNDVLIYERKFGSNVAVVAVNRNLNAPASISGLVTSLPQGSYNDVLGGLLNGNTLSVGSGGAASNFTLAAGGTAVWQYTAATATPTIGHVGPMMAKPGVTITIDGRGFGSSKGTVYFGTTAVSGADITSWEDTQIKVKIPAVAGGNYNIKVANAAGTASNVYDNFEVLSGDQVSVRFVVNNATTALGQNVYLTGSVSELGNWDPAKAIGPMYNQVVYQYPNWYYDVSVPAGKTIEFKFLKKQGSTVTWEGGSNHTFTAPSSGTATINVNWQP

SEQ ID NO: 28 - protein, 686 aa, synthetic construct
APDTSVSNKQNFSTDVIYQIFTDRFSDGNPRNNPTGAAFDGTCTNLRLYCGGDWQGIINKINDGYLTGMGVTAIWISQPVENIYSIINYSGVNNTAYHGYWARDFKKTNPAYGTIADFQNLIAAAHAKNIKVIIDFAPNHTSPASSDQPSFAENGRLYDNGTLLGGYTNDTQNLFHHNGGTDFSTTENGIYKNLYDLADLNHNNSTVDVYLKDAIKMWLDLGIDGIRMDAVKHMPFGWQKSFMAAVNNYKPVFTFGEWFLGVNEVSPENHKFANESGMSLLDFRFAQKVRQVFRDNTDNMYGLKAMLEGSAADYAQVDDQVTFIDNHDMERFHASNANRRKLEQALAFTLTSRGVPAIYYGTEQYMSGGTDPDNRARIPSFSTSTTAYQVIQKLAPLRKCNPAIAYGSTQERWINNDVLIYERKFGSNVAVVAVNRNLNAPASISGLVTSLPQGSYNDVLGGLLNGNTLSVGSGGAASNFTLAAGGTAVWQYTAATATPTIGHVGPMMAKPGVTITIDGRGFGSSKGTVYFGTTAVSGADITSWEDTQIKVKIPAVAGGNYNIKVANAAGTASNVYDNFEVLSGDQVSVRFVVNNATTALGQNVYLTGSVSELGNWDPAKAIGPMYNQVVYQYPNWYYDVSVPAGKTIEFKFLKKQGSTVTWEGGSNHTFTAPSSGTATINVNWQP

SEQ ID NO: 29 - protein, 685 aa, synthetic construct
APDTSVSNKQNFSTDVIYQIFTDRFSDGNPPNPTGAAFDGTCTNLRLYCGGDWQGIINKINDGYLTGMGVTAIWISQPVENIYSIINYSGVNNTAYHGYWARDFKKTNPAYGTIADFQNLIAAAHAKNIKVIIDFAPNHTSPASSDQPSFAENGRLYDNGTLLGGYTNDTQNLFHHNGGTDFSTTENGIYKNLYDLADLNHNNSTVDVYLKDAIKMWLDLGIDGIRMDAVKHMPFGWQKSFMAAVNNYKPVFTFGEWFLGVNEVSPENHKFANESGMSLLDFRFAQKVRQVFRDNTDNMYGLKAMLEGSAADYAQVDDQVTFIDNHDMERFHASNANRRKLEQALAFTLTSRGVPAIYYGTEQYMSGGTDPDNRARIPSFSTSTTAYQVIQKLAPLRKCNPAIAYGSTQERWINNDVLIYERKFGSNVAVVAVNRNLNAPASISGLVTSLPQGSYNDVLGGLLNGNTLSVGSGGAASNFTLAAGGTAVWQYTAATATPTIGHVGPMMAKPGVTITIDGRGFGSSKGTVYFGTTAVSGADITSWEDTQIKVKIPAVAGGNYNIKVANAAGTASNVYDNFEVLSGDQVSVRFVVNNATTALGQNVYLTGSVSELGNWDPAKAIGPMYNQVVYQYPNWYYDVSVPAGKTIEFKFLKKQGSTVTWEGGSNHTFTAPSSGTATINVNWQP

SEQ ID NO: 30 - protein, 685 aa, synthetic construct
APDTSVSNKQNFSTDVIYQIFTDRFSDGNPTNPTGAAFDGTCTNLRLYCGGDWQGIINKINDGYLTGMGVTAIWISQPVENIYSIINYSGVNNTAYHGYWARDFKKTNPAYGTIADFQNLIAAAHAKNIKVIIDFAPNHTSPASSDQPSFAENGRLYDNGTLLGGYTNDTQNLFHHNGGTDFSTTENGIYKNLYDLADLNHNNSTVDVYLKDAIKMWLDLGIDGIRMDAVKHMPFGWQKSFMAAVNNYKPVFTFGEWFLGVNEVSPENHKFANESGMSLLDFRFAQKVRQVFRDNTDNMYGLKAMLEGSAADYAQVDDQVTFIDNHDMERFHASNANRRKLEQALAFTLTSRGVPAIYYGTEQYMSGGTDPDNRARIPSFSTSTTAYQVIQKLAPLRKCNPAIAYGSTQERWINNDVLIYERKFGSNVAVVAVNRNLNAPASISGLVTSLPQGSYNDVLGGLLNGNTLSVGSGGAASNFTLAAGGTAVWQYTAATATPTIGHVGPMMAKPGVTITIDGRGFGSSKGTVYFGTTAVSGADITSWEDTQIKVKIPAVAGGNYNIKVANAAGTASNVYDNFEVLSGDQVSVRFVVNNATTALGQNVYLTGSVSELGNWDPAKAIGPMYNQVVYQYPNWYYDVSVPAGKTIEFKFLKKQGSTVTWEGGSNHTFTAPSSGTATINVNWQP

SEQ ID NO: 31 - protein, 714 aa, Paenibacillus macerans
MKSRYKRLTSLALSLSMALGISLPAWASPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTLTLITSRSDRLRPQPHVSGRAGTNPGFAENGALYDNGSLLGAYSNDTAGLFHHNGGTDFSTIEDGIYKNLYDLADINHNNNAMDAYFKSAIDLWLGMGVDGIRFDAVKQYPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGTWDPNKAIGPMYNQVIAKYPSWYYDVSVPAGTKLDFKFIKKGGGTVTWEGGGNHTYTTPASGVGTVTVDWQN

SEQ ID NO: 32 - protein, 687 aa, Paenibacillus macerans
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTLTLITSRSDRLRPQPHVSGRAGTNPGFAENGALYDNGSLLGAYSNDTAGLFHHNGGTDFSTIEDGIYKNLYDLADINHNNNAMDAYFKSAIDLWLGMGVDGIRFDAVKQYPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGTWDPNKAIGPMYNQVIAKYPSWYYDVSVPAGTKLDFKFIKKGGGTVTWEGGGNHTYTTPASGVGTVTVDWQN

SEQ ID NO: 33 - protein, 714 aa, Paenibacillus macerans
MKSRYKRLTSLALSLSMALGISLPAWASPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADRDNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 34 - protein, 687 aa, Paenibacillus macerans
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADRDNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 35 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADADNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 36 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADPDNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 37 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADRANPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 38 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADRPNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 39 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADAPNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 40 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADPANPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 41 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADPPNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 42 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTLTLITSRSDRLRPQPHVSGRAGTNPGFAENGALYDNGSLLGAYSNDTAGLFHHNGGTDFSTIEDGIYKNLYDLADINHNNNAMDAYFKSAIDLWLGMGVDGIRFDAVKQYPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGKPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGTWDPNKAIGPMYNQVIAKYPSWYYDVSVPAGTKLDFKFIKKGGGTVTWEGGGNHTYTTPASGVGTVTVDWQN

SEQ ID NO: 43 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKRSGVNNTSYHGYWARDFKQTNDAFGDFADFQNLIDTLTLITSRSDRLRPQPHVSGRAGTNPGFAENGALYDNGSLLGAYSNDTAGLFHHNGGTDFSTIEDGIYKNLYDLADINHNNNAMDAYFKSAIDLWLGMGVDGIRFDAVKQYPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGTWDPNKAIGPMYNQVIAKYPSWYYDVSVPAGTKLDFKFIKKGGGTVTWEGGGNHTYTTPASGVGTVTVDWQN

SEQ ID NO: 44 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKRSGVNNTSYHGYWARDFKQTNDAFGDFADFQNLIDTLTLITSRSDRLRPQPHVSGRAGTNPGFAENGALYDNGSLLGAYSNDTAGLFHHNGGTDFSTIEDGIYKNLYDLADINHNNNAMDAYFKSAIDLWLGMGVDGIRFDAVKQYPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGKPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGTWDPNKAIGPMYNQVIAKYPSWYYDVSVPAGTKLDFKFIKKGGGTVTWEGGGNHTYTTPASGVGTVTVDWQN

SEQ ID NO: 45 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKYSGVNNTSYHGYWARDFKQTNDAFGDFADFQNLIDTAHAHNIKVVIDFAPNHTSPADRDNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGKPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 46 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKRSGVNNTSYHGYWARDFKQTNDAFGDFADFQNLIDTAHAHNIKVVIDFAPNHTSPADRDNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGDPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 47 - protein, 687 aa, synthetic construct
SPDTSVDNKVNFSTDVIYQIVTDRFADGDRTNNPAGDAFSGDRSNLKLYFGGDWQGIIDKINDGYLTGMGVTALWISQPVENITSVIKRSGVNNTSYHGYWARDFKQTNDAFGDFADFQNLIDTAHAHNIKVVIDFAPNHTSPADRDNPGFAENGGMYDNGSLLGAYSNDTAGLFHHNGGTDFSTIEDGIYKNLYDLADINHNNNAMDAYFKSAIDLWLGMGVDGIRFDAVKHMPFGWQKSFVSSIYGGDHPVFTFGEWYLGADQTDGDNIKFANESGMNLLDFEYAQEVREVFRDKTETMKDLYEVLASTESQYDYINNMVTFIDNHDMDRFQVAGSGTRATEQALALTLTSRGVPAIYYGTEQYMTGDGKPNNRAMMTSFNTGTTAYKVIQALAPLRKSNPAIAYGTTTERWVNNDVLIIERKFGSSAALVAINRNSSAAYPISGLLSSLPAGTYSDVLNGLLNGNSITVGSGGAVTNFTLAAGGTAVWQYTAPETSPAIGNVGPTMGQPGNIVTIDGRGFGGTAGTVYFGTTAVTGSGIVSWEDTQIKAVIPKVAAGKTGVSVKTSSGTASNTFKSFNVLTGDQVTVRFLVNQANTNYGTNVYLVGNAAELGSWDPNKAIGPMYNQVIAKYPSWYYDVSVPAGTKLDFKFIKKGGGTVTWEGGGNHTYTTPASGVGTVTVDWQN

SEQ ID NO: 48 - protein, 629 aa, synthetic construct
MGLILQYLKTRILDIYTPEQRAGIEKSEDWRQFSRRMDTHFPKLMNELDSVYGNNEALLPMLEMLLAQAWQSYSQRNSSLKDIDIARENNPDWILSNKQVGGVCYVDLFAGDLKGLKDKIPYFQELGLTYLHLMPLFKCPEGKSDGGYAVSSYRDVNPALGTIGDLREVIAALHEAGISAVVDFIFNHTSNEHEWAQRCAAGDPLFDNFYYIFPDRRMPDQYDRTLNEIFPDQHPGGFSQLEDGRWVWTTFNSFQWDLNYSNPWVFRAMAGEMLFLANLGVDILRMDAVAFIWKQMGTSCENLPQAHALIRAFNAVMRIAAPAVFFKSEAIVHPDQVVQYIGQDECQIGYNPLQMALLWNTLATREVNLLHQALTYRHNLPEHTAWVNYVRSHDDIGWTFADEDAAYLGISGYDHRQFLNRFFVNRFDGSFARGVPFQYNPSTGDCRVSGTAAALVGLAQDDPHAVDRIKLLYSIALSTGGLPLIYLGDEVGTLNDDDWSQDSNKSDDSRWAHRPRYNEALYAQRNDPSTAAGQIYQGLRHMIAVRQSNPRFDGGRLVTFNTNNKHIIGYIRNNALLAFGNFSEYPQTVTAHTLQAMPFKAHDLIGGKTVSLNQDLTLQPYQVMWLEIA